(19) United States
(12) Patent Application Publication
(10) Pub. No.: US 2019/0045193 A1
(43) Pub. Date: Feb. 7, 2019

(54) REGION-BASED MOTION ESTIMATION AND MODELING FOR ACCURATE REGION-BASED MOTION COMPENSATION FOR EFFICIENT VIDEO PROCESSING OR CODING

(71) Applicant: Intel Corporation, Santa Clara, CA (US)

(72) Inventors: Daniel Socek, Miami, FL (US); Atul Puri, Redmond, WA (US)

(21) Appl. No.: 16/023,934

(22) Filed: Jun. 29, 2018

(51) Int. Cl. H04N 19/139; G06T 7/11; G06T 7/194; H04N 19/80; H04N 19/52; H04N 19/132; H04N 19/13; H04N 19/149; H04N 19/103; G06T 5/00; G06T 5/30; H04N 19/23; H04N 19/176

(52) U.S. Cl. CPC H04N 19/139; G06T 7/11; G06T 7/194; H04N 19/80; H04N 19/52; H04N 19/132; H04N 19/176; H04N 19/149; H04N 19/103; G06T 5/002; G06T 5/30; H04N 19/23; H04N 19/13

(57) ABSTRACT

Methods, apparatuses and systems may provide for technology that performs region-based motion estimation. More particularly, implementations relate to technology that provides accurate region-based motion compensation in order to improve video processing efficiency and/or video coding efficiency.

### TECHNICAL FIELD

Embodiments generally relate to region-based motion estimation. More particularly, embodiments relate to technology that provides accurate region-based motion compensation in order to improve video processing efficiency.

### BACKGROUND

Numerous previous approaches have attempted to improve estimation of global motion by a variety of approaches to achieve better global motion compensation and thus enable higher coding efficiency. However, most previous solutions typically use a frame based approach to improve estimation of global motion.

For instance a group of techniques have tried to improve robustness by filtering the often noisy motion field that is typically available from block motion estimation and used as first step in global motion estimation. Another group of techniques have tried to improve global motion compensated prediction by using pixel based motion or model adaptivity (e.g., in a specialized case of panoramas) or higher order motion models. Another group of techniques have tried to improve global motion estimation quality by using better estimation accuracy, an improved framework, or by using variable block size motion. Another group of techniques have tried to get better coding efficiency at low bit cost by improving model efficiency. A still further group of techniques have tried to address the issue of complexity or performance.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustrative block diagram of an example region-based motion analyzer system according to an embodiment;

FIG. 2 is an illustrative diagram of an example region-based parametric motion analysis process according to an embodiment;

FIG. 3 is an illustrative block diagram of a more detailed example region-based motion analyzer system according to an embodiment;

FIG. 4 is an illustrative block diagram of an example video encoder according to an embodiment;

FIG. 5 is an illustrative block diagram of an example Advanced Video Coding video encoder according to an embodiment;

FIG. 6 is an illustrative block diagram of an example High Efficiency Video Coding video encoder according to an embodiment;

FIG. 7 is an illustrative diagram of an example Group of Pictures structure according to an embodiment;

FIG. 8 is an illustrative diagram of various example global motion models with respect to chirping according to an embodiment;

FIGS. 9A-9D are illustrative charts of an example Levenberg-Marquardt Algorithm (LMA) curve fitting model for approximating global motion according to an embodiment;

FIG. 10 is an illustrative block diagram of an example local motion field noise reduction filter according to an embodiment;

FIG. 11 is an illustrative block diagram of an example regions segmenter according to an embodiment;

FIG. 12 is an illustrative chart of an example histogram distribution of locally computed affine global motion model parameters according to an embodiment;

FIG. 13 is an illustrative video sequence of an example of the difference between global and local block based vectors according to an embodiment;

FIG. 14 is an illustrative chart of an example histogram distribution of locally computed affine global motion model parameters using a random sampling approach according to an embodiment;

FIG. 15 is an illustrative video sequence of an example of the difference between global and local block based vectors according to an embodiment;

FIG. 16 is an illustrative video sequence of an example of different computed candidate selection masks according to an embodiment;

FIG. 17 is an illustrative video sequence of an example of different computed candidate selection masks according to an embodiment;

FIG. 18 is an illustrative block diagram of an example global motion model (GMM) for segmentation computer according to an embodiment;

FIG. 19 is an illustrative block diagram of an example motion vectors for GMM segmentation estimation selector according to an embodiment;

FIG. 20 is an illustrative video sequence of an example segmentation method where color is used to assist motion according to an embodiment;

FIG. 21 is a block diagram of an example background moving regions segmenter according to an embodiment;

FIG. 22 is a block diagram of an example foreground moving regions segmenter according to an embodiment;

FIG. 23 is an illustrative video sequence of an example morphological-based post-processing according to an embodiment;

FIG. 24 is an illustrative video sequence of an example regions segmentation method for low-definition content according to an embodiment;

FIG. 25 is an illustrative video sequence of an example regions segmentation method for low-definition content according to an embodiment;

FIG. 26 is an illustrative video sequence of an example regions segmentation method for low-definition content according to an embodiment;

FIG. 27 is an illustrative video sequence of an example regions segmentation method for standard-definition content according to an embodiment;

FIG. 28 is an illustrative video sequence of an example regions segmentation method for high-definition content according to an embodiment;

FIG. 29 is a block diagram of an example morphological-based regions post-processor according to an embodiment;

FIG. 30 is an illustrative video sequence of an example of compensation of detected non-content areas according to an embodiment;

FIG. 31 is an illustrative block diagram of an example multiple region based motion estimator and modeler according to an embodiment;

FIG. 32 is an illustrative block diagram of an example motion vectors for region-based motion modeling (RMM) estimation selector according to an embodiment;

FIG. 33 is an illustrative block diagram of an example adaptive sub-pel interpolation filter selector for region-based motion modeling RMM according to an embodiment;

FIG. 34 is an illustrative block diagram of an example adaptive RMM computer and selector according to an embodiment;

FIG. 35 is an illustrative chart of an example of translational 4-parameter global motion model according to an embodiment;

FIG. 36 is an illustrative block diagram of an example adaptive region-based motion compensator according to an embodiment;

FIG. 37 is an illustrative block diagram of an example region motion parameter and header encoder according to an embodiment;

FIG. 38 is an illustrative chart of an example probability distribution of the best past codebook models according to an embodiment;

FIGS. 39A-39D are an illustrative flow chart of an example process for the region-based motion analyzer system according to an embodiment;

FIG. 40 is an illustrative block diagram of an example video coding system according to an embodiment;

FIG. 41 is an illustrative block diagram of an example of a logic architecture according to an embodiment;

FIG. 42 is an illustrative block diagram of an example system according to an embodiment; and

FIG. 43 is an illustrative diagram of an example of a system having a small form factor according to an embodiment.

### DETAILED DESCRIPTION

As described above, numerous previous approaches have attempted to improve estimation of global motion by a variety of approaches to achieve better global motion compensation and thus enable higher coding efficiency. However, most previous solutions typically use a frame based approach to improve estimation of global motion.

However, while several schemes have managed to progress the state-of-the art, the actual achieved gains have been limited or have considerably fallen short of their objectives. What has been missing so far is a comprehensive approach for improving global motion estimation, compensation, and parameter coding problem. The implementations described herein represents such a solution to the existing failures of the existing state-of-the art, which include: low robustness or reliability in consistently and accurately measuring global motion; insufficiently accurate measured estimate of global motion; computed global motion estimate resulting in poor global motion compensated frame and thus poor global motion compensated prediction error; insufficient gain from use of global motion, even in scenes with global motion; high bit cost of coding global motion parameters; high computational complexity of algorithms; and low adaptivity/high failure rates for complex content and noisy content.

As will be described in greater detail below, implementations described herein may provide a solution to the technical problem of significantly improving, in video scenes with global motion, the quality of global motion estimation, the accuracy of global motion compensation, and the efficiency of global motion parameters coding—in both, a robust and a complexity-bounded manner. For example, instead of frame based single global motion, multiple dominant motions on a region-by-region basis can be compensated adding considerable flexibility over frame-based solution (e.g., as is often typical in global motion operations).

As used herein the term “region-based,” is used herein with regard to “region-based motion modeling” and the like to differentiate from “global motion modeling,” and the like. While the operation of “region-based motion modeling” may have many similarities to “global motion modeling,” when the term “region-based” is used herein it means that the region motion compensation operations being described are operating on an area that can be less in sized than an entire frame, whereas global motion compensation operations, unless expressly described otherwise, typically refer to operations over an entire frame in the art. To clarify further, note that in global motion modeling the estimation of global motion can be done either for a full video frame, or a video frame excluding certain region (say excluding local-motion region) but global motion compensation must be applied on a full frame. However in region-based motion estimation, motion parameters are estimated for a region, and region-based motion compensation is also done on a region basis. Thus in global motion modeling, only one set of global motion parameters are needed to represent parametric motion of a frame but in region-based motion modeling typically the number of motion parameter sets needed are same as number of regions in a frame.

In some implementations, a highly adaptive and accurate approach may be used to address the problem of estimation and compensation of parametric motion of each dominant region (e.g., such as background and foreground region) in video scenes. The solution may be content adaptive as it uses adaptive modeling of frame into regions and motion of each region using best of multiple models that are used to estimate global motion. Further, region-based motion estimation parameters may themselves be computed using one of the two optimization based approaches depending on the selected global motion model. Using estimated region-based motion parameters, compensation of region-based motion may be performed using interpolation filters that are adaptive to nature of the content. Further, the region-based motion parameters may be encoded using a highly adaptive approach that either uses a codebook or a context based differential coding approach for efficient bits representation. The aforementioned improvements in region-based motion estimation/compensation may be achieved under the constraint of keeping complexity as low as possible. Overall, the implementations presented herein present an adaptive and efficient approach for accurate representation of region-based parametric motion for efficient video coding.

For example, the solutions described herein may estimate motion of dominant regions within a video sequence with an improved motion filtering and selection technique for calculation of region-based motion models, calculating multiple region-based motion models for a number of different parametric models per each region (e.g., as opposed to only per each frame). From computed region-based motion models, a determination and selection may be made of the best region-based motion model and the best sub-pel interpolation filter per dominant region of a frame for performing motion compensation. The computed region-based motion model parameters may then be efficiently encoded using a combination of codebook and differential encoding techniques.

Accordingly, some implementations described below present a fast, robust, novel, accurate, and efficient method for performing region-based as well as global motion estimation and compensation in video scenes with global motion. For example, some implementations described below represent a significant step forward in state-of-the-art, and may be applicable to variety of applications including improved long term prediction, motion compensated filtering, frame-rate conversion, and compression efficiency of lossy/lossless video, scalable video, and multi-viewpoint/360 degree video. This tool may be expected to be a candidate for integration in future video standards, although it should also be possible to integrate this tool in extensions of current and upcoming standards such as H.264, H.265, AOM AV1, or H.266, for example.

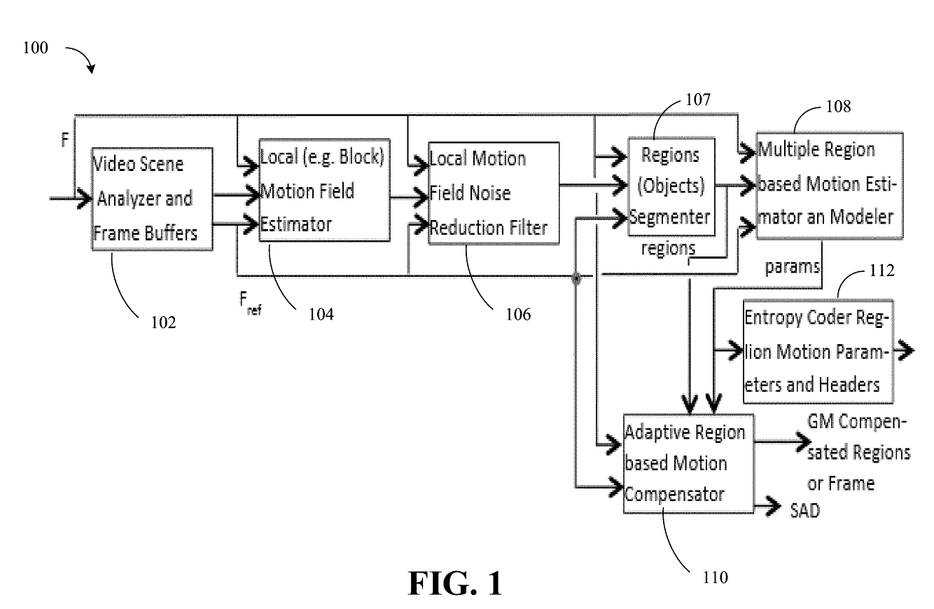

FIG. 1 is an illustrative block diagram of an example region-based motion analyzer system 100, arranged in accordance with at least some implementations of the present disclosure. In various implementations, example region-based motion analyzer system 100 may include a video scene analyzer 102 (e.g., Video Scene Analyzer and Frame Buffer), a local block based motion field estimator 104 (e.g., Local (e.g., Block) Motion Field Estimator), a local motion filed noise reduction filter 106 (e.g., Local Motion Field Noise Reduction Filter), a regions segmenter 107 (e.g., Regions (Objects) Segmenter), a multiple region-based motion estimator and modeler 108 (e.g., Multiple Region Based Motion Estimator and Modeler), an adaptive region-based motion compensator 110 (e.g., Adaptive Region Motion Compensator), a region-based motion model parameter and headers entropy coder 112 (e.g., Entropy Coder Region Motion Parameters and Headers), the like, and/or combinations thereof. For example, some of the individual components of region-based motion analyzer system 100 may not be utilized in all embodiments. In one such example, video scene analyzer 102 may be utilized in some implementations or eliminated in other implementations.

As will be described in greater detail below, example region-based motion analyzer system 100 may be adaptive in nature and may combine the use of statistical methods with segmentation methods in order to increase the quality and precision of the motion modeling in a given frame. For example, region-based motion analyzer system 100 may divide a frame into different moving regions, and adapts between models of different complexity on a region-by-region basis in order to support different motion patterns that can dynamically change. In addition, region-based motion analyzer system 100 may also adapt sub-pixel interpolation filtering operations according to the type of texture that is dominant in the given region.

As illustrated, FIG. 1 shows a high level conceptual diagram of region-based motion analyzer system 100 including aggregated building blocks to simplify discussion. Video frames are shown input to video scene analyzer 102, which performs scene analysis such as scene change detection (and optionally scene transition detection) as well as having frames buffered to enable use of reordered frames (e.g., as per a group-of-pictures organization scheme). Next, a pair of frames (e.g., a current frame and a reference frame) are input to local block based motion field estimator 104, which computes motion-vectors for all blocks of the frame. Next, this motion-field is filtered by local motion filed noise reduction filter 106 to remove noisy motion vector regions.

The filtered motion-field is then input to regions segmenter 107 that segments the frame into several regions (e.g., two or three regions, excluding static regions such as black bars, letterbox black regions, static logo regions, and/or the like) via a regions mask. The regions mask is then provided from regions segmenter 107 to multiple region-based motion estimator and modeler 108. Multiple region-based motion estimator and modeler 108 may compute estimate of region-based motion by trying per frame different motion models and selecting the best one. Next, the selected motion field parameters are encoded by region-based motion model parameter and headers entropy coder 112, and both the regions mask and the motion field is provided to adaptive region-based motion compensator 110, which generates a region-based motion compensated regions and frame.

In operation, region-based motion analyzer system 100 may be operated based on the basic principle that exploitation of region-based parametric motion in video scenes is key to further compression gains by integration in current generation coders as well as development of new generation coders. Further, the implementations described herein, as compared to the current state-of-the-art, offers improvements on all fronts, e.g., region-based parametric motion estimation, region-based parametric motion compensation, and region-based parameters coding.

As regards the region-based motion estimation, significant care is needed not only in selecting a region-based motion model but also how that motion model is computed. For lower to medium order models (such as 4 or parameters) implementations herein may use least square estimation and/or random sampling method. For higher order models (such as 8 and 12 parameters) implementations herein may use the Levenberg-Marquardt Algorithm (LMA) method. For an 8 parameter region-based model, implementations herein may identify many choices that are available, such as the bi-linear model, the perspective model, and the pseudo-perspective model. Via thorough testing, the pseudo-perspective model was found to often be the most consistent and robust. In order to be able to be able determine a separate motion model for each region-type (e.g., background region and foreground region/s) first correct segmentation of a frame is needed into a background region, and foreground region/s is necessary, and while it is not an easy task, it is however quite useful, even if region boundaries are somewhat imprecise. Further, the task of finding any region-based motion model parameters is complicated by noisiness of motion field so a good algorithm for filtering of a region-based motion field was developed to separate outlier vectors that otherwise contribute to distorting calculation of the motion field of each of the regions. Further, while the same region-based motion model can be presumably used for the same (e.g., corresponding) region in a group of frames that have similar motion characteristics, content based adaptivity and digital sampling may require more-or-less an independent selection of motion model per main region-type (e.g., background region and one or more foreground regions) of each frame from among a number of available motion models. Further, rate-distortion constraints can also be used in selection of region-based motion models due to cost of region-based motion parameter coding bits. Lastly, in some implementations herein, additional care may be taken during region-based motion estimation to not include inactive areas of a frame.

As will be described in greater detail below, in operation, once the best motion model for each region-type (e.g., background region and one or more foreground regions) is selected per frame, the model parameters require efficient coding for which the implementations herein may use a hybrid approach that uses a combination of small codebook per region and direct coding of residual coefficients of that region that use prediction from the past if a closest match for region-based parameters is not found in the codebook. Some rate-distortion tradeoffs may be employed to keep coding bit cost low. Further, since a current region-based motion model and a past region-based motion model that is used for prediction may be different in number and type of coefficient, a coefficient mapping strategy may be used by implementations herein to enable successful prediction that can reduce the residual coefficients that need to be coded. The codebook index or coefficient residuals per region may be entropy coded and transmitted to a decoder.

At the decoder, after entropy decoding of coefficient residuals to which prediction is added to generate reconstructed coefficients, or alternatively using coefficients indexed from codebook per region, region-based motion compensation may be performed, which may require sub-pel interpolation. Headers in the encoded stream for each region-type of a frame may be used to indicate the interpolation precision and filtering from among choice of 4 interpolation filter combinations available, to generate correct region-based motion compensated prediction; at encoder various filtering options were evaluated and best selection made and signaled per region per frame via bitstream.

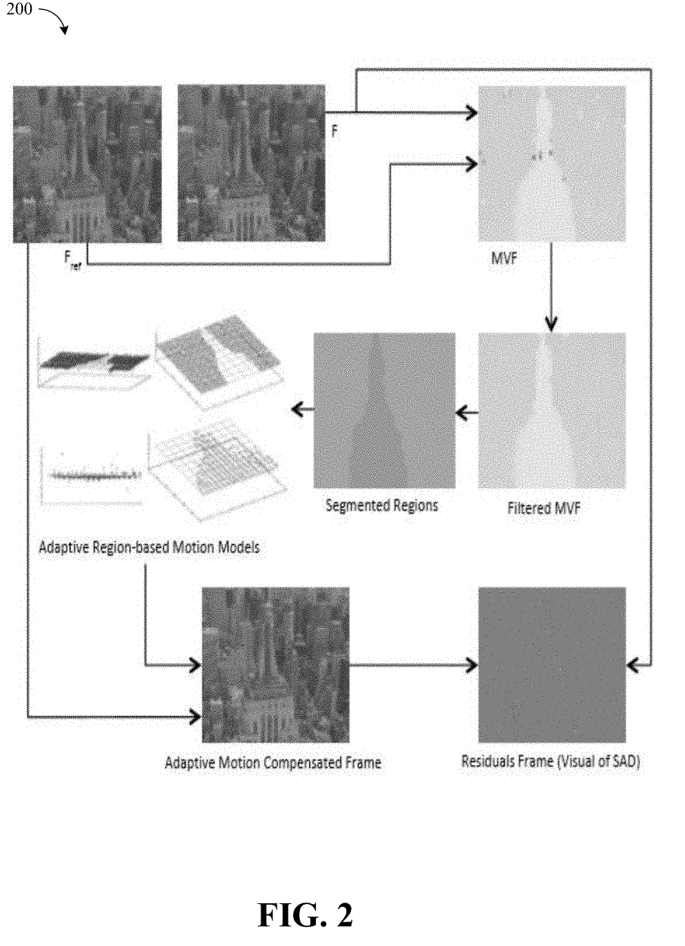

FIG. 2 is an illustrative diagram of an example region-based parametric motion analysis process 200, arranged in accordance with at least some implementations of the present disclosure. In various implementations, FIG. 2 pictorially depicts the various steps in this process using a selected medium motion portion of a “City” sequence. A reference frame F_{ref} of the sequence and current frame F are shown that are used in block motion estimation, which generates motion field MVF. The motion field is then filtered to Filtered MVF and is assisted by other features (such as color and texture) to determine background/foreground Segmented Regions per frame. Next, separately for each of the segmented regions, the best region-based parametric motion model is determined. These models are then used to compute for each of two regions, corresponding motion compensated regions the generation of which requires using the best corresponding interpolation filters to generate high precision sub-pel motion compensation. Together the individual two motion compensated regions form the motion compensated interpolation frame, which is differenced with original frame to compute the residual frame, which is shown to have low energy almost everywhere for this sequence.

Accordingly, implementations of region-based motion analyzer system 100 may be implemented so as to provide the following improvements as compared to other solutions: utilizes moderate complexity only when absolutely necessary to reduce motion compensated residual; provides a high degree of adaptivity to complex content; provides a high degree of adaptivity to noisy content; provides a high robustness in consistently and accurately measuring global motion; ability to deal with static black bars/borders so computed global motion is not adversely impacted; ability to deal with static logos and text overlays so computed global motion is not adversely impacted; improvements in computed global motion estimate results in a good global motion compensated frame and thus lower global motion compensated prediction error; typically provide a good gain from global motion in scenes with small or slowly moving local motion areas; and/or typically provide a low bit cost of coding global motion parameters.

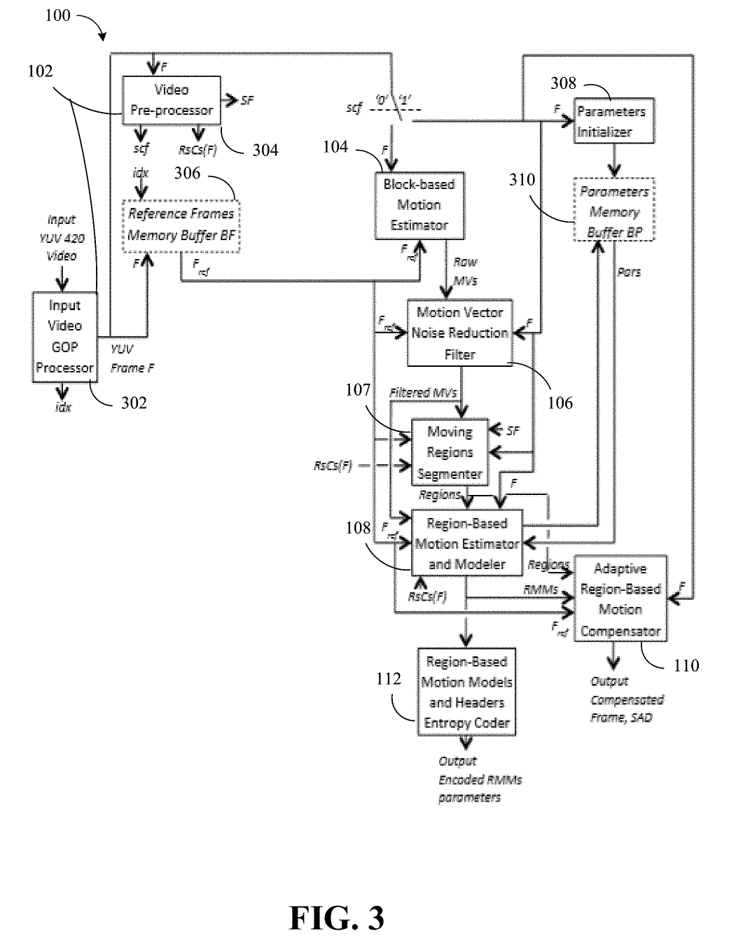

FIG. 3 is an illustrative block diagram of a more detailed example region-based motion analyzer system 100, arranged in accordance with at least some implementations of the present disclosure. In various implementations, example region-based motion analyzer system 100 may include video scene analyzer 102 (e.g., Input Video GOP processor 302 and Video Pre-processor 304), local block based motion field estimator 104 (e.g., Block-based Motion Estimator), local motion filed noise reduction filter 106 (e.g., Motion Vector Noise Reduction Filter), regions segmenter 107 (e.g., Moving Regions Segmenter), multiple region-based motion estimator and modeler 108 (e.g., Region-Based Motion Estimator and Modeler), adaptive region-based motion compensator 110 (e.g., Adaptive Region-Based Motion Compensator), region-based motion model parameter and headers entropy coder 112 (e.g., Region-Based Motion Model and Headers Entropy Coder), the like, and/or combinations thereof. For example, some of the individual components of region-based motion analyzer system 100 may not be utilized in all embodiments. In one such example, video scene analyzer 102 may be utilized in some implementations or eliminated in other implementations. Additionally, region-based motion analyzer system 100 may include reference frames memory buffer 306, parameters initializer 308, and parameters memory buffer 310.

As illustrated, region-based motion analyzer system 100 may operate so that input video is first organized into group of pictures (GOP) form via input video GOP processor 302. Next, current frame F and reference frame F_{ref} may be analyzed in a pre-processing step to detect scene changes and re-set memory buffers/codebook used for entropy coding via video pre-processor 304. If the current frame is not the first frame in the scene then block-based motion estimation may be performed between current frame F and reference frame F_{ref} via local block based motion field estimator 104, where F_{ref} may be retrieved via reference frames memory buffer 306. The resulting motion vector field (MVF) is prone to noise so that motion vector noise reduction filtering may be applied to the motion vector field (MVF) in an attempt to minimize the amount of outlier, noise-related vectors via local motion filed noise reduction filter 106. Next, the filtered vectors may be used to compute motion-based region segmentation mask via regions segmenter 107, denoted in this block diagram as Regions. The core of the proposed algorithm is the adaptive region-based parametric motion estimation and modeling, which may use the filtered motion vectors and regions mask as input for multiple region-based motion estimator and modeler 108. This step may use adaptive selection of motion vectors for region-based parametric motion estimation. In addition, several models (e.g., three models) of different complexity may be evaluated and the most suitable model may be selected for modeling of the region-based moving area of the current frame. The computed region-based motion models (RMMs) may then be passed to the compensation step, which uses an adaptively selected (e.g., out of four available filters) sub-pixel interpolation filtering that best suits the texture type in the given region via adaptive region-based motion compensator 110. RMM parameters may be converted to the reference points MVs representation and reconstructed at quantized accuracy. Adaptive region-based motion compensator 110 may output the reconstructed frame and final SAD/residuals. Finally, the RMMs parameters' (in the reference points MVs form) may be encoded with a codebook-based entropy coder via region-based motion model parameter and headers entropy coder 112. The parameters may either be coded as an index of the existing RMM from the codebook, or as residuals to an existing codeword via region-based motion model parameter and headers entropy coder 112. The residuals may be coded with adaptive modified exp-Golomb codes (e.g., three tables are used with codes of different peak qualities).

Video pre-processor 304 may perform scene change detection. Current and reference (e.g. previous) frames are analyzed in order to detect the beginning of new scene and reinitialize past frames' related information. For example, video pre-processor 304 may signal parameters initializer to initialize parameters memory buffer 310 in response to a determined scene change. For example, pre-processor 304 may perform spatial subsampling of input video for scene change detection. Conversion of YUV420 input frames to block accurate YUV444 frames may be performed (e.g., where Y is at 4×4 block accuracy, while U and V are at a 2×2 block accuracy). In addition, advanced scene change detection (SCD) may be performed in order to detect the beginning of new scene and reinitialize past frames' related information.

Local block based motion field estimator 104 may use block-based motion estimation to create a block-level motion vector field between the current frame and the reference frame(s). In one implementation, graphics hardware-accelerated video motion estimation (VME) routines may be used to generate block-based motion vectors.

Local motion filed noise reduction filter 106 may use motion vector filtering to create a smoother motion vector field from the existing raw field that was created by the local block based motion field estimator 104. This process may serve to eliminate outlier vectors from the motion vector field.

Regions segmenter 107 may perform segmentation of a current frame into moving regions. For example, in such operations a current frame may be divided into a given number of moving regions. This process may include the following steps: (1) computation of global motion model for segmentation operations; (2) performing background moving region segmentation; (3) performing segmentation of remaining (e.g., remaining foreground) moving regions; and/or (4) performing morphological-based post-processing of segmented regions.

Regions segmenter 107 may perform computation of global motion model for segmentation. For example, regions segmenter 107 may estimate a global motion model for the current frame, from which a foreground/background mask can be computed. This step may include computing an initial affine global motion model via random sampling, and then generating a candidate set of motion vector selection masks from which the final affine global motion model for segmentation may be obtained. The selection masks may be used to indicate which vectors are to be used in estimating the model parameters.

Regions segmenter 107 may perform background moving region segmentation. For example, regions segmenter 107 may compute background moving region of the current frame using the motion assisted by color segmentation. In such a motion assisted by color segmentation method, two probability maps may be obtained: a global motion probability map, or GMP map for short, and a dominant color probability map, or DCP map for short. In this method, a GMP map may be used to generate initial foreground/background segments. If the background moving region (e.g., as defined by background moving segments) contains very low texture, a shape of the region may be assisted by its DCP map.

Regions segmenter 107 may perform segmentation of remaining (e.g., remaining foreground) moving regions. For example, for the remaining foreground regions (e.g., a number of the remaining foreground regions may be one less than the total number of moving regions determined in Number of Moving Regions Estimation step) regions segmenter 107 may compute each region's GMP map. Regions segmenter 107 may use each region's GMP map to generate that moving region segments in the current frame. If a region is very low textured, its DCP map may be computed and used to correct the shape of that foreground region.

Regions segmenter 107 may perform morphological-based post-processing of segmented regions. For example, regions segmenter 107 may use morphological opening and closing to clean up the moving regions segmentation mask from a potential salt and pepper type of noise, which is typically common for almost all segmentation methods. In addition, small object removal may be employed as well to remove noise related small segmented blobs. Finally a mask's region boundary may be smoothened by a smoothing filter to remove small spikes and similar artifacts.

Multiple region-based motion estimator and modeler 108 may use region-based motion model generation, which may include several steps. For example, such operations may include several steps: (1) selecting which motion vectors to include in parametric model estimation for each region, (2) adapting sub-pixel filtering method for each region (e.g., since different regions may have different texture properties), and/or (3) adaptively selecting a motion model per region. Such adaptive selection of motion models per region may serve to estimate near-optimal parametric region-based motion models.

Multiple region-based motion estimator and modeler 108 may perform selection of motion vectors for region-based motion model estimation. For example, a random sampling based global motion estimation approach may be used to estimate initial affine global motion model for each region. Blocks whose global motion vector is similar to the corresponding block-based motion vector may be marked as selected. Such operations may be performed hierarchically, for each region separately, by increasing the similarity threshold to several levels of hierarchy (e.g., four levels of hierarchy). One additional mask (e.g., the fifth hierarchy level) may be obtained by eroding the global/local mask from a first hierarchy level. For each mask within a region an affine model may be computed and its SAD-based region-level error estimate may be used to select the best mask. If none of the hierarchical refinement models beats the initial affine model (e.g., in terms of smallest error), the selected blocks inclusion/exclusion mask for the given region may be set to include all blocks from that region.

Multiple region-based motion estimator and modeler 108 may select an adaptive region-based sub-pixel filter. This operation may be adaptively performed depending on the sharpness of the video content within a region. For example, there may be four (or another suitable number) of sub-pixel filtering methods selected for different types of video content, for example, there may be the following filter types: (1) a 1/16-th pixel accurate bilinear filter used mostly for content with blurry texture, (2) a 1/16-th pixel accurate bicubic filter used for content with slightly blurry and normal texture levels, (3) a ⅛-th pixel accurate AVC-based filter usually used for normal and slightly sharp content, and (4) a ⅛-th pixel accurate HEVC-based filter typically used for the sharpest types of content. Selection may be done using an error measure estimate and the filter with the smaller error estimate may be chosen per each region.

Multiple region-based motion estimator and modeler 108 may perform adaptive region-based motion model computation and selection. In such an operation, there may be several (e.g., two) modes of operation defined that may adapt between different motion models for each region: (1) Mode 0 (default mode) which may adaptively switch on a frame basis between translational 4-parameter, affine 6-parameter and pseudo-perspective 8-parameter region-based motion model, and (2) Mode 1 which may adaptively switch on a region basis between affine 6-parameter, pseudo-perspective 8-parameter and bi-quadratic 12-parameter region-based motion model.

Adaptive region-based motion compensator 110 may perform region-based motion model-based compensation. For example, such region-based motion model-based compensation may be done for each block at a pixel level within the block using a corresponding region-based motion model with the selected sub-pel filtering method. For each pixel within a block, a motion vector may be computed using the corresponding region-based motion model and the pixel may be moved at a sub-pel position according to the previously determined sub-pel filtering method. Thus, a pixel on one side of the block may have different motion vector than a pixel on the other side of the same block. Compensation may be done with quantized/reconstructed region-based motion model parameters. In addition, parameter coefficients may be represented as a quotient with denominator scaled (e.g., to a power of two) in order to achieve a fast performance (e.g., by using bitwise shifting instead of division).

Region-based motion model parameter and headers entropy coder 112 may perform codebook-based region-based motion model parameters coding. For example, such codebook-based region-based motion model parameters coding may be used to encode the region-based motion model parameters. Such codebook-based region-based motion model parameters coding may be based on the concept of reference points. The motion vectors corresponding to reference points may be predicted and the residuals may be coded with modified exp-Golomb codes. Predictions may be generated from the codebook that contains several (e.g., up to eight) last occurring region-based motion model parameters for each region separately.

Some implementations described herein generally relate to improvements in estimation, representation and compensation of motion that are key components of an inter-frame coding system, which can directly improve the overall coding efficiency of inter-frame coding. Specifically, some implementations described herein introduce systems and methods to enable significant improvements in global motion estimation, global motion compensation, and global motion parameters coding to improve inter-frame coding efficiency. The improvements include but are not limited to improved modeling of complex global motion, and compact representation of global motion parameters. By comparison, traditional inter-frame video coding typically uses block based motion estimation, compensation and motion vector coding which can mainly compensate for local translator motion and is thus not only is limited in many ways in ability to deal with complex global motion, but also does not allow efficient motion representation.

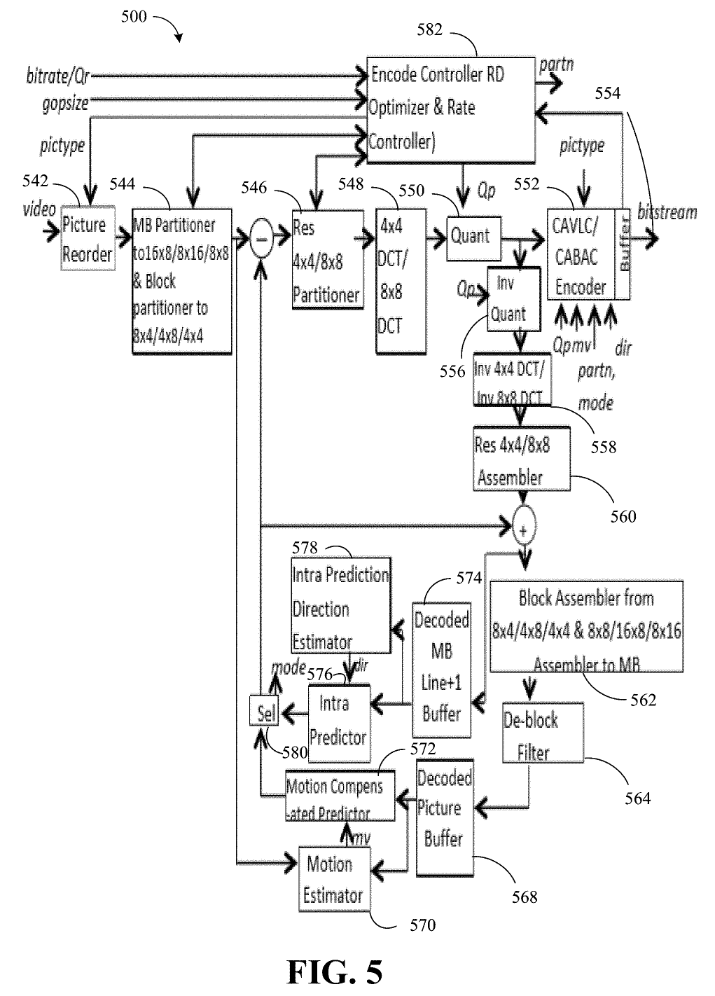

For reference, block based motion estimation forms the core motion compensation approach in recent video coding standards such as ITU-T H.264/ISO MPEG AVC and ITU-T H.265/ISO MPEG HEVC as well as upcoming standards in development such as ITU-T H.266 and the AOM AV1 standard. FIGS. 5-7 below will briefly review inter-frame video coding at a high level.

With reference to region-based motion analyzer system 100 of FIGS. 1, and/or 3, there are a number of practical issues in making a system for global motion estimation and compensation work. [1] high complexity—calculation of global motion estimation (that typically starts after a calculation of block motion vectors) is a heavily compute intensive open-form process, typically requiring a least square minimization type of solution, that is iterative and whose quick convergence is not always guaranteed; [2] motion range limitations—if the starting block motion range is insufficient with respect to fast actual motion, the resulting global motion estimate will likely be quite inaccurate resulting in large prediction residual; [3] insufficient robustness—noisy motion vectors contribute to misdirection of global motion estimation process, not only making convergence hard but also can result in poor global motion estimates; [4] Local/Global motion interaction—often local motion of objects interferes with calculation of global motion causing global motion estimates to be either somewhat inaccurate or even downright erroneous; [5] mismatch of motion model to actual motion in the scene—for instance, if a fixed four parameter global motion model is used to represent changes in perspective in a video scene, the measured motion parameters may be erroneous; [6] limitations in extension of frame boundaries for cases of large motion—while this issue impacts both local block motion compensation as well as global motion compensation, local block motion vectors do not have to follow actual motion and sometimes may provide adequate results due to random matches; [7] limitations due to inactive static area in content—if such an area (e.g., this includes presence of black bars, black borders, letter-boxing, pillar-boxing etc.) is not rejected from global motion estimation, the resulting estimates can be erroneous leading to poor motion compensated prediction; [8] limitations due to static logos or overlaid text—if static logo region and globally moving background region are not separated for global motion estimation then it is difficult to find an accurate global motion estimate and thus global motion compensation quality is likely to suffer; [9] coding bit cost of global motion parameters—since both local and global motion tends to co-exist in a video scene, sending global motion parameters is not sufficient by itself, and needs to be sent in addition to local motion vectors; thus only a limited global motion bit cost can be afforded; and [10] global motion compensation accuracy—if limited precision sub-pel interpolation with simpler filters is performed to reduce motion compensation complexity (e.g., this may be important as this process is needed to be performed both at encoder and decoder), the resulting prediction is often blurry and does not generate small residual signal.

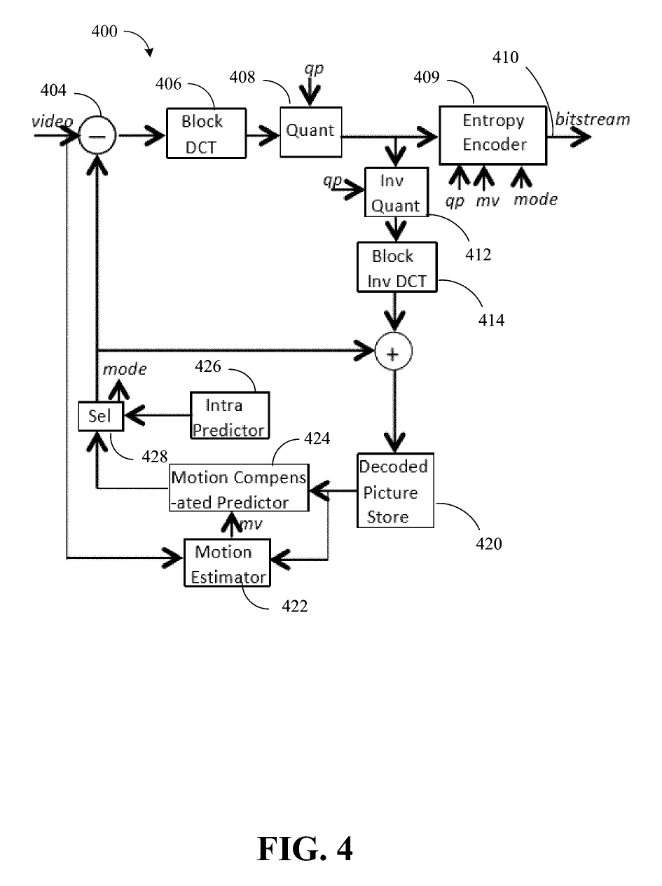

FIG. 4 is an illustrative block diagram of an example video encoder 400, arranged in accordance with at least some implementations of the present disclosure. In various implementations, video encoder 400 may be configured to undertake video coding and/or implement video codecs according to one or more advanced video codec standards, such as, for example, the Advanced Video Coding (e.g., AVC/H.264) video compression standard or the High Efficiency Video Coding (e.g., HEVC/H.265) video compression standard, but is not limited in this regard. Further, in various embodiments, video encoder 400 may be implemented as part of an image processor, video processor, and/or media processor.

As used herein, the term “coder” may refer to an encoder and/or a decoder. Similarly, as used herein, the term “coding” may refer to encoding via an encoder and/or decoding via a decoder. For example video encoder 400 may include a video encoder with an internal video decoder, as illustrated in FIG. 4, while a companion coder may only include a video decoder (not illustrated independently here), and both are examples of a “coder” capable of coding.

In some examples, video encoder 400 may include additional items that have not been shown in FIG. 4 for the sake of clarity. For example, video encoder 400 may include a processor, a radio frequency-type (RF) transceiver a display, an antenna, and/or the like. Further, video encoder 400 may include additional items such as a speaker, a microphone, an accelerometer, memory, a router, network interface logic, and/or the like that have not been shown in FIG. 4 for the sake of clarity.

Video encoder 400 may operate via the general principle of inter-frame coding, or more specifically, motion-compensated (DCT) transform coding that modern standards are based on (although some details may be different for each standard).

Motion estimation is done using fixed or variable size blocks of a frame of video with respect to another frame resulting in displacement motion vectors that are then encoded and sent to the decoder which uses these motion vectors to generate motion compensated prediction blocks. While interframe coders support both intra and inter coding, it is the interframe coding (which involves efficiently coding of residual signal between original blocks and corresponding motion compensated prediction blocks) that provides the significant coding gain. One thing to note is that it is coding of large number of high precision motion vectors of blocks (due to variable block size partitioning, and motion compensation with at least ¼ pixel accuracy as needed to reduce the residual signal) poses a challenge to efficient video coding due to needed coding bits for motion vectors even though clever techniques for motion vector prediction and coding have already been developed. Another issue with block motion vectors is that at best they can represent translatory motion model and are not capable of faithfully representing complex motion.

The key idea in modern interframe coding is thus to combine temporally predictive (motion compensated) coding that adapts to motion of objects between frames of video and is used to compute motion compensated differential residual signal, and spatial transform coding that converts spatial blocks of pixels to blocks of frequency coefficients typically by DCT (of blocksize such as 8×8) followed by reduction in precision of these DCT coefficients by quantization to adapt video quality to available bit-rate. Since the resulting transform coefficients have energy redistributed in lower frequencies, some of the small valued coefficients after quantization turn to zero, as well as some high frequency coefficients can be coded with higher quantization errors, or even skipped altogether. These and other characteristics of transform coefficients such as frequency location, as well as that some quantized levels occur more frequently than others, allows for using frequency domain scanning of coefficients and entropy coding (in its most basic form, variable word length coding) to achieve additional compression gains.

Inter-frame coding includes coding using up to three types picture types (e.g., I-pictures, P-Pictures, and B-pictures) arranged in a fixed or adaptive picture structure that is repeated a few times and collectively referred to as a group-of-pictures (GOP). I-pictures are typically used to provide clean refresh for random access (or channel switching) at frequent intervals. P-pictures are typically used for basic inter-frame coding using motion compensation and may be used successively or intertwined with an arrangement of B-pictures; where, P-pictures may provide moderate compression. B-pictures that are bi-directionally motion compensated and coded inter-frame pictures may provide the highest level of compression.

Since motion compensation is difficult to perform in the transform domain, the first step in an interframe coder is to create a motion compensated prediction error in the pixel domain. For each block of current frame, a prediction block in the reference frame is found using motion vector computed during motion estimation, and differenced to generate prediction error signal. The resulting error signal is transformed using 2D DCT, quantized by an adaptive quantizer (e.g., “quant”) 408, and encoded using an entropy coder 409 (e.g., a Variable Length Coder (VLC) or an arithmetic entropy coder) and buffered for transmission over a channel.

As illustrated, the video content may be differenced at operation 404 with the output from the internal decoding loop 405 to form residual video content.

The residual content may be subjected to video transform operations at transform module (e.g., “block DCT”) 406 and subjected to video quantization processes at quantizer (e.g., “quant”) 408.

The output of transform module (e.g., “block DCT”) 406 and quantizer (e.g., “quant”) 408 may be provided to an entropy encoder 409 and to an inverse transform module (e.g., “inv quant”) 412 and a de-quantization module (e.g., “block inv DCT”) 414. Entropy encoder 409 may output an entropy encoded bitstream 410 for communication to a corresponding decoder.

Within an internal decoding loop of video encoder 400, inverse transform module (e.g., “inv quant”) 412 and de-quantization module (e.g., “block inv DCT”) 414 may implement the inverse of the operations undertaken transform module (e.g., “block DCT”) 406 and quantizer (e.g., “quant”) 408 to provide reconstituted residual content. The reconstituted residual content may be added to the output from the internal decoding loop to form reconstructed decoded video content. Those skilled in the art may recognize that transform and quantization modules and de-quantization and inverse transform modules as described herein may employ scaling techniques. The decoded video content may be provided to a decoded picture store 120, a motion estimator 422, a motion compensated predictor 424 and an intra predictor 426. A selector 428 (e.g., “Sel”) may send out mode information (e.g., intra-mode, inter-mode, etc.) based on the intra-prediction output of intra predictor 426 and the inter-prediction output of motion compensated predictor 424. It will be understood that the same and/or similar operations as described above may be performed in decoder-exclusive implementations of Video encoder 400.

FIG. 5 is an illustrative block diagram of an example Advanced Video Coding (AVC) video encoder 500, arranged in accordance with at least some implementations of the present disclosure. In various implementations, video encoder 500 may be configured to undertake video coding and/or implement video codecs according to one or more advanced video codec standards, such as, for example, the Advanced Video Coding (e.g., AVC/H.264) video compression standard or the High Efficiency Video Coding (e.g., HEVC/H.265) video compression standard, but is not limited in this regard. Further, in various embodiments, video encoder 500 may be implemented as part of an image processor, video processor, and/or media processor.

As illustrated, FIG. 5 shows block diagram of an AVC encoder that follows the principles of the generalized inter-frame video encoder 400 of FIG. 4 discussed earlier. Each frame is partitioned into macroblocks (MB's) that correspond to 16×16 luma (and two corresponding 8×8 chroma signals). Each MB can potentially be used as is or partitioned into either two 16×8's, or two 8×16's or four 8×8's for prediction. Each 8×8 can also be used as is or partitioned into two 8×4's, or two 4×8's or four 4×4's for prediction. The exact partitioning decision depends on coding bit-rate available vs. distortion optimization (by full or partial).

For each MB a coding mode can be assigned from among intra, inter or skip modes in unidirectionally predicted (P-) pictures. B- (bidirectionally) predicted pictures are also supported and include an additional MB or block based direct mode. Even P-pictures can refer to multiple (4 to 5) past references.

In the high profile, transform block size allowed are 4×4 and 8×8 that encode residual signal (generated by intra prediction or motion compensated inter prediction). The generated transform coefficients are quantized and entropy coded using a Context-Adaptive Binary Arithmetic Coding (CABAC) arithmetic encoder. A filter in the coding loop ensures that spurious blockiness noise is filtered, benefitting both objective and subjective quality.

In some examples, during the operation of video encoder 500, current video information may be provided to a picture reorder 542 in the form of a slice of video data. Picture reorder 542 may determine the picture type (e.g., I-, P-, or B-slices) of each video slice and reorder the video slices as needed.

The current video frame may be split so that each MB can potentially be used as is or partitioned into either two 16×8's, or two 8×16's or four 8×8's for prediction, and each 8×8 can also be used as is or partitioned into two 8×4's, or two 4×8's or four 4×4's for prediction at prediction partitioner 544 (e.g., “MB Partitioner”). A coding partitioner 546 (e.g., “Res 4× 4/8×8 Partitioner”) may partition residual macroblocks.

The coding partitioner 546 may be subjected to known video transform and quantization processes, first by a transform 548 (e.g., 4×4 DCT/8×8 DCT), which may perform a discrete cosine transform (DCT) operation, for example. Next, a quantizer 550 (e.g., Quant) may quantize the resultant transform coefficients.

The output of transform and quantization operations may be provided to an entropy encoder 552 as well as to an inverse quantizer 556 (e.g., Inv Quant) and inverse transform 558 (e.g., Inv 4×4 DCT/Inv 8×8 DCT). Encoder 552 (e.g., “CAVLC/CABAC Encoder”) may output an entropy-encoded bitstream 554 for communication to a corresponding decoder.

Within the internal decoding loop of video encoder 500, inverse quantizer 556 and inverse transform 558 may implement the inverse of the operations undertaken by transform 548 and quantizer 550 to provide output to a residual assembler 560 (e.g., Res 4× 4/8×8 Assembler).

The output of residual assembler 560 may be provided to a loop including a prediction assembler 562 (e.g., Block Assembler), a de-block filter 564, a decoded picture buffer 568, a motion estimator 570, a motion compensated predictor 572, a decoded macroblock line plus one buffer 574 (e.g., Decoded MB Line+1 Buffer), an intra prediction direction estimator 576, and an intra predictor 578. As shown in FIG. 5B, the output of either motion compensated predictor 572 or intra predictor 578 is selected via selector 580 (e.g., Sel) and may be combined with the output of residual assembler 560 as input to de-blocking filter 564, and is differenced with the output of prediction partitioner 544 to act as input to coding partitioner 546. An encode controller 582 (e.g., Encode Controller RD Optimizer & Rate Controller) may operate to perform Rate Distortion Optimization (RDO) operations and control the rate of video encoder 500.

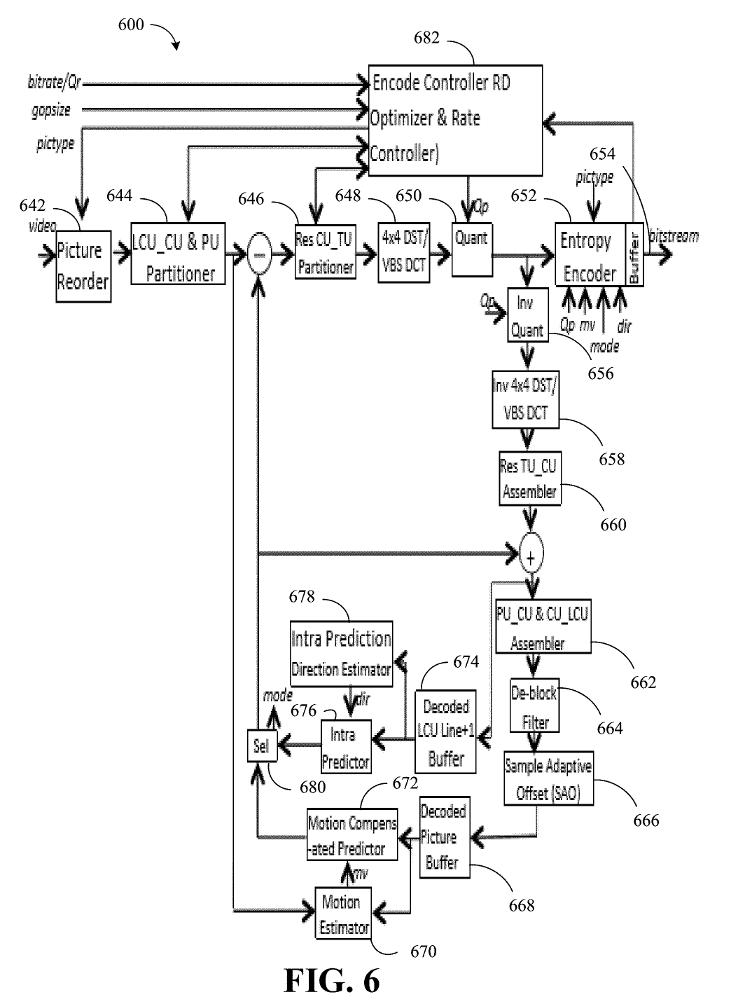

FIG. 6 is an illustrative diagram of an example High Efficiency Video Coder (HEVC) video encoder 600, arranged in accordance with at least some implementations of the present disclosure. In various implementations, video encoder 600 may be configured to undertake video coding and/or implement video codecs according to one or more advanced video codec standards, such as, for example, the Advanced Video Coding (e.g., AVC/H.264) video compression standard or the High Efficiency Video Coding (e.g., HEVC/H.265) video compression standard, but is not limited in this regard. Further, in various embodiments, video encoder 600 may be implemented as part of an image processor, video processor, and/or media processor.

As illustrated in FIG. 6, the high level operation of video encoder 600 follows the principles of general inter-frame encoder discussed earlier via FIG. 4. For instance, video encoder 600 of FIG. 6 is also an inter-frame motion compensated transform encoder that typically either uses a combination of either I- and P-pictures only or I-, P- and B-pictures (note that in HEVC a generalized B-picture (GBP) can be used in place of P-picture) in a non-pyramid, or pyramid GOP arrangement. Further like H.264/AVC coding, not only B-pictures (that can use bi-directional references), but also P-picture can also use multiple references (these references are unidirectional for P-pictures). As in previous standards B-pictures implies forward and backward references, and hence picture reordering is necessary.

In some examples, during the operation of video encoder 600, current video information may be provided to a picture reorder 642 in the form of a frame of video data. Picture reorder 642 may determine the picture type (e.g., I-, P-, or B-frame) of each video frame and reorder the video frames as needed.

The current video frame may be split from Largest Coding Units (LCUs) to coding units (CUs), and a coding unit (CU) may be recursively partitioned into smaller coding units (CUs); additionally, the coding units (CUs) may be partitioned for prediction into prediction units (PUs) at prediction partitioner 644 (e.g., “LC_CU & PU Partitioner). A coding partitioner 646 (e.g., “Res CU_TU Partitioner) may partition residual coding units (CUs) into transform units (TUs).

The coding partitioner 646 may be subjected to known video transform and quantization processes, first by a transform 648 (e.g., 4×4 DCT/VBS DCT), which may perform a discrete cosine transform (DCT) operation, for example. Next, a quantizer 650 (e.g., Quant) may quantize the resultant transform coefficients.

The output of transform and quantization operations may be provided to an entropy encoder 652 as well as to an inverse quantizer 656 (e.g., Inv Quant) and inverse transform 658 (e.g., Inv 4×4 DCT/VBS DCT). Entropy encoder 652 may output an entropy-encoded bitstream 654 for communication to a corresponding decoder.

Within the internal decoding loop of video encoder 600, inverse quantizer 656 and inverse transform 658 may implement the inverse of the operations undertaken by transform 648 and quantizer 650 to provide output to a residual assembler 660 (e.g., Res TU CU Assembler).

The output of residual assembler 660 may be provided to a loop including a prediction assembler 662 (e.g., PU_CU & CU_LCU Assembler), a de-block filter 664, a sample adaptive offset filter 666 (e.g., Sample Adaptive Offset (SAO)), a decoded picture buffer 668, a motion estimator 670, a motion compensated predictor 672, a decoded largest coding unit line plus one buffer 674 (e.g., Decoded LCU Line+1 Buffer), an intra prediction direction estimator 676, and an intra predictor 678. As shown in FIG. 6B, the output of either motion compensated predictor 672 or intra predictor 678 is selected via selector 680 (e.g., Sel) and may be combined with the output of residual assembler 660 as input to de-blocking filter 664, and is differenced with the output of prediction partitioner 644 to act as input to coding partitioner 646. An encode controller 682 (e.g., Encode Controller RD Optimizer & Rate Controller) may operate to perform Rate Distortion Optimization (RDO) operations and control the rate of video encoder 600.

In operation, the Largest Coding Unit (LCU) to coding units (CU) partitioner partitions LCU's to CUs, and a CU can be recursively partitioned into smaller CU's. The CU to prediction unit (PU) partitioner partitions CUs for prediction into PUs, and the TU partitioner partitions residual CUs into Transforms Units (TUs). TUs correspond to the size of transform blocks used in transform coding. The transform coefficients are quantized according to Qp in bitstream. Different Qp's can be specified for each CU depending on maxCuDQpDepth with LCU based adaptation being of the least granularity. The encode decisions, quantized transformed difference and motion vectors and modes are encoded in the bitstream using Context Adaptive Binary Arithmetic Coder (CABAC).

An Encode Controller controls the degree of partitioning performed, which depends on quantizer used in transform coding. The CU/PU Assembler and TU Assembler perform the reverse function of partitioner. The decoded (every DPCM encoder incorporates a decoder loop) intra/motion compensated difference partitions are assembled following inverse DST/DCT to which prediction PUs are added and reconstructed signal then Deblock, and SAO Filtered that correspondingly reduce appearance of artifacts and restore edges impacted by coding. HEVC uses Intra and Inter prediction modes to predict portions of frames and encodes the difference signal by transforming it. HEVC uses various transform sizes called Transforms Units (TU). The transform coefficients are quantized according to Qp in the bitstream. Different Qps can be specified for each CU depending on maxCuDQpDepth.

AVC or HEVC encoding classifies pictures or frames into one of 3 basic picture types (pictyp), I-Picture, P-Pictures, and B-Pictures. Both AVC and HEVC also allow out of order coding of B pictures, where the typical method is to encode a Group of Pictures (GOP) in out of order pyramid configuration. The typical Pyramid GOP configuration uses 8 pictures Group of Pictures (GOP) size (gopsz). The out of order delay of B Pictures in the Pyramid configuration is called the picture level in pyramid (piclvl).

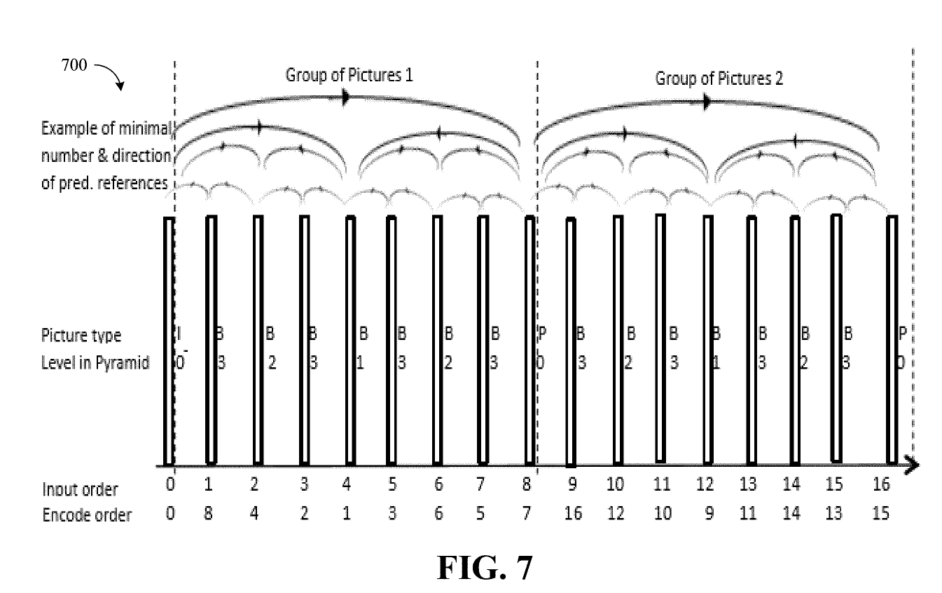

FIG. 7 shows an example Group of Pictures 700 structure. Group of Pictures 400 shows a first 17 frames (frames 0 to 16) including a first frame (frame 0) an intra frame followed by two GOPs, each with eight pictures each. In the first GOP, frame 8 is a P frame (or can also be a Generalized B (GPB) frame) and is a level 0 frame in the pyramid. Whereas frame 1 is a first level B-frame, frame 2 and 6 are second level B-frames, and frames 1, 3, 5 and 7 are all third level B-frames. For instance, frame 1 is called the first level B-frame, as it only needs the I-frame (or the last P-frame of previous GOP) as the previous reference and actual P-frame of current GOP as the next reference to create predictions necessary for encoding frame 1. In fact, frame 1 can use more than 2 references, although 2 references may be used to illustrate the principle. Further, frames 2 and 6 are called second level B-frames as they use first level B-frame (frame 1) as a reference, along with a neighboring I and P-frame. Similarly level 3 B-frames use at least one level 2 B-frame as a reference. A second GOP (frame 9 through 16) of the same size is shown, that uses decoded P-frame of previous GOP (instead of I-frame as in case of previous GOP), e.g., frame 8 as one reference; where the rest of the second GOP works identically to the first GOP. In terms of encoding order, the encoded bitstream encodes frame 0, followed by frame 8, frame 4, frame 2, frame 1, frame 3, frame 6, frame 5, frame 7, etc. as shown in the figure.

As used herein, the term “coder” may refer to an encoder and/or a decoder. Similarly, as used herein, the term “coding” may refer to encoding via an encoder and/or decoding via a decoder. For example video encoder 400, 500, 600, and the like may include a video encoder with an internal video decoder, as illustrated in FIGS. 4, 5, and 6, while a companion coder may only include a video decoder (not illustrated independently here), and both are examples of a “coder” capable of coding.

Global Motion Models:

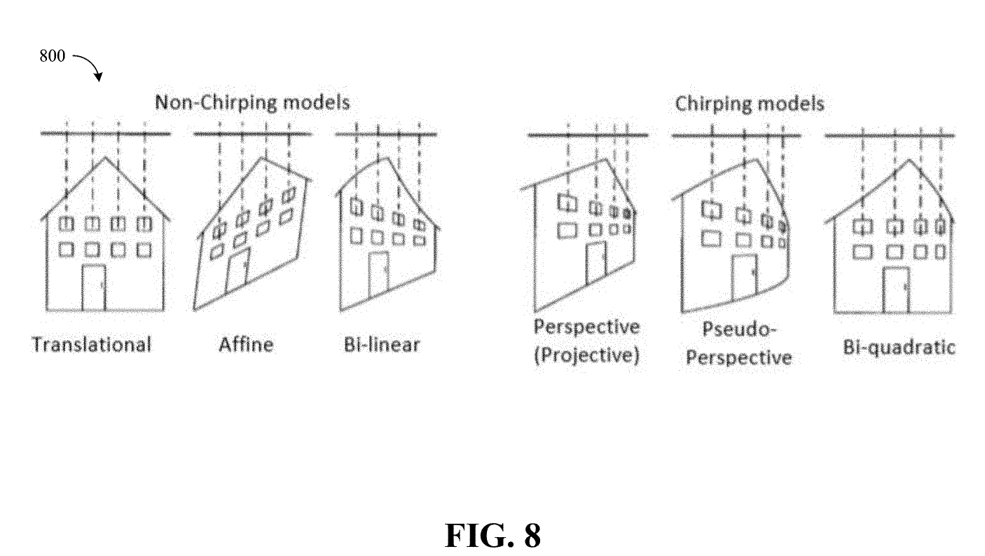

FIG. 8 is an illustrative diagram of various example global motion models 800 with respect to chirping, arranged in accordance with at least some implementations of the present disclosure. In various implementations, example global motion models 800 may include a translational non-chirping model, an affine non-chirping model, a bi-liner non-chirping model, a perspective (e.g., projective) chirping model, a pseudo-perspective chirping model, a bi-biquadratic chirping model, the like, and/or combinations thereof.

A number of global motion models have been proposed in published literature. Generally speaking, a particular motion model establishes a tradeoff between the complexity of the model and the ability to handle different types of camera related motions, scene depth/perspective projections, etc. Models are often classified into linear (e.g., simple) models, and nonlinear (e.g., complex models). Linear models are capable of handling normal camera operations such as translational motion, rotation and even zoom. More complex models, which are typically non-linear and contain at least one quadratic (or higher order) term, are often used in cases when there is complex scene depth, strong perspective projection effects in the scene, or simply if more precision is needed for a given application. One disadvantage of non-linear models is that they have higher computational complexity. On the other hand, Translational and affine models are more prone to errors when noisy motion vector field is used for GME. The most commonly used models for global motion estimation in video coding applications are simpler, linear models.

Suppose we are given a motion vector field, (MXᵢ, MYᵢ), i=0, . . . , N−1, where N is the number of motion vectors in the frame. Then, each position (xᵢ, yᵢ) corresponding to the center of the block i of the frame is moved to (x′ᵢ, y′ᵢ) as per motion vector (MXᵢ, MYᵢ) as follows:

xᵢ′=xᵢ+MXᵢ

yᵢ′=yᵢ+MYᵢ

A simple 4-parameter motion model aims to approximate these global motion moves of frame positions by a single linear equation with a total of 4 parameters {a₀, a₁, a₂, a₃}:

xᵢ′=a₀x₁+a₁

yᵢ′=a₂y₁+a₃

This equation defines translational 4-parameter motion model. Another 4-parameter model, is referred to as a pseudo-affine 4-parameter motion model. Pseudo-affine motion model is defined as:

xᵢ′=a₀x₁+a₁yᵢ+a₂

yᵢ′=a₀yᵢ−a₁xᵢ+a₃

The advantage of pseudo-affine model is that it often can estimate additional types of global motion while having the same number of parameters as a simple translational model. One of the most commonly used motion models in practice is the 6-parameter affine global motion model. It can more precisely estimate most of the typical global motion caused by camera operations. The affine model is defined as follows:

xᵢ′=a₀xᵢ+a₁yᵢ+a₂

yᵢ′=a₃xᵢ+a₄yᵢ+a₅

Unfortunately, linear models cannot handle camera pan and tilt properly. Thus, non-linear models are required for video scenes with these effects. More complex models are typically represented with quadratic terms. They are widely used for video applications such as medical imaging, remote sensing or computer graphics. The simplest non-linear model is bi-linear 8-parameter global motion model which is defined as:

xᵢ′=a₀xᵢyᵢ+a₁xᵢ+a₂yᵢ+a₃

yᵢ′=a₄xᵢyᵢ+a₅xᵢ+a₆yᵢ+a₇

Another popular 8-parameter model is perspective (or projective) 8-parameter global motion model. This model is designed to handle video scenes with strong perspective, which creates global motion field that follows more complex non-linear distribution. The Projective model is defined as follows:

$${x}_{i}^{′} = \frac{{a}_{0} {x}_{i} + {a}_{1} {y}_{i} + {a}_{2}}{{a}_{6} {x}_{i} + {a}_{7} {y}_{i} + 1}$$

$${y}_{i}^{′} = \frac{{a}_{3} {x}_{i} + {a}_{4} {y}_{i} + {a}_{5}}{{a}_{6} {x}_{i} + {a}_{7} {y}_{i} + 1}$$

A variant of the perspective model, called pseudo perspective model, has been is shown to have a good overall performance as it can handle perspective projections and related effects such as “chirping” (the effect of increasing or decreasing spatial frequency with respect to spatial location).

One 8-parameter pseudo-perspective model, is defined as follows:

xᵢ′=a₀xᵢ²+a₁xᵢyᵢ+a₂xᵢ+a₃yᵢ+a₄

yᵢ′=a₁yᵢ²+a₀xᵢyᵢ+a₅xᵢ+a₆yᵢ+a₇

Pseudo-projective model has an advantage over the perspective model because it typically has smaller computational complexity during the estimation process while at the same time is being able to handle all perspective-related effects on 2-D global motion field. Perspective model has been known to be notoriously difficult to estimate and often requires many more iterations in the estimation process.

FIG. 8 shows pictorial effects of different modeling functions. As illustrated, the pseudo-perspective model can produce both chirping and converging effects, and it is the best approximation of perspective mapping using low order polynomials. It also shows that bilinear function, although also has 8-parameters like perspective and pseudo-perspective models, fails to capture the chirping effect.

Finally, for video applications where very high precision in modeling is required, capable of handling all degrees of freedom in camera operations and perspective mapping effects, Bi-quadratic model can be used. It is a 12-parameter model, and thus most expensive in terms of coding cost. Bi-quadratic 12-parameter model is defines as follows:

xᵢ′=a₀xᵢ²+a₁yᵢ²+a₂xᵢyᵢ+a₃xᵢ+a₄yᵢ+a₅

yᵢ′=a₆xᵢ²+a₇yᵢ²+a₈xᵢyᵢ+a₉xᵢ+aₙyᵢ+a₁₁

Table 1 shows summary of the aforementioned global motion models. For example, other, even higher order polynomial models are possible to define (e.g., 20-parameter bi-cubic model) but are rarely used in practice because of extremely high coding cost.

TABLE 1
summary of global motion models and their proper:

| Motion | | Number of |
|---|---|---|
| Model | Model Equation | Parameters |
| Trans- lational | $( \begin{matrix}{x}^{′} \\ {y}^{′}\end{matrix} ) = ( \begin{matrix}{a}_{0} x + {a}_{1} \\ {a}_{2} x + {a}_{3}\end{matrix} )$ | 4 |
| Pseudo- Affine | $( \begin{matrix}{x}^{′} \\ {y}^{′}\end{matrix} ) = ( \begin{matrix}{a}_{0} x + {a}_{1} y + {a}_{2} \\ {a}_{0} y - {a}_{1} x + {a}_{3}\end{matrix} )$ | 4 |
| Affine | $( \begin{matrix}{x}^{′} \\ {y}^{′}\end{matrix} ) = ( \begin{matrix}{a}_{0} x + {a}_{1} y + {a}_{2} \\ {a}_{3} x + {a}_{4} y + {a}_{5}\end{matrix} )$ | 6 |
| Bi-linear | $( \begin{matrix}{x}^{′} \\ {y}^{′}\end{matrix} ) = ( \begin{matrix}{a}_{0} xy + {a}_{1} x + {a}_{2} y + {a}_{3} \\ {a}_{4} xy + {a}_{5} x + {a}_{6} y + {a}_{7}\end{matrix} )$ | 8 |
| Perspec- tive | $( \begin{matrix}{x}^{′} \\ {y}^{′}\end{matrix} ) = ( \begin{matrix}( {a}_{0} x + {a}_{1} y + {a}_{2} ) / ( {a}_{6} x + {a}_{7} y + 1 ) \\ ( {a}_{3} x + {a}_{4} y + {a}_{5} ) / ( {a}_{6} x + {a}_{7} y + 1 )\end{matrix} )$ | 8 |
| Pseudo- Perspec- tive | $( \begin{matrix}{x}^{′} \\ {y}^{′}\end{matrix} ) = ( \begin{matrix}{a}_{0} {x}_{i}^{2} + {a}_{1} {x}_{i} {y}_{i} + {a}_{2} {x}_{i} + {a}_{3} {y}_{i} + {a}_{4} \\ {a}_{1} {y}_{i}^{2} + {a}_{0} {x}_{i} {y}_{i} + {a}_{5} {x}_{i} + {a}_{6} {y}_{i} + {a}_{7}\end{matrix} )$ | 8 |
| Bi- quadratic | $( \begin{matrix}{x}^{′} \\ {y}^{′}\end{matrix} ) = ( \begin{matrix}{a}_{0} {x}^{2} + {a}_{1} {y}^{2} + {a}_{2} xy + {a}_{3} x + {a}_{4} y + {a}_{5} \\ {a}_{6} {x}^{2} + {a}_{7} {y}^{2} + {a}_{8} xy + {a}_{9} x + {a}_{10} y + {a}_{11}\end{matrix} )$ | 12 |

Global Motion Model Estimation Approaches:

Most common techniques used to estimate the desired model's parameters are based on the least squares fitting. Next describe several least squares based methods are described that are used to compute the parameters of a global motion model.

Global Motion Model—Least Square Estimation:

Least squares error fitting method is often used to estimate optimal motion model parameter values. It is a standard approach used to find solutions to over-determined systems (e.g., sets of equations with more equations than unknowns).

In global motion estimation a motion vector field is given, (MXᵢ,MYᵢ), i=0, . . . , N−1, where N is the number of motion vectors in the frame. According to the motion field, each position (xᵢ, yᵢ) corresponding to the center of the block i of the frame is moved to (x′ᵢ, y′ᵢ) as per motion vector (mxᵢ, myᵢ) as follows:

xᵢ′=xᵢ+MXᵢ

yᵢ′=yᵢ+MYᵢ

In a 4-parameter Translational motion model the goal is to approximate 4 parameters {a₀, a₁, a₂, a₃} so that the difference between observed data (x′ᵢ, y′ᵢ) and modeled data (a₀xᵢ+a₁, a₂yᵢ+a₃) is minimized. Least squares approach minimizes the following two squared errors with respect to parameters {a₀, a₁} and {a₂, a₃}:

SEₐ_{₀}ₐ_{₁}=Σᵢ₌₀^{N-1}(xᵢ′−(a₀xᵢ+a₁))²

SEₐ_{₂}ₐ_{₃}=Σᵢ₌₀^{N-1}(yᵢ′−(a₂yᵢ+a₃))²

Typically the number of parameters (4 in this example) is much smaller than the total number of vectors used for estimation, making it an over-determined system.

For linear global motion models (such as Translational, Pseudo-Affine and Affine, for example), the minimum of the sum of squares is found by taking the partial derivatives with respect to each parameter and setting it to zero. This results in the set of linear equations whose solution represents the global minimum in the squared error sense, e.g., the least squares error. The above equation for a 4-parameter affine motion model with respect to {a₀, a₁} is expanded as follows:

$$\begin{matrix}{SE}_{{a}_{0} {a}_{1}} = {\sum }_{i = 0}^{N - 1} {( {x}_{i}^{′2} + {a}_{0}^{2} {x}_{i}^{2} + {a}_{1}^{2} - 2 {a}_{0} {x}_{i} {x}_{i}^{′} - 2 {a}_{1} {x}_{i}^{′} + 2 {a}_{0} {a}_{1} {x}_{i} )}^{2} = \\ = {\sum }_{i = 0}^{N - 1} {x}_{i }^{′2} + {a}_{0}^{2} {\sum }_{i = 0}^{N - 1} {x}_{i}^{2} + {a}_{1}^{2} N - 2 {a}_{0} {\sum }_{i = 0}^{N - 1} {x}_{i} {x}_{i}^{′} - \\ 2 {a}_{1} {\sum }_{i = 0}^{N - 1} {x}_{i}^{′} + 2 {a}_{0} {a}_{1} {\sum }_{i = 0}^{N - 1} {x}_{i}\end{matrix}$$

Taking partial derivatives of the above equation yields the following system:

$$\frac{\partial {SE}_{{a}_{0} {a}_{1}}}{\partial {a}_{0}} = 2 {a}_{0} {\sum }_{i = 0}^{N - 1} {x}_{i}^{2} + 2 {a}_{1} {\sum }_{i = 0}^{N - 1} {x}_{i} - 2 {\sum }_{i = 0}^{N - 1} {x}_{i} {x}_{i}^{′} = 0$$

$$\frac{\partial {SE}_{{a}_{0} {a}_{1}}}{\partial {a}_{1}} = 2 {a}_{0} {\sum }_{i = 0}^{N - 1} {x}_{i} + 2 {a}_{1} N - 2 {\sum }_{i = 0}^{N - 1} {x}_{i}^{′} = 0$$

The system from above can be expressed as the following matrix equation which solution determines the two unknown parameters {a₀, a₁}:

$$( \begin{matrix}{a}_{0} \\ {a}_{1}\end{matrix} ) = {( \begin{matrix}{\sum }_{i = 0}^{N - 1} {x}_{i}^{2} & {\sum }_{i = 0}^{N - 1} {x}_{i} \\ {\sum }_{i = 0}^{N - 1} {x}_{i} & N\end{matrix} )}^{- 1} ( \begin{matrix}{\sum }_{i = 0}^{N - 1} {x}_{i} {x}_{i}^{2} \\ {\sum }_{i = 0}^{N - 1} {x}_{i}^{′}\end{matrix} )$$

Similarly, one is able to express the second set of parameters {a₂, a₃} as the solution to the following matrix equation:

$$( \begin{matrix}{a}_{2} \\ {a}_{3}\end{matrix} ) = {( \begin{matrix}{\sum }_{i = 0}^{N - 1} {y}_{i}^{2} & {\sum }_{i = 0}^{N - 1} {y}_{i} \\ {\sum }_{i = 0}^{N - 1} {y}_{i} & N\end{matrix} )}^{- 1} ( \begin{matrix}{\sum }_{i = 0}^{N - 1} {y}_{i} {y}_{i}^{′} \\ {\sum }_{i = 0}^{N - 1} {y}_{i}^{′}\end{matrix} )$$

If a determinant based solution to matrix inverse is used, the two matrix equations from above can be further expressed as:

$$( \begin{matrix}{a}_{0} \\ {a}_{1}\end{matrix} ) = \frac{1}{N {\sum }_{i = 0}^{N - 1} {x}_{i}^{2} - {( {\sum }_{i = 0}^{N - 1} {x}_{i} )}^{2}} ( \begin{matrix}N & - {\sum }_{i = 0}^{N - 1} {x}_{i} \\ - {\sum }_{i = 0}^{N - 1} {x}_{i} & {\sum }_{i = 0}^{N - 1} {x}_{i}^{2}\end{matrix} ) ( \begin{matrix}{\sum }_{i = 0}^{N - 1} {x}_{i} {x}_{i}^{′} \\ {\sum }_{i = 0}^{N - 1} {x}_{i}^{′}\end{matrix} ) ; and \\ ( \begin{matrix}{a}_{2} \\ {a}_{3}\end{matrix} ) = \frac{1}{N {\sum }_{i = 0}^{N - 1} {y}_{i}^{2} - {( {\sum }_{i = 0}^{N - 1} {y}_{i} )}^{2}} ( \begin{matrix}N & - {\sum }_{i = 0}^{N - 1} {y}_{i} \\ - {\sum }_{i = 0}^{N - 1} {y}_{i} & {\sum }_{i = 0}^{N - 1} {y}_{i}^{2}\end{matrix} ) ( \begin{matrix}{\sum }_{i = 0}^{N - 1} {y}_{i} {y}_{i}^{′} \\ {\sum }_{i = 0}^{N - 1} {y}_{i}^{′}\end{matrix} )$$

Finally, the matrix equations yield the following least squares expressions for directly solving the unknown parameters of an affine 4-parameter global motion model:

$${a}_{0} = \frac{N {\sum }_{i = 0}^{N - 1} {x}_{i} {x}_{i}^{′} - {\sum }_{i = 0}^{N - 1} {x}_{i} {\sum }_{i = 0}^{N - 1} {x}_{i}^{′}}{N {\sum }_{i = 0}^{N - 1} {x}_{i}^{2} - {( {\sum }_{i = 0}^{N - 1} {x}_{i} )}^{2}}$$

$${a}_{1} = \frac{{\sum }_{i = 0}^{N - 1} {x}_{i}^{2} {\sum }_{i = 0}^{N - 1} {x}_{i}^{′} - {\sum }_{i = 0}^{N - 1} {x}_{i} {\sum }_{i = 0}^{N - 1} {x}_{i} {x}_{i}^{′}}{N {\sum }_{i = 0}^{N - 1} {x}_{i}^{2} - {( {\sum }_{i = 0}^{N - 1} {x}_{i} )}^{2}}$$

$${a}_{2} = \frac{N {\sum }_{i = 0}^{N - 1} {y}_{i} {y}_{i}^{′} - {\sum }_{i = 0}^{N - 1} {y}_{i} {\sum }_{i = 0}^{N - 1} {y}_{i}^{′}}{N {\sum }_{i = 0}^{N - 1} {y}_{i}^{2} - {( {\sum }_{i = 0}^{N - 1} {y}_{i} )}^{2}}$$

$${a}_{3} = \frac{{\sum }_{i = 0}^{N - 1} {y}_{i}^{2} {\sum }_{i = 0}^{N - 1} {y}_{i}^{′} - {\sum }_{i = 0}^{N - 1} {y}_{i} {\sum }_{i = 0}^{N - 1} {y}_{i} {y}_{i}^{′}}{N {\sum }_{i = 0}^{N - 1} {y}_{i}^{2} - {( {\sum }_{i = 0}^{N - 1} {y}_{i} )}^{2}}$$

Using the same procedure, least squares fitting equations for Pseudo-Affine 4-parameter and affine 6-parameter global motion models can be determined. For non-linear global motion models, a non-linear least squares fitting method such as Levenberg-Marquardt algorithm (LMA for short) can be used. An overview of LMA is presented next.

Global Motion Model—Levenberg-Marquardt Least Squares Solution:

Levenberg-Marquardt algorithm is a well-established method for solving non-linear least squares problems. It was first published by Levenberg in 1944 and rediscovered by Marquardt in 1963. The LMA is an iterative procedure. To start a minimization, the user has to provide an initial guess for the parameters. Like many fitting algorithms, the LMA finds only a local minimum, which is not necessarily the global minimum. In case of multiple minima, the algorithm converges to the global minimum only if the initial guess is already somewhat close to the final solution. In the context of estimating global motion model parameters, setting the parameters to past values (e.g. previous frame(s)′ parameters) generally improves the performance.

The LMA interpolates between two different non-linear least squares solving methods: (1) the Gauss-Newton algorithm (GNA), and (2) gradient descent the method. The LMA is more robust than the GNA, in the sense that in many cases it finds a solution even if it starts very far off the final minimum. An analysis has shown that LMA is in fact GNA with a trust region, where the algorithm restricts the converging step size to the trust region size in each iteration in order to prevent stepping too far from the optimum.

Again, let (x′ᵢ, y′ᵢ), i=0, . . . , N−1, represent the observed data, e.g., the new positions of the center (xᵢ,yᵢ) of i-th block of a frame moved according to the block-based motion vector field. A model is referred to as separable if x′ᵢ and y′ᵢ model functions have exactly the same independent variables structure and parameter aₖ is only used in computing either x′ᵢ or y′ᵢ but not both. Otherwise model is referred to as non-separable. Therefore, Affine, Bi-linear, and Bi-quadratic models are separable, while Translational, Pseudo-Affine, Perspective, and Pseudo-Perspective are non-separable.

Let β=(a₀, a₁, . . . , aₙ₋₁) be the vector of parameters of an n-parameter model that is to be used to model the global motion. For a separable global motion model we first compute parameters β_{x′}=(a₀, . . . , a_{(n/2)-1}) and then we compute the remaining parameters β_{y′}=(a_{n/2}, . . . , aₙ₋₁). On the other hand, for non-separable models we create 2N data points, and if i<N we use x′ model equation, while if N≤i<2N we use y′ model's equation. For simplicity of argument, we describe the LMA algorithm for global motion modeling by the 1^{st} part of separable parameters computation, e.g., computing the parameters associated with x′ model equation.

In each LMA iteration step, the parameter vector β is replaced by a new estimate β+δ. To determine the step vector δ, the functions f (xᵢ, β+δ) are approximated by their linearizations as follows:

f(xᵢ,β+δ)≈f(xᵢ,β)+Jᵢδ

Where

$${J}_{i} = \frac{\partial f ( {x}_{i} , β )}{\partial β}$$

Then, the sum of square errors S(β+δ) is approximated as

S(β+δ)≈Eᵢ₌₀^{N-1}(x′ᵢ−f(xᵢ,β)−Jᵢδ)²

The sum of squared errors function S is at its minimum at zero gradient with respect to β. Taking the derivative of S(β+δ) with respect to δ and setting the result to zero gives the following equality:

(J^{T}J)δ=J^{T}(x′−f(β))

Where J is the Jacobian matrix whose i-th row is Jᵢ and f and x′ are vectors whose i-th component is f(xᵢ,β) and x′ᵢ respectively. This defines a set of linear equations, whose solution is the unknown vector δ.

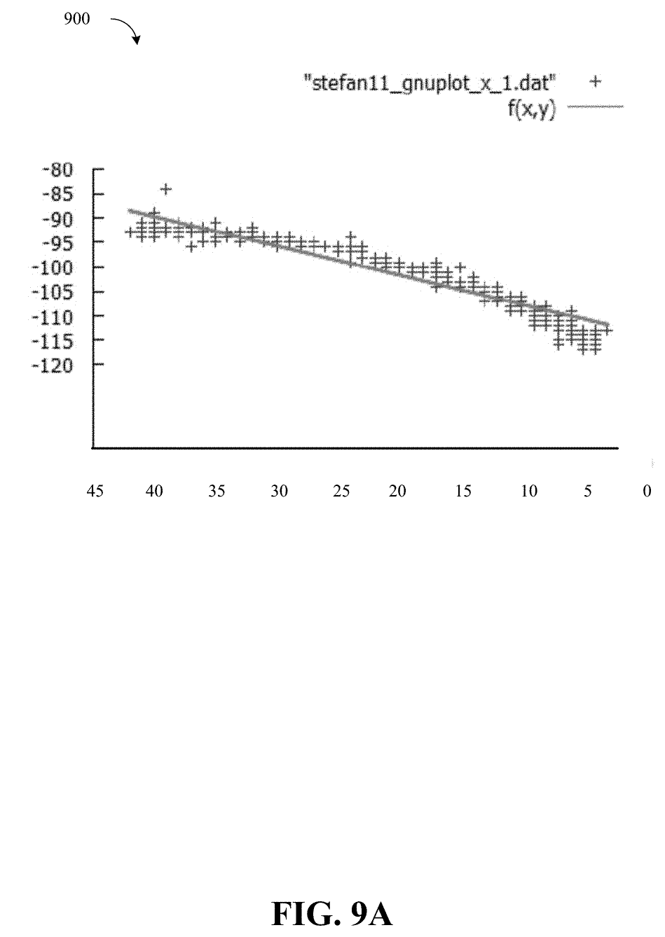

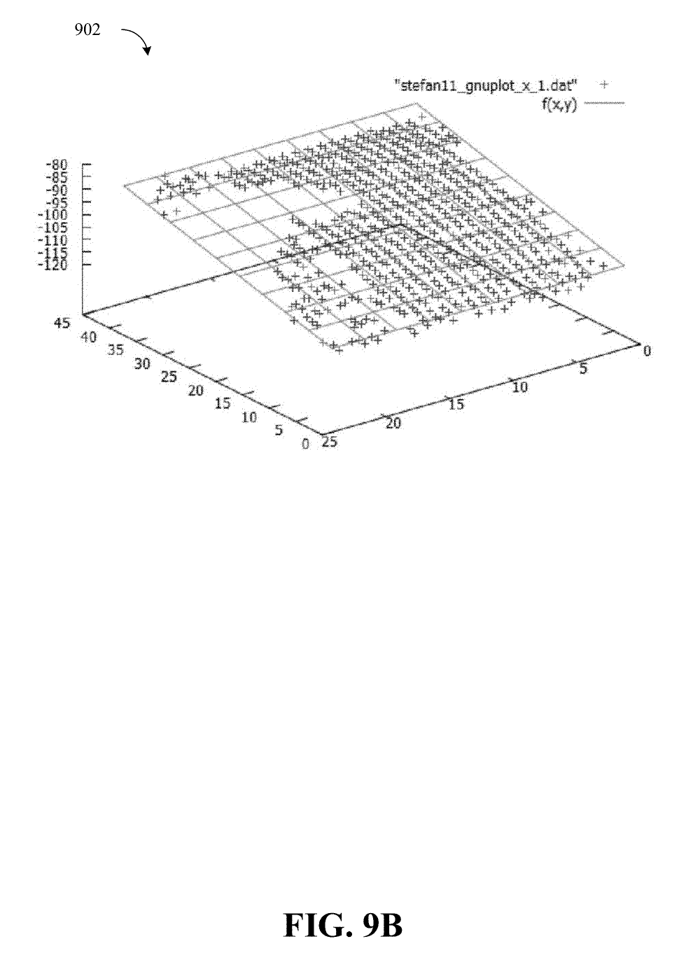

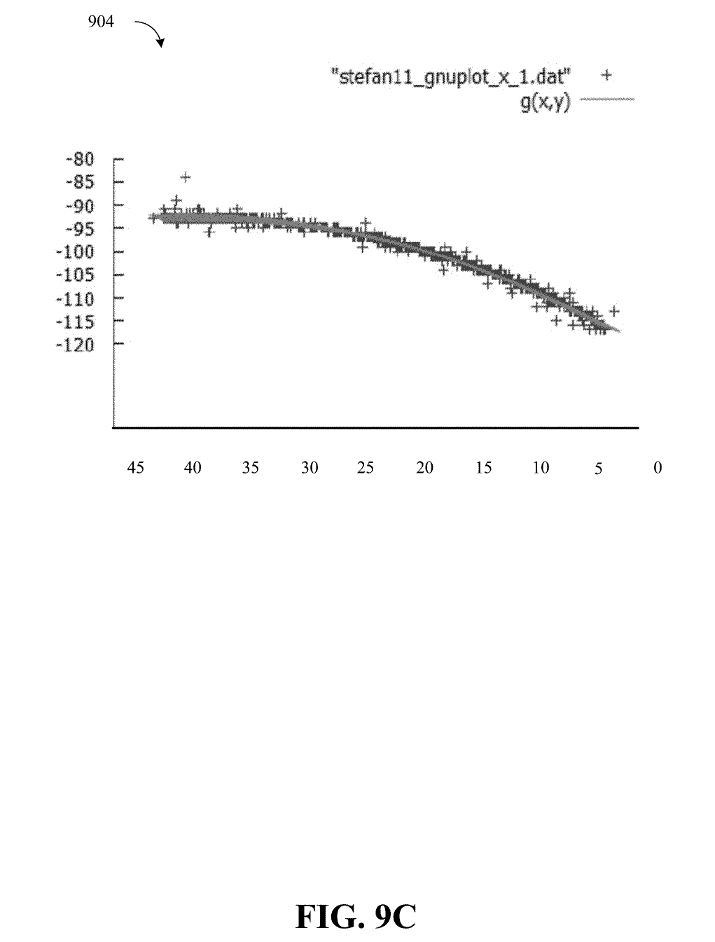

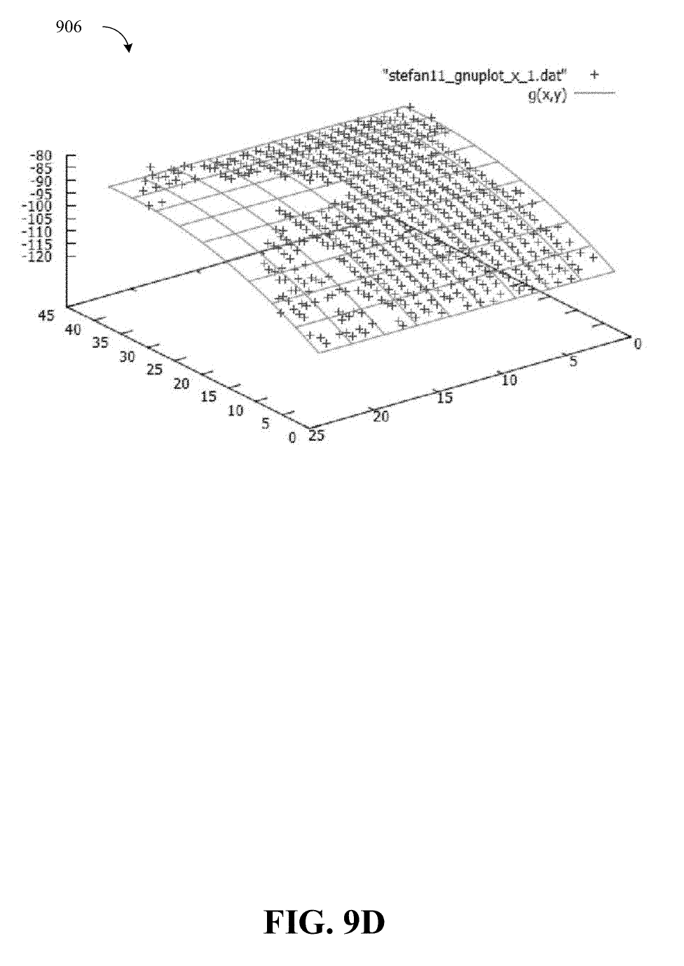

FIGS. 9A-9D are illustrative charts 900, 902, 904, and 906 of an example Levenberg-Marquardt Algorithm (LMA) curve fitting model for approximating global motion, arranged in accordance with at least some implementations of the present disclosure. In various implementations, LMA curve fitting model for approximating global motion: charts 900 and 902 show plots of motion vector field (x dimension) of global moving area of “Stefan” sequence (dots) and the Affine 6-parameter model fit (lines) computed using the LMA. On the other hand, charts 904 and 906 show Bi-quadratic 12-parameter model for “Stefan” computed via LMA. As it can be observed, the perspective and zoom effects in this scene require a higher order model than the 6-parameter linear affine model.

Levenberg contributed to replace this equation by a “damped” variant which uses a non-negative parameter λ, to control the rate of reduction of error function S:

(J^{T}J+=λI)δ=x′−f(β)

Smaller λ value brings the LMA closer to GNA, while larger value of λ brings it closer to gradient descent method. If either the length of the calculated step δ or the reduction of S from the latest parameter vector β+δ fall below predefined limits, the LMA iteration stops, and the last β is output as the solution. Marquardt improved the final LMA equation in order to avoid slow convergence in the direction of small gradient. He replaced the identity matrix I with the diagonal matrix consisting of the diagonal elements of the matrix J^{T}J, resulting in the final Levenberg-Marquardt algorithm equation:

(J^{T}J+λdiag(J^{T}J))δ=x′−f(β)

Marquardt recommended an initial value of λ in a general case. However, for global motion modeling LMA, in some implementations herein, a method may instead be used where the initial parameter λ is set to the square root of the sum of the squared errors of the initial model parameters.

The LMA can be used to compute linear parameters as well. However, the empirical data shows that direct least square fitting estimate yields practically same SAD error when compared to the LMA, but with several key benefits: (1) computation of 4- and 6-parameter linear models can be done in one pass, and (2) while LMA gives more tuned coefficients, direct least square computation for linear models offers higher correlation of parameters from frame to frame, thus making the coding cost less expensive. Computing of non-linear models however is often best done with the LMA method. FIGS. 9A-9D show an example of the LMA estimation of 6- and 12-parameter global motion models.

Global Motion Model Parameters Coding Overview

Global motion parameters are typically computed as floating point numbers, and as such are not easily transmittable to the decoder. In MPEG-4 standard, coding of global motion parameters is proposed which uses so called “reference points” or “control grid points”. Motion vectors of reference points are transmitted as the global motion parameters. Motion vectors of the reference points are easier to encode, and at the decoder, the parameters are reconstructed from the decoded vectors. Since the vectors are quantized (e.g. to half-pel precision in MPEG-4), the method is lossy. However, reconstructed coefficients typically produce very similar global motion field and loss in quality is tolerable.

In MPEG-4, up to 4 reference points are used, which can support translational, affine and perspective models. The number of reference points that are needed to be sent to the decoder depends on the complexity of the motion model. When an 8-parameter model is used in MPEG-4 (e.g., as in a perspective model), then 4 points are needed to determine the unknown parameters by solving the linear system. For a 4-parameter model and 6-parameter models the number of needed reference points is reduced to 2 and 3 respectively.

The reference points are located at the corners of the bounding box. The bounding box can be the entire frame area or a smaller rectangular area inside the frame. The locations of these parameters are defined as follows:

z₀=(x₀,y₀)

z₁=(x₁,y₁)=(x₀+W,y₀)

z₂=(x₂,y₂)=(x₀,y₀+H)

z₃=(x₃,y₃)=(x₀+W,y₀+H)

Where (x₀, y₀) is the coordinate of the top left corner, W is the width and H is the height of the frame or the bounding box.

The estimated global motion model may be applied on the reference points resulting in the following motion vectors:

MXᵢ=xᵢ′−xᵢ

MYᵢ=yᵢ′−yᵢ

Where i=0, . . . , 3 and (xᵢ′, yᵢ′) may be computed using the global motion model equation. When the decoder receives the vectors (MXᵢ, MYᵢ) it may reconstruct the global motion parameters. If a 4-parameter model is used, the decoder receives two vectors (MX₀, MY₀) and (MX₃, MY₃) which correspond to reference points z₀ and z₃ respectively. For the case when global motion is defined over the entire frame, reference points are z₀=(0, 0) and z₃=(W, H) where W and H are the frame width and height. To reconstruct parameters a₀, . . . , a₃ of a translational global motion model, the following two systems are solved:

$$( \begin{matrix}{a}_{0} \\ {a}_{1}\end{matrix} ) = {( \begin{matrix}{x}_{0} & 1 \\ {x}_{3} & 1\end{matrix} )}^{- 1} ( \begin{matrix}{x}_{0} + {MX}_{0} \\ {x}_{3} + {MX}_{3}\end{matrix} ) = {( \begin{matrix}0 & 1 \\ W & 1\end{matrix} )}^{- 1} ( \begin{matrix}{x}_{0}^{′} \\ {x}_{3}^{′}\end{matrix} ) = ( \begin{matrix}- \frac{1}{W} & \frac{1}{W} \\ 1 & 0\end{matrix} ) ( \begin{matrix}{x}_{0}^{′} \\ {x}_{3}^{′}\end{matrix} )$$

$$( \begin{matrix}{a}_{2} \\ {a}_{3}\end{matrix} ) = {( \begin{matrix}{y}_{0} & 1 \\ {y}_{3} & 1\end{matrix} )}^{- 1} ( \begin{matrix}{y}_{0} + {MY}_{0} \\ {y}_{3} + {MY}_{3}\end{matrix} ) = {( \begin{matrix}0 & 1 \\ H & 1\end{matrix} )}^{- 1} ( \begin{matrix}{y}_{0}^{′} \\ {y}_{3}^{′}\end{matrix} ) = ( \begin{matrix}- \frac{1}{H} & \frac{1}{H} \\ 1 & 0\end{matrix} ) ( \begin{matrix}{y}_{0}^{′} \\ {y}_{3}^{′}\end{matrix} )$$

When a 6-parameter model is used, the decoder may receive three vectors (MX₀, MY₀), (MX₁, MY₁), and (MX₂, MY₂), which correspond to reference points z₀, and z₂ respectively. The reference points are z₀=(0, 0), z₁=(W, 0) and z₂=(0, H). Reconstructing parameters a₀, . . . , a₅ of an affine global motion model may be done by solving the following two systems:

$$( \begin{matrix}{a}_{0} \\ {a}_{1} \\ {a}_{2}\end{matrix} ) = {( \begin{matrix}0 & 0 & 1 \\ W & 0 & 1 \\ 0 & H & 1\end{matrix} )}^{- 1} ( \begin{matrix}{x}_{0} + {MX}_{0} \\ {x}_{1} + {MX}_{1} \\ {x}_{2} + {MX}_{2}\end{matrix} ) = ( \begin{matrix}- \frac{1}{W} & \frac{1}{W} & 0 \\ - \frac{1}{H} & 0 & \frac{1}{H} \\ 1 & 0 & 0\end{matrix} ) ( \begin{matrix}{x}_{0}^{′} \\ {x}_{1}^{′} \\ {x}_{2}^{′}\end{matrix} )$$

$$( \begin{matrix}{a}_{3} \\ {a}_{4} \\ {a}_{5}\end{matrix} ) = {( \begin{matrix}0 & 0 & 1 \\ W & 0 & 1 \\ 0 & H & 1\end{matrix} )}^{- 1} ( \begin{matrix}{x}_{0} + {MY}_{0} \\ {x}_{1} + {MY}_{1} \\ {x}_{2} + {MY}_{2}\end{matrix} ) = ( \begin{matrix}- \frac{1}{W} & \frac{1}{W} & 0 \\ - \frac{1}{H} & 0 & \frac{1}{H} \\ 1 & 0 & 0\end{matrix} ) ( \begin{matrix}{y}_{0}^{′} \\ {y}_{1}^{′} \\ {y}_{2}^{′}\end{matrix} )$$

Similarly, other parameter models can be reconstructed by solving the linear system determined by the motion vectors of reference points.

For efficient representation, in MPEG-4 the motion vectors may be transmitted differentially. Suppose a 4-parameter model is used. Then, the motion vector (MX₀, MY₀) for grid point z₀ will be coded as is, while the motion vector for grid point z₃ will be coded differentially by using (MX₃-MX₀, MY₃-MY₀) [21]. The differentials are encoded using the exponential-Golomb code.

An exponential-Golomb code, or exp-Golomb code for short, is a type of universal code used to encode any non-negative integer. The following rule can be used to encode a non-negative integer n with exp-Golomb code: 1) represent n+1 in and write that number of zero bits preceding the previous bit string; 2) since motion vector differentials are not strictly non-negative integers, in MPEG-4 standard they are converted to non-negative binary digits; and 3) count the number of digits in binary representation of n+1, subtract one representation. The motion vector differential value m is represented as vₘ as follows:

$${v}_{m} = \{ \begin{matrix}2 m - 1 & when m > 0 , \\ - 2 m & when m \leq 0.\end{matrix}$$

In Table 2 below, the first 11 exp-Golomb codes for integers (m) and non-negative integers (vₘ) are illustrated.

TABLE 2

| | | Exp-Golomb | Bit |
|---|---|---|---|
| m | vₘ | Code | Length |
| 0 | 0 | 1 | 1 |
| 1 | 1 | 010 | 3 |
| −1 | 2 | 011 | 3 |
| 2 | 3 | 00100 | 5 |
| −2 | 4 | 00101 | 5 |
| 3 | 5 | 00110 | 5 |
| −3 | 6 | 00111 | 5 |
| 4 | 7 | 0001000 | 7 |
| −4 | 8 | 0001001 | 7 |
| 5 | 9 | 0001010 | 7 |
| −5 | 10 | 0001011 | 7 |
| . . . | . . . | . . . | . . . |

Error! Reference Source not Found.

Table 2, above, shows the first few exp-Golomb codes. For example, if a motion vector (differential) in MPEG-4 to be coded is −1, the encoder may represent it with a 3-bit codeword “011”. This representation may be efficient since the probability of differentials is similar to the probability distribution represented by exp-Golomb coding.

Preprocessing

Preprocessing component of the proposed algorithm may include: a) down-sampling of the input frame from the pixel resolution to a block-accurate resolution, and b) scene change detection that decides if the current frame is part of the new scene or not.

For example, down-sampling may be performed on the input frames in order to improve segmentation processing speed and also to reduce the level of noise in the region segmentation process. In order to obtain a higher quality down-sampled frame, the down-sampling may be performed by averaging of pixel values on a block level. Down-sampling converts input YUV420 frame to a block accurate YUV444 frame where luminance signal may be subsampled by 4 (i.e., 4×4 block accuracy) while chrominance signal may be subsampled by 2 (i.e., 2×2 block accuracy). For example, in high definition 1080p sequence, luma may be subsampled from 1920×1080 resolution into 480×270 resolution, while chroma may be subsampled from 960×540 resolution into 480×270 resolution.

Detecting a scene change may be necessary in order to properly reset the algorithm parameters in some implementations. Generally speaking, any generic scene change detector can be used in this step; however, we use an advanced scene change detector (SCD), which reliably and efficiently performs scene change detection as the pre-processing stage. In scene change detection, each input frame at original pixel resolution is passed into the SCD algorithm, which computes a scene change flag scf. If the flag is on, the current frame is a part of the new scene and the buffer of past GMM parameters is initialized. The details of SCD method are omitted here.

Motion Estimation

The proposed region-based motion modeling approach uses block-based motion vector field as a basis from which each of the models may be computed. Although in general, any block-based motion estimator could be used to compute a motion vector field, one such estimator may be based on GPU graphics hardware-accelerated VME routines. Hardware-accelerated motion estimation approach allows for a significantly faster processing.

VME is a motion estimation routine which, relying on a graphics GPU, estimates motion vector field at one or more block accuracies. In some implementation described herein, VME may be used to obtain block-based motion vector fields at 16×16 and 8×8 levels. VME routine may use full search motion estimation method with a given search range. Unfortunately, the maximum VME search range is often limited and cannot handle very fast moving areas and/or larger distances between current and reference frames. Therefore, a multistage VME-based method may be used for block-based motion estimation in order to support larger search ranges. In particular, a 3-stage VME method may be used, which is described next.

A multistage VME may use subsampled frames in the previous stage in order to estimate the initial motion vectors for the current frame, e.g., the starting position of the VME motion search for each block. The subsampling factor may depend on the stage number as well as the frame resolution. In the first stage, the current and reference frames of low definition sequences are subsampled in each direction by 8. If a frame width is smaller than 600, frame height is smaller than 300, and the product of frame width and height is smaller than 180,000, then sequence is classified as the low definition sequence. On the other hand, the first stage for other (larger) resolutions may uses subsampling factor of 16 in each direction. Subsampling in 2^{nd} stage is by 4 in each direction for all resolutions. Finally, a 3^{rd} (final) stage VME may use full resolution frames and produces motion vector fields at 16×16 and 8×8 block accuracies. One such example of such a 3-stage VME algorithm may include the following steps:
1. If H<300 and W<600 and W×H<180,000 then set ld=1; otherwise set ld=0.
2. Given the current frame F and the reference frame F_{ref}, create subsampled luma frames SF′ and SF_{ref}′ as the input to the 1^{st} stage VME. The subsampling is performed in each direction by 8 if ld=1 and by 16 if ld=0.
3. Perform 1^{st} stage VME routine using SF′ and SF_{ref}′ with search range set to 64×32.
4. Filter and resize output of 1^{st} stage motion vector field to create input to 2^{nd} stage as follows:
   a. Remove isolated noise-like motion vectors from the 16×16 and 8×8 output motion vector fields. For a given vector (mx_{(j,i)},my_{(j,i)}) at subsampled position (j,i) where w and h are subsampled motion vector field width and height (respectively), do:
      i. If j>0 set d_{L}=abs(mx_{(j,i)}−mx_{(j-1,i)})+abs(my_{(j,i)}−my_{(j-1,i)}; otherwise set d_{L}=∞.
      ii. If i>0 set d_{T}=abs(mx_{(j,i)}−mx_{(j,i-1)})+abs(my_{(j,i)}−my_{(j,i-1)}); otherwise set d_{T}=∞.
      iii. If j<w−1 set d_{R}=abs(mx_{(j,i)}−mx_{(j+1,i)}+abs(my_{(j,i)}| my_{(j+1,i)}; otherwise set d_{R}=∞.
      iv. If i<h−1 set d_{B}=abs(mx_{(j,i)}−mx_{(j,i+1)})+abs(my_{(j,i)}−my_{(j,i+1)}); otherwise set d_{B}=∞.
      v. Set d=(d_{L}, d_{T}, d_{R}, d_{B})
      vi. If d>T (in software implementation T=16) then do the following:
         1. If d=d_{L} then replace (mx_{(j,i)}, my_{(j,i)}) with (mx_{(j-1,i)}, my_{(j-1,i)})
         2. Else If d=d_{T} replace (mx_{(j,i)},my_{(j,i)}) with (mx_{(j-1,i)}, my_{(j-1,i)})
         3. Else If d=d_{R} replace (mx_{(j,i)},my_{(j,i)}) with (mx_{(j+1,i)}, mu_{(j+1,i)})
         4. Else If d=d_{B} replace (mx_{(j,i)}, my_{(j,i)}) with (mx_{(j,i+1)}, my_{(j,i+1)})
   b. Merge 16×16 and 8×8 output motion vectors into merged 8×8 motion vector field: if SAD of a 16×16 block is up to 2% higher than sum of 4 collocated 8×8 blocks, then use repeat motion vector of a 16×16 block into the merged field; otherwise, otherwise copy 4 collocated motion vectors from 8×8 motion vector field. Note that here, for low definition sequences the resulting 8×8 block size in the subsampled resolution corresponds to 64×64 block size in the original full resolution, while in the other (higher) resolutions it corresponds to a 128×128 blocks in the original resolution.
   c. Up-sample (resize) the merged motion vector field in each dimension by 2 for low definition and by 4 for other resolutions. Also for other resolutions, rescale motion vectors in the merged motion vector field by 2 (i.e., multiply each coordinate by 2).
5. Use the resulting merged motion vector field as the input motion vectors for 2^{nd} stage VME
6. Given the current frame F and the reference frame F_{ref}, create subsampled luma frames SF and SF_{ref} as the input to the 2^{nd} stage VME. The subsampling is performed in each direction by 4.
7. Perform 2^{nd} stage VME routine using SF and SF_{ref} with search range set to 64×32.
8. Filter and resize output of 2^{nd} stage motion vector field to create input to 3^{rd} stage as follows:
   a. Remove isolated noise-like motion vectors from the 16×16 and 8×8 output motion vector fields. For a given vector (mx_{(j,i)}, my_{(j,i)}) at subsampled position (j,i) where w and h are subsampled motion vector field width and height (respectively), using same algorithm as in 4.a.
   b. Merge 16×16 and 8×8 output motion vectors into merged 8×8 motion vector field as in 4.b
   c. Compute median merged motion vector field by applying 5×5 median filter to merged motion vector field
   d. Compute block based SAD for both merged MVF and median merged MMF using the current luma frame SF and the reference luma frame SF_{ref}
   e. Create final merged motion vector field by choosing either vector from merged MVF of from median merged MMF, depending on which one of the two has a smaller block SAD.
   f. Up-sample (resize) the final merged motion vector field in each dimension by 4, and rescale motion vectors in the merged motion vector field by 2 (i.e., multiply each coordinate by 2).
9. Use the resulting merged motion vector field as the input motion vectors for 3^{rd} stage VME
10. Perform 3^{rd} stage VME routine using SF and SF_{ref} with search range set to 64×32.

The output of the 3-stage VME algorithm includes 16×16 and 8×8 block-based motion vector fields (e.g., where block size is relative to full frame resolution). Next how these vectors are filtered is described so that noisy matches during motion estimation stage are removed and replaced with more correct motion vectors in respect to the actual motion of the underlying visual objects in the scene.

Motion Vector Filtering

The motion estimation search often creates incorrect motion vector matches, referred to as outlier motion vectors. The outlier motion vectors are created because of the random matches during motion estimation phase and they do not correspond to the actual motion. Outliers occur either in flat areas or in blocks that contain edges/texture patterns, which are prone to the aperture problem. The aperture problem refers to the fact that the motion of a visual object, which resembles a repeated 1-dimensional pattern (e.g. a bar or an edge) cannot be determined unambiguously when viewed through a small aperture (e.g. a block size window in block-based motion estimation). This is exactly what is happening during block-based motion estimation phase.

Incorrect motion vectors, even though they have small prediction error, can quite negatively affect global motion estimation phase. If several incorrect vectors are used to compute global motion the equation would be incorrect and thus global motion error would be large.

In order to cope with this problem, some implementations described herein are designed and implemented with a motion filtering method that reduces motion vector outliers and improves the motion vector field used for global motion estimation, as will be described in greater detail below.

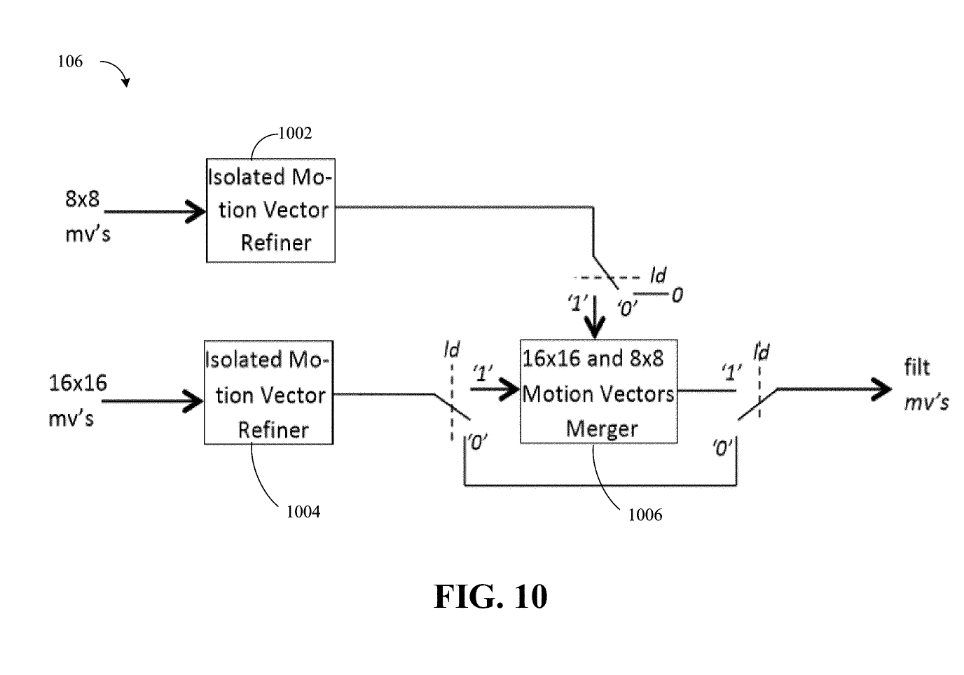

FIG. 10 is an illustrative block diagram of an example local motion field noise reduction filter, arranged in accordance with at least some implementations of the present disclosure. In various implementations of local motion field noise reduction filter 106, an Id signal may be used to switch between filtering 8×8 block-based motion vectors at isolated motion vector refiner 1002 and filtering 16×16 block-based motion vectors at isolated motion vector refiner 1004. The signal value may be previously set to ld=1 if the sequence is a low-definition sequence, or to ld=0 otherwise. For low definition sequences, the input may be an 8×8 block-based motion vector field, which is then filtered in 2 steps: (1) by removing isolated motion vectors (e.g., motion vectors that are very different than its 4 direct neighbors) at isolated motion vector refiner 1002, and (2) by merging some 4 8×8 vectors into a single collocated 16×16 vector at 16×16 and 8×8 motion vectors merger 1006. For other resolutions the filtering is in performed in one step, simply by removing of the isolated motion vectors. The isolated motion vectors removal may be performed by comparing the sum of absolute differences (SAD) coordinate-wise between a motion vector and its top, left, right and bottom direct neighbors. If all 4 differences are larger than the similarity threshold (e.g., which in some implementations may be set to 16, for example) then the vector is replaced with the smallest sum of absolute differences (SAD) of a corresponding direct neighbor.

In case of low definition sequences, the merging step may be performed by computing the sum of SADs of the 4 8×8 vectors in the 8×8 field and comparing it to the SAD of the collocated 16×16 motion vector. If the SAD of the 16×16 vector is within a small percentage (e.g., 1%) of error from the sum of 4 collocated 8×8 s, then the 4 8×8 vectors may be merged and replaced with the single 16×6 collocated vector. One example of such an algorithm may include the following steps:
1. If H<300 and W<600 and W×H<180,000 then set ld=1; otherwise set ld=0.
2. If ld=1 then do the following:
   a. Remove isolated noise-like motion vectors from the 16×16 and 8×8 output motion vector fields. For a given vector (mx_{(j,i)}, my_{(j,i)}) at subsampled position (j,i) where w and h are subsampled motion vector field width and height (respectively), do:
      i. If j>0 set d_{L}=abs(mx_{(j,i)}−mx_{(j-1,i)})+abs(my_{(j,i)}−my_{(j-1,i)}); otherwise set d_{L}=∞.
      ii. If i>0 set d_{T}=abs(mx_{(j,i)}−+abs(my_{(j,i)})−my_{(j,i-1)}); otherwise set d_{T}=∞.
      iii. If j<w−1 set d_{R}=abs(mx_{(j,i)}−mx_{(j+1,i)})+abs(my_{(j,i)})−my_{(j+1,i)}); otherwise set d_{R}=∞.
      iv. If i<h−1 set d_{B}=abs(mx_{(j,i)}−mx_{(j,i+1)})+abs(my_{(j,i)}−my_{(j,i+1)}); otherwise set d_{B}=∞.
      v. Set d=(d_{L}, d_{T}, d_{B}, d_{B})
      vi. If d>T (in our implementation T=16) then do the following:
         1. If d=d_{L} then replace (mx_{(j,i)}, my_{(j,i)}) with (mx_{(j,i-1)}, my_{(j-1,i)})
         2. Else If d=d_{T} replace (mx_{(j,i)}, my_{(j,i)}) with
         3. Else If d=d_{R} replace (mx_{(j,i)}, my_{(j,i)}) with (mx_{(j+1,i)}, my_{(j+1,i)})
         4. Else If d=d_{B} replace (mx_{(j,i)}, my_{(j,i)}) with (mx_{(j,i+1)}, my_{(j,i+1)})
   b. Merge 16×16 and 8×8 output motion vectors into merged 8×8 motion vector field: if SAD of a 16×16 block is up to 2% higher than sum of 4 collocated 8×8 blocks, then use repeat motion vector of a 16×16 block into the merged field; otherwise, otherwise copy 4 collocated motion vectors from 8×8 motion vector field. Note that here, for low definition sequences the resulting 8×8 block size in the subsampled resolution corresponds to 64×64 block size in the original full resolution, while in the other (higher) resolutions it corresponds to a 128×128 blocks in the original resolution.
   c. Output merged 8×8 motion vector field to be used for computing the global motion model parameters
3. Otherwise if ld=0 then do the following:
   a. Remove isolated noise-like motion vectors from the 16×16 motion vector field. For a given vector (mx_{(j,i)}, my_{(j,i)}) at subsampled position (j,i) where w and h are subsampled motion vector field width and height (respectively), do:
      i. If j>0 set d_{L}=abs(mx_{(j,i)}−mx_{(j-1,i)})+abs(my_{(j,i)}−my_{(j-1,i)}); otherwise set d_{L}=∞.
      ii. If i>0 set d_{T}=abs(mx_{(j,i)}−mx_{(j,i-1)})+abs(my_{(j,i)}−my_{(j,i-1)}); otherwise set d_{T}=∞.
      iii. If j<w−1 set d_{R}=abs(mx_{(j,i)}−mx_{(j+1,i)})+abs(my_{(j,i)}−my_{(j+1,i)}); otherwise set d_{R}=∞.
      iv. If i<h−1 set d_{B}=abs(mx_{(j,i)}−mx_{(j,i+1)})+abs(my_{(j,i)}−my_{(j,i+1)}); otherwise set d_{B}=∞.
      v. Set d=(d_{L}, d_{T}, d_{B}, d_{B})
      vi. If d>T (in our implementation T=16) then do the following:
         1. If d=d₁, then replace (mx_{(j,i)}, my_{(j,i)}) with (mx_{(j-1,i)}, my_{(j-1,i)})
         2. Else If d=d_{T} replace (mx_{(j,i)}, my_{(j,i)}) with
         3. Else If d=d_{R} replace (mx_{(j,i)}, my_{(j,i)}) with (mx_{(j+1,i)}, my_{(j+1,i)})
         4. Else If d=d_{B} replace (mx_{(j,i)}, my_{(j,i)}) with (mx_{(j,i+1)}, my_{(j,i+1)})
   b. Output the filtered 16×16 motion vector field to be used for computing the global motion model parameters

Segmentation into Moving Regions

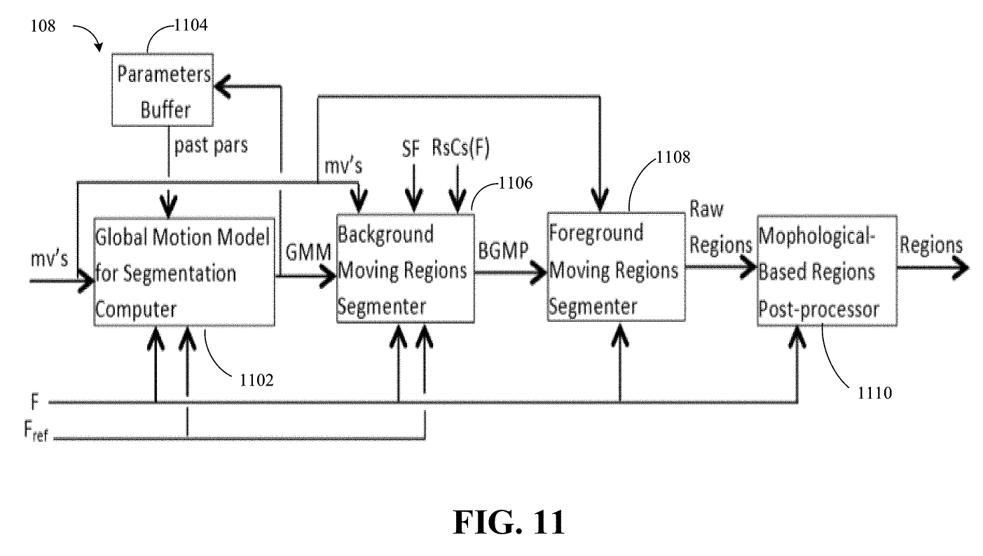

FIG. 11 is an illustrative block diagram of regions segmenter 107, arranged in accordance with at least some implementations of the present disclosure. In various implementations, example regions segmenter 107 may include global motion model for segmentation computer 1102, parameter buffer 1104, background moving regions segmenter 1106, foreground moving regions segmenter 1108, and/or morphological based regions post-processor 1110.

In operation, regions segmenter 107 may operate so that a frame is divided into a number of moving regions. The number of moving regions may typically be limited to one to three regions per frame, for example. An additional region may be allowed (thus having a maximum of 4 regions in the frame) that indicates stationary non-active content areas such as: black bars and areas created by letterboxing, pillar boxing, circular or cropped circular fisheye cameras, the like, and/or combinations thereof.

As illustrated, regions segmenter 107 may operate so that the region segmentation may include the following stages: 1) computing the global motion model for segmentation via global motion model for segmentation computer 1102, 2) segmenting the frame into foreground/background moving areas (background moving region segmentation) via background moving regions segmenter 1106, 3) segmentation of the remaining (foreground) moving regions (if any) via foreground moving regions segmenter 1108, and/or 4) post-processing of segmented moving regions using morphological operations via morphological based regions post-processor 1110.

In the illustrated example, regions segmenter 107 may compute several (e.g., 1-3) moving regions in the current frame. The first step may be to compute the affine global motion model for segmentation (denoted GMM) via global motion model for segmentation computer 1102. Either the currently computed model or one of the past models (e.g., past two models) via parameters buffer 1104 may be selected as GMM via global motion model for segmentation computer 1102.

Then, using this GMM model the current frame may be segmented into background moving region and other regions via background moving regions segmenter 1106. Either purely motion based segmentation is employed or, if there is strong dominant color present, a color assisted motion segmentation is used. The binary segmentation mask (BGMP) may be produced via background moving regions segmenter 1106 based on this segmentation.

In the next step, potential additional (e.g., foreground moving) regions may be detected and segmented via foreground moving regions segmenter 1108. For example, the foreground moving regions segmentation process may use dominant motion and peak analyzer to determine if 0, 1, or 2 additional (e.g., foreground) motion-based regions are present in the frame, producing a raw regions mask.

After all regions are segmented, the raw regions mask may be post-processed to reduce segmentation noise and make the raw regions mask more solid via morphological based regions post-processor 1110.

Computation of Global Motion Model for Segmentation

In some implementations, the first step in segmenting the frame into the moving regions is to determine the global motion model that will be used for background moving area segmentation. The model, referred to as the global motion model for segmentation, is derived using an initial affine 6-parameter global motion model by random sampling. From this initial model, an affine 6-parameter global motion model for segmentation will eventually be computed, which will be used to derive the foreground/background segmentation mask. Random sampling is used initially to filter out the outlier motion vectors from the motion vector field, e.g., motion vectors that are not consistent with the global motion. Random sampling provides statistics from which a stable global motion model can be deduced.

An affine global motion model has 6 unknown parameters that are to be estimated, and therefore any 3 chosen motion vectors (MX₀, MY₀), (MX₁, MY₁) and (MX₂, MY₂) at positions (x₀, y₀), (x₁, y₁) and (x₂, y₂) from the motion vector field can be used to solve the system of equations for the parameters (provided they form the independent system) as follows:

$${a}_{0} = \frac{{x}_{0}^{′} ( {y}_{1} - {y}_{2} ) - {x}_{1}^{′} ( {y}_{0} - {y}_{2} ) + {x}_{2}^{′} ( {y}_{0} - {y}_{1} )}{{x}_{0} {y}_{1} - {x}_{0} {y}_{2} - {x}_{1} {y}_{0} + {x}_{1} {y}_{2} + {x}_{2} {y}_{0} - {x}_{2} {y}_{1}}$$

$${a}_{1} = \frac{- {x}_{0}^{′} ( {x}_{1} - {x}_{2} ) + {x}_{1}^{′} ( {x}_{0} - {x}_{2} ) - {x}_{2}^{′} ( {x}_{0} - {x}_{1} )}{{x}_{0} {y}_{1} - {x}_{0} {y}_{2} - {x}_{1} {y}_{0} + {x}_{1} {y}_{2} + {x}_{2} {y}_{0} - {x}_{2} {y}_{1}}$$

$${a}_{2} = \frac{- {x}_{0}^{′} ( {x}_{1} {y}_{2} - {x}_{2} {y}_{1} ) - {x}_{1}^{′} ( {x}_{0} {y}_{2} - {x}_{2} {y}_{0} ) + {x}_{2}^{′} ( {x}_{0} {y}_{1} - {x}_{1} {y}_{0} )}{{x}_{0} {y}_{1} - {x}_{0} {y}_{2} - {x}_{1} {y}_{0} + {x}_{1} {y}_{2} + {x}_{2} {y}_{0} - {x}_{2} {y}_{1}}$$

$${a}_{3} = \frac{{y}_{0}^{′} ( {y}_{1} - {y}_{2} ) - {y}_{1}^{′} ( {y}_{0} - {y}_{2} ) + {y}_{2}^{′} ( {y}_{0} - {y}_{1} )}{{x}_{0} {y}_{1} - {x}_{0} {y}_{2} - {x}_{1} {y}_{0} + {x}_{1} {y}_{2} + {x}_{2} {y}_{0} - {x}_{2} {y}_{1}}$$

$${a}_{4} = \frac{- {y}_{0}^{′} ( {x}_{1} - {x}_{2} ) + {y}_{1}^{′} ( {x}_{0} - {x}_{2} ) - {y}_{2}^{′} ( {x}_{0} - {x}_{1} )}{{x}_{0} {y}_{1} - {x}_{0} {y}_{2} - {x}_{1} {y}_{0} + {x}_{1} {y}_{2} + {x}_{2} {y}_{0} - {x}_{2} {y}_{1}}$$

$${a}_{5} = \frac{- {y}_{0}^{′} ( {x}_{1} {y}_{2} - {x}_{2} {y}_{1} ) - {y}_{1}^{′} ( {x}_{0} {y}_{2} - {x}_{2} {y}_{0} ) + {y}_{2}^{′} ( {x}_{0} {y}_{1} - {x}_{1} {y}_{0} )}{{x}_{0} {y}_{1} - {x}_{0} {y}_{2} - {x}_{1} {y}_{0} + {x}_{1} {y}_{2} + {x}_{2} {y}_{0} - {x}_{2} {y}_{1}}$$

Where xᵢ′=xᵢ+MXᵢ and yᵢ′=yᵢ+MYᵢ for i={0, 1, 2}.

The number of motion vectors from which random samples are taken depends on the video resolution. For standard and high definition, the block size is set to 8. For low definition sequences the block size is set to 16. If a frame width is smaller than 600, frame height is smaller than 300, and the product of frame width and height is smaller than 180,000, then sequence may be classified as the low definition sequence and the motion vector field from which the samples are taken is an 8×8 motion vector field. Otherwise, 16×16 based motion vector field is used as a pool from which random motion vector samples are drawn.

In some implementations, the random sampling approach uses the equations above to solve for parameters a₀, . . . , a₅ by selecting three motion vectors at random. The parameters computed from selected vectors that form an independent system are referred to as local parameters. After a large sample of local parameters are collected, statistical properties of collected data can be used to estimate a stable set of global motion parameters. The final random sampling based estimated parameters are what we refer to as the initial affine global motion model. The algorithm for the initial affine global motion model computation is described next.
1. Set N to a total number of motion vectors in the input motion vector field
2. Initialize 6 histograms H₀, . . . , H₅ of a chosen size to 0. The histogram size, denoted here by S_{H}, determines how many bins are supported by each of the 6 histograms. More bins means more precision of estimating a parameter within the parameter range. However, too many bins would create a flat-looking histogram and determining the correct peak would be harder. In one implementation the following value was set S_{H}=128.
3. Select range of values for each parameter. We use the following ranges: a_{0,4} ∈[0.95, 1.05), a_{1,3} ∈[−0.1, 0,1), a₂ ∈[−64, 64), a₅ ∈[−48,48).
4. For each parameter assign (e.g., in one implementation 128) equidistant sub-ranges within the selected range to a bin in the histogram. For example, for parameter a₀, a range [0.95,1.05) is subdivided to 128 bins (sub-ranges): [0.95, 0.95078125), [0.95078125,0.9515625), . . . , [1.04921875,1.05).
5. For i=0 to N do the following:
   a. Pick 3 random positions and corresponding vectors in the motion vector field
   b. Compute local affine 6-parameter model from 3 points/vectors
   c. For each parameter determine the histogram bin whose sub-range the parameter value falls into
   d. If a parameter value falls in a valid sub-range, increment histogram count at the index of that sub-range
6. Detect 6 highest peaks in each of the 6 histograms and select corresponding sub-ranges.
7. Set the initial affine global motion model candidate to the parameters corresponding to the mid-value of their peak sub-range. For example, if a peak in H₀ is at 2^{nd} position, then the peak sub-range for parameter a₀ is [0.95078125,0.9515625) and the parameter a₀=(0.95078125+0.9515625)/2=0.951171875.
8. Add the previous two initial affine motion models to the candidate set (e.g., clearly, at the beginning of the scene nothing is added and after the first frame one model is added)
9. If there is only 1 candidate, select it as the initial affine motion model for the current frame. Otherwise, if the number of candidates is more than 1 then:
   a. Compute SAD measure of all candidates as follows. For each candidate:
      i. Create reconstructed frame at pixel accuracy using global motion model candidate parameters
      ii. Compute SAD between reconstructed frame pixels and current frame pixels
   b. Select candidate with smallest SAD as the initial affine motion model for the current frame

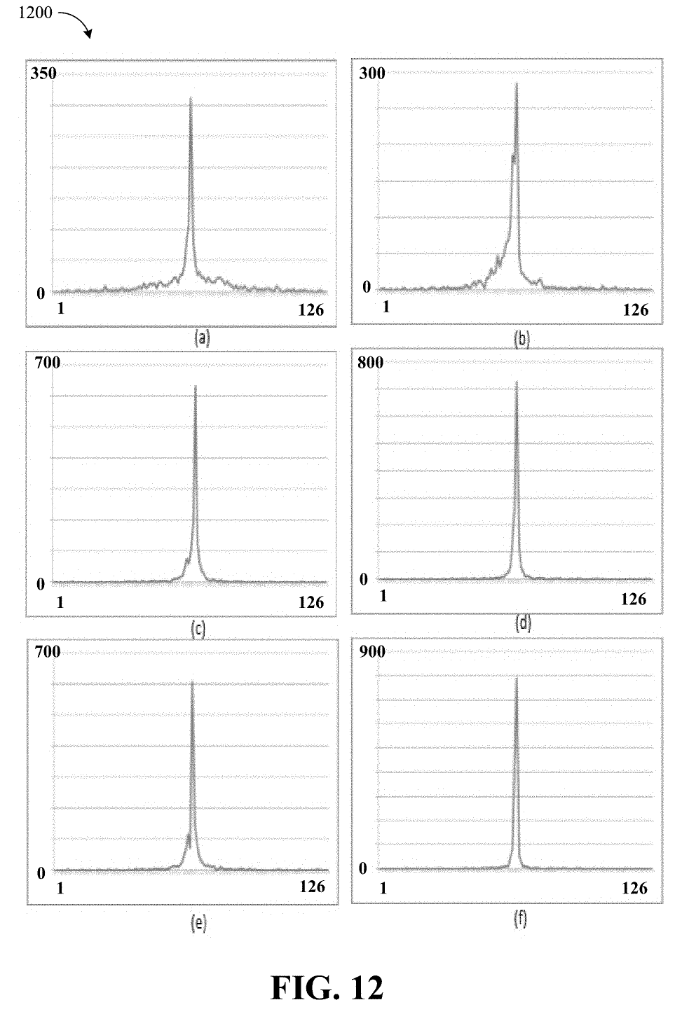

FIG. 12 is an illustrative chart of an example histogram distribution 1200 of locally computed affine global motion model parameters, arranged in accordance with at least some implementations of the present disclosure. In various implementations, histogram distribution 1200 illustrates an example of the “City” sequence where the current frame is frame #1 and the reference frame is frame #0. For instance, chart (a) shows H₀ histogram where peak is in position 64 which corresponds to sub-range [1.0,1.00078125) so that parameter a₀ is set to the mid-point 1.000390625, chart (b) shows H₁ histogram where peak is in position 64 which corresponds to sub-range [0.0,0.0015625) so that parameter a₁ is set to the mid-point 0.00078125, chart (c) shows H₂ histogram where peak is in position 66 which corresponds to sub-range [2.0,3.0) so that parameter a₂ is set to the mid-point 2.5, chart (d) shows H₃ histogram where peak is in position 64 which corresponds to sub-range [0.0,0.0015625) so that parameter a₃ is set to the mid-point 0.00078125, chart (e) shows H₄ histogram where peak is in position 64 which corresponds to sub-range [1.0,1.00078125) so that parameter a₄ is set to the mid-point 1.000390625, and chart (f) shows H₅ histogram where peak is in position 64 which corresponds to sub-range [0.0,0.75) so that parameter a₅ is set to the mid-point 0.375.

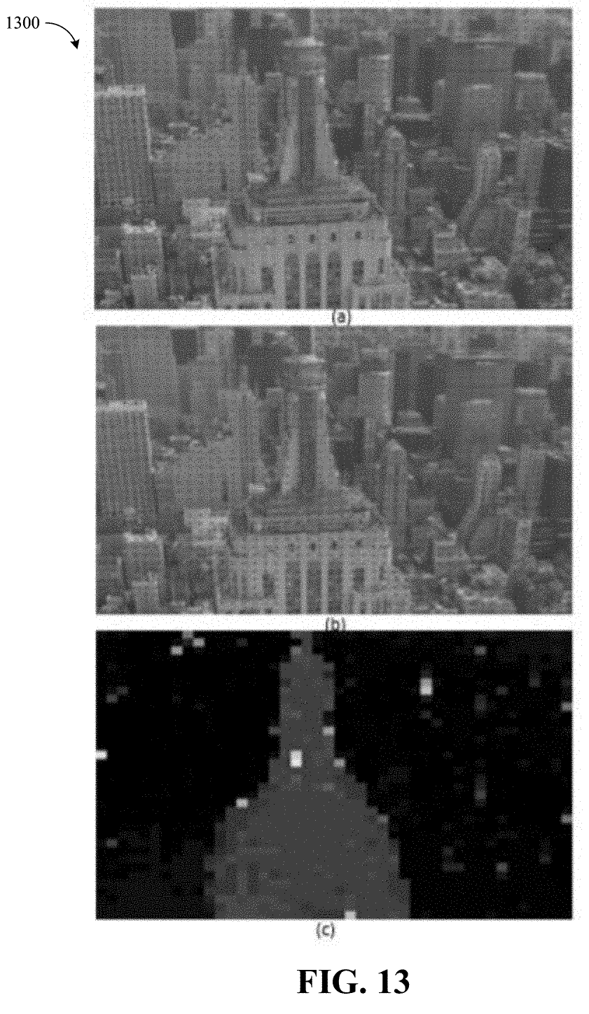

FIG. 13 is an illustrative video sequence 1300 of an example of the difference between global and local block based vectors, arranged in accordance with at least some implementations of the present disclosure. In various implementations, video sequence 1500 shows an example of the “City” sequence showing an initial affine global motion model from the previous figure, FIG. 12, where: frame (a) illustrates the current frame with an 8×8 block-based motion vector field shown with arrows, frame (b) illustrates the current frame with an 8×8 global motion vector field (also shown with arrows) derived from the computed initial affine global motion model, and frame (c) illustrates the difference heat map (e.g., darker shade indicate smaller differences between global and local block-based vectors, while lighter shade indicate larger differences).

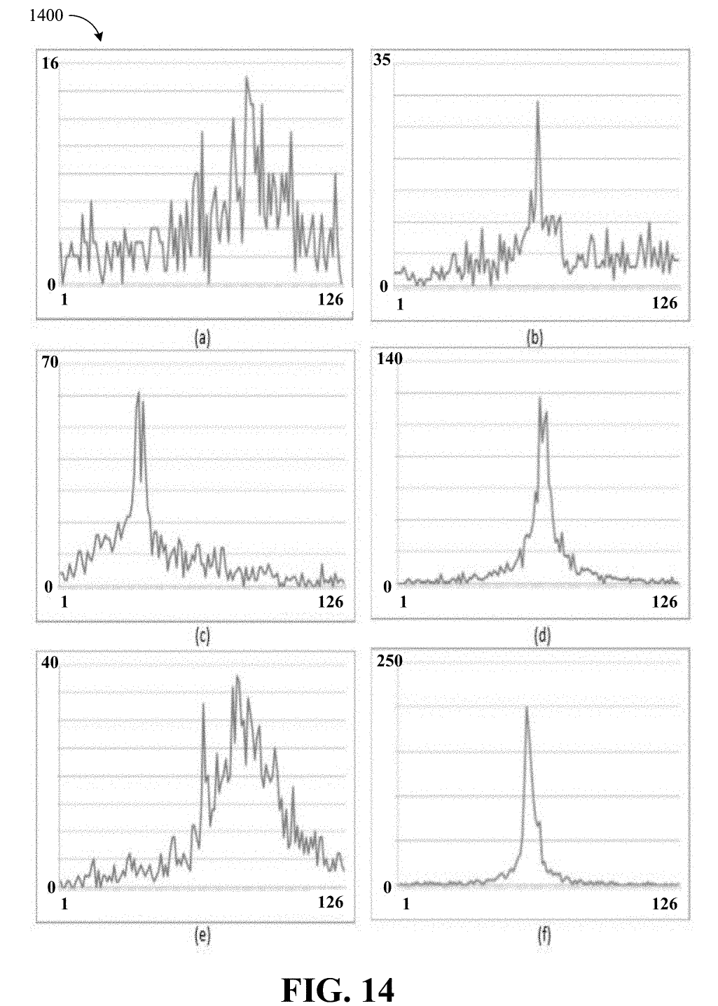

FIG. 14 is an illustrative chart of an example histogram distribution 1400 of locally computed affine global motion model parameters using a random sampling approach, arranged in accordance with at least some implementations of the present disclosure. In various implementations, histogram distribution 1400 illustrates an example of histograms of locally computed affine global motion model parameters using random sampling approach for the “Stefan” sequence with current and reference frames being one frame apart. In the illustrated example, chart (a) shows an H₀ histogram where peak is in position 84 which corresponds to sub-range [1.015625,1.01640625) so that parameter a₀ is set to the mid-point 1.016015625, chart (b) shows an H₁ histogram where peak is in position 64 which corresponds to sub-range [0.0,0.0015625) so that parameter a₁ is set to the mid-point 0.00078125, chart (c) shows an H₂ histogram where peak is in position 35 which corresponds to sub-range [−29.0, −28.0) so that parameter a₂ is set to the mid-point −28.5, chart (d) shows an H₃ histogram where peak is in position 64 which corresponds to sub-range [0.0,0.0015625) so that parameter a₃ is set to the mid-point 0.00078125, chart (e) shows an H₄ histogram where peak is in position 79 which corresponds to sub-range [1.01171875,1.0125) so that parameter a₄ is set to the mid-point 1.012109375, and chart (f) an shows H₅ histogram where peak is in position 58 which corresponds to sub-range [−4.5, −3.75) so that parameter a₅ is set to the mid-point −4.125.

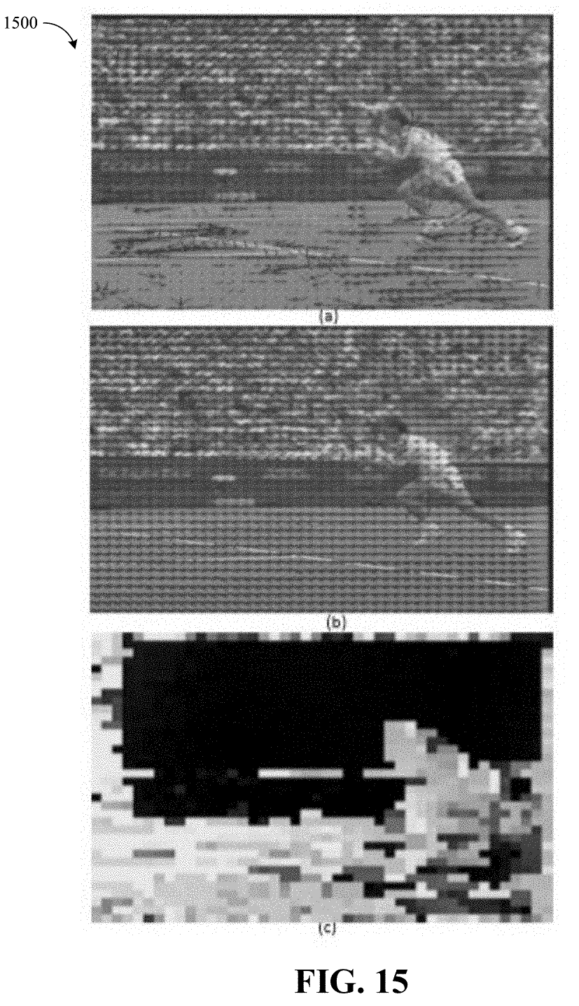

FIG. 15 is an illustrative video sequence 1500 of an example of an initial affine global motion model, arranged in accordance with at least some implementations of the present disclosure. In various implementations, video sequence 1500 illustrates an example of the “Stefan” sequence showing an initial affine global motion model from the previous figure, FIG. 14. In the illustrated example, frame (a) illustrates the current frame with an 8×8 block-based motion vector field (shown with arrows), frame (b) illustrates the current frame with an 8×8 global motion vector field (also shown with arrows) derived from the computed initial affine global motion model, and frame (c) the difference heat map (darker shade indicate smaller differences between global and local block-based vectors, while lighter shade indicate larger differences).

In some examples, the initial affine global motion model may be used for estimating the affine global motion model for segmentation. The selection process may include generation of a number of candidate selection masks as well as corresponding affine motion models, and then choosing the model for segmentation that yields smallest estimated error. The proposed selection method is described next.

In order to correctly estimate global motion from the given motion vector field, it may be vital to first select which motion vectors should be included as well as which ones should be excluded. This task is not easy due to imperfect motion vector fields and the difficulty of perfectly separating blocks into moving visual objects. To solve this problem, some implementations described herein may use a candidate set (e.g., a set of 7, although a different number could be used) possible block selection masks from which the affine global motion model for segmentation may be chosen.

The initial affine global motion model may first used to generate several candidate selection masks (e.g., 5, although a different number could be used). The selection masks obtained from initial affine model are in essence binary masks, which classify all frame blocks into two classes: 1) globally moving blocks, and 2) locally moving blocks. Blocks whose global motion vector computed from the initial model is not similar to corresponding block-based motion vector are marked as local while the other blocks are marked as global. A binary mask may be used to indicate the motion vectors that are pertinent to global motion. An additional mask may be obtained by eroding the mask from the first level of hierarchy. For each of the 5 masks, an affine global motion model may be computed using the described least squares fitting algorithm such that only the motion vectors indicated by the mask are used in least squares computation process.

An SAD-based error measure may then be computed for these 5 models, as well as for the initial affine global motion model. The affine model for segmentation may set to the one that has the smallest error measure. Also, the current selection mask may be set to the mask associated with the one of the 5 hierarchical models that has the smallest error measure.

Next, additional refinement steps (e.g., 2, although a different number could be used) may be performed on the current selected mask in attempt to create a more accurate affine global motion model for segmentation. First, all blocks lying on a frame border may be removed as well as all blocks with very low texture activity. This alternate selection mask's error is compared to the error of the current selected mask and better mask is set as the current one. If the new refined mask is better, the affine model for segmentation may be set to the model computed from the refined mask.

Finally, a second refinement may be performed where only the high texture blocks are selected (e.g. blocks containing multiple edges, corners and complex patterns) from the current selection mask and final candidate mask is formed. Again, the second refined mask's error is compared to the error of the current selected mask and better mask is set as the current selection mask. Finally if the final candidate selection mask yields smaller error, then the affine global motion model for segmentation may be set to the model computed from the final candidate mask.

In some implementations, the algorithm for computing the affine global motion model for segmentation may include the following steps:
1. For i=1 to 4 do the following:
   a. Set t=0
   b. Set minimum local objects size m to a value that estimates how many global blocks should minimally be present in the mask. In our implementation m=0.1×N (10% of total number of blocks).
   c. Compute global motion vector field {GMXⱼ, GMYⱼ}, j=0, . . . , N−1 using the initial affine global motion model
   d. Set t=t+i
   e. For each position j in the motion vector field compute eⱼ=abs(GMXⱼ−MXⱼ)+abs(GMYⱼ−MYⱼ). If eⱼ≤t then set mask Mᵢ[j]=1; otherwise set Mᵢ[j]=0
   f. If sum of all values of Mᵢ is less than m then repeat go back to step 1c
2. Set mask M₀ to erosion of mask M₁
3. For all 5 masks M₀, . . . , M₄ compute affine 6 parameter models using the described least squares fitting algorithm such that only the motion vectors indicated by the mask are used in least squares computation process
4. Compute SAD measure for all 5 least square fit affine models and set l∈{0, . . . , 4} to the index of the model with the smallest SAD measure value. Set the current selection mask to mask Mₗ.
5. Compare SAD measure of the selected l-th affine parameter model with the SAD measure of the initial affine global motion vector model and set the current best initial affine global motion model to the model that yields smaller SAD measure.
6. If H<300 and W<600 and W×H<180,000 then set T=4; otherwise set T=6.
7. Create additional candidate mask M₅ by refining the current selection mask as follows:
   a. Remove all blocks that lie on the frame border
   b. Remove all blocks whose minimum of Rs and Cs texture measures is smaller than the threshold T
8. For mask M₅ compute affine 6 parameter model using the least squares fitting algorithm such that only the motion vectors indicated by the mask are used in least squares computation process
9. Compute SAD measure the computed affine model for M₅
10. Compare SAD measures of the current model and computed model for M₅ mask and set the current model and mask to the one that has the smallest SAD measure.
11. Set thresholds T_{RS} to 1.5× average Rs value in the Rs/Cs 2-D array, and T_{CS} to 1.5× average Cs value in the Rs/Cs 2-D array
12. Create final candidate selection mask M₆ by refining the current selection mask as follows:
   a. Remove all blocks whose Rs texture measure is smaller than threshold T_{RS} and whose Cs texture measure is smaller than threshold T_{CS}
13. For mask M₆ compute affine 6 parameter model using the least squares fitting algorithm such that only the motion vectors indicated by the mask are used in least squares computation process
14. Compute SAD measure the computed affine model for M₆
15. Compare SAD measures of the current model and computed model for M₆ mask and set the current model and mask to the one that has the smallest SAD measure. Output the current model and mask as the final selection mask to be used in the global motion model computation.

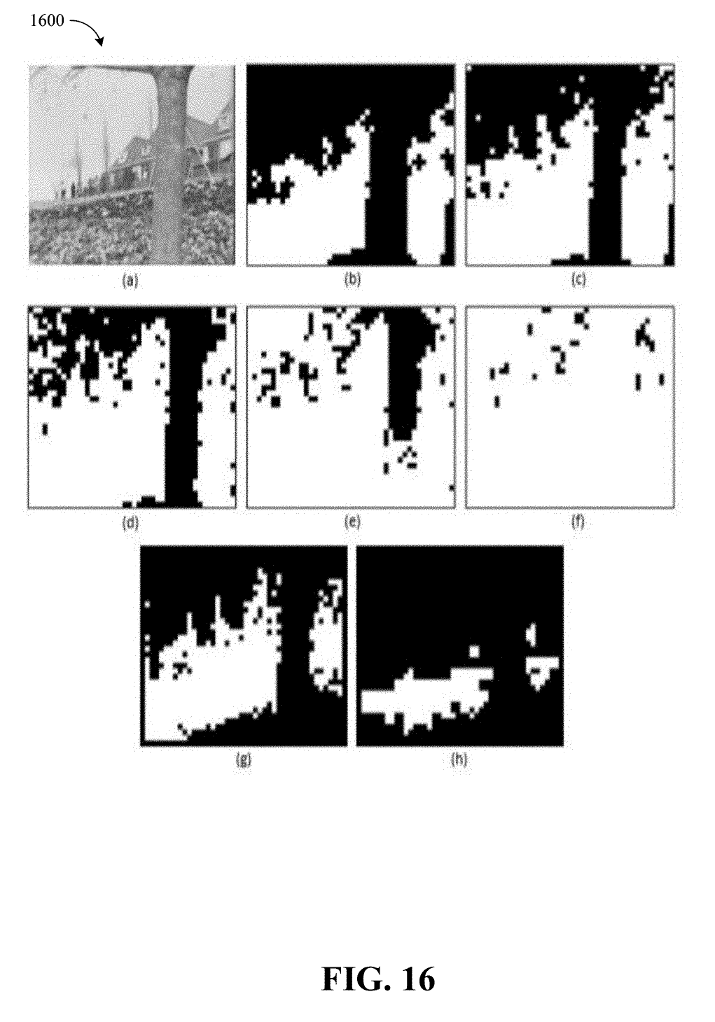

FIG. 16 is an illustrative video sequence of an example of different computed candidate selection masks 1600, arranged in accordance with at least some implementations of the present disclosure. In various implementations, this example of the computed candidate selection masks 1600 for the “Flower” sequence may include: frame (a) original YUV frame, candidate selection mask (b) M₀ eroded estimated mask in the 1^{st} level of hierarchy (M₀-based error measure=987505), candidate selection mask (c) M₁ estimated mask in the 1^{st} level of hierarchy (M₁-based error measure=970341), candidate selection mask (d) M₂ estimated mask in the 2^{nd} level of hierarchy (M₂-based error measure=1002673), candidate selection mask (e) M₃ estimated mask in the 3^{rd} level of hierarchy (M₃-based error measure=1373757), candidate selection mask (f) M₄ estimated mask in the 4^{th} level of hierarchy (M₄-based error measure=1417258), candidate selection mask (g) M₅ refined mask using best mask from the 5 hierarchical candidates (e.g., in this case the best candidate is M₁, e.g., the candidate with the smallest error measure) where flat blocks and frame border blocks are removed from the mask (M₅-based error measure=972156), and candidate selection mask (h) M₆ refined mask using the best mask from the previous 6 candidates (e.g., in this case it is still mask M₁) where only high texture blocks (e.g., such as blocks containing multiple edges, corners and complex patterns) are selected (M₆-based error measure=981807). In this example, the final candidate selection mask is set to M₁.

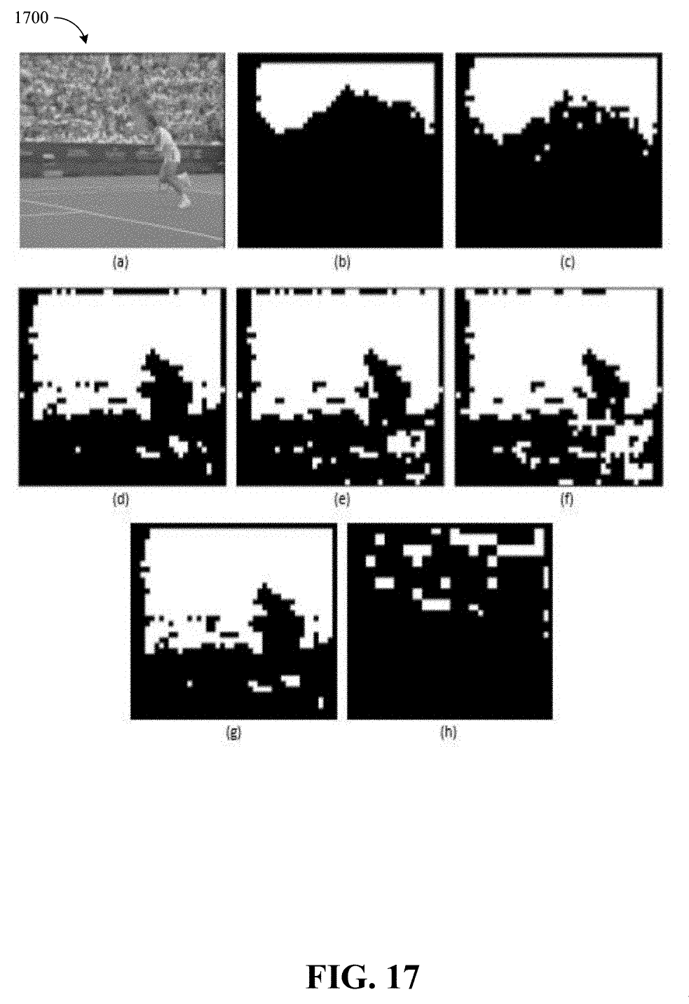

FIG. 17 is an illustrative video sequence of an example of different computed selection masks 1700, arranged in accordance with at least some implementations of the present disclosure. In various implementations, this example of the computed selection masks 1700 for the “Stefan” sequence may include: frame (a) original YUV frame, candidate selection mask (b) M₀ encoded estimated mask in the 1^{st} level of hierarchy (M₀-based error measure=1365848), candidate selection mask (c) M₁ estimated mask in the 1^{st} level of hierarchy (M₁-based error measure=1363467), candidate selection mask (d) M₂ estimated mask in the 2^{nd} level of hierarchy (M₂-based error measure=1318886), candidate selection mask (e) M₃ estimated mask in the 3^{rd} level of hierarchy (M₃-based error measure=1327907), candidate selection mask (f) M₄ estimated mask in the 4^{th} level of hierarchy (M₄-based error measure=1349339), candidate selection mask (g) M₅ refined mask using best mask from the 5 hierarchical candidates (in this case the best candidate is M₂, e.g., candidate with the smallest error measure) where flat blocks and frame border blocks are removed from the mask (M₅-based error measure=1313352), and candidate selection mask (h) M₆ refined mask using the best mask from the previous 6 candidates (in this case it is mask M₅) where only high texture blocks (e.g., such as blocks containing multiple edges, corners and complex patterns) are selected (M₆-based error measure=1348624). In this example, the final candidate selection mask is set to M₅.

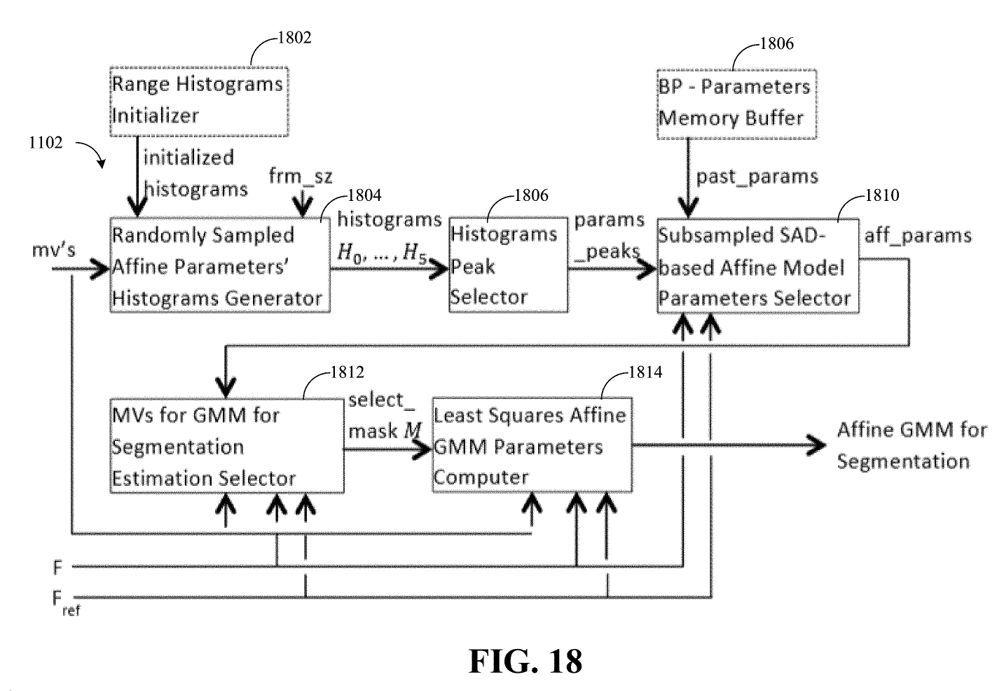

FIG. 18 is an illustrative block diagram of an example global motion model (GMM) for segmentation computer 1102, arranged in accordance with at least some implementations of the present disclosure. In various implementations, global motion model for segmentation computer 1102 may include a range histogram initializer 1802, a randomly sampled affine parameters histogram generator 1804, a histogram peak selector 1806, a subsampled SAD based affine model parameters selector 1808, a BP parameters memory buffer 1810, a MVs for GMM for segmentation estimation selector 1812, and a least squares affine GMM parameters computer 1814.

As illustrated, FIG. 18 shows a detailed block diagram of the first block of FIG. 11, global motion model for segmentation computer 1102. Global motion model for segmentation computer 1102 may compute the affine global motion model for segmentation, which will later be used to create background moving area segmentation mask. First, the range histograms may be initialized and set to all 0 counts via range histogram initializer 1802. Ranges of the histogram are determined empirically as described previously.

Next, for a given block-based motion vector field, three MVs may be chosen at random frm_sz times via randomly sampled affine parameters histogram generator 1804. For each triple of randomly selected MVs, a 6-parameter motion model may be computed using least squares approach. Then, each of the 6 parameters may be mapped to a range in a corresponding histogram and a histogram count in that range may be increased.

After the histograms are collected, the next step may be to analyze them and select the highest histogram peaks via histogram peak selector 1806. For each selected peak, a parameter value may be computed as the mid-point of the given range. This results in an estimated 6-parameter affine global motion model, denoted in the block diagram as params_peaks.

Then, up to 2 previous models (past_params) from BP parameters memory buffer 1810 may be tested along with the computed one in order to select the model that yields the smallest subsampled SAD (SSAD) via subsampled SAD based affine model parameters selector 1808, here denoted by aff_params.

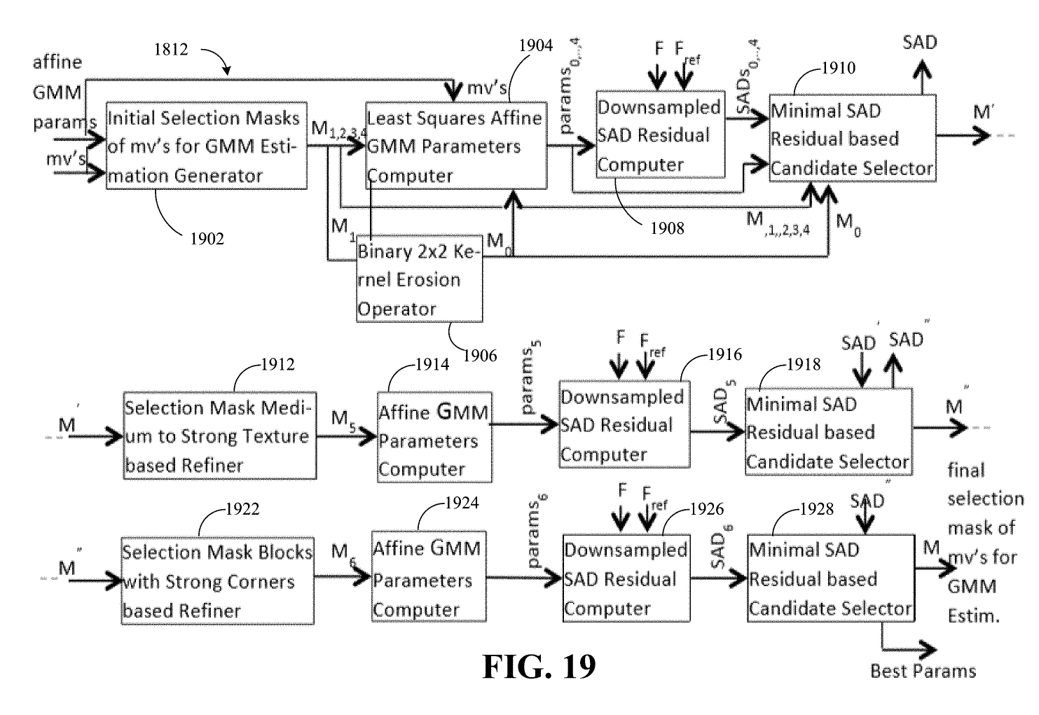

Next, the affine model aff_params may be used to generate the selection mask M that selects which motion vectors to use from the block-based motion vector field mv's in estimating the final affine global motion model for segmentation via MVs for GMM for segmentation estimation selector 1812 (this block is described in more detail in FIG. 19 below).

Finally, a least squares fitting may be used along with the motion vectors mv's, mask M and the current and reference frames F and F_{ref} to estimate the affine GMM parameters for segmentation via least squares affine GMM parameters computer 1814.

FIG. 19 is an illustrative block diagram of an example motion vectors for GMM for segmentation estimation selector 1812, arranged in accordance with at least some implementations of the present disclosure. In various implementations, motion vectors for GMM for segmentation estimation selector 1812 may include an initial selection masks of MVs for GMM estimation generator 1902, a least squares affine GMM parameters computer 1904, a binary 2×2 kernel erosion operator 1906, a downsampled SAD residual computer 1908, a minimal SAD residual based candidate selector 1910, a selection mask medium to strong texture based refiner 1912, an affine GMM parameters computer 1914, a downsampled SAD residual computer 1916, a minimal SAD residual based candidate selector 1918, a selection mask blocks with strong corners based refiner 1922, an affine GMM parameters computer 1924, a downsampled. SAD residual computer 1926, and a minimal SAD residual based candidate selector 1928.

As illustrated, shows a detailed block diagram of the sixth block of FIG. 18, motion vectors for GMM for segmentation estimation selector 1812. FIG. 19 illustrates an example of the steps that may be used for computation of the selection mask, which may be used to identify which motion vectors are to be used in the global motion model for segmentation estimation phase. In the first step of this process, the initial affine model is used to generate an estimated global motion field at the center of the block of the same size as the blocks of the block-based motion vector field via initial selection masks of MVs for GMM estimation generator 1902. Such global motion vector field is then differenced with the block-based field (e.g., by computing the sum of absolute differences for each vector coordinate). The differences are classified with 4 different adaptively chosen thresholds to obtain 4 candidate binary selection masks M_{1, . . . , 4}.

An additional mask M₀ may be computed by eroding mask M₁ with a 2×2 kernel via binary 2×2 kernel erosion operator 1906.

Next, 5 affine models are computed using the least squares fitting method according to the 5 binary selection masks (e.g., a vector is used in the fitting process if the mask value is 1; otherwise, it is skipped) via least squares affine GMM parameters computer 1904. This produces the initial 5 candidate models denoted by params_{0, . . . , 4}.

For each of them a subsampled SAD error may be computed using the current and the reference frames as input via downsampled SAD residual computer 1908, and the mask M′ is selected which corresponds to the minimal error via minimal SAD residual based candidate selector 1910.

After that, two more candidate masks may be generated. The first one, denoted M₅, may be obtained by refining M′ so that only medium and strong texture blocks are kept while flat texture blocks are removed via selection mask medium to strong texture based refiner 1912. In addition, frame borders may also be removed since most of the uncovered area appears there, which yields unreliable vectors. Similarly the corresponding affine model for M₅ and the corresponding subsampled SAD error may be computed via affine GMM parameters computer 1914. Then, either M₅ or M′ is chosen (and denoted by M″) via downsampled SAD residual computer 1916 and minimal SAD residual based candidate selector 1918.

The chosen M″ may be input to the 2^{nd} refinement step, which may produce the candidate selection mask M₆ by selecting only the high texture blocks (e.g., blocks with both Rs and Cs values high) from the input mask M″ via selection mask blocks with strong corners based refiner 1922. Using the same steps as before, the corresponding affine model may be computed for M₆ via affine GMM parameters computer 1924 and the corresponding subsampled SAD error, and, according to the smallest error, either M₆ or M″ may be chosen as the final selection mask via downsampled SAD residual computer 1926 and minimal SAD residual based candidate selector 1928.

Background Moving Region Segmentation

In order to determine what moving regions exist in the given frame, the first step may be to segment the frame into the two main motion-based areas: (1) global moving area (also referred to as the background moving region), and (2) local moving area (also referred to as foreground moving regions). The global moving area may itself be a region, typically the largest one in the frame. It is worth noting that the background moving region may not move at all, e.g., the background moving region could be stationary. In this case, the region “moves” with a global vector of (0, 0). On the other hand, local moving area may consist of 0 or more of foreground moving regions, depending on the content of the scene. Thus, the first step may be to determine the background moving region, a process referred to as the background moving region segmentation.

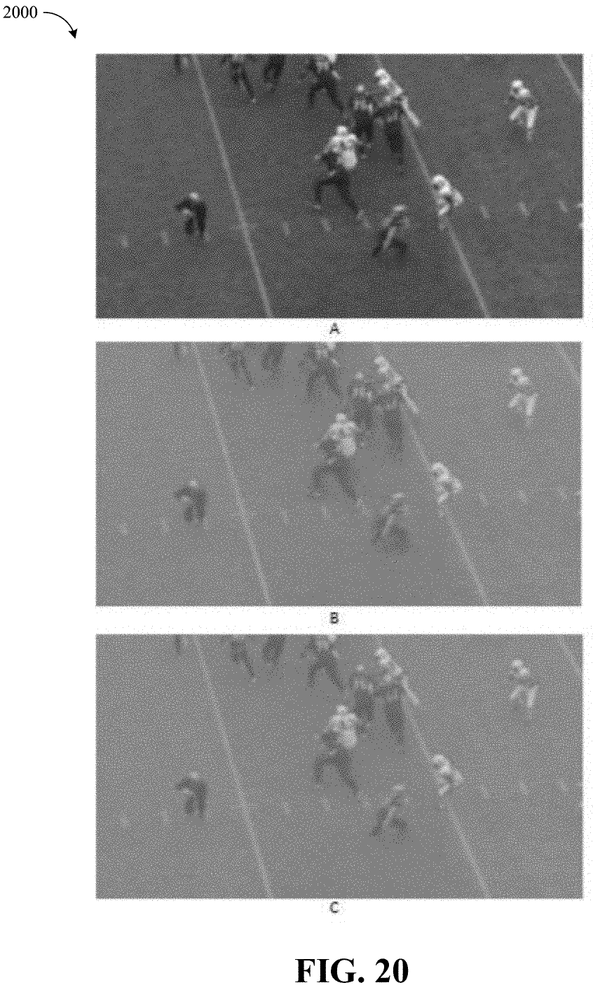

In some implementations, the purely motion based segmentation may be extended to be assisted by color for content that has a significant low textured dominant color within the moving region. This extension of the algorithm may enhance quality, temporal stability, and, therefore, also codability of the moving regions mask within the RMM. An existing motion region may be analyzed for presence of a single dominant color in the low texture area of the region, and if present in significant percentage (e.g., over 85%), the region's dominant color may be used to enhance region boundary. Blocks of the given region that contain little to none of the determined dominant color may be removed and blocks that most consist of colors similar to the dominant color may be added to that region. An example is shown in FIG. 20 below.

The proposed background moving region segmentation operation may include the following steps:
1. Let W×H denote full frame resolution. If H<300 and W<600 and W×H<180,000 then set N=8; otherwise set N=16.
2. Compute global motion probability map (GMP map) as follows:
   a. Create (W/N)×(H/N) global motion vector field (GMVF) by computing global motion vector for the center pixel of each N×N block in the current frame using the affine global motion model for segmentation that was computed previously
   b. Let (gmxᵢ, gmyᵢ) be the i-th motion vector in GMVF, and let (mxᵢ, myᵢ) be the i-th motion vector in the block-based motion vector field (produced by the motion estimation step). Then the i-th value of the (W/N)×(H/N) GMP map is set to: GMP(i)=abs(gmxᵢ−mxᵢ)+abs(gmyᵢ−myᵢ)
3. Compute a binarization threshold Tₘ for the global motion probability map
4. Apply threshold Tₘ to obtain a 2-level (binary) mask of GMP, denoted by BGMP:
   a. For all blocks i in GMP
      i. If GMP(i)<Tₘ then BGMP(i)=1
      ii. Otherwise BGMP(i)=0
5. Compute dominant color probability map as follows:
   a. Initialize color histogram H_{c} to 0
   b. For all blocks i in BGMP, if BGMP(i)=1 then collect N/4 YUV colors from the collocated blocks in the (W/4)×(H/4) YUV444 subsampled frame SF and add counts to H_{c}
   c. Set dominant color (d_{Y}, d_{U}, d_{V}) to the highest peak in H_{c}
   d. Subsample SF to (W/N)×(H/N) YUV444 frame SSF
   e. For all i in (W/N)×(H/N) DCP map, set DCP(i)=8×abs(d_{y}−SSF_{y(i)}+abs(d_{y}−SSF_{y(i)}+abs(d_y−SSF_y(i))
6. If N=8 set Rs/Cs low value (flat) threshold T_{f} to 4; otherwise, set T_{f} to 6
7. Set counter c=0, and set color similarity threshold T_{c}=16
8. For all i in (W/N)×(H/N) BGMP map:
   a. If BGMP(i)=1 and DCP(i)<T_{c} and max(Rs(i), Cs(i))<T_{f} then set c=c+1
9. If c>0.85×(W/N)×(H/N) then reset BGMP as follows:
   a. For all i in (W/N)×(H/N):
      i. If DCP(i)<T_{c} and max(Rs(i), Cs(i))<T_{f} then set BGMP(i)=1
      ii. Otherwise set BGMP(i)=0
10. Output BGMP as the background moving region segmentation mask.

FIG. 20 is an illustrative video sequence of an example segmentation method 2000 where color is used to assist motion, arranged in accordance with at least some implementations of the present disclosure. In various implementations, segmentation method 2000 shows an example of a high-definition (1080p) “Touchdown Sequence” that uses color assist in conjunction with motion. For instance, frame (a) shows the original frame, frame (b) shows the final moving regions without using motion-only segmentation (SAD=8442667, 2, regions), and frame (c) shows final moving regions generated by using motion assisted by color segmentation (SAD=8133603, 2 regions), Full frame SAD=10914919.

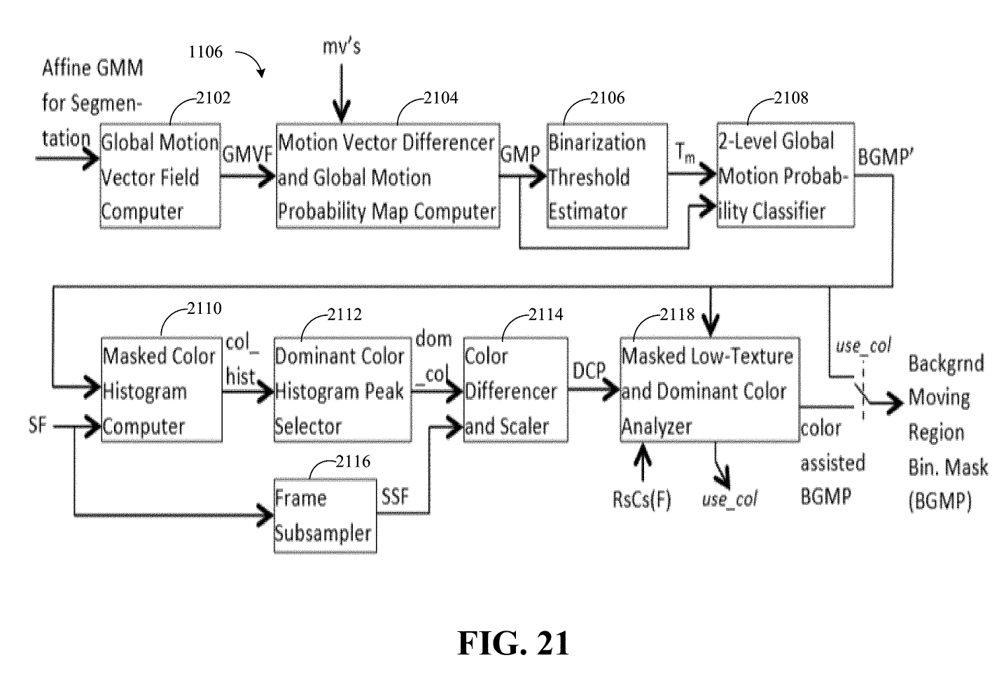

FIG. 21 is a block diagram of an example background moving regions segmenter 1106, arranged in accordance with at least some implementations of the present disclosure. In various implementations, background moving regions segmenter 1106 may include a global motion vector field computer 2102, a motion vector difference and global motion probability map computer 2104, a binarization threshold estimator 2106, a 2-level global motion probability classifier 2108, a masked color histogram computer 2110, a dominant color histogram peak selector 2112, a color difference and scaler 2114, a frame subsampler 2116, and a masked low-texture and dominant color analyzer 2118.

As illustrated, FIG. 21 shows a detailed block diagram of the third block of FIG. 11, background moving regions segmenter 1106. Background moving regions segmenter 1106 may generate a binary segmentation mask, which indicates background (e.g., a globally) moving area versus the rest of the frame, which either has static or locally moving blocks.

In operation, first, the previously computed affine GMM for segmentation may be used to compute global motion vector field via global motion vector field computer 2102, denoted by GMVF. The field may be computed by applying the affine parameter equation of the GMM to the center of the block position (e.g., using the same block size as in block-based mv's field).

Then, differences between GMVF and mv's may be computed and scaled to 0-255 range producing the so called Global Motion Probability map (GMP) via global motion probability map computer 2104. The GMP map may then be binarized using the computed threshold Tₘ (generated via binarization threshold estimator 2106) into binary mask denoted by BGMP′ via 2-level global motion probability classifier 2108.

Next, a masked color histogram may be computed using BGMP′ to mask out only globally moving blocks via masked color histogram computer 2110. Form the histogram (col_hist) peaks may be determined and a corresponding dominant color may be generated (dom_col) via dominant color histogram peak selector 2112. Using the dominant color and resolution adjusted subsampled YUV444 frame SSF from frame subsampler 2116, color differences may be computed and scaled to 0-255 range (DCP map) via color difference and scaler 2114. DCP Map, along with RsCs(F) and BGMP′ mask may be used to compute the percentage of low-textured, dominant color blocks in the background moving area, which is represented as a binary mask color assisted BGMP via masked low-texture and dominant color analyzer 2118. Analysis may be done to determine if the percentage of these blocks is high enough (e.g., in some implementations this percentage threshold may be to 85% or more of the background moving blocks from BGMP′) then the use_col control signal may be set to 1, otherwise the use_col control signal may be set to 0. If the use_col signal is 1, then color assisted BGMP may be output as the final background moving region binary mask (BGMP); otherwise, the BGMP′ mask may be output as BGMP.

Segmentation of Remaining (Foreground) Moving Regions

Once the background moving region is segmented, the remaining area (e.g., the foreground moving area minus the detected stationary non-active content area) may be potentially segmented further. An analysis may be performed to determine if the foreground area should be split into two separate regions or not. If the foreground area should be split further, the following motion based segmentation may be performed within the current foreground region:
1. Compute dominant motion vector (from block-based MVF) in the non-background moving region of the segmentation mask BGMP (i.e. where mask values are 0):
   a. Initialize motion vector histogram Hₘ to 0
   b. For all blocks i in BGMP, if BGMP(i)=0 then collect i-th motion vector from MVF add counts to Hₘ
2. Set dominant motion vector (dmx, dmy) to the highest peak in Hₘ
3. Compute motion vector differences according into the masked dominant motion probability map (DMP map) as follows:
   a. For all blocks i in BGMP, if BGMP(i)=0 then DMP(i)=abs(dmx−mxᵢ)+abs(dmy−myᵢ). Here, (mx₁, myᵢ) denotes the i-th motion vector in the block-based MVF.
4. Compute binarization threshold Tₘ₁ for the differences and apply it to all foreground blocks thus splitting the foreground area into two foreground regions. The resulting binary mask is denoted by BDMP.
5. Analyze solidity and size of the dominant motion area in mask BDMP: if the larges 4-connected segment in BDMP is at least 10% of the frame, then add the new foreground region defined my BDMP to Regions mask. Otherwise skip to step 6.
6. Create final Regions mask by adding, if available, the non-active content area region mask.

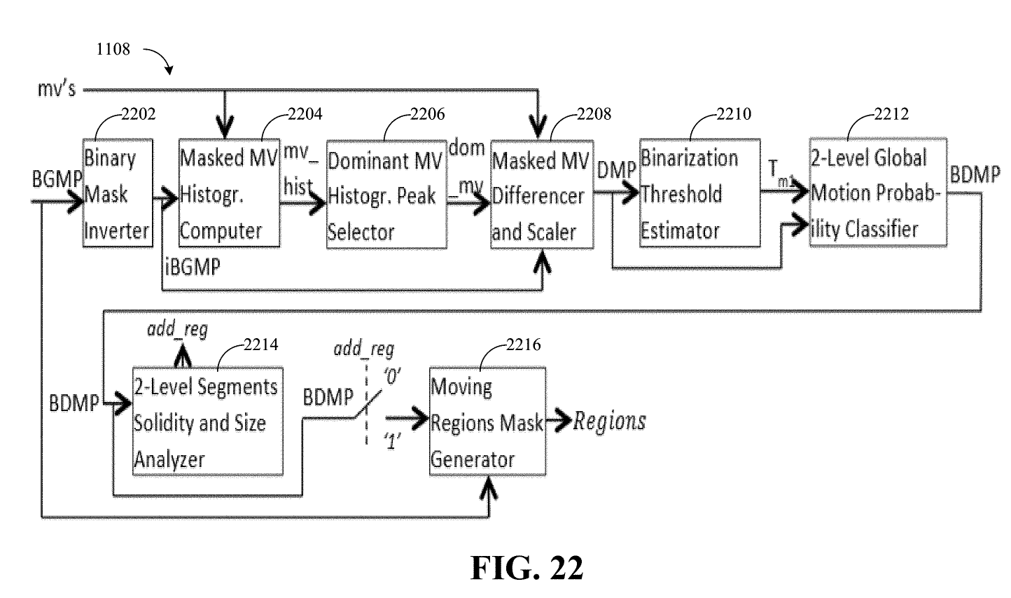

FIG. 22 is a block diagram of an example foreground moving regions segmenter 1108, arranged in accordance with at least some implementations of the present disclosure. In various implementations, foreground moving regions segmenter 1108 may included a binary mask inverter 2202, a masked MV histogram peak selector 2204, a dominant MV histogram peak selector 2206, a masked MV difference and scaler 2208, a binarization threshold estimator 2210, a 2-level global motion probability classifier 2212, a 2-level segments solidity and size analyzer 2214, and a moving regions mask generator 2216.

As illustrated, FIG. 22 shows a detailed block diagram of the fourth block of FIG. 11, foreground moving regions segmenter 1108. Foreground moving regions segmenter 1108 may generate up to 2 remaining foreground regions (if any) and may produce the final regions mask. In this example, foreground moving regions segmenter 1108 may operate as a 2 stage cascade segmentation system. First, the BGMP mask that defined background moving region may be inverted so that remaining, non-background area is turned on (e.g., bit mask has a value of 1) via binary mask inverter 2202.

Then, using the inverted mask iBGMP, a masked histogram of motion vectors may be computed for the frame using the block-based motion vectors mv's, via masked MV histogram peak selector 2204. The histogram, denoted by mv_hist, may be analyzed and peaks may be selected to obtain the dominant motion vector within the foreground moving area via dominant MV histogram peak selector 2206. The motion vector field mv's may be next differenced with the dominant motion vector and the results may be scaled to 0-255 range into the dominant color probability map (DMP map) via masked MV difference and scaler 2208.

A binarization threshold may be estimated for the resulting DMP map via binarization threshold estimator 2210 and the map may be binarized into the 2-level binary mask BDMP via 2-level global motion probability classifier 2212. Next, the segment solidity and size analysis may be performed to determine if the new foreground region defined by BDMP is significant or not via 2-level global motion probability classifier 2212. If it is significant the control signal add_reg is set to 1 (else, it is set to 0). If add_reg is 0 then there is no foreground regions and the resulting Regions mask is created with only 1-2 regions (as defined by BGMP) via moving regions mask generator 2216. Otherwise, the Regions mask is created with only 2-3 regions (as defined by BGMP and the and BDMP masks) via moving regions mask generator 2216.

Morphological Based Post Processing of Segmented Regions

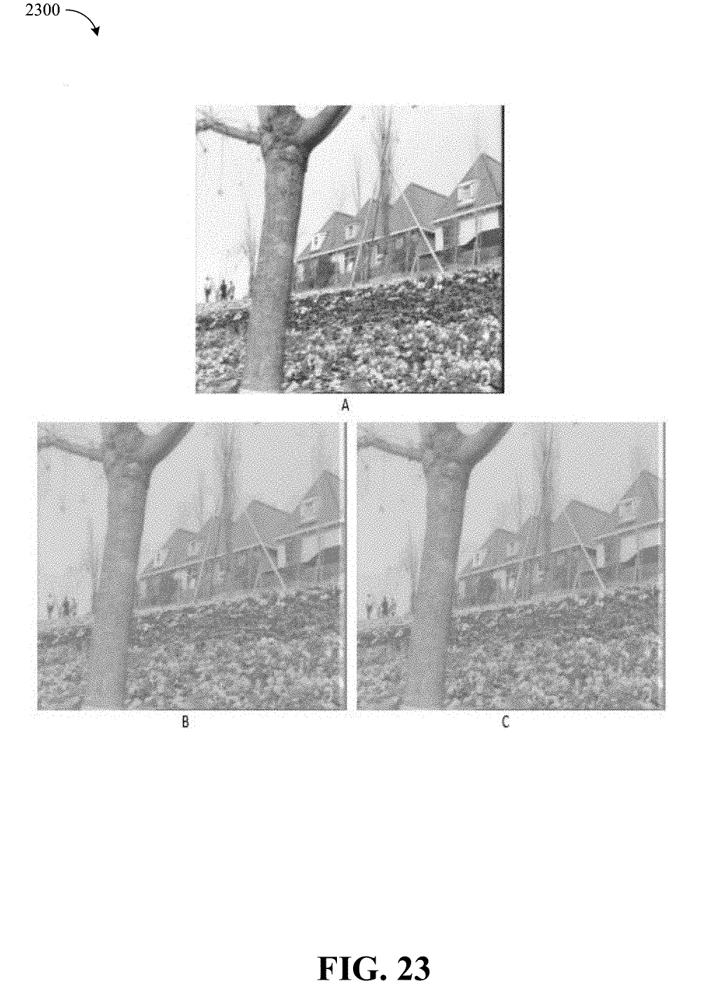

The generated regions mask may be post-processed in order to create more stable and less noisy region segments. Morphological opening and closing may be used to clean up the moving regions segmentation mask from the salt and pepper type of noise that is typically common for almost all segmentation methods. Additionally, a two-level small object removal process may be employed as well to remove noise related small segmented blobs. Finally, a mask's region boundary may be smoothened by a smoothing filter to remove small spikes and similar noise artifacts on the region boundaries. An example of post-processing of regions mask is shown in FIG. 23 below.

The regions mask post-processing algorithm consists of the following steps:
1. Apply morphological opening with 2×2 kernel to the regions mask. Morphological opening is defined as image erosion followed by image dilation.
2. Apply morphological closing with 2×2 kernel to the regions mask. Morphological closing is defined as image dilation followed by image erosion.
3. Set resolution scaling factor rsf=max(1, (W/350)*(H/300))
4. For all segments S in region mask do the following:
   a. If size of S is less than rsf×4 then perform the 1st level removal of small segments in the regions mask as follows:
      i. Compute bounding box of S
      ii. Expand bounding box of S by 1 on each side
      iii. Collect the histogram of region indices within the expanded bounding box
      iv. Set the count of the current region index of S in the histogram to 0
      v. Replace the region index of segment S with the region index whose count is the highest in the histogram
   b. Otherwise, if the size of S is greater or equal to rsf×4 and less than rsf×8 then perform the 2nd level removal of small segments in the regions mask as follows:
      i. Compute bounding box of S
      ii. Expand bounding box of S by 1 on each side
      iii. Collect the histogram of region indices within the expanded bounding box
      iv. Set the count of the current region index of S in the histogram to 0
      v. Compute SAD of S using motion models corresponding to all regions whose region index in the histogram is nonzero
      vi. Choose the region index whose corresponding SAD is the smallest
      vii. If SAD corresponding to the chosen new region index is within 5% of the existing SAD of S, then replace the region index of S with the chosen new region index
5. Smooth mask vertically and horizontally with

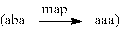

mapping: if the previous and next values are the same then replace the current value with the previous/next value.

FIG. 23 is an illustrative video sequence of an example morphological-based post-processing method 2300, arranged in accordance with at least some implementations of the present disclosure. In various implementations, in morphological-based post-processing method 2300 frame (a) shows the original frame, frame (b) shows regions mask before post-processing, and frame (c) shows regions mask after post-processing showing a cleaner looking mask.

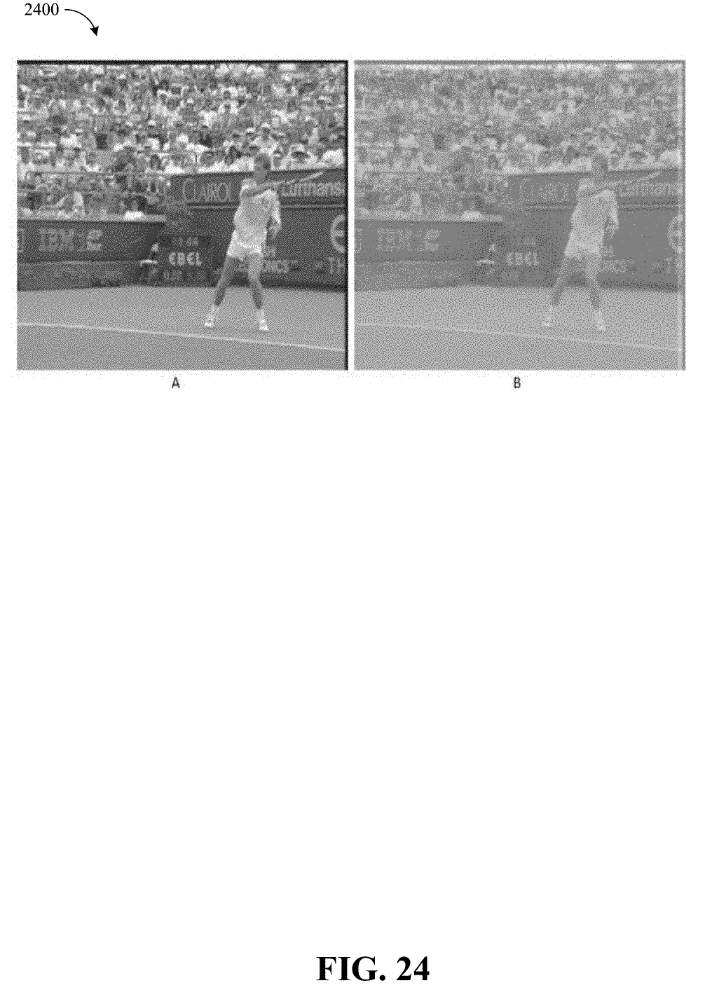

Examples of the final segmented region masks for several sequences of various resolutions are illustrated below in FIG. 24-FIG. 2328.

FIG. 24 is an illustrative video sequence of an example regions segmentation method 2400 for low-definition content, arranged in accordance with at least some implementations of the present disclosure. In various implementations, regions segmentation method 2400 shows segmentation of a low-definition (CIF) “Stefan” sequence. For instance, frame (a) shows the original frame, and frame (b) shows final moving regions mask (contains 3 moving regions and 1 non-active content area region).

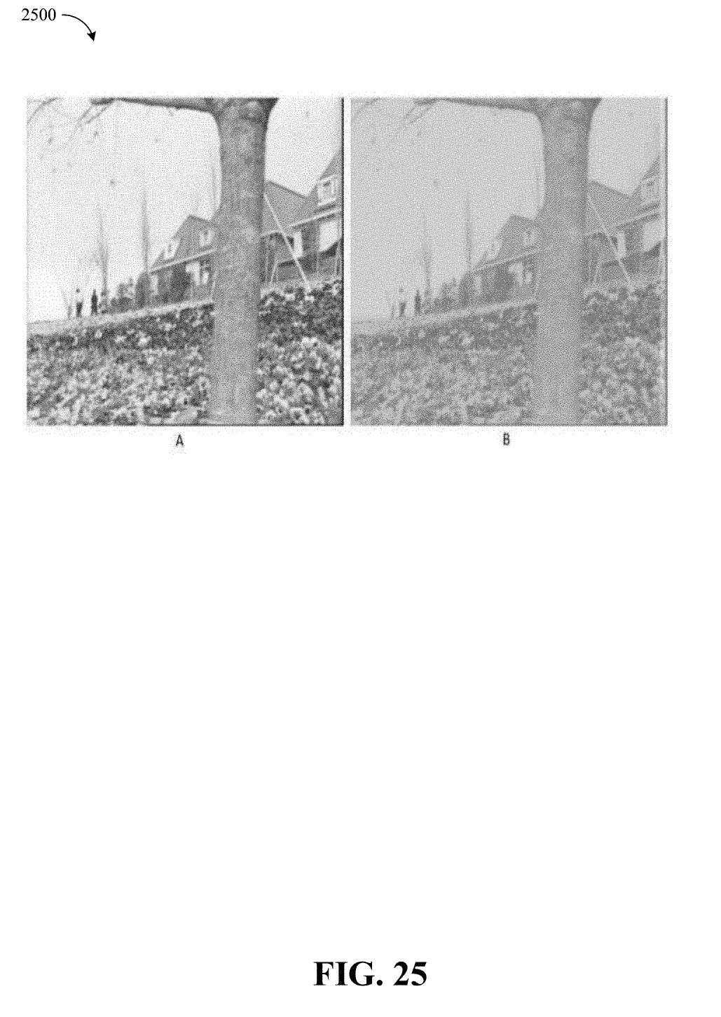

FIG. 25 is an illustrative video sequence of an example regions segmentation method 2500 for low-definition content, arranged in accordance with at least some implementations of the present disclosure. In various implementations, regions segmentation method 2500 shows segmentation of a low-definition (CIF) “Flower” sequence. For instance, frame (a) shows the original frame, and frame (b) shows the final moving regions mask (e.g., containing three moving regions and one non-active content area region).

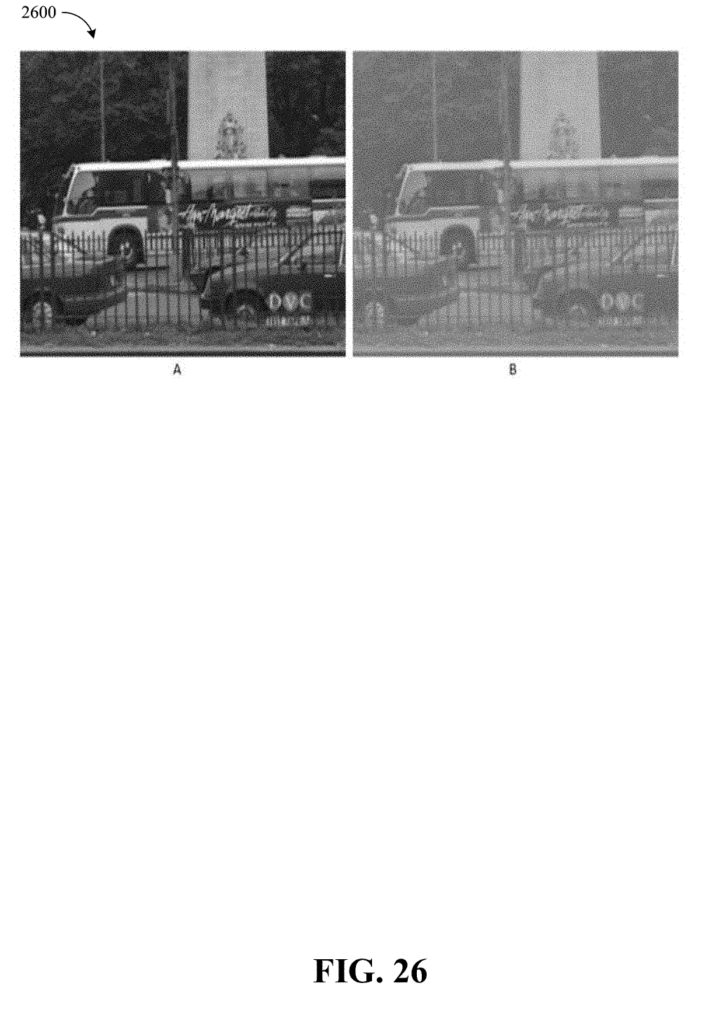

FIG. 26 is an illustrative video sequence of an example regions segmentation method 2600 for low-definition content, arranged in accordance with at least some implementations of the present disclosure. In various implementations, regions segmentation method 2600 shows segmentation of a low-definition (CIF) “Bus” sequence. For instance, frame (a) shows the original frame, and frame (b) shows the final moving regions mask (e.g., containing three moving regions).

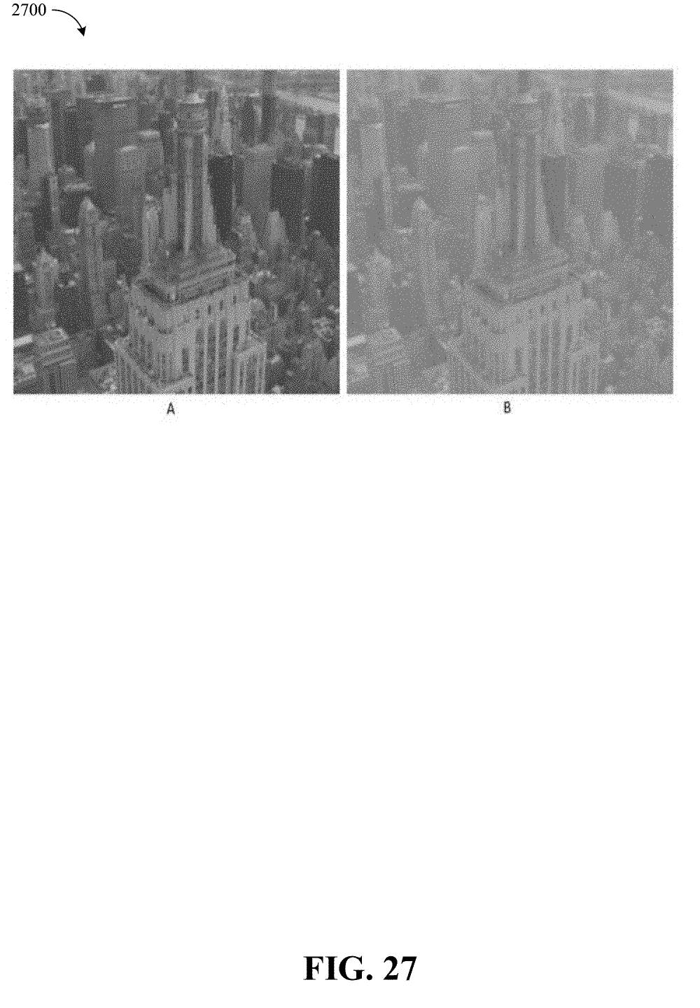

FIG. 27 is an illustrative video sequence of an example regions segmentation method 2700 for standard-definition content, arranged in accordance with at least some implementations of the present disclosure. In various implementations, regions segmentation method 2700 shows segmentation of a standard-definition (704×576) “City” sequence. For instance, frame (a) shows the original frame, and frame (b) shows the final moving regions mask (e.g., containing two moving regions).

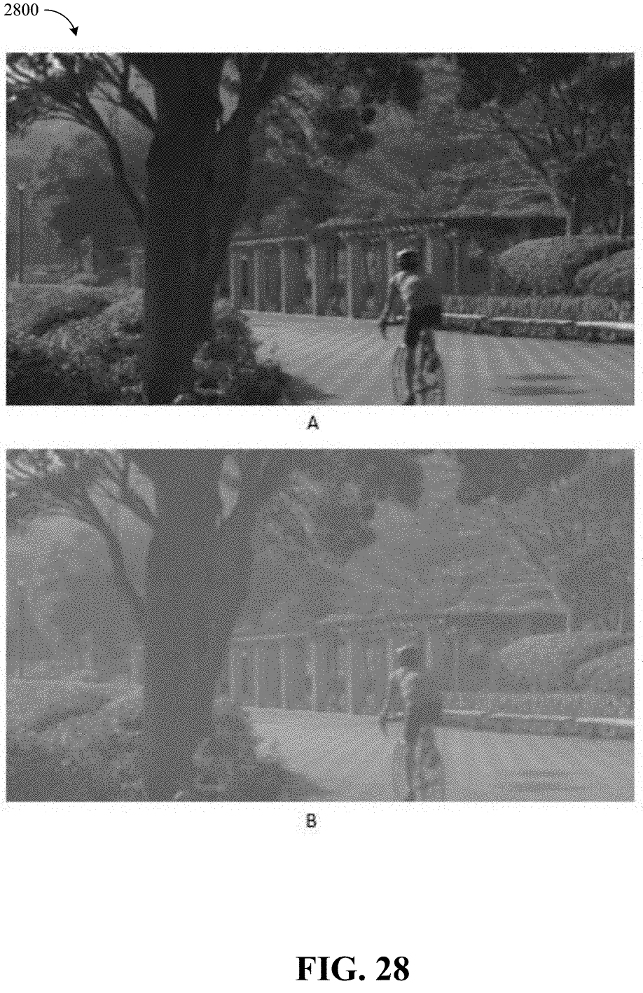

FIG. 28 is an illustrative video sequence of an example regions segmentation method 2800 for high-definition content, arranged in accordance with at least some implementations of the present disclosure. In various implementations, regions segmentation method 2800 shows segmentation of a high-definition (1080p) “Park Scene” sequence. For instance, frame (a) shows the original frame, and frame (b) shows the final moving regions mask (e.g., containing three moving regions).

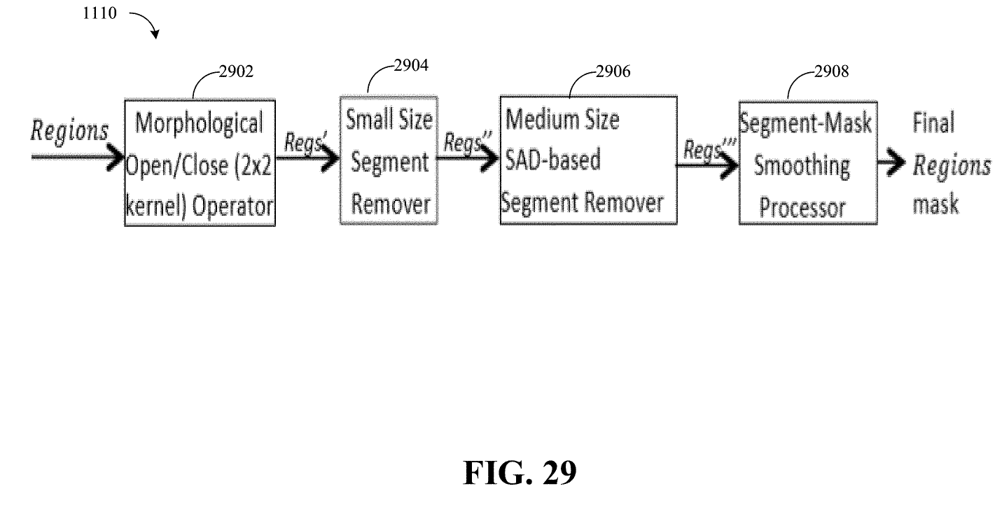

FIG. 29 is a block diagram of an example morphological-based regions post-processor 1110, arranged in accordance with at least some implementations of the present disclosure. In various implementations, morphological-based regions post-processor 1110 may include a morphological open/close (2×2 kernel) operator 2902, a small size segment remover 2904, a medium size SAD-based segment remover 2906, and a segment-mask smoothing processor 2908.

As illustrated, FIG. 29 shows a detailed block diagram of the fifth block of FIG. 11, morphological-based regions post-processor 1110. Morphological-based regions post-processor 1110 may clean up the regions mask from the typical noise related to a segmentation process. First, the 2×2 kernel-based morphological open and close operators may be applied to the regions mask via morphological open/close (2×2 kernel) operator 2902. Next, small blobs may be removed from the resulting mask (e.g., where minimum allowed blob size is resolution dependent) via small size segment remover 2904. After that, medium size blobs may be removed if their blob SAD that is created by removing the blob and reassigning another region to it is up to a tolerable threshold higher than the SAD of the blow with the old region (e.g., before removal) via medium size SAD-based segment remover 2906. Finally the resulting mask is smoothened by a spike removal filter described previously in this section via segment-mask smoothing processor 2908.

Detection of Non-Active Content Area

Video can often contain a non-active content area, which can cause problems when computing or applying global motion. Such non-content areas may include: black bars and areas due to letterboxing, pillar-boxing, circular or cropped circular fisheye cameras capture, etc. Detecting and excluding such area may greatly improve the GMM results.

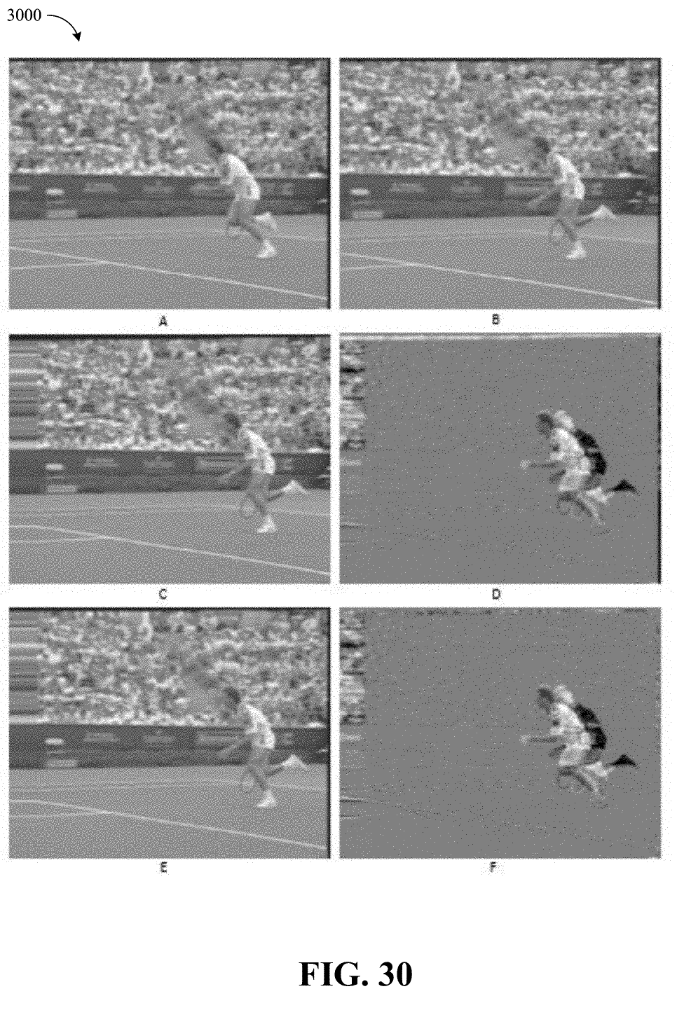

FIG. 30 is an illustrative video sequence 3000 of an example of compensation of detected non-content areas, arranged in accordance with at least some implementations of the present disclosure. In various implementations, FIG. 30 shows an example video sequence 3000 where black bars are detected and removed from GMM and the resulting impact on the quality. The algorithm for letterboxing and pillar-boxing area detection and removal from GMM is described next:
1. For all pixels in F that are at the left edge of the frame do:
   a. Scan current luma frame F_{y} from left towards right and break at break position when RsCs(F_{y}) is larger than threshold T_{bar} (which is in our implementation set to 240) or if the pixel value of F_{y} exceeds black bar threshold T_{blk} (we use T_{blk}=20);
2. Determine the dominant break position of the left frame edge, denoted L_{brp} as the multiple of 4 pels that is closest to the majority of left edge break positions;
3. If L_{brp} is larger than 4 pels, smaller than ⅓ of W (the frame width) and 90% or more left edge break positions are within 4 pixel distance of L_{brp}, then declare non-content area at left edge that spans to L_{brp} pixels wide; and
4. Repeat steps 1-3 for right edge, top, edge, and bottom edge to detect non-content area at remaining sides of the frame.

In the example illustrated in FIG. 30, shows video sequence 3000, based on the “Stefan” sequence, there are 4 pixel thick bars detected on top and on right frame edge. The non-content area is then excluded from GMM compensation and zero motion is applied. Remaining area is normally modeled with GMM, as FIG. 30 depicts.

For example, the “Stefan” video sequence 3000 shows compensation of detected non-content area (e.g., 2 bars, top and right, both 4 pixel thick are detected and coded, [0,0] motion is used at bar area) where: frame (a) is the current original luma frame, frame (b) is the reference luma frame (1 frame apart), frame (c) is the reconstructed frame without bar detection, frame (d) is the residuals frame without bar detection (SAD=1087071), frame (e) is the reconstructed frame with bar detection, and frame (f) is the residuals frame without bar detection (SAD=933913).

Region-Based Motion Models Generation

Region-based motion models generation operations may include several steps: (1) selecting which motion vectors to include in parametric model estimation for each region, (2) adapting sub-pixel filtering methods for each region (e.g., since different regions may have different texture properties), and (3) adaptively selecting a motion model per region. This part of the proposed example algorithm may serve to estimate motion models to be used for detected moving regions in the frame.

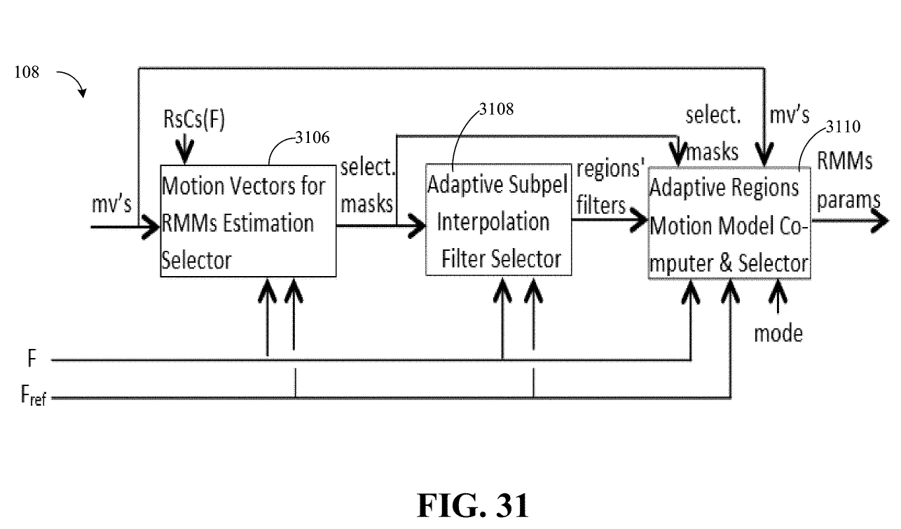

FIG. 31 is an illustrative block diagram of an example multiple region based motion estimator and modeler 108, arranged in accordance with at least some implementations of the present disclosure. In various implementations, multiple region-based motion estimator and modeler 108 may include a motion vectors for RMM estimation selector 3106, an adaptive sub-pel interpolation filter selector 3108, and an adaptive regions motion model computer and selector 3110.

In the illustrated example, FIG. 31 shows portion of example multiple region based motion estimator and modeler 108 that computes a parametric motion model for each region. In the first step, motion vectors for RMM estimation selector 3106 may compute two potential motion vector selection masks for each region. Based on the smallest subsampled SAD of the region motion vectors for RMM estimation selector 3106 may chose one selection mask per region.

Next, one of the 4 possible sub-pixel interpolation filters may be selected for each region based on the minimal subsampled SAD via adaptive sub-pel interpolation filter selector 3108. There may be several (e.g., four) predefined filters in the illustrated example. For example, the filters may include the following filter types: (1) 1/16th-pel smooth texture filter (bilinear), (2) 1/16th-pel medium texture filter (bicubic), (3) ⅛th-pel medium sharp texture filter (modified AVC filter), and (4) ⅛th-pel sharp texture filter (modified HEVC filter), the like, and/or combinations thereof.

Finally, given the selected filers and selection masks for each region, a region based motion model may be selected via adaptive regions motion model computer and selector 3110. For each region, depending on the mode, one of the 3 possible models is selected. Given the value of the control signal mode, either standard or high-complexity models are used as candidates. If the value of the signal mode=0, the system may adaptively select one of the following models per region: (1) translational 4-parameter model, (2) affine 6-parameter model, and (3) pseudo-perspective 8-parameter model. On the other hand, if the value of the signal mode=1, the system may, on a region basis, adaptively select between: (1) affine 6-parameter model, (2) pseudo-perspective 8-parameter model, and (3) bi-quadratic 12-parameter model.

Selection of Motion Vectors for Region-Based Motion Model Estimation

In order to estimate a more accurate motion model for each region, it is often important to select motion vectors (within the given region) that will be used in the model estimation process. For each region there may be several (e.g., 3) candidate selection masks that are computed and one of them is selected to be used in the motion model estimation process.

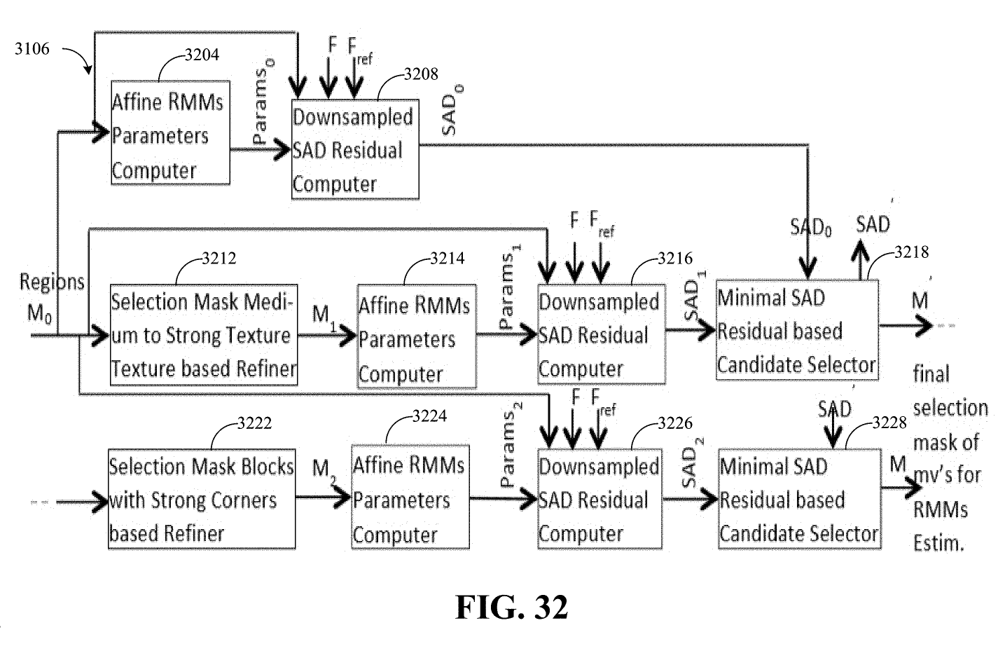

FIG. 32 is an illustrative block diagram of an example motion vectors for RMM estimation selector 3106, arranged in accordance with at least some implementations of the present disclosure. In various implementations, motion vectors for RMM estimation selector 3106 may include an affine RMM parameters computer 3204, a downsampled SAD residual computer 3208, a selection mask medium to strong texture based refiner 3212, an affine RMM parameters computer 3214, a downsampled SAD residual computer 3216, a minimal SAD residual based candidate selector 3218, a selection mask blocks with strong corners based refiner 3222, an affine RMM parameters computer 3224, a downsampled SAD residual computer 3226, and a minimal SAD residual based candidate selector 3228.

As illustrated, FIG. 32 shows a detailed block diagram of the first block of FIG. 31, motion vectors for RMM estimation selector 3106. FIG. 32 shows the steps that may be needed for computation of the selection mask, which is used to identify which motion vectors are to be used in the region-based motion model estimation phase. In the first step of this process, the first candidate mask for each region is the mask of the entire region, denoted by here by M₀. For it, the RMM parameters may be computed via affine RMM parameters computer 3204 and then downsampled SAD may be obtained, denoted by SAD₀, via downsampled SAD residual computer 3208.

Next, a second candidate mask, denoted M₁, may be obtained by refining M₀ so that only medium and strong texture blocks are kept while flat texture blocks are removed via selection mask medium to strong texture based refiner 3212. In addition, frame borders are also removed since most of the uncovered area appears there which yields unreliable vectors. Similarly the corresponding affine model may then be competed for M₅ (denoted Params₁) via affine RMM parameters computer 3214 and the corresponding subsampled SAD error, denoted SAD₁, may be determined via downsampled SAD residual computer 3216. Then, either M₀ or M₁ is chosen (denoted by M′) per region via minimal SAD residual based candidate selector 3218 and input to the 2nd refinement step which produces the candidate selection mask M₂ by selecting only the high texture blocks (e.g., blocks with both Rs and Cs values high) from the input mask M′, via selection mask blocks with strong corners based refiner 3222. Using the same steps as before, the corresponding affine model for M₂, denoted Params₂, may be computed via affine RMM parameters computer 3224 and the corresponding subsampled SAD error, denoted SAD₂, may be determined via downsampled SAD residual computer 3226, and, according to the smallest error, either M₂ or M′ is chosen as the final selection mask for the region via downsampled SAD residual computer 3208. This is repeated for all regions so that the final mask M, contains binary information about which MVs to include and which to exclude from computation of RMMs.

The selection of motion vectors to be used for motion model estimation for region R may be performed as follows:
1. Set the first binary selection mask M₀ to all blocks in the frame that are part of region R
2. If H<300 and W<600 and W×H<180,000 then set T=4; otherwise set T=6.
3. Create additional candidate mask M₁ by refining the current selection mask as follows:
   a. Remove all blocks that lie on the frame border
   b. Remove all blocks whose minimum of Rs and Cs texture measures is smaller than the threshold T
4. For masks M₀ and M₁ compute affine 6-parameter model using the least squares fitting algorithm such that only the motion vectors indicated by the mask are used in least squares computation process
5. Compute SAD measures for the computed affine models corresponding to M₀ and M₁, compare them and set the current model and mask to the one that has the smallest SAD measure.
6. Set thresholds T_{RS} to 1.5× average Rs value in the Rs/Cs 2-D array, and T_{CS} to 1.5× average Cs value in the Rs/Cs 2-D array
7. Create final candidate selection mask M₂ by refining the current selection mask as follows:
   a. Remove all blocks whose Rs texture measure is smaller than threshold T_{RS} and whose Cs texture measure is smaller than threshold T_{CS}
8. For mask M₂ compute affine 6-parameter model using the least squares fitting algorithm such that only the motion vectors indicated by the mask are used in least squares computation process
9. Compute SAD measure for the computed affine model corresponding to M₂ and compare it to the SAD measure of the current model, and set the current model and mask to the one that has the smallest SAD measure.
10. Output the current mask as the selection of motion vectors mask for region R, which will be used for computing of that region's motion model.

Adaptive Region-Based Sub-Pel Filter Selection

In order to maximize gains of the region-based motion modeling, an optimal sub-pixel filtering for motion compensation may be adaptively selected for each region. Here, one of the four different sub-pixel filtering methods is selected for a region. Table 3 lists the 4 filters used in one such implementation.

TABLE 3
Sub-pixel filters used in region-based motion compensation

| | # of | | Typically Suited |
|---|---|---|---|
| Filter | Taps | Accuracy | For |
| Bilinear filter for all 1/16 pel positions | 2 | 1/16 pel | Blurry texture |
| Bicubic filter for all 1/16 pel positions | 16 | 1/16 pel | Blurry and |
| | | | normal texture |
| AVC-based filter | | | |
| [1 −5 20 20 −5 1] for ½ pel and ¼ | 6 | ⅛ pel | Normal and |
| pel positions | | | sharp texture |
| Bilinear for ⅛ pel positions | 2 | | |
| HEVC-based filter | | ⅛ pel | Sharp texture |
| [−1 4 −11 40 40 −11 4 −1] for 1/2 pel | 8 | | |
| [−1 4 −10 58 17 −5 1 0] and | 8 | | |
| [0 1 −5 17 58 −10 4 −1] for ¼ pel | 8 | | |
| positions | | | |
| [0 −1 9 9 −1 0] for ⅛ pel positions | 6 | | |

The optimal filter for the given region may be content dependent. Typically, sharper luma content may be better filtered via HEVC-based filters and AVC-based filters. For example, HEVC-based filter usually may work better on content with very sharp texture. On the other hand, more blurry textured luma regions may be better filtered with Bicubic and Bilinear filters, where Bicubic filters likely work better in interpolating medium textured areas. Clearly, the best-suited region filters yield the smallest SAD of the reconstructed frame in comparison to the current frame. In order to select the most optimal filter for the given region, in the interest of speed, a simplified, sub-sampled SAD (S SAD) measure may be computed. The method for automatically selecting an optimal filter for a region is described next.

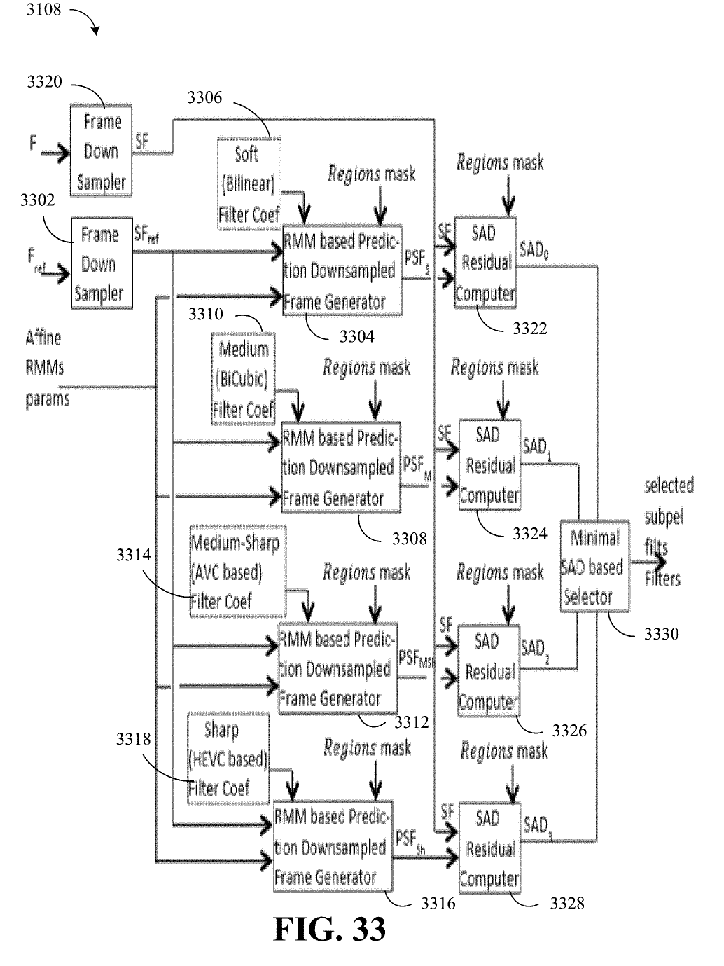

FIG. 33 is an illustrative block diagram of an example adaptive sub-pel interpolation filter selector 3108, arranged in accordance with at least some implementations of the present disclosure. In various implementations, adaptive sub-pel interpolation filter selector 3108 may include a frame downsampler 3302, a RMM based prediction downsampled frame generator 3304, a soft (Bilinear) filter coefficient 3306, a RMM based prediction downsampled frame generator 3308, a medium (BiCubic) filter coefficient 3310, a RMM based prediction downsampled frame generator 3312, a medium (AVC based) filter coefficient 3314, a RMM based prediction downsampled frame generator 3316, a sharp (HEVC based) filter coefficient 3318, a frame downsampler 3320, an SAD residual computer 3322, an SAD residual computer 3324, an SAD residual computer 3326, an SAD residual computer 3328, and a minimal SAD based selector 3330.

The illustrated example shows a detailed view of the second block of FIG. 31, adaptive sub-pel interpolation filter selector 3108. In FIG. 33, adaptive sub-pel interpolation filter selector 3108 serves to adaptively select the adequate sub-pixel filter according to the video content for each region. In the example adaptive sub-pel interpolation filter selector 3108 illustrated in FIG. 33, there are 4 predefined filters (although a different number could be used): (1) 1/16^{th}-pel smooth texture filter (bilinear), (2) 1/16^{th}-pel medium texture filter (bicubic), (3) ⅛^{th}-pel medium sharp texture filter (modified AVC filter), and (4) ⅛^{th}-pel sharp texture filter (modified HEVC filter). The initial affine global motion model computed previously is used to move all pixels in the reference frame according to the model and all four filter candidates.

The reference frame F_{ref} may be subsampled to generate a subsampled reference frame SF_{ref} via frame downsampler 3302. Similarly, the current frame F may be subsampled to generate a subsampled current frame SF_{S} via frame downsampler 3320.

For each pixel in the subsampled reference frame SF_{ref} the resulting motion vectors are rounded to either 1/16^{th}-pel or ⅛^{th}-pel accuracy (depending on the filter candidate) via RMM based prediction downsampled frame generators 3304, 3308, 3312, and 3316. This results in four prediction frames denoted by PSF_{S} (which is computed by using the smooth sub-pel filter candidate via soft (Bilinear) filter coefficient 3306), PSF_{M} (result of using the medium sub-pel filter candidate via medium (BiCubic) filter coefficient 3310), PSF_{MSh} (result of using the medium sharp sub-pel filter candidate via medium (AVC based) filter coefficient 3314) and PSF_{Sh} (result of using the sharp sub-pel filter candidate sharp (HEVC based) filter coefficient 3318). Next, subsampled SAD error is computed for all 4 candidates for each region via SAD residual computers 3322, 3324, 3326, and 3328 and the minimal SAD criterion may be used to select the final regions' sub-pel filters filts via minimal SAD based selector 3130.

An example algorithm for automatically selecting optimal sub-pixel filtering for a region R may include the following steps:
1. Set SSADᵢ=0, i=0, . . . , 3.
2. For each filter fltᵢ, i=0, . . . , 3, do the following:
   a. For each N×N block in the reference frame that is part of region R:
      i. Take the pixel in the center of the frame, compute motion vector according to the affine global motion model for R that was computed in the previous part (e.g., the model for R computed in selection of motion vectors mask step).
      ii. Round the computed vector either to ⅛^{th} or 1/16^{th} pixel accuracy depending on the filter fltᵢ (corresponding filter accuracy shown in Table 3).
      iii. Compute interpolated sub-pixel value corresponding to the computed motion vector using fltᵢ filter.
      iv. Compute absolute difference between the current block's center pixel in the current frame and the computed interpolated sub-pixel value and increase SSADᵢ by that amount.
3. Select filter fltᵢ for which SSADᵢ is the smallest.

Adaptive Region-Based Motion Model Computation and Selection

Depending on the mode of operation, in this step the algorithm may select optimal complexity region-based motion models. There are may be several modes of operation (e.g., 2 modes, although the number could vary) defined in some implementations described herein. In one such example, the modes may include:
1. Mode 0 (default mode)—is a mode that may be designed for sequences with normal motion complexity. Mode 0 may adaptively switch on a frame basis between translational 4-parameter, affine 6-parameter, and pseudo-perspective 8-parameter region-based motion models, for example.
2. Mode 1—is a mode that may be designed for sequences with complex motion (such as sequences with high perspective depth, fast motion etc.). Mode 1 may adaptively switch on a frame basis between affine 6-parameter, pseudo-perspective 8-parameter, and bi-quadratic 12-parameter region-based motion models, for example.

For typical applications, the adaptive translational 4-parameter, affine 6-parameter, and pseudo-perspective 8-parameter mode (e.g., Mode 0) may be used. Therefore, it Mode 0 may be set as a default mode of operation in some implementations described herein.

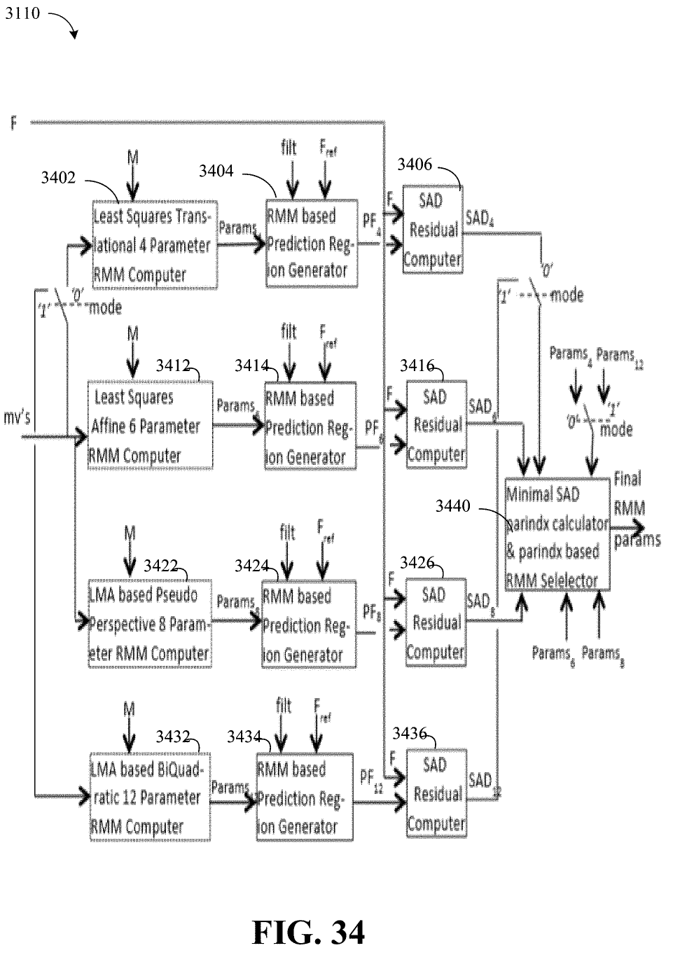

FIG. 34 is an illustrative block diagram of an example adaptive RMM computer and selector 3110, arranged in accordance with at least some implementations of the present disclosure. In various implementations, adaptive RMM computer and selector 3110 may include a least squares translational 4 parameter RMM computer 3402, a RMM based prediction frame generator 3404, an SAD residual computer 3406, a least squares affine 6 parameter RMM computer 3412, a RMM based prediction frame generator 3414, an SAD residual computer 3416, an LMA (Levenberg-Marquardt algorithm) based pseudo perspective 8 parameter RMM computer 3422, a RMM based prediction frame generator 3424, an SAD residual computer 3426, an LMA (Levenberg-Marquardt algorithm) based BiQuadratic 12 parameter RMM computer 3432, a RMM based prediction frame generator 3434, an SAD residual computer 3436, and a minimal SAD parameter index (parindx) calculator and parameter index (parindx) based RMM selector.

In the illustrated example, FIG. 34 shows a detailed view of the third block of FIG. 31, adaptive RMM computer and selector 3110. In FIG. 34, the final global motion model is generated via adaptive RMM computer and selector 3110. A control signal mode may be used to select between standard and high-complexity models. While the illustrated example shows 4 total models with 3 models being used in a first mode and 3 models being used in a second mode, it will be appreciated that a different number of modes may be use, a different number of total models may be used, an/or a different number of models per mode may be used.

In the illustrated example, the control signal mode may be used to select between standard and high-complexity models as follows: if mode=0, adaptive RMM computer and selector 3110 may adaptively selects one of the following models: (1) translational 4-parameter model, (2) affine 6-parameter model, and (3) pseudo-perspective 8-parameter model. Otherwise, if mode=1 adaptive RMM computer and selector 3110 may select between: (1) affine 6-parameter model, (2) pseudo-perspective 8-parameter model, and (3) bi-quadratic 12-parameter model.

In either case, 3 of the 4 models may be computed using the motion vector selection mask M and the corresponding model computation method (e.g., least squares fitting for 4-parameter models and 6-parameter models, and Levenberg-Marquardt algorithm (LMA) for 8-parameter models and 12-parameter models). For example, 3 of the 4 models may be computed using the motion vector selection mask M and the corresponding model computation method via corresponding least squares translational 4 parameter RMM computer 3402, least squares affine 6 parameter RMM computer 3412, LMA (Levenberg-Marquardt algorithm) based pseudo perspective 8 parameter RMM computer 3422, and LMA (Levenberg-Marquardt algorithm) based BiQuadratic 12 parameter RMM computer 3432.

For the 3 computed models, using the previously selected sub-pixel filtering method filt and the reference frame F_{ref} the corresponding prediction frames may be generated via corresponding RMM based prediction frame generators 3404, 3414, 3424, and/or 3434.

Furthermore, the frame-based SAD error may be computed for the 3 prediction frames in respect to the current frame F via SAD residual computers 3406, 3416, 3426, and/or 3436.

Finally, SAD errors are weighted and compared so that the smallest weighted SAD is used to select the corresponding model via minimal SAD parameter index (parindx) calculator and parameter index (parindx) based RMM selector.

In Mode 0, the affine 6-parameter model may be set to the affine global motion model computed in the selection of motion vectors mask step. The transitional 4-parameter motion model may be computed using direct least squares fitting approach described above. It is important to note that the selected motion vectors mask computed in the refinement step may be used to filter only motion vectors pertinent to region-based motion. The least squares fitting may be done on motion vectors from the motion vector field whose corresponding value in the selected motion vectors mask is 1. Next, the pseudo-perspective 8-parameter model may be computed using Levenberg-Marquardt (LMA) algorithm for non-linear least squares fitting. Likewise, the new parameter set (8-parameter model) may be computed using only motion vectors from the motion vector field whose corresponding value in the global/local binary mask from the previous step is 1. Once the parameters for all models are available, SAD measure for 4-, 6-, and 8-parameter models may be computed, denoted by SAD₄ₚ, SAD₆ₚ and SAD₈ₚ, respectively, for each region. The SAD measure may be the sum of absolute differences between the current luma frame, and reconstructed luma frame. The reconstructed frame may be obtained by applying region-based motion model equations on all pixels in the reference frame on a region-by-region basis. In this process, either a ⅛^{th} or a 1/16^{th} pixel precision may be used, depending on the sub-pel filter chosen.

The quality control parameter in Mode 0, denoted by δ₀, may be computed as follows:

δ₀=0.01×min(SAD₄ₚ,SAD₆ₚ,SAD₈ₚ)

The selection of final parameter model may be done as follows:

If SAD₆ₚ<SAD₈ₚ+δ₀ and SAD₄ₚ<SAD₆ₚ+δ₀ then select translational 4-parameter model to model global motion in the current region;

If SAD₆ₚ<SAD₈ₚ+δ₀ and SAD₄ₚ>SAD₆ₚ+δ₀ then select affine 6-parameter model to model global motion in the current region;

If SAD₆ₚ≥SAD₈ₚ+δ₀ and SAD₄ₚ<SAD₆ₚ+δ₀ then select translational 4-parameter model to model global motion in the current region; and

If SAD₆ₚ≥SAD₈ₚ+δ₀ and SAD₄ₚ≥SAD₆ₚ+δ₀ then select pseudo-perspective 8-parameter model to model global motion in the current region.

In Mode 1, the affine 6-parameter model may also be set to the affine motion model computed previously. The pseudo-perspective 8-parameter model and bi-quadratic 12-parameter model may be computed using Levenberg-Marquardt (LMA) algorithm for non-linear least squares fitting. These parameter sets may be computed using only motion vectors from the motion vector field whose corresponding value in the motion vectors selection binary mask. Once the parameters for all models are available, SAD measure for 6-, 8-, and 12-parameter models may be computed, denoted by SAD₆ₚ, SAD₈ and SAD₁₂ₚ, respectively. The SAD measure may be the sum of absolute differences between the current luma frame, and reconstructed luma frame. The reconstructed frame may be obtained by applying region-based motion equations on all pixels in the reference frame. In this process, either a ⅛^{th} or a 1/16^{th} pixel precision is used, depending on the sub-pel filter chosen.

The quality control parameter in Mode 1, denoted by δ₁, may be computed as follows:

δ₁=0.01×min(SAD₆ₚ,SAD₈ₚ,SAD₁₂ₚ)

The selection of final parameter model may be done as follows:

If SAD₈<SAD₁₂ₚ+δ₁ and SAD₆ₚ<SAD₈ₚ+δ₁ then select translational 4-parameter model to model global motion in the current region;

If SAD₈ₚ<SAD₁₂ₚ+δ₁ and SAD₆ₚ≥SAD₈ₚ+δ₁ then select affine 6-parameter model to model global motion in the current region;

If SAD₈ₚ≥SAD₁₂ₚ+δ₁ and SAD₆ₚ<SAD₈ₚ+δ₁ then select translational 4-parameter model to model global motion in the current region; and

If SAD₈ₚ≥SAD₁₂ₚ+δ₁ and SAD₆ₚ≥SAD₈ₚ+δ₁ then select pseudo-perspective 8-parameter model to model global motion in the current region.

Region-Based Motion Model Based Accurate Motion Compensation

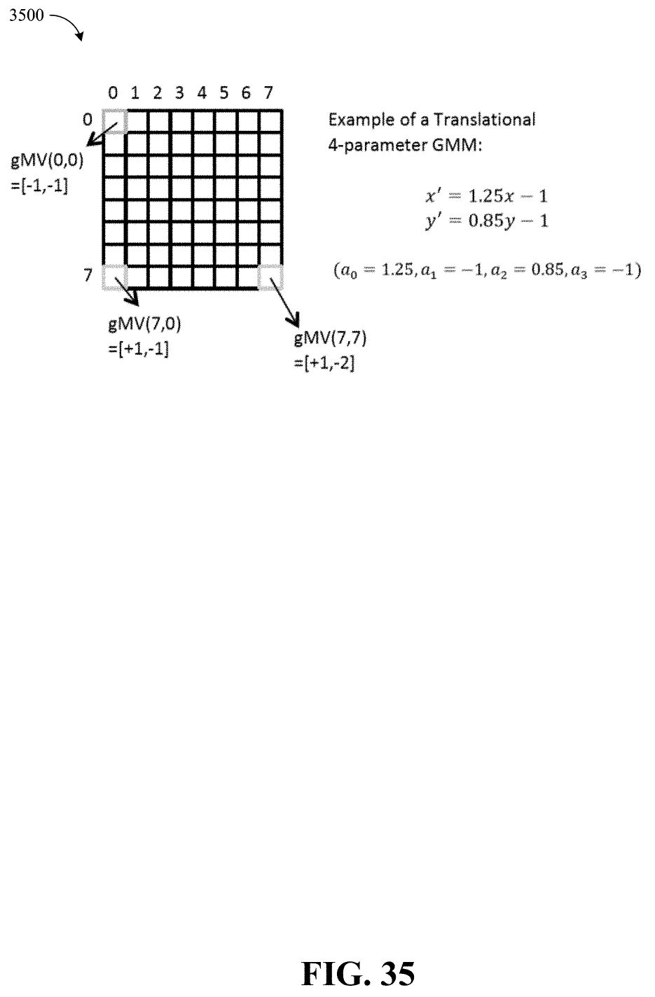

At the beginning of the region-based motion compensation phase, a model was selected (e.g., depending on the mode of operation, either with 4, 6, 8, or 12 parameters), as well as a sub-pixel filtering method. Although the region-based motion compensation processes blocks of a region at a time, RMM may be applied on a pixel level within the given block. In other words, for each pixel within a block, a region-based motion vector may be computed and the pixel may be moved at a sub-pel position according to the previously determined sub-pel filtering method. Thus, a pixel on one side of the block may have different motion vector than a pixel on the other side of the same block, as illustrated by an example in FIG. 35 below.

FIG. 35 is an illustrative chart of an example of translational 4-parameter global motion model 3500, arranged in accordance with at least some implementations of the present disclosure. In various implementations, an example of a translational 4-parameter model 3500 may be applied on different pixel positions within an 8×8 block. Note that different global motion vectors could appear within a block.

In the illustrated example, the chosen block size depends on the resolution. In one example, for standard and high definition, the block size may be set to 8; while, for low definition sequences the block size may be set to 16. If a frame width is smaller than 600, frame height is smaller than 300, and the product of frame width and height is smaller than 180,000, then sequence may classified as a low definition sequence, although different numbers may be used.

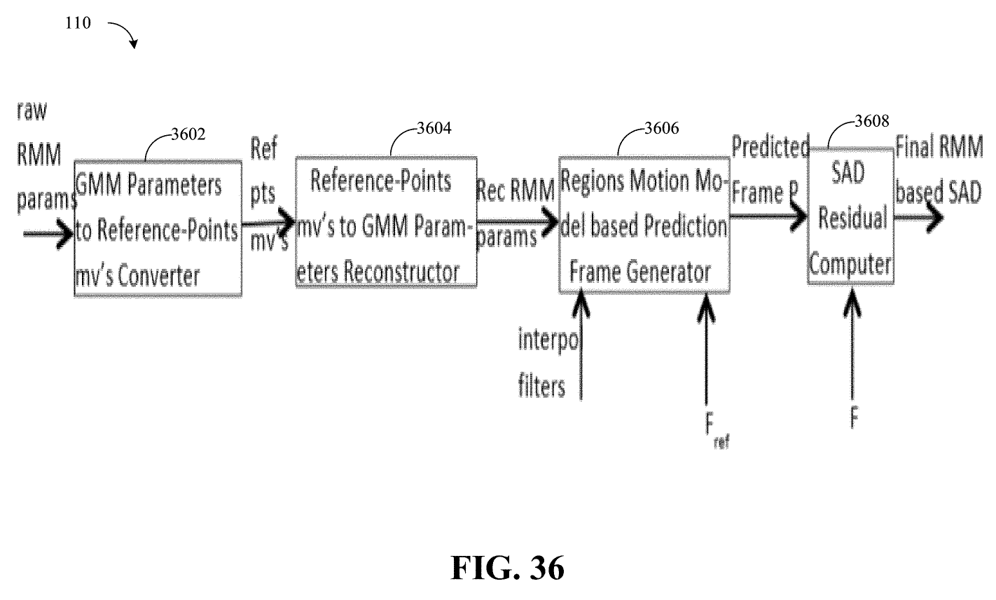

FIG. 36 is an illustrative block diagram of an example adaptive global motion compensator 110, arranged in accordance with at least some implementations of the present disclosure. In various implementations, adaptive global motion compensator 110 may include a GMM parameters to reference points MVs converter 3602, a reference points MVs to GMM parameters reconstructor 3604, a global motion model based prediction frame generator 3606, and an SAD residual computer 3608.

In the illustrated example, FIG. 36 shows the details of adaptive global motion compensator 110 (originally discussed in FIG. 1) that may produce the final RMM-based SAD. The input into the first block of this method may be the final region-based motion models' parameters, which are applied to the frame-based reference points via GMM parameters to reference points MVs converter 3602. As previously described in detail, the number of reference points depends on the model. An n-parameter model uses n/2 reference points. Therefore, an n/2 motion vectors corresponding to the motion at the reference points may be computed in the first step. The computed motion vectors may be quantized to a ¼-pel accuracy.

Next, from the reference points, the reconstructed parameters may be generated via reference points MVs to GMM parameters reconstructor 3604. The reconstructed parameters may be obtained by solving the system of equations for the motion vectors at the reference points for each region separately. Also, the reconstructed parameters may be represented as a quotient where the denominator is scaled to a power of 2. This means that the parameters can be applied with just multiplication and binary shifting operations in the interest of speed.

After that, the prediction frame P may generated by applying the reconstructed motion model parameters to the pixels of the reference frame F_{ref} where sub-pixel positions are interpolated via global motion model based prediction frame generator 3606 with the previously chosen region-based filters filts, separately for each region. Finally, the corresponding frame-based SAD may be computed from the predicted frame P and the current frame F via SAD residual computer 3608.

Since it is not feasible to encode the actual floating point representation of the global motion model parameters, an approximation of the parameters is performed. The method of representing the RMM parameters is based on the concept of reference points (also referred to as control grid points), which were described above. According to that representation, an n-parameter RMM model requires n/2 reference points. At each reference point a motion vector may need to be sent in order to reconstruct the parameters at the decoder side. The accuracy of the encoded motion vectors at reference points determines the RMM parameter approximation accuracy. In some implementations herein, the accuracy may be set to a ¼-pel precision.

The locations of the reference points are defined as follows:

z₀=(x₀,y₀)

z₁=(x₁,y₁)(x₀+y₀)

z₂=(x₂,y₂)(x₀,y₀+H)

z₃=(x₃,y₃)=(x₀+W,y₀+H)

z₄=(x₄,y₄)=(x₀−y₀)

z₅=(x₅,y₅)=(x₀,y₀−H)

For 4-parameter model, points z₀ and z₃ are used. Applying translational global motion model g₄ on z₀ and z₃ yields globally moved points g₄(z₀)=(g₄(x₀), g₄(y₀))=(a₀x₀+a₁, a₂y₀+a₃), and g₄(z₃)=(a₀x₃+a₁, a₂y₃+a₃). On the other hand, for 6-parameter model points z₀, z₁, and z₂ are used. Applying affine global motion model g₆ on z₀, z₁, and z₂ yields globally moved points g₆(zᵢ)=(g₆(xᵢ), g₆(yᵢ))=(a₀xᵢ+a₁yᵢ+a₂, a₃xᵢ+a₄yᵢ+a₅), i=0, 1, 2. For 8-parameter model points z₀, z₁, z₂, and z₃ are used. Applying pseudo-perspective global motion model g₈ on z₀, z₁, z₂ and z₃ yields globally moved points g₈(zᵢ)=(g₈(xᵢ), g₈(yᵢ))=(a₀xᵢ²+a₁xᵢyᵢ+a₂xᵢ+a₃yᵢ+a₄, a₁yᵢ²+a₀xᵢyᵢ+a₅xᵢ+a₆yᵢ+a₇), i=0, 1, 2, 3. Finally, for a 12-parameter model all 6 points are used (z₀, z₁, z₂, z₃, z₄ and z₅). Applying 12-parameter bi-quadratic global motion model g₁₂ on z₀, z₁, z₂, z₃, z₄ and z₅ yields globally moved points g₁₂ (zᵢ)=(g₁₂(xᵢ), g₁₂(yᵢ)=(a₀xᵢ²+a₁yᵢ²+a₂xᵢyᵢ+a₃xᵢ+a₄yᵢ+a₅, a₆xᵢ²+a₇yᵢ²+a₈xᵢyᵢ+a₀xᵢ+a₁₀yᵢ+a₁₁), i=0, 1, 2, 3, 4, 5.

As discussed earlier, the motion vectors at reference points define a system of equations whose solution determines the reconstructed global motion model parameters. In order to allow for fast processing, the reconstructed parameters may be approximated with a ratio of two integers, with denominator being a power of 2. This way, applying RMM on any pixel location in the frame can be achieved with a multiplication and binary shifting operations.

For example, to obtain the reconstructed 4-parameter model {ā₀, ā₁, ā₂, ā₃} from the given model g₄ (applied at 1/s-th pixel precision) the following equation may be used:

$${\overline{a}}_{0} = \frac{{g}_{4} ( {x}_{3} ) - {g}_{4} ( {x}_{0} )}{sW} , {\overline{a}}_{1} = \frac{{g}_{4} ( {x}_{0} )}{s} , \\ {\overline{a}}_{2} = \frac{{g}_{4} ( {y}_{3} ) - {g}_{4} ( {y}_{0} )}{sH} , {\overline{a}}_{3} = \frac{{g}_{4} ( {y}_{0} )}{s}$$

This equation may be modified to allow for fast global motion modeling as follows:

$${\overline{a}}_{0} = \frac{{d}_{0}}{{2}^{k}} , {\overline{a}}_{1} = \frac{{d}_{1}}{{2}^{k}} , {\overline{a}}_{2} = \frac{{d}_{2}}{{2}^{l}} , {\overline{a}}_{3} = \frac{{d}_{3}}{{2}^{l}}$$

Where d₀=(2^{k}/(sW))×(g₄(x₃)−g₄(x₀)), d₁=(2^{k} s)×g₄(x₀), k=┌log₂ sW┘, d₂=(2^{l}/(sH))×(g₄(y₃)−g₄(y₀)), d₃=(2^{l}/s)×g₄(y₀), 1=┌log₂ sH┘.

Therefore, in order to apply the reconstructed global motion model g̅₄ to a pixel location (x,y), the following equation without division may be used:

$${\overline{g}}_{4} ( x ) = {\overline{a}}_{0} x + {\overline{a}}_{1} = \frac{{d}_{0}}{{2}^{k}} x + \frac{{d}_{1}}{{2}^{k}} = ( {d}_{0} x + {d}_{1} ) ≫ k$$

$$And$$

$${\overline{g}}_{4} ( y ) = {\overline{a}}_{2} y + {\overline{a}}_{3} = \frac{{d}_{2}}{{2}^{l}} y + \frac{{d}_{3}}{{2}^{l}} = ( {d}_{2} x + {d}_{3} ) ≫ l$$

Where >> denotes bitwise shift to the right.

To obtain the reconstructed 6-parameter model {ā₀, . . . , ā₅} from the given model g₆ (applied at 1/s-th pixel precision) the following equation may be used:

$${\overline{a}}_{0} = \frac{{g}_{6} ( {x}_{1} ) - {g}_{6} ( {x}_{0} )}{sW} , {\overline{a}}_{1} = \frac{{g}_{6} ( {x}_{2} ) - {g}_{6} ( {x}_{0} )}{sH} , {\overline{a}}_{2} = \frac{{g}_{6} ( {x}_{0} )}{s} , \\ {\overline{a}}_{3} = \frac{{g}_{6} ( {y}_{1} ) - {g}_{6} ( {y}_{0} )}{sW} , {\overline{a}}_{4} = \frac{{g}_{6} ( {y}_{2} ) - {g}_{6} ( {y}_{0} )}{sH} , {\overline{a}}_{5} = \frac{{g}_{6} ( {y}_{0} )}{s}$$

This equation may be modified to allow for fast global motion modeling as follows:

$${\overline{a}}_{0} = \frac{{d}_{0}}{{2}^{k}} , {\overline{a}}_{1} = \frac{{d}_{1}}{{2}^{k}} , {\overline{a}}_{2} = \frac{{d}_{2}}{{2}^{k}} , {\overline{a}}_{3} = \frac{{d}_{3}}{{2}^{k}} , {\overline{a}}_{4} = \frac{{d}_{4}}{{2}^{k}} , {\overline{a}}_{5} = \frac{{d}_{5}}{{2}^{k}}$$

Where d₀=(2^{k}/(sW))×(g₆(x₁)−g₆(x₀)), d₁=(2^{k}/(sH))×(g₆(x₂)−g₆(x₀)), d₂=(2^{k}/s)×g₆(x₀), d₃=(2^{k}/(sW))×(g₆(y)−g₆(y₀)), d₄=(2^{k}/(sH))×(g₆(y₂)−g₆(y₀)), d₅=(2^{k}/s)×g₆(y₀), k=┌log₂(s²WH)┘.

Therefore, in order to apply the reconstructed global motion model g̅₆ to a pixel location (x,y), the following equation without division may be used:

$${\overline{g}}_{6} ( x ) = {\overline{a}}_{0} x + {\overline{a}}_{1} y + {\overline{a}}_{2} = \frac{{d}_{0}}{{2}^{k}} x + \frac{{d}_{1}}{{2}^{k}} y + \frac{{d}_{2}}{{2}^{k}} = ( {d}_{0} x + {d}_{1} y + {d}_{2} ) ≫ k$$

$$And$$

$${\overline{g}}_{6} ( y ) = {\overline{a}}_{3} x + {\overline{a}}_{4} y + {\overline{a}}_{5} = \frac{{d}_{3}}{{2}^{k}} x + \frac{{d}_{4}}{{2}^{k}} y + \frac{{d}_{5}}{{2}^{k}} = ( {d}_{3} x + {d}_{4} y + {d}_{5} ) ≫ k$$

In case of pseudo-perspective model, in order to obtain the reconstructed 8-parameter model {ā₀, . . . , ā₇} from the given model g₈ (applied at 1/s-th pixel precision) the following equation may be used:

$${\overline{a}}_{0} = \frac{{g}_{8} ( {y}_{0} ) - {g}_{8} ( {y}_{1} ) - {g}_{8} ( {y}_{2} ) + {g}_{8} ( {y}_{3} )}{{s}^{2} WH} , \\ {\overline{a}}_{1} = \frac{{g}_{8} ( {x}_{0} ) - {g}_{8} ( {x}_{1} ) - {g}_{8} ( {x}_{2} ) + {g}_{8} ( {x}_{3} )}{{s}^{2} WH} , \\ {\overline{a}}_{2} = \frac{\begin{matrix}- {sHg}_{8} ( {x}_{0} ) - {sWg}_{8} ( {y}_{0} ) + {sHg}_{8} ( {x}_{1} ) + \\ {sWg}_{8} ( {y}_{1} ) + {sWg}_{8} ( {y}_{2} ) - {sWg}_{8} ( {y}_{3} )\end{matrix}}{{s}^{2} WH} , \\ {\overline{a}}_{3} = \frac{{g}_{8} ( {x}_{2} ) - {g}_{8} ( {x}_{0} )}{sH} , {\overline{a}}_{4} = \frac{{g}_{8} ( {x}_{0} )}{s} , \\ {\overline{a}}_{5} = \frac{{g}_{8} ( {y}_{1} ) - {g}_{8} ( {y}_{0} )}{sW} , {\overline{a}}_{7} = \frac{{g}_{8} ( {y}_{0} )}{s}$$

$${\overline{a}}_{6} = \frac{\begin{matrix}- {sHg}_{8} ( {x}_{0} ) - {sWg}_{8} ( {y}_{0} ) + {sHg}_{8} ( {x}_{1} ) + \\ {sHg}_{8} ( {x}_{2} ) + {sWg}_{8} ( {y}_{2} ) - {sHg}_{8} ( {y}_{3} )\end{matrix}}{{s}^{2} WH}$$

Like in the previous cases of simpler models, this equation may be expressed as follows:

$${\overline{a}}_{i} = \frac{{d}_{i}}{{2}^{k}} , i = 0 , … , 7$$

To apply the reconstructed global motion model g̅₈ to a pixel location (x,y), the following equation without division may be used:

g̅₈(x)=(d₀x²+d₁xy+d₂x+d₃y+d₄)>>k

And

g̅₈(y)=(d₁y²+d₀xy+d₅x+d₆y+d₇)>>k

Where k=┌log₂(s²WH)┘.

Finally, in the case of bi-quadratic model, in order to obtain the reconstructed 12-parameter model {ā₀, . . . , ā₁₁} from the given model g₁₂ (applied at 1/s-th pixel precision) the following equation may be used:

$${\overline{a}}_{0} = \frac{- 2 {g}_{12} ( {x}_{0} ) + {g}_{12} ( {x}_{1} ) + {g}_{12} ( {x}_{4} )}{2 {s}^{2} {W}^{2}} , \\ {\overline{a}}_{1} = \frac{- 2 {g}_{12} ( {x}_{0} ) + {g}_{12} ( {x}_{2} ) + {g}_{12} ( {x}_{5} )}{2 {s}^{2} {H}^{2}} , \\ {\overline{a}}_{2} = \frac{{g}_{12} ( {x}_{0} ) - {g}_{12} ( {x}_{1} ) - {g}_{12} ( {x}_{2} ) + {g}_{12} ( {x}_{3} )}{{s}^{2} WH} , \\ {\overline{a}}_{3} = \frac{{g}_{12} ( {x}_{1} ) - {g}_{12} ( {x}_{4} )}{sW}$$

$${\overline{a}}_{3} = \frac{{g}_{12} ( {x}_{2} ) - {g}_{12} ( {x}_{5} )}{sH} , {\overline{a}}_{5} = \frac{{g}_{12} ( {x}_{0} )}{s}$$

$${\overline{a}}_{6} = \frac{- 2 {g}_{12} ( {y}_{0} ) + {g}_{12} ( {y}_{1} ) + {g}_{12} ( {y}_{4} )}{2 {s}^{2} {W}^{2}} , \\ {\overline{a}}_{7} = \frac{- 2 {g}_{12} ( {y}_{0} ) + {g}_{12} ( {y}_{2} ) + {g}_{12} ( {y}_{5} )}{2 {s}^{2} {H}^{2}} , \\ {\overline{a}}_{8} = \frac{{g}_{12} ( {y}_{0} ) - {g}_{12} ( {y}_{1} ) - {g}_{12} ( {y}_{2} ) + {g}_{12} ( {y}_{3} )}{{s}^{2} WH} , \\ {\overline{a}}_{9} = \frac{{g}_{12} ( {y}_{1} ) - {g}_{12} ( {y}_{4} )}{sW}$$

$${\overline{a}}_{10} = \frac{{g}_{12} ( {y}_{2} ) - {g}_{12} ( {y}_{5} )}{sH} , {\overline{a}}_{11} = \frac{{g}_{12} ( {y}_{0} )}{s}$$

Like in the previous cases of simpler models, this equation can be expressed as follows:

$${\overline{a}}_{i} = \frac{{d}_{i}}{{2}^{k}} , i = 0 , … , 11$$

Where k=┌log₂(s²W²H²)┘.

To apply the reconstructed global motion model g̅₁₂ to a pixel location (x,y), the following equation without division may be used:

g̅₁₂(x)=(d₀x²+d₁y²+d₂xy+d₃x+d₄y+d₅)>>k

And

g̅₁₂(y)=(d₆x²+d₇y²+d₈xy+d₉x+d₁₀y+d₁₁)>>k

Based on the computed SAD, either the computed global motion model parameters are encoded, or the model is approximated from a set of previous models. Typically, the approximated model produces larger SAD than the computed one, but it is usually encoded using significantly smaller number of bits. The details of the coding process are described next.

Efficient Coding of Region-Based Motion Model's Parameters

In a typical video content, consecutive frames within the same scene, and even the frames that are at a few frames distance from each other (but still within the same scene), maintain the same or very similar motion properties. In other words, abrupt changes in global motion, such as direction or magnitude, are a rare occurrence within a video scene. Therefore, global motion models for consecutive or close frames are unlikely to change very much. Also, models from recent past frames typically work very well as global motion models for the current frame. In that sense, the method of coding the global motion parameters in MPEG-4 standard is suboptimal, as it does not fully utilize previous models from the recent past. Accordingly, some implementations herein may us a coding algorithm that fully exploits the redundancy of past global motion models to represent and code RMM parameters.

The proposed method for RMM parameters coding, like the global motion coding method of MPEG-4 standard, may rely on reference points for representing a model. The global motion coding method of MPEG-4 was described above.

A codebook is a collection of past parameters represented as global motion based motion vectors of reference points. At the beginning the codebook is empty, as no past models are known. As the frames are processed, the codebook is updated to include newly coded models. Only unique models may be added. When the codebook becomes full, e.g., when the number of models in the codebook is the same as the maximum capacity of the codebook, the oldest model is replaced with the newest one. The codebook is therefore content adaptive as it changes during encoding/decoding process. In experiments based on implementations described herein, the best performance/complexity tradeoff was achieved with a codebook of size 8. Thus, in some implementation, the size of the codebook is set to 8, although a different size could be used. Each region is assigned a separate codebook.

As already discussed, the number of motion vectors needed to represent a model depends on the number of parameters in the model itself. Suppose each frame uses an affine 6-parameter model (e.g., Mode 0). Then each model's parameters may be represented with 3 motion vectors associated with 3 reference points. A full codebook would therefore contain a total of 24 motion vectors associated with the reference points of past models, in such an example.

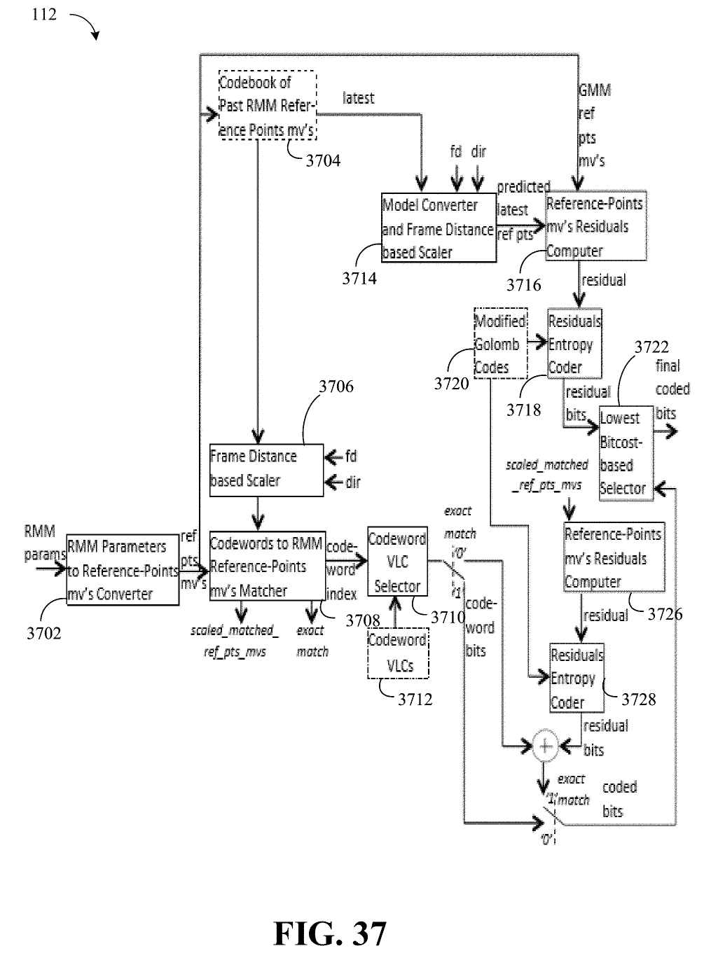

FIG. 37 is an illustrative block diagram of an example region-based motion model parameter and headers entropy coder 112, arranged in accordance with at least some implementations of the present disclosure. In various implementations, region-based motion model parameter and headers entropy coder 112 may include a RMM parameters to Reference-Points mv's converter 3702, a Codebook of Past RMM Reference Points mv's 3704, a frame distance based scaler 3706, a Codewords to RMM Reference-Points mv's Matcher 3708, a Codeword VLC (variable length code) Selector 3710, a Codeword VLCs 3712, a Model Converter and Frame Distance based Scaler 3714, a Reference Points mv's Residuals Computer 3716, a Residuals Entropy Coder 3718, a Modified Golomb Codes 3720, a lowest bitcost based Selector 3722, a Reference Points mv's Residuals Computer 3726, and a Residuals Entropy Coder 3728.

FIG. 37 shows an example region-based motion model parameter and headers entropy coder 112 that may be used to encode global motion model parameters. In this example, region-based motion model parameter and headers entropy coder 112 performs the illustrated operations for each region's RMM parameter set separately (e.g., on a region-by-region basis). In this example, the coding of RMM parameters is based on the codebook principle. The codebook of up to 8 last encountered parameters is kept and updated with every new frame via Codebook of Past RMM Reference Points mv's 3704. There is one codebook kept for each model separately, therefore resulting in a total of 3 codebooks in the system per region. The entries in the codebook (e.g., the codewords) are used as predictors for the current parameters. Each codeword includes the reference points' motion vectors (corresponding to previous RMM parameters) along with the number of parameters information, as well as the frame distance fd (distance between the current and reference frames) and the direction dir that was used in estimating the model.

The final computed RMM parameters are first converted to the frame-level reference points via RMM parameters to Reference-Points mv's converter 3702. As previously described in detail, the number of reference points depends on the model. An n-parameter model uses n/2 reference points. Therefore, n/2 motion vectors corresponding to the motion at the reference points are computed in the first step. The computed motion vectors may be quantized to a ¼-pel accuracy.

In the illustrated example, two coded bits may computed in parallel: (1) coded residuals with the latest codeword via Residuals Entropy Coder 3718, and (2) coded residuals with the closest matched codeword via Residuals Entropy Coder 3728 and/or codebook index code via Codeword VLC (variable length code) Selector 3710.

In the first path, the latest model from all 3 codebooks is chosen from Codebook of Past RMM Reference Points mv's 3704, denoted in the diagram by latest, and then scaled according to the f d and dir values so that it matches to ref_pts_mvs's distance and direction via Model Converter and Frame Distance based Scaler 3714. In addition to scaling, the model is converted to match the number of points in the current model. In the case when the current model has more points than the latest model, the model is reconstructed and the missing additional points' MVs are computed and added to the latest model's points' MVs. The resulting predicted points are referred to in the diagram as predicted_latest_ref_pts_mvs.

The resulting predicted points predicted_latest_ref_pts_mvs may be differenced with ref_pts_mvs to produce the residuals via Reference Points mv's Residuals Computer 3716.

Such residuals may then be encoded via Residuals Entropy Coder 3718 with the modified Golomb code from Modified Golomb Codes 3720. The modified Golomb codes may be adaptive and either sharp, medium of flat table is chosen based on previous residual magnitude.

The first coded bits may be redirected to lowest bitcost based Selector 3722, which serves to select the method with smallest bitcost. The lowest bitcost based Selector 3722 also has as an input the 2^{nd} coded bits which are obtained in the second path, as stated earlier.

In the 2^{nd} path, the computed points ref_pts_mvs are compared to the points from to the corresponding codebook using RMM Reference-Points mv's Matcher 3708. Before comparison, the points from Codebook of Past RMM Reference Points mv's 3704 may be scaled according to the fd and dir values via frame distance based scaler 3706. If ref_pts_mvs match to an entry in the codebook, the control signal exact_match is set to 1 via RMM Reference-Points mv's Matcher 3708 and the process outputs the bits for the codebook index as the 2^{nd} set of coded bits.

Otherwise, exact_match is set to 0 via RMM Reference-Points mv's Matcher 3708 and the ref_pts_mvs are coded differentially as follows. The closest model computed by RMM Reference-Points mv's Matcher 3708, and denoted by scaled_matched_ref_pts_mvs in the diagram, is used to compute the residuals via Reference Points mv's Residuals Computer 3726. The residuals are computed and encoded via Residuals Entropy Coder 3728 with modified adaptive Golomb codes from Modified Golomb Codes 3720. The bits for the codebook index and the residual bits are joined into 2^{nd} set of coded bits. The final step is to select the coding method and output the final coded bits to which a one-bit selection bit is prepended. This is repeated for each region and the final output bits consists of individual region's final coded bits all appended to form frame-based final coded bits.

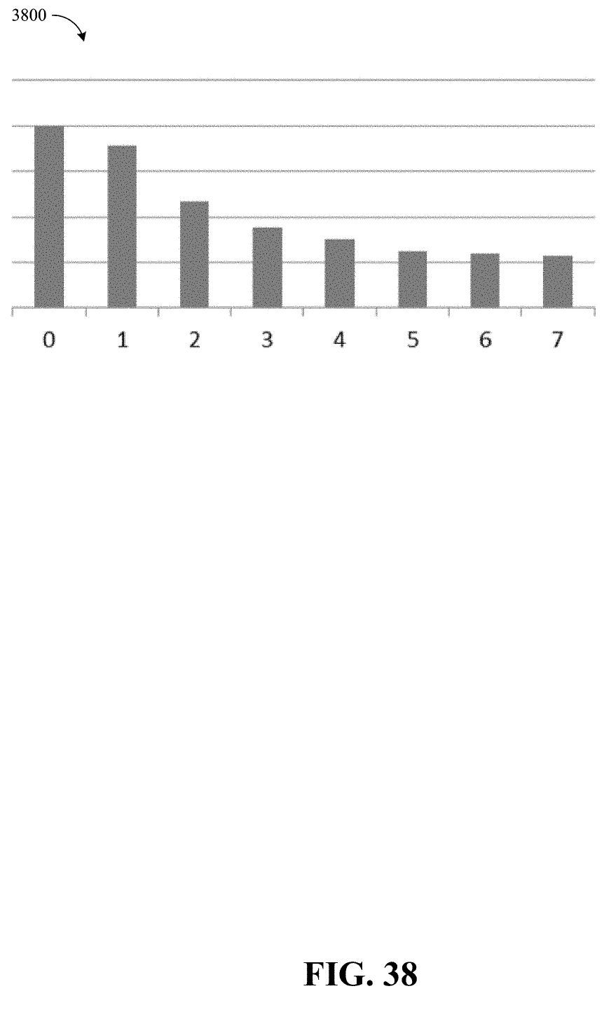

Each entry in the codebook is also associated with a codeword from Codeword VLCs 3712 selected by Codeword VLC (variable length code) Selector 3710, which is used to encode its index. The probability distribution of the most optimal codebook model in respect to the current frame is slightly skewed towards the most recent model, as shown in FIG. 38. Based on these observations, Table 4 defines the variable length code (VLC) tables used for coding the codebook indices.

FIG. 38 is an illustrative chart 3800 of an example probability distribution of the best past codebook models, arranged in accordance with at least some implementations of the present disclosure. In various implementations, chart 3800 illustrates a probability distribution of the best past codebook models (with codebook indices 0-7) for the current frame. It can be observed that the most likely optimal model is the most recent one (index 0) while the least likely is the oldest (index 7). However, the distribution is not too peaky.

Table 4, below, illustrates a Variable length codes used for coding the codeword index in the codebook in RMM:

| | VLCs for a1l codewords in the codebook | | | | | | | |
|---|---|---|---|---|---|---|---|---|
| Code− | depending on the size of the codebook | | | | | | | |
| word | size = | size = | size = | size = | size = | size = | size = | size = |
| Index | 0/1 | 2 | 3 | 4 | 5 | 6 | 7 | 8 |
| 0 | — | 0 | 0 | 00 | 00 | 00 | 00 | 00 |
| 1 | — | 1 | 10 | 01 | 01 | 01 | 01 | 01 |
| 2 | — | — | 11 | 10 | 10 | 100 | 100 | 100 |
| 3 | — | — | — | 11 | 110 | 101 | 101 | 101 |
| 4 | — | — | — | — | 111 | 110 | 110 | 1100 |
| 5 | — | — | — | — | — | 111 | 1110 | 1101 |
| 6 | — | — | — | — | — | — | 1111 | 1110 |
| 7 | — | — | — | — | — | — | — | 1111 |

In the proposed approach, each model may have its own codebook. In Mode 0, as well as Mode 1, there may be a plurality (e.g., 3) codebooks being maintained since each of the modes allows for a plurality (e.g., up to 3) models.

Codebook-based methods described herein may switch between coding an exact model with the codebook index and coding the index and the error residuals. In order to determine which coding method is adequate for the given frame, SADs of all past parameters from the corresponding model's codebook may be computed. The parameter set corresponding to the smallest SAD may be chosen and the SAD of the computed model may be compared to it. If the SAD of the chosen codebook model up to a threshold (e.g., 1% larger than the SAD of the computed model), the codebook model may be chosen and encoded according to the Table 4. Otherwise, the computed model may be chosen. Next, a method of coding the computed model with a prediction approach is described.

Coding of the computed global motion model may be done by encoding the residuals of the predicted global motion vectors of the reference points (i.e. control grid points). As discussed earlier, the number of reference points depends on the number of parameter of the model. The prediction of the motion vectors at the reference points may be done with the global motion model from the previous frame, even though the model of the current frame and that of the previous frame could differ. In the case when the models of the current and previous frames are the same or if the current frame model uses less reference points, the motion vectors at grid points may be copied from previous frame. However, if the current frame model is more complex, e.g., it uses more points than the model of the previous frame, then the motion vectors of the reference points of the previous frame are all copied, and additional missing reference points may be computed with the model from the previous frame. Once predicted reference points are obtained, the differential (residual) between them and the motion vectors at reference points corresponding to the current frame's computed global motion model may be obtained and coded with, “modified” generalized Golomb codes.

Instead of relying on exp-Golomb code like in MPEG-4 global motion parameters coding, an adaptive VLC method may be used in some implementations herein, which is able to select one of 3 contexts based on the previously observed differentials/residuals. When a past differential is small (magnitude is <=4), the sharp VLC table may be used. The sharp VLC table may be a modified generalized exp-Golomb code with k=0 where first 15 entries are modified to sizes {1, 3, 3, 4, 4, 6, 6, 7, 7, 7, 7, 7, 7, 8, 8}. An example VLC table is shown in Table 5. In the case when the past differential is of medium magnitude (>4 and <=64) then the medium VLC table may be used. The medium VLC table may be a modified generalized exp-Golomb code with k=2 where first 30 entries are modified to sizes {3, 4, 4, 4, 4, 4, 4, 5, 5, 5, 5, 5, 5, 5, 5, 6, 6, 6, 6, 7, 7, 7, 7, 7, 7, 8, 8, 8, 8, 8}. An example VLC table is shown in Table 6. Finally when the past differentials are large (>64), the flat VLC table may be used. The flat VLC table may be the modified generalized exp-Golomb code with k=5 where the first 40 entries are modified to sizes {5, 6, 6, 6, 6, 6, 6, 6, 6, 6, 6, 6, 6, 6, 6, 6, 6, 6, 6, 6, 6, 6, 6, 6, 6, 6, 6, 6, 6, 7, 7, 7, 7, 7, 7, 8, 8, 8, 8, 8}. An example VLC table is shown in Table 7.

The following tables show details of the “modified” generalized Golomb codes used in RMM. The motion vector differential value m is represented as a non-negative integer vₘ using the following rule:

$${v}_{m} = \{ \begin{matrix}2 m - 1 & when m > 0 , \\ - 2 m & when m \leq 0.\end{matrix}$$

Table 5, below, illustrates the sharp VLC table uses modified generalized exp-Golomb code with k=0 where the first 15 entries are modified to better fit experimentally observed statistics:

| | | Exp-Golomb | Bit |
|---|---|---|---|
| m | vₘ | Code | Length |
| 0 | 0 | 1 | 1 |
| 1 | 1 | 011 | 3 |
| −1 | 2 | 010 | 3 |
| 2 | 3 | 0011 | 4 |
| −2 | 4 | 0010 | 4 |
| 3 | 5 | 000111 | 6 |
| −3 | 6 | 000110 | 6 |
| 4 | 7 | 0001011 | 7 |
| −4 | 8 | 0001010 | 7 |
| 5 | 9 | 0001001 | 7 |
| −5 | 10 | 0001000 | 7 |
| 6 | 11 | 0000111 | 7 |
| −6 | 12 | 0000110 | 7 |
| 7 | 13 | 00001011 | 8 |
| −7 | 14 | 00001010 | 8 |
| . . . | . . . | Exp-Golomb (k = 0) | . . . |

Table 6, below, illustrates a medium VLC table that uses modified generalized exp-Golomb code with k=2 where the first 30 entries are modified to better fit experimentally observed statistics:

| | | VLC | Bit |
|---|---|---|---|
| m | vₘ | Code | Length |
| 0 | 0 | 111 | 3 |
| 1 | 1 | 1101 | 4 |
| −1 | 2 | 1100 | 4 |
| 2 | 3 | 1011 | 4 |
| −2 | 4 | 1010 | 4 |
| 3 | 5 | 1001 | 4 |
| −3 | 6 | 1000 | 4 |
| 4 | 7 | 01111 | 5 |
| −4 | 8 | 01110 | 5 |
| 5 | 9 | 01101 | 5 |
| −5 | 10 | 01100 | 5 |
| 6 | 11 | 01011 | 5 |
| −6 | 12 | 01010 | 5 |
| 7 | 13 | 01001 | 5 |
| −7 | 14 | 01000 | 5 |
| 8 | 15 | 001111 | 6 |
| −8 | 16 | 001110 | 6 |
| 9 | 17 | 001101 | 6 |
| −9 | 18 | 001100 | 6 |
| 10 | 19 | 0001111 | 7 |
| −10 | 20 | 0001110 | 7 |
| 11 | 21 | 0001101 | 7 |
| −11 | 22 | 0001100 | 7 |
| 12 | 23 | 0001011 | 7 |
| −12 | 24 | 0001010 | 7 |
| 13 | 25 | 00010011 | 8 |
| −13 | 26 | 00010010 | 8 |
| 14 | 27 | 00010001 | 8 |
| −14 | 28 | 00010000 | 8 |
| 15 | 29 | 00001111 | 8 |
| . . . | . . . | Exp-Golomb | . . . |
| | | (k = 2) | |

Table 7, below, illustrates, a flat VLC table that uses modified generalized exp-Golomb code with k=5 where the first 40 entries are modified to better fit experimentally observed statistics:

| | | VLC | Bit |
|---|---|---|---|
| m | vₘ | Code | Length |
| 0 | 0 | 11111 | 5 |
| 1 | 1 | 111101 | 6 |
| −1 | 2 | 111100 | 6 |
| 2 | 3 | 111011 | 6 |
| −2 | 4 | 111010 | 6 |
| 3 | 5 | 111001 | 6 |
| −3 | 6 | 111000 | 6 |
| 4 | 7 | 110111 | 6 |
| −4 | 8 | 110110 | 6 |
| 5 | 9 | 110101 | 6 |
| −5 | 10 | 110100 | 6 |
| 6 | 11 | 110011 | 6 |
| −6 | 12 | 110010 | 6 |
| 7 | 13 | 110001 | 6 |
| −7 | 14 | 110000 | 6 |
| 8 | 15 | 101111 | 6 |
| −8 | 16 | 101110 | 6 |
| 9 | 17 | 101101 | 6 |
| −9 | 18 | 101100 | 6 |
| 10 | 19 | 101011 | 6 |
| −10 | 20 | 101010 | 6 |
| 11 | 21 | 101001 | 6 |
| −11 | 22 | 101000 | 6 |
| 12 | 23 | 100111 | 6 |
| −12 | 24 | 100110 | 6 |
| 13 | 25 | 100101 | 6 |
| −13 | 26 | 100100 | 6 |
| 14 | 27 | 100011 | 6 |
| −14 | 28 | 100010 | 6 |
| 15 | 29 | 1000011 | 7 |
| −15 | 30 | 1000010 | 7 |
| 16 | 31 | 1000001 | 7 |
| −16 | 32 | 1000000 | 7 |
| 17 | 33 | 0111111 | 7 |
| −17 | 34 | 0111110 | 7 |
| 18 | 35 | 01111011 | 8 |
| −18 | 36 | 01111010 | 8 |
| 19 | 37 | 01111001 | 8 |
| −19 | 38 | 01111000 | 8 |
| 20 | 39 | 01110111 | 8 |
| . . . | . . . | Exp-Golomb | . . . |
| | | (k = 5) | |

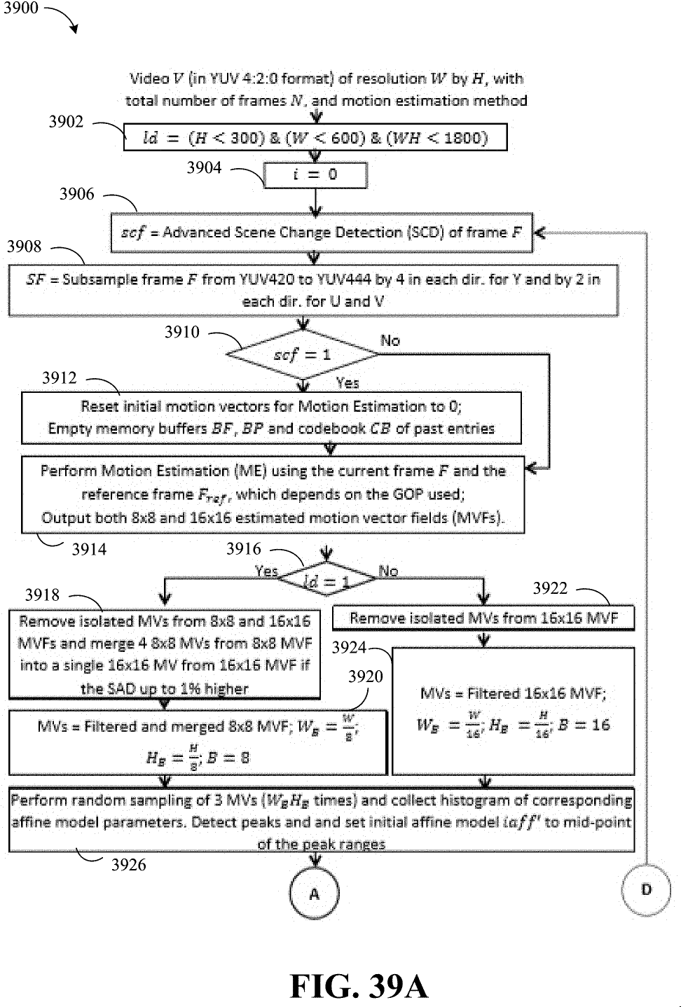

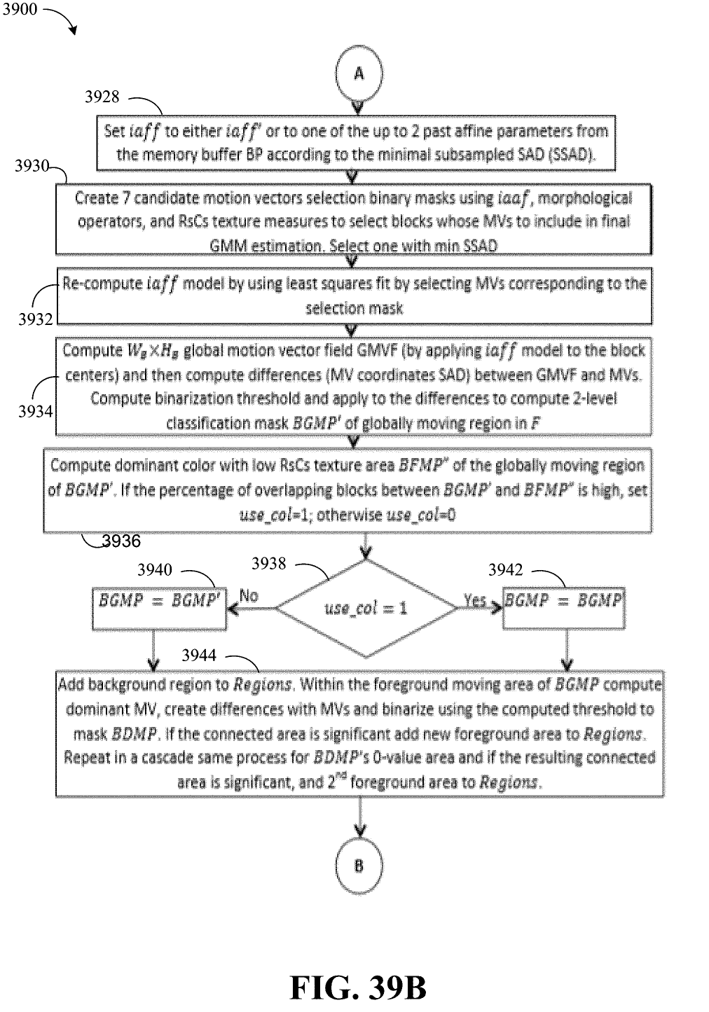

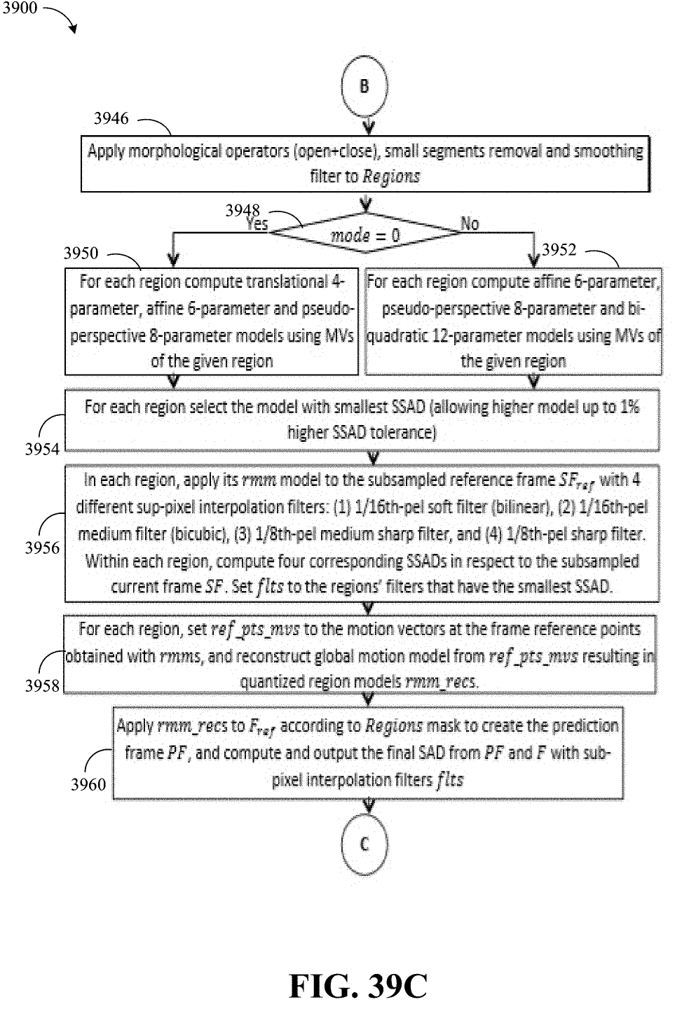

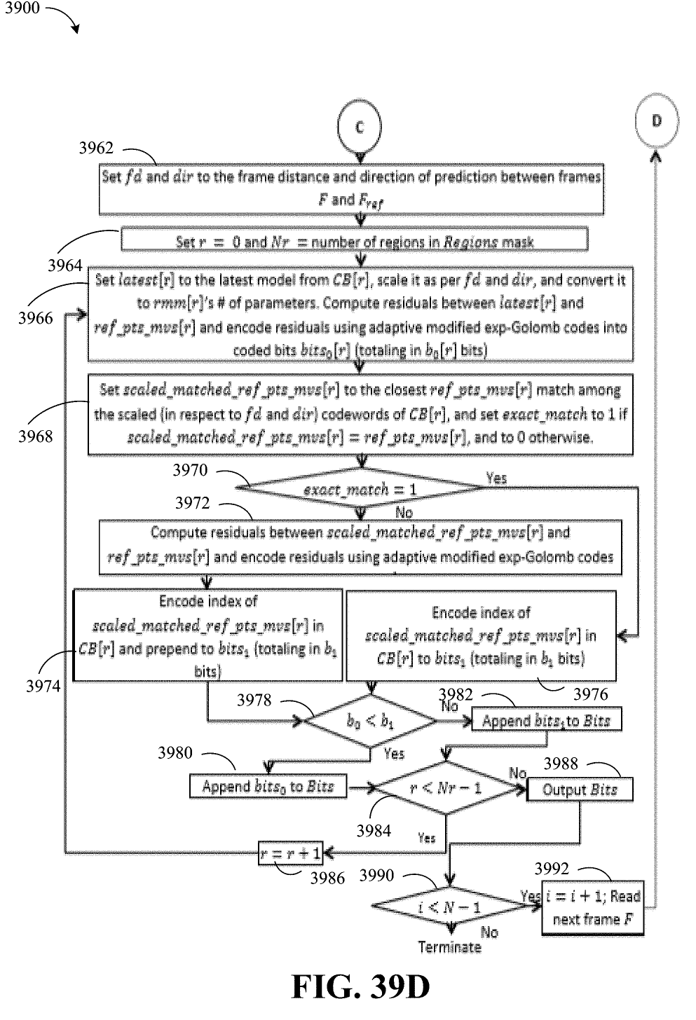

FIGS. 39A-39D shows a process 3900 of region-based motion estimation and compensation, arranged in accordance with at least some implementations of the present disclosure. In various implementations, process 3900 may generally be implemented via one or more of the components of the region-based motion analyzer system 100 (e.g., region-based motion analyzer system 100 of FIG. 1 and/or FIG. 3), already discussed.

At operation 3902 “ld=(H<300) & (W<600) & (WH<1800)” if a frame width is smaller than 600, frame height is smaller than 300, and the product of frame width and height is smaller than 180,000, then sequence is classified as low definition via a low definition flag (ld). If H<300 and W<600 and W×H<180,000 then set ld=1; otherwise set ld=0.

At operation 3904 “i=0”

At operation 3906 “scf=Advanced Scene Change Detection (SCD) of frame f” scene change detection may be performed to set a scene change flag (scf).

At operation 3908 “SF=Subsampled frame F from YUV420 to YUV444 by 4 in each dir. For Y and by 2 in each dir. For U and V” subsampling converts input YUV420 frame to a block accurate YUV444 frame were luminance signal is subsampled by 4 (e.g., 4×4 block accuracy) while chrominance signal is subsampled by 2 (e.g., 2×2 block accuracy).

At operation 3910 “scf=1” scene change flag (scf)=1 indicates that a scene change has been detected, while scene change flag (scf)=0 indicates that no scene change has been detected.

When operation 3910 is met (e.g., a scene change has been detected), at operation 3912 “Reset initial motion vectors for Motion Estimation to 0; Empty memory buffers BF, BP and codebook CB of past entries” initial motion vectors for Motion Estimation may be reset to zero, and memory buffers BF, BP and codebook CB may be emptied of past entries.

When operation 3910 is not met (e.g., a scene change has not been detected), at operation 3914 “Perform Motion Estimation (ME) using the current frame F and the reference frame Fref, which depends on the GOP used; Output both 8×8 and 16×16 estimated motion vector fields (MVFs)” block motion estimation may be performed between current frame F and the reference frame Fref.

At operation 3916 “ld=1” a determination may be made as to whether the current fame is low definition, where low definition flag (ld)=1 indicates low definition.

When operation 3916 is met (e.g., the current frame F is low definition), at operation 3918 “remove isolated MVs from 8×8 and 16×16 MVFs and merge 4 8×8 MVs from 8×8 MVF into a singe 16×16 MV from 16×16 MVF if the SAD up to 1% higher” where primarily isolated MVs from 8×8 may be removed.

At operation 3920 “MVs=Filtered and merged 8×8 MVF; W_{B}=W/8, H_{B}=H/8, B=8” the remaining motion vectors may be filtered and merged.

When operation 3916 is not met (e.g., the current frame F is not low definition), at operation 3922 “Remove isolated MVs from 16×16 MVF” where primarily isolated MVs from 16×16 may be removed.

At operation 3924 “MVs=Filtered 16×16 MVF; W_{B}=W/16, H_{B}=H/16, B=16” remaining motion vectors may be filtered and merged.

At operation 3926 “Perform random sampling of 3 MVs (W_{B}H_{B} times) and collect histogram of corresponding affine model parameters. Detect peaks and set initial affine model iaff′ to mid-point of the peak ranges” a repeated random sampling may be performed three motion vectors at a time to calculate affine model parameters. For each parameter, a histogram may be utilized to detect a peak to set an initial affine model iaff′ to a mid-point of the peak range.

At operation 3928 “Set iaff to either iaff′ or to one of the up to 2 past affine parameters from the memory buffer BP according to the minimal subsampled SAD (SSAD)” two prior affine motion models from two prior frames as well as the initial affine model iaff′ are used to select a best initial affine model iaff.

At operation 3930 “Create 7 candidate motion vectors selection binary masks using iaaf, morphological operators, and RsCs texture measures to select blocks whose MVs to include in final GMM estimation; Select one with min SAD” a plurality of candidate motion vectors selection binary masks may be created based on the best initial affine model iaff. A best selection mask from the candidate motion vectors selection binary mask with a minimum error may be selected.

As used herein the term “RsCs” is defined as the square root of average row difference square and average column difference squares over a given block of pixels.

At operation 3932 “Re-compute iaff model by using least squares fit by selecting MVs corresponding to the selection mask” the best initial affine model iaff may be re-computed based on the best selection mask.

At operation 3934 “Compute W_{B}×H_{B} global motion vector field GMVF (by applying iaff model to the block centers) and then compute differences (MV coordinates SAD) between GMVF and MVs; Compute binarization threshold and apply to the differences to compute 2-level classification mask BGMP′ of globally moving region in F” the previously computed affine GMM for segmentation may be used to compute global motion vector field, denoted by GMVF. The field may be computed by applying the affine parameter equation of the GMM to the center of the block position (e.g., using the same block size as in block-based mv's field). Then, differences between GMVF and mv's may be computed and scaled to 0-255 range producing the so called Global Motion Probability map (GMP). The GMP map may then be binarized using the computed threshold T_m (generated via binarization threshold estimator 2106) into binary mask denoted by BGMP′ via 2-level global motion probability classifier 2108.

At operation 3936 “Compute dominant color with low RsCs texture area BFMP” of the globally moving region of BGMP′; If the percentage of overlapping blocks between BGMP′ and BFMP″ is high, set use_col=1; otherwise use_col=0″ a masked color histogram may be computed using BGMP′ to mask out only globally moving blocks. The histogram (col_hist) peaks may be determined and a corresponding dominant color may be generated (dom_col). Using the dominant color and resolution adjusted subsampled YUV444 frame SSF, color differences may be computed and scaled to 0-255 range (DCP map). DCP Map, along with RsCs(F) and BGMP′ mask may be used to compute the percentage of low-textured, dominant color blocks in the background moving area, which is represented as a binary mask color assisted BGMP. Analysis may be done to determine if the percentage of these blocks is high enough (e.g., in some implementations this percentage threshold may be to 85% or more of the background moving blocks from BGMP′) then the use_col control signal may be set to 1, otherwise the use_col control signal may be set to 0.

At operation 3938 “use col=1” a determination may be made as to whether the use_col signal is 1 or 0.

At operation 3940 “BGMP=BGMP′” if the use_col signal is 1, then color assisted BGMP may be output as the final background moving region binary mask (BGMP).

At operation 3942 “BGMP=BGMP” ”if the use_col_signal is 0, then the BGMP′ mask may be output as BGMP.

At operation 3944 “Add background region to Regions. Within the foreground moving area of BGMP compute dominant MV, create differences with MVs and binarize using the computed threshold to mask BDMP. If the connected area is significant add new foreground area to Regions. Repeat in a cascade same process for BDMP's 0-value area and if the resulting connected area is significant, and 2^{nd} foreground area to Regions.” the BGMP mask that defined background moving region may be inverted so that remaining, non-background area is turned on (e.g., bit mask has a value of 1). Then, using the inverted mask iBGMP, a masked histogram of motion vectors may be computed for the frame using the block-based motion vectors mv's. The histogram, denoted by mv_hist, may be analyzed and peaks may be selected to obtain the dominant motion vector within the foreground moving area. The motion vector field mv's may be next differenced with the dominant motion vector and the results may be scaled to 0-255 range into the dominant color probability map (DMP map). A binarization threshold may be estimated for the resulting DMP map and the map may be binarized into the 2-level binary mask BDMP. Next, the segment solidity and size analysis may be performed to determine if the new foreground region defined by BDMP is significant or not. If it is significant the control signal add_reg is set to 1 (else, it is set to 0). If add_reg is 0 then there is no foreground regions and the resulting Regions mask is created with only 1-2 regions (as defined by BGMP) via moving regions mask generator 2216. Otherwise, the Regions mask is created with only 2-3 regions (as defined by BGMP and the and BDMP masks).

At operation 3946 “Apply morphological operators (open+close), small segments removal and smoothing filter to Regions” all regions are segmented, the raw regions mask may be post-processed to reduce segmentation noise and make the raw regions mask more solid.

At operation 3948 “mode=0” a determination may be made regarding a mode of operation. Mode 0 (default mode)—is a mode designed for sequences with normal motion complexity. Mode 1—is a mode designed for sequences with complex motion (such as sequences with high perspective depth, fast motion etc.).

When operation 3948 is met, at operation 3950 “For each region compute translational 4-parameter, affine 6-parameter and pseudo-perspective 8-parameter models using MVs of the given region” when operating in mode 0 (default mode) process 3900 may adaptively switch on a region basis between translational 4-parameter, affine 6-parameter and pseudo-perspective 8-parameter global motion model.

When operation 3948 is not met, at operation 3952 “For each region compute affine 6-parameter, pseudo-perspective 8-parameter, and bi-quadratic 12-parameter models using MVs of the given region” when operating in mode 1 process 3900 may adaptively switch on a region basis between affine 6-parameter, pseudo-perspective 8-parameter and bi-quadratic 12-parameter global motion model.

At operation 3954 “For each region elect the model with smallest SSAD (allowing higher order model up to 1% higher SSAD tolerance” final global motion model parameters may be selected based on the smallest subsampled error.

At operation 3956 “In each region, apply its rmm model to the subsampled reference frame SFref with 4 different sub-pixel interpolation filters: (1) 1/16^{th}—pel soft filter (bilinear), (2) 1/16^{th}—pel medium filter (bicubic), (3) ⅛^{th}—pel medium sharp filter, and (4) ⅛^{th}—pel sharp filter; Within each region, compute four corresponding SSADs in respect to the subsampled current frame SF; Set flt to the regions' filters that have the smallest S SAD” within each region, the re-computed best initial affine model iaff may be applied to a subsampled reference frame SFref with several different sub-pixel interpolation filters to select the filter for each region that has the smallest error.

At operation 3958 “For each region, set ref_pts_mvs to the motion vectors at the frame reference points obtained with rmms, and reconstruct global motion model form ref_pts_mvs resulting in quantized model rmm_rec” for each region, the final region-based motion model parameters may be applied to frame-based reference points to form reference points motion vectors ref_pts_mvs. The computed reference points motion vectors ref_pts_mvs may be quantized, e.g., to a ¼-pel accuracy. Next, from the reference points motion vectors ref_pts_mvs, the reconstructed parameters rmm_rec may be generated. The reconstructed parameters rmm_rec may be obtained by solving the system of equations for the motion vectors at the reference points.

At operation 3960 “Apply rmm_rec to Fref according to Regions mask to create the prediction frame PF, and compute and output final SAD from PF and F with sub-pixel interpolation filter flt” the reconstructed parameters rmm_rec may be applied to the reference frame Fref according on a region-by-region basis (e.g., via the Regions mask) to create the prediction frame PF. the prediction frame PF may be generated by applying the reconstructed parameters rmm_rec to the pixels of the reference frame Fref where sub-pixel positions may be interpolated with the previously chosen filter filt.

At operation 3962 “Set fd and dir to the frame distance and direction of prediction between frames F and Fref” a frame distance fd (distance between the current frame F and reference frames Fref) and a direction dir may be set by the frame distance and direction of prediction that was used in estimating the model between the current frame F and the reference frames Fref.

At operation 3964 “Set r=0 and Nr=number of regions in Regions mask” a incremental region counter is set to zero and a number of regions flag is set based on the computed Regions mask.

At operation 3966 “Set latest[r] to the latest model from CB[r], scale it as per fd and dir, and convert it to rmm[r]'s # of parameters; Compute residuals between latest[r] and ref_pts_mvs[r] and encode residuals using adaptive modified exp-goulomb coders into coded bits bits₀[r] (totaling in b₀[r]bits)” for each region, the latest model from at least one region's codebook (CB) may be chosen, and then scaled according to the fd and dir values so that it matches to that region's ref_pts_mvs[r]'s distance and direction. In addition to scaling, that region's model may be converted to match the number of points in the current model. In the case when the current model has more points than that region's latest[r] model, the model may be reconstructed and the missing additional points' MVs may be computed and added to the latest model's points' MVs. The resulting predicted points are differenced with the region specific ref_pts_mvs[r] to produce that region's residuals, which are then encoded with the modified Golomb code.

At operation 3968 “Set scaled_matched_ref_pts_mvs[r] to the closest ref_pts_mvs[r] match among the scaled (in respect to fd and dir) codewords of CB[r], and set exact_match to 1 if scaled_matched_ref_pts_mvs[r]=ref_pts_mvs[r], and to 0 otherwise” for each region, that region's computed points ref_pts_mvs[r] may be compared to the points from to the corresponding codebook of that region using a matcher to find corresponding points from the region specific codebook (CB[r]). Before comparison, the points from the region specific codebook may be scaled according to the fd and dir values to get that region's scaled matched reference points scaled_matched_ref_pts_mvs[r]. If that region's computed points ref_pts_mvs[r] match to an entry in the region specific codebook (CB[r]), the control signal exact_match is set to 1. Otherwise, exact_match is set to 0.

At operation 3970 “exact_match=1” a determination may be made as to whether the exact_match control signal is set to 1 for an exact match or to 0 for not an exact match.

When operation 3970 is not met (e.g., not an exact match), at operation 3972 “Compute residuals between scaled_matched_ref_pts_mvs[r] and ref_pts_mvs[r] and encode residuals using adaptive modified exp-Golomb codes into coded bits bits₁” for each region, the closest model computed by the matcher, denoted by scaled_matched_ref_pts_mvs[r], may be used to compute the residuals with ref_pts_mvs[r]. The residuals are computed and encoded with modified adaptive Golomb codes. The bits for the codebook index and the residual bits are joined into a 2^{nd} set of coded bits.

When operation 3970 is met (e.g., an exact match), at operation 3974 “Encode index of scaled_matched_ref_pts_mvs[r] in CB and prepend to bits₁ (totaling in b₁ bits)” for each region, when ref_pts_mvs[r] match to an entry in the codebook CB[r], the control signal exact_match is set to 1 and the process 3900 outputs the bits for the codebook index as the 2^{nd} set of coded bits.

At operation 3976 “Encode index of scaled_matched_ref_pts_mvs[r] in CB[r] and prepend to bits₁ (totaling in b₁ bits)” for each region, where an index of scaled_matched_ref_pts_mvs[r] in CB[r] is encoded and prepend to bits₁.

At operation 3978 “1)₀<b₁” the bits b₀ from operation 3966 are compared to the bits 1)₁ from operation 3974 or 3976.

When operation 3978 is met (e.g., the bits b₀ from operation 3966 are smaller than the bits b₁ from operation 3974 or 3976), at operation 3980 “Append bits₀ to Bits” for each region, bits₀ are appended to the running count of bits to be output. The final output bits will include all of the individual region's final coded bits all appended to form frame-based final coded bits.

When operation 3978 is not met (e.g., the bits b₀ from operation 3966 are not smaller than the bits b₁ from operation 3974 or 3976), at operation 3982 “Append bits₁ to Bits” for each region, bits₁ are appended to the running count of bits to be output. The final output bits will include all of the individual region's final coded bits all appended to form frame-based final coded bits.

At operation 3984 “r<Nr−1” a determination may be made as to whether counter r is completed counting all of the regions of the current frame.

When operation 3984 is met, at operation 3986 “r=r+1” process 3900 iterates and increases counter r by one and the next region is read.

When operation 3984 is not met, at operation 3988 “Output Bits” the final running count of bits to be output from iterations of operation 3980 and/or 3982 are output. As noted above, the final output bits will include all of the individual region's final coded bits all appended to form frame-based final coded bits.

At operation 3990 “i<N−1” a determination may be made as to whether counter i is completed.

When operation 3990 is met, at operation 3992 “i=i+1; Read next frame F” process 3900 iterates and increases counter i by one and the next frame is read.

When operation 3990 is not met, then process 3900 is terminated.

FIG. 39 shows a high level process 3900 of region-based motion analyzer system 100 (e.g., region-based motion analyzer system 100 of FIG. 1 and/or FIG. 3).

Embodiments of the method 2900 (and other methods herein) may be implemented in a system, apparatus, processor, reconfigurable device, etc., for example, such as those described herein. More particularly, hardware implementations of the method 2900 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 2900 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, embodiments or portions of the method 2900 (and other methods herein) may be implemented in applications (e.g., through an application programming interface/API) or driver software running on an OS. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Pre-Segmentation

Pre-segmentation of a video sequence can be thought of as a rough segmentation of a scene into regions based on some common feature that may be scene dependent. For instance the common feature maybe a color (or in practice) a narrow band of colors, and/or a motion (or in practice) a narrow band of motion parameters. Often the goal of pre-segmentation is to partition a video sequence on frame-frame basis into global, and local regions.

Consistency and Coherence

Segmenting of each frame of the video sequence may be done into three or more regions that are not only spatially and temporally consistent but are also semantically coherent. For instance to generate three regions, starting with a two region segmentation, the foreground region can be segmented into two regions resulting in the background region, a foreground region #1, and a foreground region #2. Further, in an example case of four regions, in addition, a foreground region #3 may be used. Likewise, if needed, in place of initial segmentation (e.g., pre-segmentation) of the foreground region, the background region could have been split if necessary.

Spatial Consistency

For a general class of video sequence undergoing frame-frame segmentation into regions, spatial consistency can be defined as being able to roughly segment the same spatial object, such as nearly the same shape and nearly the same size.

Temporal Consistency

For a general class of video sequence undergoing frame-frame segmentation into regions, temporal consistency can be defined as being able to roughly segment the same temporal object, such as nearly the same location (except for motion) and nearly the same motion trajectory.

Semantic Coherence

For a restricted class of video sequences undergoing frame-frame segmentation into regions, semantic coherence can be defined as the segmented region being roughly of same shape, size, location and/or trajectory, and may be considered as representing the background, while the other region(s) may be considered as foreground region(s) such as foreground region #1, foreground region #2, etc.

Explicit Region Boundary Shape Coding

In region based video coding operating on frame-frame segmented regions there is often a necessity for efficiently identifying region(s) via the encoded bitstream to the decoder. For example, one way this identification can be performed is by the video encoder explicitly encoding boundary of region(s) information (e.g., typically one less number of boundary region shapes need to be coded as compared to the total number of regions). In some implementations herein, to reduce coding cost of boundary of region(s) information, a reduced precision such as 4-pixel, 8-pixel, or even 16-pixel precision can be used. Further, the MPEG-4 part 2 standard may provides one efficient method for region boundary coding that uses context information from past neighbors as well as temporal prediction and arithmetic coding. Besides MPEG-4, other technologies also exist for region shape coding that may be simpler, but also may be less efficient.

Implicit Region Representation

Region boundary information, depending on the precision with which it is sent, can be costly in bits. If region based motion compensation is used in video coding, an alternative way of achieving the same goal (e.g., being able to identify which block belongs to which region) may be accomplished by extending coding a mode table of the standard (e.g. AVC standard, HEVC standard, or the like), such as typically might include modes such as skip mode, inter mode, and/or intra mode so as to also be able to indicate which region (e.g., ‘skip-region1’ block or ‘inter-region1’) a given coding block is associated with. Coding modes may be typically encoded very efficiently with arithmetic coding, so shape information may be represented efficiently.

Embodiments of the method 3900 (and other methods herein) may be implemented in a system, apparatus, processor, reconfigurable device, etc., for example, such as those described herein. More particularly, hardware implementations of the method 3900 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 3900 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, embodiments or portions of the method 3900 (and other methods herein) may be implemented in applications (e.g., through an application programming interface/API) or driver software running on an OS. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Results

SAD Reduction and Entropy Coding of GMM Model Parameter Results

One implementation was evaluated on test sets of various resolutions. The tabulated results use the following column headers:
F=the index of the current frame
R=the reference frame index
Ref SAD=the 8×8 block-based SAD (the reference SAD)
RMM SAD=is the region-based motion full frame SAD
NBB=refer to the number of 16×16 blocks in the frame whose GMM SAD is better or equal to the collocated Ref SAD
Bits=total number of bits per frame spent for GMM parameters coding and coding of headers that signal the selected model and sub-pel filter
SP Filter=denotes the selected sub-pel filter (values are “ 1/16 BIL”= 1/16-pel Bilinear filter, “ 1/16 BIC”= 1/16-pel Bicubic filter, “⅛ AVC”=⅛-pel AVC-based filter, and “⅛ HEVC”=⅛-pel HEVC-based filter)
Mod=is the chosen global motion model (values are “4 par”=translational 4-parameter global motion model, “6-par”=affine 6-parameter global motion model, and “8 par”=pseudo-perspective 8-parameter global motion model)
RMM Parameters=final region-based motion model parameter coefficients

Average Frame SAD reduction for low delay IPP pictures

TABLE 8
below, illustrates an average SAD Results of RMM for
CIF sequences (33 frame) with low delay IPP pictures:

| | Ref SAD | RMM SAD | NBB | Bits |
|---|---|---|---|---|
| | (33 frame | (33 frame | (33 frame | (33 frame |
| Sequence | Avg) | Avg) | Avg) | Avg) |
| Bus | 389601 | 561486 | 146 | 78 |
| City | 210014 | 212870 | 227 | 70 |
| Flower | 444764 | 636215 | 61 | 127 |
| Stefan | 614102 | 947909 | 60 | 99 |
| Mobile | 503788 | 652820 | 114 | 43 |
| Football | 349557 | 751048 | 53 | 90 |
| Foreman | 213772 | 391640 | 108 | 69 |
| Harbour | 481541 | 514964 | 163 | 16 |
| Soccer | 287422 | 672652 | 112 | 68 |
| Tennis | 286460 | 483821 | 172 | 78 |
| Tennis2 | 352610 | 526263 | 194 | 54 |
| Coast | 431386 | 534679 | 146 | 66 |

TABLE 9
SAD Results of RMM for CIF “Bus” sequence (33 frames) with Low
Delay IPP pictures:

| | | Ref | RMMs | | | SP | | |
|---|---|---|---|---|---|---|---|---|
| F | R | SAD | SAD | NBB | Bits | Filter | Mod | RMMs Parameters |
| 1 | 0 | 450196 | 682912 | 166 | 120 | | | |
| | | 305098 | 311388 | 163 | 50 | 1/16 | 6par | a0 = l.005859 a1 = 0.0 |
| | | | | | | BIC | | a2 = −4.5 a3 = 0.0 |
| | | | | | | | | a4 = 1.005371 a5 = −0.75 |
| | | 134422 | 357408 | 3 | 46 | 1/16 | 6par | a0 = 1.003418 |
| | | | | | | BIL | | a1 = 0.107422 |
| | | | | | | | | a2 = −16.0 a3 = 0.0 |
| | | | | | | | | a4 = 1.0 a5 = −0.25 |
| | | 10676 | 14116 | 0 | 18 | 1/16 | 4par | a0 = 0.992188 a1 = 2.25 |
| | | | | | | BIC | | a2 = 1.000977 a3 = −0.25 |
| 2 | 1 | 456828 | 725190 | 88 | 75 | | | |
| | | 304524 | 323713 | 84 | 26 | ⅛ | 4par | a0 = 1.004883 a1 = −4.5 |
| | | | | | | HEVC | | a2 = 1.005859 a3 = −1.0 |
| | | 141763 | 386342 | 4 | 29 | 1/16 | 6par | a0 = 1.003418 |
| | | | | | | BIL | | a1 = 0.110352 a2 = −16.25 |
| | | | | | | | | a3 = 0.000488 |
| | | | | | | | | a4 = 1.010254 a5 = −2.0 |
| | | 10541 | 15135 | 0 | 18 | 1/16 | 4par | a0 = 0.992676 a1 = 2.0 |
| | | | | | | BIC | | a2 = 1.001953 a3 = −0.5 |
| 3 | 2 | 449217 | 747536 | 142 | 92 | | | |
| | | 310926 | 316729 | 141 | 27 | ⅛ | 6par | a0 = 1.004883 a1 = 0.0 |
| | | | | | | HEVC | | a2 = −4.5 a3 = 0.0 |
| | | | | | | | | a4 = 1.005371 a5 = −0.75 |
| | | 126635 | 415500 | 1 | 19 | 1/16 | 4par | a0 = 0.998535 a1 = 0.0 |
| | | | | | | BIL | | a2 = 1.005859 a3 = −1.0 |
| | | 11656 | 15307 | 0 | 44 | 1/16 | 6par | a0 = 0.992676 |
| | | | | | | BIC | | a1 = −0.009766 |
| | | | | | | | | a2 = 4.5 a3 = 0.001465 |
| | | | | | | | | a4 = 1.002441 a5 = −1.0 |
| 4 | 3 | 439079 | 575033 | 121 | 69 | | | |
| | | 310122 | 326171 | 113 | 26 | ⅛ | 6par | a0 = 1.004883 a1 = −0.000977 |
| | | | | | | HEVC | | a2 = −4.5 a3 = 0.0 |
| | | | | | | | | a4 = 1.004395 a5 = −0.5 |
| | | 116698 | 232015 | 8 | 24 | 1/16 | 4par | a0 = 1.004395 a1 = 0.25 |
| | | | | | | BIL | | a2 = 1.002441 a3 = −0.5 |
| | | 12259 | 16847 | 0 | 17 | 1/16 | 4par | a0 = 0.991699 a1 = 2.5 |
| | | | | | | BIC | | a2 = l .003418 a3 = −0.75 |
| 5 | 4 | 407518 | 480787 | 134 | 71 | | | |
| | | 304139 | 327736 | 127 | 14 | ⅛ | 6par | a0 = 1.004395 |
| | | | | | | AVC | | a1 = 0.0 a2 = −4.5 a3 = 0.0 |
| | | | | | | | | a4 = 1.003418 a5 = −0.5 |
| | | 90701 | 137328 | 7 | 39 | 1/16 | 6par | a0 = 1.004395 a1 = 0.015625 |
| | | | | | | BIC | | a2 = −1.75 a3 = 0.0 |
| | | | | | | | | a4 = 0.997559 a5 = 0.25 |
| | | 12678 | 15723 | 0 | 16 | 1/16 | 4par | a0 = 0.992188 a1 = 2.25 |
| | | | | | | BIC | | a2 = 1.001953 a3 = −0.5 |
| 6 | 5 | 385958 | 504500 | 150 | 75 | | | |
| | | 259418 | 266689 | 146 | 25 | ⅛ | 4par | a0 = 1.00293 |
| | | | | | | HEVC | | a1 = −4.25 a2 = 1.001953 |
| | | | | | | | | a3 = −0.25 |
| | | 113090 | 220025 | 4 | 41 | 1/16 | 6par | a0 = 0.998047 a1 = −0.026855 |
| | | | | | | BIL | | a2 = 5.5 a3 = 0.0 |
| | | | | | | | | a4 = 1.000977 a5 = −0.25 |
| | | 13450 | 17786 | 0 | 7 | 1/16 | 4par | a0 = 0.992676 a1 = 2.0 |
| | | | | | | BIC | | a2 = 1.001953 a3 = −0.5 |
| 7 | 6 | 368091 | 468537 | 125 | 83 | | | |
| | | 245682 | 260004 | 122 | 24 | ⅛ | 6par | a0 = 1.001465 |
| | | | | | | HEVC | | a1 = −0.000977 a2 = −4.0 |
| | | | | | | | | a3 = −0.000488 a4 = 1.000977 |
| | | | | | | | | a5 = 0.0 |
| | | 109219 | 188226 | 3 | 29 | 1/16 | 6par | a0 = 1.001465 |
| | | | | | | BIC | | a1 = −0.002441 a2 = 1.25 |
| | | | | | | | | a3 = 0.0 a4 = 0.999023 |
| | | | | | | | | a5 = 0.0 |
| | | 13190 | 20307 | 0 | 28 | 1/16 | 6par | a0 = 1.004395 |
| | | | | | | BIC | | a1 = −0.006836 a2 = 0.25 |
| | | | | | | | | a3 = −0.000488 a4 = 1.0 |
| | | | | | | | | a5 = 0.25 |
| 8 | 7 | 338548 | 412994 | 159 | 71 | | | |
| | | 210334 | 236030 | 155 | 24 | 1/16 | 6par | a0 = 1.0 a1 = 0.0 a2 = −4.0 |
| | | | | | | BIC | | a3 = 0.0 a4 = 1.0 a5 = 0.0 |
| | | 114898 | 150958 | 4 | 21 | ⅛ | 4par | a0 = 0.999512 |
| | | | | | | AVC | | a1 = 1.25 a2 = 1.0 a3 = 0.0 |
| | | 13316 | 26006 | 0 | 24 | 1/16 | 6par | a0 = 1.000488 a1 = −0.013184 |
| | | | | | | BIL | | a2 = 2.75 a3 = −0.000488 |
| | | | | | | | | a4 = 1.0 a5 = 0.25 |
| 9 | 8 | 336075 | 381676 | 209 | 51 | | | |
| | | 215560 | 230083 | 196 | 6 | 1/16 | 6par | a0 = 1.0 a1 = 0.0 |
| | | | | | | BIC | | a2 = −4.0 a3 = 0.0 a4 = 1.0 |
| | | | | | | | | a5 = 0.0 |
| | | 105785 | 129085 | 13 | 21 | ⅛ | 4par | a0 = 0.998535 a1 = 1.5 |
| | | | | | | HEVC | | a2 = 0.995605 a3 = 0.5 |
| | | 14730 | 22508 | 0 | 22 | 1/16 | 4par | a0 = 1.0 a1 = −0.25 |
| | | | | | | BIC | | a2 = 0.999023 a3 = 0.25 |
| 10 | 9 | 329192 | 424591 | 154 | 63 | | | |
| | | 215718 | 237877 | 147 | 22 | 1/16 | 6par | a0 = 1.000488 a1 = 0.0 |
| | | | | | | BIC | | a2 = −4.0 a3 = 0.0 |
| | | | | | | | | a4 = 0.999023 a5 = 0.25 |
| | | 98474 | 163988 | 7 | 19 | ⅛ | 4par | a0 = 1.001953 |
| | | | | | | AVC | | a1 = 0.75 a2 = 1.0 a3 = 0.0 |
| | | 15000 | 22726 | 0 | 20 | 1/16 | 4par | a0 = 1.007813 |
| | | | | | | BIC | | a1 = −2.5 a2 = 1.0 a3 = 0.0 |
| 11 | 10 | 319843 | 397847 | 233 | 59 | | | |
| | | 204049 | 220991 | 231 | 16 | 1/8 | 4par | a0 = l .0 |
| | | | | | | HEVC | | a1 = −4.0 a2 = 1.0 a3 = 0.0 |
| | | 100106 | 153241 | 2 | 34 | ⅛ | 6par | a0 = 1.0 |
| | | | | | | HEVC | | a1 = 0.004395 a2 = 0.5 a3 = 0.0 |
| | | | | | | | | a4 = 0.994629 a5 = 0.5 |
| | | 15688 | 23615 | 0 | 7 | 1/16 | 4par | a0 = 1.0 a1 = −0.25 |
| | | | | | | BIC | | a2 = 0.999023 a3 = 0.25 |
| 12 | 11 | 339549 | 434032 | 200 | 58 | | | |
| | | 201835 | 220878 | 195 | 7 | ⅛ | 6par | a0 = 1.0 a1 = 0.0 |
| | | | | | | HEVC | | a2 = −4.0 a3 = 0.0 |
| | | | | | | | | a4 = 1.0 a5 = 0.0 |
| | | 120399 | 192705 | 5 | 27 | 1/16 | 6par | a0 = 1.0 |
| | | | | | | BIC | | a1 = −0.002441 a2 = 1.25 |
| | | | | | | | | a3 = 0.000488 a4 = 0.996582 |
| | | | | | | | | a5 = 0.25 |
| | | 17315 | 20449 | 0 | 22 | 1/16 | 4par | a0 = 0.995605 a1 = 1.25 |
| | | | | | | BIC | | a2 = 1.007813 a3 = −1.75 |
| 13 | 12 | 363667 | 469814 | 168 | 67 | | | |
| | | 225470 | 228733 | 165 | 20 | 1/16 | 6par | a0 = 1.0 a1 = −0.000977 |
| | | | | | | BIC | | a2 = −4.0 a3 = 0.0 a4 = 1.0 |
| | | | | | | | | a5 = 0.0 |
| | | 121721 | 220674 | | 22 | 1/16 | 4par | a0 = 0.999512 a1 = 0.75 |
| | | | | | | BIL | | a2 = 0.997559 a3 = 0.25 |
| | | 16476 | 20407 | 0 | 23 | 1/16 | 4par | a0 = 0.98877 |
| | | | | | | BIC | | a1 = 3.25 a2 = 1.0 a3 = 0.0 |
| 14 | 13 | 367329 | 531075 | 166 | 43 | | | |
| | | 221842 | 235372 | 166 | 14 | ⅛ | 6par | a0 = 1.0 a1 = 0.0 a2 = −4.25 |
| | | | | | | HEVC | | a3 = 0.0 a4 = 1.0 a5 = 0.0 |
| | | 127359 | 270365 | 0 | 20 | 1/16 | 4par | a0 = 0.99707 |
| | | | | | | BIL | | a1 = 1.0 a2 = 0.999023 a3 = 0.0 |
| | | 18128 | 25338 | 0 | 7 | 1/16 | 4par | a0 = 1.0 a1 = −0.25 |
| | | | | | | BIC | | a2=0.999023 a3 = 0.25 |
| 15 | 14 | 366339 | 535804 | 196 | 54 | | | |
| | | 228006 | 227902 | 185 | 17 | ⅛ | 6par | a0 = 1.0 a1 = 0.0 a2 = −4.5 |
| | | | | | | HEVC | | a3 = 0.0 a4 = 1.0 a5 = 0.0 |
| | | 119444 | 289024 | 2 | 19 | 1/16 | 4par | a0 = 0.995605 a1 = 1.0 |
| | | | | | | BIL | | a2 = 0.997559 a3 = 0.25 |
| | | 18889 | 18878 | 9 | 16 | ⅛ | 4par | a0 = 1.0 a1 = 0.0 |
| | | | | | | HEVC | | a2 = 1.0 a3 = 0.0 |
| 16 | 15 | 376432 | 518436 | 164 | 62 | | | |
| | | 232008 | 248966 | 163 | 6 | ⅛ | 6par | a0 = 1.0 a1 = 0.0 a2 = −4.5 |
| | | | | | | HEVC | | a3 = 0.0 a4 = l .0 a5 = 0.0 |
| | | 126729 | 244411 | 1 | 34 | ⅛ | 6par | a0 = 0.998047 a1 = 0.001953 |
| | | | | | | AVC | | a2 = 0.5 a3 = 0.000488 |
| | | | | | | | | a4 = 1.001953 a5 = −0.5 |
| | | 17695 | 25059 | 0 | 20 | 1/16 | 4par | a0 = 0.986328 a1 = 3.75 |
| | | | | | | BIC | | a2 = 1.002441 a3 = −0.75 |
| 17 | 16 | 375927 | 568442 | 166 | 43 | | | |
| | | 242929 | 252844 | 165 | 6 | ⅛ | 6par | a0 = 1.0 a1 = 0.0 a2 = −4.5 |
| | | | | | | HEVC | | a3 = 0.0 a4 = 1.0 a5 = 0.0 |
| | | 114395 | 292476 | 0 | 16 | ⅛ | 4par | a0 = 0.998047 a1 = 0.5 |
| | | | | | | AVC | | a2 = 0.998047 a3 = 0.0 |
| | | 18603 | 23122 | 1 | 19 | 1/16 | 4par | a0 = 0.990723 a1 = 2.5 |
| | | | | | | BIC | | a2 = 1.000977 a3 = −0.25 |
| 18 | 17 | 369877 | 583006 | 156 | 65 | | | |
| | | 235293 | 230571 | 154 | 18 | ⅛ | 6par | a0 = 1.0 a1 = −0.000977 |
| | | | | | | HEVC | | a2 = −4.5 a3 = 0.0 a4 = 1.0 |
| | | | | | | | | a5 = 0.0 |
| | | 114169 | 313699 | 2 | 17 | 1/16 | 4par | a0=0.998047 a1 = 0.25 |
| | | | | | | BIL | | a2 = 0.999023 a3 = 0.0 |
| | | 20415 | 38736 | 0 | 28 | ⅛ | 6par | a0 = 1.015137 a1 = 0.014648 |
| | | | | | | AVC | | a2 = −8.5 a3 = 0.000488 |
| | | | | | | | | a4 = 0.999023 a5 = 0.0 |
| 19 | 18 | 349564 | 449149 | 165 | 135 | | | |
| | | 220761 | 237038 | 162 | 17 | 1/16 | 6par | a0 = 1.0 a1 = 0.0 a2 = −4.75 |
| | | | | | | BIC | | a3 = 0.0 a4 = 1.0 a5 = 0.0 |
| | | 108350 | 176480 | 3 | 94 | ⅛ | 8par | a0 = 0.000026 a1 = −0.000171 |
| | | | | | | AVC | | a2 = 0.002604 a3 = 0.035645 |
| | | | | | | | | a4 = −1.0 a5 = −0.003418 |
| | | | | | | | | a6 = 0.026594 a7 = −1.0 |
| | | 20453 | 35631 | 0 | 22 | 1/16 | 4par | a0 = 1.007324 a1 = −2.5 |
| | | | | | | BIL | | a2 = 1.000977 a3 = 0.0 |
| 20 | 19 | 363053 | 514003 | 181 | 60 | | | |
| | | 227443 | 233953 | 180 | 20 | 1/16 | 6par | a0 = 1.0 a1 = −0.000977 |
| | | | | | | BIC | | a2 = −5.0 a3 = 0.000488 |
| | | | | | | | | a4 = 1.0 a5 = 0.0 |
| | | 113876 | 234885 | 1 | 13 | 1/16 | 4par | a0 = 0.998535 |
| | | | | | | BIL | | a1 = 0.0 a2 = 0.999023 a3 = 0.0 |
| | | 21734 | 45165 | 0 | 25 | 1/16 | 4par | a0 = 1.035645 a1 = −l 1.0 |
| | | | | | | BIL | | a2 = 1.006836 a3 = −l .75 |
| 21 | 20 | 406103 | 571966 | 112 | 96 | | | |
| | | 236805 | 247536 | 106 | 22 | ⅛ | 6par | a0 = 1.0 a1 = −0.000977 |
| | | | | | | HEVC | | a2 = −5.5 a3 = 0.0 a4 = 1.0 |
| | | | | | | | | a5 = 0.0 |
| | | 143808 | 270136 | 6 | 28 | 1/16 | 6par | a0 = 0.995117 a1 = 0.003418 |
| | | | | | | BIC | | a2 = 0.0 a3 = −0.001465 |
| | | | | | | | | a4 = 1.004395 a5 = −0.5 |
| | | 25490 | 54294 | 0 | 44 | 1/16 | 6par | a0 = 1.05127 a1 = 0.041504 |
| | | | | | | BIL | | a2 = −26.0 a3 = −0.004883 |
| | | | | | | | | a4 = 1.000977 a5 = 1.25 |
| 22 | 21 | 388160 | 538760 | 113 | 74 | | | |
| | | 239462 | 263599 | 108 | 25 | 1/16 | 6par | a0 = 0.999512 a1 = −0.000977 |
| | | | | | | BIC | | a2 = −5.5 a3 = 0.0 |
| | | | | | | | | a4 = 0.999023 a5 = 0.25 |
| | | 123459 | 237084 | 4 | 24 | ⅛ | 4par | a0 = 1.001465 a1 = −0.75 |
| | | | | | | AVC | | a2 = 1.005859 a3 = −1.0 |
| | | 25239 | 38077 | 1 | 23 | 1/16 | 4par | a0 = l .018555 a1 = −5.75 |
| | | | | | | BIL | | a2 = 1.0 a3 = 0.0 |
| 23 | 22 | 370195 | 564436 | 80 | 83 | | | |
| | | 217635 | 253285 | 78 | 18 | 1/16 | 6par | a0 = 1.000488 a1 = 0.000977 |
| | | | | | | BIC | | a2 = −6.25 a3 = 0.0 |
| | | | | | | | | a4 = 0.999023 a5 = 0.25 |
| | | 128855 | 265114 | 2 | 23 | 1/16 | 4par | a0 = 0.998047 a1 = −0.5 |
| | | | | | | BIL | | a2 = 1.009766 a3 = −1.5 |
| | | 23705 | 46037 | 0 | 40 | 1/16 | 6par | a0 = 1.039063 a1 = 0.048828 |
| | | | | | | BIL | | a2 = −23.75 a3 = −0.000488 |
| | | | | | | | | a4 = 0.999023 a5 = 0.5 |
| 24 | 23 | 381250 | 602303 | 155 | 75 | | | |
| | | 184341 | 194029 | 153 | 25 | ⅛ | 6par | a0 = 1.0 a1 = 0.0 a2 = −6.25 |
| | | | | | | HEVC | | a3 = 0.0 a4 = 1.0 a5 = 0.0 |
| | | 171709 | 365567 | 2 | 22 | 1/16 | 4par | a0 = l .001465 a1 = −1.25 |
| | | | | | | BIL | | a2 = 1.006836 a3 = −1.25 |
| | | 25200 | 42707 | 0 | 26 | 1/16 | 4par | a0 = 1.041016 a1 = −12.0 |
| | | | | | | BIL | | a2 = 1.010254 a3 = −2.5 |
| 25 | 24 | 427065 | 704422 | 137 | 151 | | | |
| | | 236415 | 247716 | 136 | 19 | ⅛ | 6par | a0 = 0.999512 a1 = −0.000977 |
| | | | | | | HEVC | | a2 = −6.25 a3 = 0.000488 |
| | | | | | | | | a4 = 1.000977 a5 = 0.0 |
| | | 165703 | 410306 | 1 | 103 | 1/16 | 8par | a0 = −0.000194 a1 = −0.000783 |
| | | | | | | BIL | | a2 = 0.174006 a3 = 0.100586 |
| | | | | | | | | a4 = −19.0 a5 = 0.029297 |
| | | | | | | | | a6 = 0.268308 a7 = −22.0 |
| | | 24947 | 46400 | 0 | 27 | 1/16 | 4par | a0 = 1.049805 a1 = −15.0 |
| | | | | | | BIL | | a2 = 0.998047 a3 = 0.5 |
| 26 | 25 | 396717 | 535947 | 130 | 69 | | | |
| | | 212510 | 219955 | 123 | 20 | 1/16 | 6par | a0 = 1.0 a1 = 0.0 a2 = −6.75 |
| | | | | | | BIC | | a3 = 0.000488 a4 = 1.0 a5 = 0.0 |
| | | 160328 | 270020 | 7 | 23 | 1/16 | 4par | a0 = 0.998047 a1 = −0.5 |
| | | | | | | BIL | | a2 = 1.001953 a3 = −0.25 |
| | | 23879 | 45972 | 0 | 24 | 1/16 | 4par | a0 = 1.03125 |
| | | | | | | BIL | | a1 = −9.75 a2 = 1.0 a3 = 0.0 |
| 27 | 26 | 410356 | 569587 | 115 | 121 | | | |
| | | 202047 | 207334 | 104 | 57 | ⅛ | 8par | a0 = −0.000019 a1 = 0.000006 |
| | | | | | | HEVC | | a2 = 0.006313 a3 = −0.005371 |
| | | | | | | | | a4 = −28.0 a5 = 0.00293 |
| | | | | | | | | a6 = 0.001578 a7 = 0.0 |
| | | 184338 | 309363 | 11 | 35 | ⅛ | 6par | a0 = 0.995605 a1 = −0.004395 |
| | | | | | | AVC | | a2 = 0.0 a3 = 0.000488 |
| | | | | | | | | a4 = 1.002441 a5 = −0.5 |
| | | 23971 | 52890 | 0 | 27 | 1/16 | 4par | a0 = 0.98291 a1 = 4.0 |
| | | | | | | BIL | | a2 = 0.998047 a3 = 0.5 |
| 28 | 27 | 419391 | 701873 | 104 | 105 | | | |
| | | 212664 | 221263 | 101 | 21 | ⅛ | 6par | a0 = 1.0 a1 = −0.000977 |
| | | | | | | HEVC | | a2 = −7.25 a3 = 0.000488 |
| | | | | | | | | a4 = 1.0 a5 = 0.0 |
| | | 183066 | 432744 | 3 | 38 | 1/16 | 6par | a0 = 0.99707 a1 = −0.019043 |
| | | | | | | BIL | | a2 = 2.25 a3 = 0.000488 |
| | | | | | | | | a4 = 1.008789 a5 = −1.5 |
| | | 23661 | 47866 | 0 | 44 | 1/16 | 6par | a0 = 1.006348 a1 = 0.058105 |
| | | | | | | BIL | | a2 = −16.75 a3 = −0.004395 |
| | | | | | | | | a4 = 0.996582 a5 = 2.0 |
| 29 | 28 | 446769 | 774599 | 131 | 109 | | | |
| | | 233241 | 235823 | 122 | 27 | ⅛ | 6par | a0 = 1.0 a1 = −0.000977 |
| | | | | | | HEVC | | a2 = −7.25 a3 = 0.0 a4 = 1.0 |
| | | | | | | | | a5 = 0.25 |
| | | 187942 | 512219 | 5 | 34 | 1/16 | 6par | a0 = 1.00293 a1 = 0.001953 |
| | | | | | | BIL | | a2 = −2.0 a3 = 0.001465 |
| | | | | | | | | a4 = 1.010254 a5 = −1.75 |
| | | 25586 | 26557 | 4 | 46 | ⅛ | 8par | a0 = 0.0 a1 = 0.0 a2 = 0.0 |
| | | | | | | AVC | | a3 = 0.0 a4 = 0.0 a5 = 0.0 |
| | | | | | | | | a6 = 0.0 a7 = 0.0 |
| 30 | 29 | 430705 | 673063 | 125 | 84 | | | |
| | | 231657 | 227703 | 125 | 24 | ⅛ | 6par | a0 = 1.0 a1 = −0.000977 |
| | | | | | | HEVC | | a2 = −7.25 a3 = −0.000488 |
| | | | | | | | | a4 = 1.0 a5 = 0.25 |
| | | 174786 | 393591 | 0 | 24 | 1/16 | 4par | a0 = l .000488 a1 = −1.5 |
| | | | | | | BIL | | a2 = 0.995605 a3 = 0.5 |
| | | 24262 | 51769 | 0 | 34 | 1/16 | 4par | a0 = l .077637 a1 = −22.5 |
| | | | | | | BIL | | a2 = 1.014648 a3 = −3.5 |
| 31 | 30 | 414954 | 681224 | 114 | 52 | | | |
| | | 220333 | 237129 | 112 | 6 | ⅛ | 6par | a0 = 1.0 a1 = −0.000977 |
| | | | | | | HEVC | | a2 = −7.25 a3 = 0.0 a4 = 1.0 |
| | | | | | | | | a5 = 0.25 |
| | | 171238 | 391712 | 2 | 19 | 1/16 | 4par | a0 = 1.003418 a1 = −2.25 |
| | | | | | | BIL | | a2 = 1.001953 a3 = −0.25 |
| | | 23383 | 52383 | 0 | 25 | 1/16 | 4par | a0 = 1.053223 a1 = −16.25 |
| | | | | | | BIL | | a2 = 0.994141 a3 = 1.5 |
| 32 | 31 | 423283 | 644011 | 103 | 56 | | | |
| | | 239873 | 253978 | 99 | 6 | ⅛ | 6par | a0 = 1.0 a1 = −0.000977 |
| | | | | | | HEVC | | a2 = −7.25 a3 = 0.0 |
| | | | | | | | | a4 = 1.0 a5 = 0.25 |
| | | 156816 | 332641 | 4 | 23 | ⅛ | 4par | a0 = 0.998535 a1 = −1.0 |
| | | | | | | AVC | | a2 = 1.0 a3 = 0.0 |
| | | 26594 | 57392 | 0 | 25 | 1/16 | 4par | a0 = 1.029785 a1 = −9.5 |
| | | | | | | BIL | | a2 = 0.989746 a3 = 2.75 |

TABLE 10
SAD Results of WM for CIF “City” sequence (33 frames) with Low
Delay IPP pictures:

| | | Ref | RMMs | | | SP | | |
|---|---|---|---|---|---|---|---|---|
| F | R | SAD | SAD | NBB | Bits | Filter | Mod | RMMs Parameters |
| 1 | 0 | 212423 | 192437 | 319 | 145 | | | |
| | | 158412 | 140102 | 259 | 69 | ⅛ | 8par | a0 = 0.000021 a1 = −0.000007 |
| | | | | | | HEVC | | a2 = −0.006787 |
| | | | | | | | | a3 = −0.005371 |
| | | | | | | | | a4 = 9.0 a5 = −0.00293 |
| | | | | | | | | a6 = −0.001736 a7 = 0.0 |
| | | 54011 | 52335 | 60 | 70 | ⅛ | 8par | a0 = 0.000119 a1 = 0.000015 |
| | | | | | | HEVC | | a2 = −0.042535 |
| | | | | | | | | a3 = −0.002441 |
| | | | | | | | | a4 = 5.0 a5 = −0.022949 |
| | | | | | | | | a6 = −0.02036 a7 = 3.0 |
| 2 | 1 | 229550 | 234466 | 223 | 79 | | | |
| | | 169572 | 154724 | 214 | 42 | ⅛ | 6par | a0 = 1.0 a1 = −0.001953 |
| | | | | | | HEVC | | a2 = 1.75 a3 = 0.000488 |
| | | | | | | | | a4 = 1.0 a5 = −0.75 |
| | | 59978 | 79742 | 9 | 35 | ⅛ | 6par | a0 = 1.0 a1 = 0.0 a2 = 0.0 |
| | | | | | | AVC | | a3 = 0.005859 a4 = l.000977 |
| | | | | | | | | a5 = −l.75 |
| 3 | 2 | 205169 | 211963 | 224 | 50 | | | |
| | | 151965 | 147291 | 207 | 26 | ⅛ | 6par | a0 = 1.0 a1 = −0.000977 |
| | | | | | | HEVC | | a2 = 1.25 a3 = 0.0 a4 = 1.0 |
| | | | | | | | | a5 = −0.75 |
| | | 53204 | 64672 | 17 | 22 | ⅛ | 4par | a0 = 1.0 a1 = −0.5 |
| | | | | | | HEVC | | a2 = 0.999023 a3 = −0.75 |
| 4 | 3 | 209697 | 206665 | 238 | 89 | | | |
| | | 153360 | 152438 | 178 | 16 | ⅛ | 6par | a0 = 0.999512 a1 = −0.001953 |
| | | | | | | HEVC | | a2 = l .25 a3 = −0.000488 |
| | | | | | | | | a4 = 1.0 a5 = −0.75 |
| | | 56337 | 54227 | 60 | 71 | ⅛ | 8par | a0 = −0.00004 a1 = −0.000052 |
| | | | | | | HEVC | | a2 = 0.018782 a3 = 0.012207 |
| | | | | | | | | a4 = −5.0 a5 = 0.01123 |
| | | | | | | | | a6 = 0.022175 a7 = −6.0 |
| 5 | 4 | 215696 | 207325 | 282 | 92 | | | |
| | | 158210 | 151872 | 233 | 19 | ⅛ | 6par | a0 = 1.0 a1 = −0.001953 |
| | | | | | | HEVC | | a2 = 1.25 a3 = 0.0 a4 = 1.0 |
| | | | | | | | | a5 = −0.5 |
| | | 57486 | 55453 | 49 | 71 | ⅛ | 8par | a0 = 0.000089 a1 = −0.00005 |
| | | | | | | HEVC | | a2 = −0.014205 a3 = 0.010254 |
| | | | | | | | | a4 = −3.0 a5 = −0.023926 |
| | | | | | | | | a6 = −0.000631 a7 = 1.0 |
| 6 | 5 | 219246 | 229817 | 205 | 45 | | | |
| | | 165371 | 169497 | 174 | 18 | ⅛ | 6par | a0 = 1.0 a1 = −0.002441 |
| | | | | | | HEVC | | a2 = 1.0 a3 = 0.0 a4 = 1.0 |
| | | | | | | | | a5 = −0.5 |
| | | 53875 | 60320 | 31 | 25 | ⅛ | 6par | a0 = l.001465 a1 = 0.0 |
| | | | | | | HEVC | | a2 = −1.25 a3 = −0.000488 |
| | | | | | | | | a4 = 1.000977 a5 = −0.5 |
| 7 | 6 | 208662 | 238344 | 159 | 102 | | | |
| | | 159533 | 186796 | 114 | 29 | ⅛ | 6par | a0 = 1.000488 a1 = −0.002441 |
| | | | | | | HEVC | | a2 = 0.75 a3 = 0.0 a4 = 1.0 |
| | | | | | | | | a5 = 0.0 |
| | | 49129 | 51548 | 45 | 71 | 1/16 | 8par | a0 = 0.000212 a1 = −0.00003 |
| | | | | | | BIC | | a2 = −0.057134 a3 = 0.0 |
| | | | | | | | | a4 = 0.0 a5 = −0.051758 |
| | | | | | | | | a6 = −0.020597 a7 = 7.0 |
| 8 | 7 | 200582 | 188583 | 269 | 75 | | | |
| | | 146402 | 135954 | 213 | 19 | ⅛ | 6par | a0 = 1.0 a1 = −0.000977 |
| | | | | | | HEVC | | a2 = 0.25 a3 = 0.000488 |
| | | | | | | | | a4 = 1.0 a5 = 0.0 |
| | | 54180 | 52629 | 56 | 54 | ⅛ | 8par | a0 = −0.000008 |
| | | | | | | HEVC | | a1 = −0.000013 |
| | | | | | | | | a2 = 0.004182 a3 = 0.000977 |
| | | | | | | | | a4 = −6.0 a5 = 0.004395 |
| | | | | | | | | a6 = 0.002762 a7 = 0.0 |
| 9 | 8 | 213050 | 192488 | 300 | 46 | | | |
| | | 157005 | 139785 | 234 | 16 | ⅛ | 6par | a0 = 1.0 a1 = −0.002441 |
| | | | | | | HEVC | | a2 = 0.25 a3 = 0.001465 |
| | | | | | | | | a4 = 1.0 a5 = 0.0 |
| | | 56045 | 52703 | 66 | 28 | ⅛ | 6par | a0 = l.000488 a1 = −0.000977 |
| | | | | | | HEVC | | a2 = −1.75 a3 = 0.000488 |
| | | | | | | | | a4 = 1.0 a5 = 0.25 |
| 10 | 9 | 209863 | 212980 | 232 | 64 | | | |
| | | 155920 | 153900 | 193 | 43 | ⅛ | 8par | a0 = −0.0 a1 = −0.0 |
| | | | | | | HEVC | | a2 = 0.000868 a3 = −0.006836 |
| | | | | | | | | a4 = 1.0 a5 = 0.004395 |
| | | | | | | | | a6 = 0.00071 a7 = 0.0 |
| | | 53943 | 59080 | 39 | 19 | ⅛ | 4par | a0 = 1.0 a1 = −1.75 |
| | | | | | | HEVC | | a2 = 1.000977 a3 = 0.0 |
| 11 | 10 | 187940 | 199108 | 200 | 37 | | | |
| | | 143245 | 141634 | 184 | 17 | ⅛ | 6par | a0 = 0.999512 a1 = −0.001953 |
| | | | | | | HEVC | | a2 = 0.5 a3 = 0.0 |
| | | | | | | | | a4 = 1.0 a5 = 0.0 |
| | | 44695 | 57474 | 16 | 18 | ⅛ | 4par | a0 = 1.0 a1 = −1.5 |
| | | | | | | HEVC | | a2 = 0.999023 a3 = 0.0 |
| 12 | 11 | 210591 | 202473 | 235 | 49 | | | |
| | | 159901 | 148231 | 195 | 20 | ⅛ | 6par | a0 = 1.0 a1 = −0.003418 |
| | | | | | | HEVC | | a2 = 1.0 a3 = 0.001465 |
| | | | | | | | | a4 = 1.0 a5 = 0.0 |
| | | 50690 | 54242 | 40 | 27 | ⅛ | 6par | a0 = 1.000488 a1= −0.000977 |
| | | | | | | HEVC | | a2 = −1.0 a3 = 0.001465 |
| | | | | | | | | a4 = 1.000977 a5 = −0.25 |
| 13 | 12 | 206503 | 211452 | 212 | 41 | | | |
| | | 150555 | 146944 | 189 | 20 | ⅛ | 6par | a0 = 1.0 a1 = −0.003418 |
| | | | | | | HEVC | | a2 = 1.5 a3 = 0.001465 |
| | | | | | | | | a4 = 1.0 a5 = 0.0 |
| | | 55948 | 64508 | 23 | 19 | 1/16 | 4par | a0 = 1.001465 a1 = −1.0 |
| | | | | | | BIC | | a2 = 1.000977 a3 = 0.0 |
| 14 | 13 | 220126 | 230887 | 178 | 49 | | | |
| | | 158717 | 162731 | 143 | 21 | ⅛ | 6par | a0 = 1.0 a1 = −0.003418 |
| | | | | | | HEVC | | a2 = 1.75 a3 = 0.001953 |
| | | | | | | | | a4 = 0.999023 a5 = 0.25 |
| | | 61409 | 68156 | 35 | 26 | ⅛ | 6par | a0 = 1.000488 |
| | | | | | | HEVC | | a1 = −0.000977 |
| | | | | | | | | a2 = −0.25 a3 = 0.0 |
| | | | | | | | | a4 = 0.999023 a5 = 0.5 |
| 15 | 14 | 216806 | 214247 | 236 | 94 | | | |
| | | 156268 | 157991 | 174 | 30 | ⅛ | 6par | a0 = 1.0 a1 = −0.002441 |
| | | | | | | HEVC | | a2 = 2.25 a3 =0.000488 |
| | | | | | | | | a4 = 1.0 a5 = −0.5 |
| | | 60538 | 56256 | 62 | 62 | ⅛ | 8par | a0 = −0.000028 a1 = 0.000009 |
| | | | | | | HEVC | | a2 = 0.002131 |
| | | | | | | | | a3 = −0.005371 |
| | | | | | | | | a4 = 2.0 a5 = 0.017578 |
| | | | | | | | | a6 = −0.000237 a7 = −4.0 |
| 16 | 15 | 204315 | 184048 | 308 | 99 | | | |
| | | 149776 | 136328 | 230 | 47 | ⅛ | 8par | a0 = 0.000019 |
| | | | | | | HEVC | | a1 = −0.000007 |
| | | | | | | | | a2 = −0.005445 |
| | | | | | | | | a3 = −0.008789 |
| | | | | | | | | a4 = 9.0 a5 = 0.000488 |
| | | | | | | | | a6 = 0.0 a7 = −4.0 |
| | | 54539 | 47720 | 78 | 50 | 1/16 | 8par | a0 = 0.000042 a1 = 0.000002 |
| | | | | | | BIC | | a2 = −0.016572 |
| | | | | | | | | a3 = −0.002441 |
| | | | | | | | | a4 = 3.0 a5 = −0.001465 |
| | | | | | | | | a6 = −0.008207 a7 = −3.0 |
| 17 | 16 | 220697 | 235234 | 184 | 58 | | | |
| | | 163720 | 180242 | 138 | 29 | ⅛ | 6par | a0 = 1.0 a1 = −0.004395 |
| | | | | | | HEVC | | a2 = 2.0 a3 = 0.001465 |
| | | | | | | | | a4 = 1.000977 a5 = −0.75 |
| | | 56977 | 54992 | 46 | 27 | ⅛ | 6par | a0 = 0.999512 a1 = −0.000977 |
| | | | | | | HEVC | | a2 = 0.0 a3 = 0.000488 |
| | | | | | | | | a4 = 1.0 a5 = −0.5 |
| 18 | 17 | 212522 | 208490 | 241 | 49 | | | |
| | | 157953 | 155194 | 186 | 22 | ⅛ | 6par | a0 = 1.0 a1 = −0.003418 |
| | | | | | | HEVC | | a2 = 1.5 a3 = 0.001953 |
| | | | | | | | | a4 = 1.0 a5 = −0.75 |
| | | 54569 | 53296 | 55 | 25 | ⅛ | 6par | a0 = 1.0 a1 = −0.000977 |
| | | | | | | HEVC | | a2 = −0.5 a3 = 0.001953 |
| | | | | | | | | a4 = 1.0 a5 = −0.75 |
| 19 | 18 | 202083 | 210725 | 179 | 83 | | | |
| | | 150404 | 157936 | 127 | 23 | ⅛ | 6par | a0 = 1.0 a1 = −0.002441 |
| | | | | | | HEVC | | a2 = 1.25 a3 = 0.001465 |
| | | | | | | | | a4 = 1.0 a5 = −0.5 |
| | | 51679 | 52789 | 52 | 58 | ⅛ | 8par | a0 = 0.000063 a1 = 0.000018 |
| | | | | | | HEVC | | a2 = −0.026752 |
| | | | | | | | | a3 = −0.005371 |
| | | | | | | | | a4 = 0.0 a5 = −0.004395 |
| | | | | | | | | a6 = −0.015388 a7 = 0.0 |
| 20 | 19 | 228566 | 222360 | 263 | 78 | | | |
| | | 164540 | 155123 | 209 | 23 | ⅛ | 6par | a0 = 1.0 a1 = −0.001953 |
| | | | | | | HEVC | | a2 = 1.5 a3 = 0.0 |
| | | | | | | | | a4 = 1.000977 |
| | | | | | | | | a5 = −0.75 |
| | | 64026 | 67237 | 54 | 53 | ⅛ | 8par | a0 = 0.000062 a1 = 0.000025 |
| | | | | | | HEVC | | a2 = −0.016651 |
| | | | | | | | | a3 = −0.000977 |
| | | | | | | | | a4 = −1.0 a5 = −0.01709 |
| | | | | | | | | a6 = −0.022333 a7 = 2.0 |
| 21 | 20 | 214900 | 231231 | 183 | 94 | | | |
| | | 160630 | 167022 | 147 | 22 | ⅛ | 6par | a0 = 1.0 a1 = −0.003418 |
| | | | | | | HEVC | | a2 = 2.0 a3 = 0.001465 |
| | | | | | | | | a4 = 1.0 a5 = −0.5 |
| | | 54270 | 64209 | 36 | 70 | ⅛ | 8par | a0 = 0.000284 a1 = −0.000052 |
| | | | | | | HEVC | | a2 = −0.078993 a3 = 0.001953 |
| | | | | | | | | a4 = 6.0 a5 = −0.063965 |
| | | | | | | | | a6 = −0.027304 a7 = 8.0 |
| 22 | 21 | 210792 | 212656 | 249 | 48 | | | |
| | | 157735 | 154479 | 204 | 25 | ⅛ | 6par | a0 = 1.0 a1 = −0.001953 |
| | | | | | | HEVC | | a2 = 1.5 a3 = 0.000488 |
| | | | | | | | | a4 = 1.0 a5 = 0.0 |
| | | 53057 | 58177 | 45 | 21 | ⅛ | 4par | a0 = 1.001953 a1 = −0.75 |
| | | | | | | HEVC | | a2 = 0.998047 a3 = 0.5 |
| 23 | 22 | 209067 | 203311 | 273 | 40 | | | |
| | | 157811 | 152582 | 206 | 23 | ⅛ | 6par | a0 = 1.0 a1 = −0.001953 |
| | | | | | | HEVC | | a2 = 1.0 a3 = 0.000488 |
| | | | | | | | | a4 = 0.999023 a5 = 0.25 |
| | | 51256 | 50729 | 67 | 15 | ⅛ | 4par | a0 = 1.000488 a1 = −1.0 |
| | | | | | | HEVC | | a2 = 1.0 a3 = 0.25 |
| 24 | 23 | 192579 | 188654 | 239 | 87 | | | |
| | | 144162 | 140398 | 191 | 16 | ⅛ | 6par | a0 = 1.0 a1 = −0.002441 |
| | | | | | | HEVC | | a2 = 1.0 a3 = 0.0 a4 = 1.0 |
| | | | | | | | | a5 = 0.0 |
| | | 48417 | 48256 | 48 | 69 | 1/16 | 8par | a0 = 0.00017 a1=0.000012 |
| | | | | | | BIC | | a2 = −0.063289 |
| | | | | | | | | a3 = −0.003418 a4 = 2.0 |
| | | | | | | | | a5 = −0.039551 |
| | | | | | | | | a6 = −0.031566 a7 = 7.0 |
| 25 | 24 | 210923 | 202512 | 272 | 43 | | | |
| | | 153889 | 146668 | 208 | 20 | ⅛ | 6par | a0 = 1.0 a1 = −0.000977 |
| | | | | | | HEVC | | a2 = 1.0 a3 = 0.0 a4 = 1.0 |
| | | | | | | | | a5 = −0.25 |
| | | 57034 | 55844 | 64 | 21 | ⅛ | 4par | a0 = 1.0 a1 = −0.75 a2 = 1.0 |
| | | | | | | HEVC | | a3 = −0.25 |
| 26 | 25 | 220190 | 237977 | 184 | 96 | | | |
| | | 159167 | 158211 | 158 | 22 | ⅛ | 6par | a0 = 0.999512 |
| | | | | | | HEVC | | a1 = −0.002441 a2 = 1.75 |
| | | | | | | | | a3 = 0.001465 |
| | | | | | | | | a4 = 1.0 a5 = 0.25 |
| | | 61023 | 79766 | 26 | 72 | ⅛ | 8par | a0 = 0.000044 a1 = −0.00007 |
| | | | | | | HEVC | | a2 = 0.000158 a3 = 0.010254 |
| | | | | | | | | a4 = −3.0 a5 = −0.022949 |
| | | | | | | | | a6 = 0.009075 a7 = 5.0 |
| 27 | 26 | 217409 | 242732 | 182 | 41 | | | |
| | | 167075 | 196924 | 122 | 16 | ⅛ | 6par | a0 = 1.0 a1 = −0.003418 |
| | | | | | | HEVC | | a2 = 2.0 a3 = 0.001465 |
| | | | | | | | | a4 = 1.0 a5 = 0.25 |
| | | 50334 | 45808 | 60 | 23 | ⅛ | 6par | a0 = 1.0 a1 = −0.000977 |
| | | | | | | HEVC | | a2 = 0.0 a3 = 0.001465 |
| | | | | | | | | a4 = 1.0 a5 = 0.25 |
| 28 | 27 | 201569 | 201045 | 217 | 110 | | | |
| | | 147695 | 148409 | 160 | 48 | ⅛ | 8par | a0 = 0.000018 a1 = −0.000012 |
| | | | | | | HEVC | | a2 = −0.003 867 a3 = −0.013672 |
| | | | | | | | | a4 = 9.0 a5 = 0.004883 |
| | | | | | | | | a6 = 0.001341 a7 = 0.0 |
| | | 53874 | 52636 | 57 | 60 | ⅛ | 8par | a0 = 0.000091 a1 = 0.000009 |
| | | | | | | HEVC | | a2 = −0.032591 a3 = −0.008789 |
| | | | | | | | | a4 = 4.0 a5 = −0.010742 |
| | | | | | | | | a6 = −0.02036 a7 = 3.0 |
| 29 | 28 | 200677 | 195462 | 239 | 79 | | | |
| | | 149224 | 146386 | 178 | 49 | ⅛ | 8par | a0 = 0.000027 a1 = −0.000001 |
| | | | | | | HEVC | | a2 = −0.009075 a3 = −0.017578 |
| | | | | | | | | a4 = 10.0 a5 = 0.006348 |
| | | | | | | | | a6 = −0.004656 a7 = −2.0 |
| | | 51453 | 49076 | 61 | 28 | ⅛ | 6par | a0 = 0.999512 a1 = −0.002441 |
| | | | | | | HEVC | | a2 = 0.5 a3 = 0.001953 |
| | | | | | | | | a4 = 1.0 a5 = −0.5 |
| 30 | 29 | 200552 | 202578 | 206 | 51 | | | |
| | | 149921 | 150478 | 158 | 26 | ⅛ | 6par | a0 = 1.0 a1 = −0.004395 |
| | | | | | | HEVC | | a2 = 2.25 a3 = 0.001953 |
| | | | | | | | | a4 = 1.0 a5 = −0.5 |
| | | 50631 | 52100 | 48 | 23 | ⅛ | 6par | a0 = 1.0 a1 = −0.001953 |
| | | | | | | HEVC | | a2 = 0.25 a3 = 0.001465 |
| | | | | | | | | a4 = 1.000977 a5 = −0.5 |
| 31 | 30 | 203812 | 236197 | 155 | 70 | | | |
| | | 147832 | 147935 | 153 | 49 | ⅛ | 8par | a0 = 0.000015 a1 =0.0 |
| | | | | | | HEVC | | a2 = −0.004498 a3 = −0.016602 |
| | | | | | | | | a4 = 8.0 a5 = 0.007813 |
| | | | | | | | | a6 = −0.001736 a7 = −1.0 |
| | | 55980 | 88262 | 2 | 19 | ⅛ | 4par | a0 = 1.0 a1 = −0.25 |
| | | | | | | AVC | | a2 = 0.998047 a3 = 0.25 |
| 32 | 31 | 203885 | 223401 | 180 | 55 | | | |
| | | 148303 | 151917 | 149 | 27 | ⅛ | 6par | a0 = 1.0 a1 = −0.004395 |
| | | | | | | HEVC | | a2 = 2.0 a3 = 0.001953 |
| | | | | | | | | a4 = 1.0 a5 = −0.25 |
| | | 55582 | 71484 | 31 | 26 | ⅛ | 6par | a0 = 1.000488 a1 = −0.001953 |
| | | | | | | HEVC | | a2 = 0.0 a3 = −0.001465 |
| | | | | | | | | a4 = 0.998047 a5 = 0.5 |

TABLE 11
SAD Results of RMM for CIF “Flower” sequence (33 frames) with Low Delay IPP
pictures:

| F | R | Ref SAD | RMMs SAD | NBB | Bits | SP Filter | Mod | RMMs Parameters |
|---|---|---|---|---|---|---|---|---|
| 1 | 0 | 527540 | 708926 | 63 | 182 | | | |
| | | 45730 | 117600 | 15 | 112 | 1/16 | 8 par | a0 = −0.000199 |
| | | | | | | BIL | | a1 = −0.000272 |
| | | | | | | | | a2 = 0.094302 |
| | | | | | | | | a3 = −0.048828 |
| | | | | | | | | a4 = 5.0 |
| | | | | | | | | a5 = 0.003418 |
| | | | | | | | | a6 = 0.056108 |
| | | | | | | | | a7 = −3.0 |
| | | 406573 | 462448 | 46 | 31 | 1/8 | 6 par | a0 = 1.001953 |
| | | | | | | HEVC | | a1 = 0.010254 |
| | | | | | | | | a2 = −1.25 |
| | | | | | | | | a3 = 0.0 |
| | | | | | | | | a4 = 1.0 |
| | | | | | | | | a5 = −0.25 |
| | | 75237 | 128878 | 2 | 33 | 1/16 | 4 par | a0 = 0.993652 |
| | | | | | | BIC | | a1 = 7.25 |
| | | | | | | | | a2 = 1.005371 |
| | | | | | | | | a3 = −1.75 |
| 2 | 1 | 463009 | 633694 | 63 | 152 | | | |
| | | 44411 | 111541 | 8 | 79 | 1/16 | 8 par | a0 = −0.000038 |
| | | | | | | BIL | | a1 = −0.000005 |
| | | | | | | | | a2 = 0.016888 |
| | | | | | | | | a3 = −0.054688 |
| | | | | | | | | a4 = 9.0 |
| | | | | | | | | a5 = −0.003418 |
| | | | | | | | | a6 = −0.001263 |
| | | | | | | | | a7 = 0.0 |
| | | 346868 | 413480 | 48 | 28 | 1/8 | 6 par | a0 = 1.001465 |
| | | | | | | HEVC | | a1 = 0.009766 |
| | | | | | | | | a2 = −1.0 |
| | | | | | | | | a3 = −0.000488 |
| | | | | | | | | a4 = 1.0 |
| | | | | | | | | a5 = 0.0 |
| | | 71730 | 108673 | 7 | 43 | 1/16 | 6 par | a0 = 1.007813 |
| | | | | | | BIC | | a1 = 0.003418 |
| | | | | | | | | a2 = 3.25 |
| | | | | | | | | a3 = 0.001465 |
| | | | | | | | | a4 = 1.005371 |
| | | | | | | | | a5 = −2.0 |
| 3 | 2 | 355197 | 513141 | 75 | 122 | | | |
| | | 44273 | 111547 | 10 | 68 | 1/16 | 8 par | a0 = −0.000126 |
| | | | | | | BIL | | a1 = −0.000215 |
| | | | | | | | | a2 = 0.048532 |
| | | | | | | | | a3 = −0.050293 |
| | | | | | | | | a4 = 8.0 |
| | | | | | | | | a5 = −0.00293 |
| | | | | | | | | a6 = 0.038826 |
| | | | | | | | | a7 = 0.0 |
| | | 240094 | 309241 | 44 | 20 | 1/8 | 6 par | a0 = 1.001953 |
| | | | | | | HEVC | | a1 = 0.01123 |
| | | | | | | | | a2 = −1.25 |
| | | | | | | | | a3 = 0.0 |
| | | | | | | | | a4 = 1.0 |
| | | | | | | | | a5 = 0.0 |
| | | 70830 | 92353 | 21 | 32 | 1/16 | 6 par | a0 = 1.012207 |
| | | | | | | BIC | | a1 = 0.003418 |
| | | | | | | | | a2 = 2.5 |
| | | | | | | | | a3 = −0.00293 |
| | | | | | | | | a4 = 1.005371 |
| | | | | | | | | a5 = −0.75 |
| 4 | 3 | 327923 | 486773 | 65 | 110 | | | |
| | | 42272 | 106832 | 12 | 62 | 1/16 | 8 par | a0 = −0.00021 |
| | | | | | | BIL | | a1 = −0.000311 |
| | | | | | | | | a2 = 0.082071 |
| | | | | | | | | a3 = −0.048828 |
| | | | | | | | | a4 = 7.0 |
| | | | | | | | | a5 = −0.003418 |
| | | | | | | | | a6 = 0.066288 |
| | | | | | | | | a7 = −1.0 |
| | | 210086 | 277605 | 51 | 19 | 1/8 | 6 par | a0 = 1.001953 |
| | | | | | | HEVC | | a1 = 0.010254 |
| | | | | | | | | a2 = −1.25 |
| | | | | | | | | a3 = 0.0 |
| | | | | | | | | a4 = 1.0 |
| | | | | | | | | a5 = 0.0 |
| | | 75565 | 102336 | 2 | 27 | 1/16 | 6 par | a0 = 1.012207 |
| | | | | | | BIC | | a1 = 0.002441 |
| | | | | | | | | a2 = 2.25 |
| | | | | | | | | a3 = −0.00293 |
| | | | | | | | | a4 = 1.005371 |
| | | | | | | | | a5 = −0.75 |
| 5 | 4 | 424389 | 559797 | 74 | 103 | | | |
| | | 43770 | 100412 | 12 | 54 | 1/16 | 8 par | a0 = −0.000111 |
| | | | | | | BIC | | a1 = −0.00017 |
| | | | | | | | | a2 = 0.043324 |
| | | | | | | | | a3 = −0.035645 |
| | | | | | | | | a4 = 6.0 |
| | | | | | | | | a5 = −0.001465 |
| | | | | | | | | a6 = 0.038905 |
| | | | | | | | | a7 = −1.0 |
| | | 298487 | 352855 | 55 | 17 | 1/8 | 6 par | a0 = 1.001953 |
| | | | | | | HEVC | | a1 = 0.010254 |
| | | | | | | | | a2 = −1.25 |
| | | | | | | | | a3 = −0.000488 |
| | | | | | | | | a4 = 1.0 |
| | | | | | | | | a5 = 0.0 |
| | | 82132 | 106530 | 7 | 30 | 1/16 | 6 par | a0 = 1.008301 |
| | | | | | | BIC | | a1 = 0.002441 |
| | | | | | | | | a2 = 3.0 |
| | | | | | | | | a3 = −0.004883 |
| | | | | | | | | a4 = 1.004395 |
| | | | | | | | | a5 = −0.25 |
| 6 | 5 | 426906 | 571831 | 73 | 120 | | | |
| | | 48326 | 119744 | 15 | 62 | 1/16 | 8 par | a0 = −0.000073 |
| | | | | | | BIL | | a1 = −0.000061 |
| | | | | | | | | a2 = 0.041509 |
| | | | | | | | | a3 = −0.055664 |
| | | | | | | | | a4 = 7.0 |
| | | | | | | | | a5 = −0.003418 |
| | | | | | | | | a6 = 0.02257 |
| | | | | | | | | a7 = −2.0 |
| | | 297729 | 339208 | 52 | 23 | 1/8 | 6 par | a0 = 1.00293 |
| | | | | | | HEVC | | a1 = 0.01123 |
| | | | | | | | | a2 = −1.5 |
| | | | | | | | | a3 = −0.000488 |
| | | | | | | | | a4 = 1.0 |
| | | | | | | | | a5 = 0.0 |
| | | 80851 | 112879 | 6 | 33 | 1/16 | 6 par | a0 = 1.01123 |
| | | | | | | BIL | | a1 = 0.004395 |
| | | | | | | | | a2 = 2.0 |
| | | | | | | | | a3 = 0.0 |
| | | | | | | | | a4 = 1.004395 |
| | | | | | | | | a5 = −1.25 |
| 7 | 6 | 381103 | 561953 | 73 | 170 | | | |
| | | 42289 | 119515 | 9 | 63 | 1/16 | 8 par | a0 = −0.000166 |
| | | | | | | BIL | | a1 = −0.000096 |
| | | | | | | | | a2 = 0.058949 |
| | | | | | | | | a3 = −0.064453 |
| | | | | | | | | a4 = 8.0 |
| | | | | | | | | a5 = −0.007813 |
| | | | | | | | | a6 = 0.015309 |
| | | | | | | | | a7 = 1.0 |
| | | 267467 | 331981 | 56 | 24 | 1/8 | 6 par | a0 = 1.00293 |
| | | | | | | HEVC | | a1 = 0.010254 |
| | | | | | | | | a2 = −1.25 |
| | | | | | | | | a3 = −0.000488 |
| | | | | | | | | a4 = 1.0 |
| | | | | | | | | a5 = 0.0 |
| | | 71347 | 110457 | 8 | 81 | 1/16 | 8 par | a0 = −0.000012 |
| | | | | | | BIC | | a1 = 0.000058 |
| | | | | | | | | a2 = 0.075442 |
| | | | | | | | | a3 = 0.000977 |
| | | | | | | | | a4 = 4.0 |
| | | | | | | | | a5 = 0.009277 |
| | | | | | | | | a6 = 0.001815 |
| | | | | | | | | a7 = −6.0 |
| 8 | 7 | 361055 | 546999 | 54 | 108 | | | |
| | | 39855 | 117321 | 10 | 51 | 1/16 | 8 par | a0 = −0.000185 |
| | | | | | | BIL | | a1 = −0.000304 |
| | | | | | | | | a2 = 0.0756 |
| | | | | | | | | a3 = −0.049316 |
| | | | | | | | | a4 = 6.0 |
| | | | | | | | | a5 = 0.001465 |
| | | | | | | | | a6 = 0.074968 |
| | | | | | | | | a7 = −3.0 |
| | | 238230 | 321802 | 39 | 26 | 1/16 | 6 par | a0 = 1.001953 |
| | | | | | | BIC | | a1 = 0.01123 |
| | | | | | | | | a2 = −1.25 |
| | | | | | | | | a3 = 0.0 |
| | | | | | | | | a4 = 1.0 |
| | | | | | | | | a5 = 0.0 |
| | | 82970 | 107876 | 5 | 29 | 1/16 | 6 par | a0 = 1.012207 |
| | | | | | | BIC | | a1 = 0.004395 |
| | | | | | | | | a2 = 2.25 |
| | | | | | | | | a3 = −0.005859 |
| | | | | | | | | a4 = 1.005371 |
| | | | | | | | | a5 = −0.25 |
| 9 | 8 | 332791 | 521954 | 51 | 103 | | | |
| | | 47542 | 120929 | 12 | 64 | 1/16 | 8 par | a0 = −0.000136 |
| | | | | | | BIL | | a1 = −0.000089 |
| | | | | | | | | a2 = 0.043403 |
| | | | | | | | | a3 = −0.063477 |
| | | | | | | | | a4 = 9.0 |
| | | | | | | | | a5 = 0.009277 |
| | | | | | | | | a6 = 0.023122 |
| | | | | | | | | a7 = −2.0 |
| | | 206465 | 291211 | 39 | 7 | 1/8 | 6 par | a0 = 1.001953 |
| | | | | | | HEVC | | a1 = 0.01123 |
| | | | | | | | | a2 = −1.25 |
| | | | | | | | | a3 = 0.0 |
| | | | | | | | | a4 = 1.0 |
| | | | | | | | | a5 = 0.0 |
| | | 78784 | 109814 | 0 | 30 | 1/16 | 6 par | a0 = 1.009277 |
| | | | | | | BIC | | a1 = 0.003418 |
| | | | | | | | | a2 = 3.0 |
| | | | | | | | | a3 = −0.003418 |
| | | | | | | | | a4 = 1.004395 |
| | | | | | | | | a5 = −0.5 |
| 10 | 9 | 327951 | 513992 | 38 | 104 | | | |
| | | 38317 | 98346 | 9 | 62 | 1/16 | 8 par | a0 = −0.000248 |
| | | | | | | BIL | | a1 = −0.000314 |
| | | | | | | | | a2 = 0.079782 |
| | | | | | | | | a3 = −0.052734 |
| | | | | | | | | a4 = 9.0 |
| | | | | | | | | a5 = 0.026367 |
| | | | | | | | | a6 = 0.099195 |
| | | | | | | | | a7 = −7.0 |
| | | 211145 | 311970 | 26 | 19 | 1/16 | 6 par | a0 = 1.001953 |
| | | | | | | BIC | | a1 = 0.010254 |
| | | | | | | | | a2 = −1.0 |
| | | | | | | | | a3 = 0.0 |
| | | | | | | | | a4 = 1.0 |
| | | | | | | | | a5 = 0.0 |
| | | 78489 | 103676 | 3 | 21 | 1/16 | 6 par | a0 = 1.01123 |
| | | | | | | BIC | | a1 = 0.004395 |
| | | | | | | | | a2 = 2.5 |
| | | | | | | | | a3 = −0.004883 |
| | | | | | | | | a4 = 1.004395 |
| | | | | | | | | a5 = −0.25 |
| 11 | 10 | 427390 | 570389 | 88 | 109 | | | |
| | | 37991 | 96276 | 11 | 61 | 1/16 | 8 par | a0 = −0.00021 |
| | | | | | | BIL | | a1 = −0.000012 |
| | | | | | | | | a2 = 0.059501 |
| | | | | | | | | a3 = −0.078125 |
| | | | | | | | | a4 = 9.0 |
| | | | | | | | | a5 = 0.016113 |
| | | | | | | | | a6 = 0.016098 |
| | | | | | | | | a7 = −3.0 |
| | | 309698 | 374240 | 67 | 18 | 1/8 | 6 par | a0 = 1.001953 |
| | | | | | | HEVC | | a1 = 0.01123 |
| | | | | | | | | a2 = −1.25 |
| | | | | | | | | a3 = −0.000488 |
| | | | | | | | | a4 = 1.0 |
| | | | | | | | | a5 = 0.0 |
| | | 79701 | 99873 | 10 | 28 | 1/16 | 6 par | a0 = 1.018555 |
| | | | | | | BIC | | a1 = 0.003418 |
| | | | | | | | | a2 = 1.25 |
| | | | | | | | | a3 = −0.005859 |
| | | | | | | | | a4 = 1.004395 |
| | | | | | | | | a5 = −0.25 |
| 12 | 11 | 501845 | 607990 | 96 | 177 | | | |
| | | 40898 | 82668 | 7 | 64 | 1/16 | 8 par | a0 = −0.000185 |
| | | | | | | BIC | | a1 = −0.000143 |
| | | | | | | | | a2 = 0.047191 |
| | | | | | | | | a3 = −0.055664 |
| | | | | | | | | a4 = 9.0 |
| | | | | | | | | a5 = 0.015625 |
| | | | | | | | | a6 = 0.048611 |
| | | | | | | | | a7 = −4.0 |
| | | 358061 | 388183 | 87 | 79 | 1/8 | 8 par | a0 = −0.000003 |
| | | | | | | HEVC | | a1 = −0.000003 |
| | | | | | | | | a2 = 0.013573 |
| | | | | | | | | a3 = 0.050293 |
| | | | | | | | | a4 = −7.0 |
| | | | | | | | | a5 = 0.0 |
| | | | | | | | | a6 = 0.003551 |
| | | | | | | | | a7 = −1.0 |
| | | 102886 | 137139 | 2 | 32 | 1/16 | 6 par | a0 = 1.012207 |
| | | | | | | BIL | | a1 = 0.002441 |
| | | | | | | | | a2 = 2.5 |
| | | | | | | | | a3 = −0.001465 |
| | | | | | | | | a4 = 1.004395 |
| | | | | | | | | a5 = −1.0 |
| 13 | 12 | 570213 | 721544 | 57 | 114 | | | |
| | | 37039 | 75890 | 11 | 58 | 1/16 | 8 par | a0 = −0.000198 |
| | | | | | | BIC | | a1 = −0.000189 |
| | | | | | | | | a2 = 0.057923 |
| | | | | | | | | a3 = −0.061523 |
| | | | | | | | | a4 = 11.0 |
| | | | | | | | | a5 = 0.01123 |
| | | | | | | | | a6 = 0.063684 |
| | | | | | | | | a7 = −5.0 |
| | | 428744 | 509305 | 38 | 28 | 1/8 | 6 par | a0 = 1.001953 |
| | | | | | | AVC | | a1 = 0.009766 |
| | | | | | | | | a2 = −1.0 |
| | | | | | | | | a3 = 0.0 |
| | | | | | | | | a4 = 1.0 |
| | | | | | | | | a5 = −0.25 |
| | | 104430 | 136349 | 8 | 26 | 1/16 | 6 par | a0 = 1.012207 |
| | | | | | | BIC | | a1 = 0.003418 |
| | | | | | | | | a2 = 2.5 |
| | | | | | | | | a3 = −0.004395 |
| | | | | | | | | a4 = 1.004395 |
| | | | | | | | | a5 = −0.75 |
| 14 | 13 | 635293 | 815540 | 67 | 124 | | | |
| | | 40024 | 85155 | 16 | 64 | 1/16 | 8 par | a0 = −0.000256 |
| | | | | | | BIL | | a1 = −0.000206 |
| | | | | | | | | a2 = 0.06976 |
| | | | | | | | | a3 = −0.058105 |
| | | | | | | | | a4 = 9.0 |
| | | | | | | | | a5 = 0.02002 |
| | | | | | | | | a6 = 0.05303 |
| | | | | | | | | a7 = −4.0 |
| | | 486823 | 575803 | 44 | 27 | 1/8 | 6 par | a0 = 1.001953 |
| | | | | | | AVC | | a1 = 0.008789 |
| | | | | | | | | a2 = −0.75 |
| | | | | | | | | a3 = 0.0 |
| | | | | | | | | a4 = 1.000977 |
| | | | | | | | | a5 = −0.5 |
| | | 108446 | 154582 | 7 | 31 | 1/16 | 6 par | a0 = 1.017578 |
| | | | | | | BIC | | a1 = 0.005859 |
| | | | | | | | | a2 = 1.0 |
| | | | | | | | | a3 = −0.001953 |
| | | | | | | | | a4 = 1.004395 |
| | | | | | | | | a5 = −1.25 |
| 15 | 14 | 587789 | 759067 | 45 | 83 | | | |
| | | 36551 | 90176 | 7 | 29 | 1/16 | 4 par | a0 = 0.998535 |
| | | | | | | BIL | | a1 = 1.25 |
| | | | | | | | | a2 = 1.001953 |
| | | | | | | | | a3 = −0.25 |
| | | 447329 | 532092 | 37 | 24 | 1/8 | 6 par | a0 = 1.001953 |
| | | | | | | AVC | | a1 = 0.010254 |
| | | | | | | | | a2 = −1.0 |
| | | | | | | | | a3 = 0.0 |
| | | | | | | | | a4 = 1.0 |
| | | | | | | | | a5 = −0.25 |
| | | 103909 | 136799 | 1 | 28 | 1/16 | 6 par | a0 = 1.012207 |
| | | | | | | BIC | | a1 = 0.004395 |
| | | | | | | | | a2 = 2.25 |
| | | | | | | | | a3 = −0.001953 |
| | | | | | | | | a4 = 1.005371 |
| | | | | | | | | a5 = −1.25 |
| 16 | 15 | 501674 | 666272 | 67 | 109 | | | |
| | | 36330 | 84353 | 14 | 71 | 1/16 | 8 par | a0 = −0.000135 |
| | | | | | | BIL | | a1 = 0.000061 |
| | | | | | | | | a2 = 0.019807 |
| | | | | | | | | a3 = −0.076172 |
| | | | | | | | | a4 = 12.0 |
| | | | | | | | | a5 = 0.007324 |
| | | | | | | | | a6 = −0.007102 |
| | | | | | | | | a7 = −1.0 |
| | | 374469 | 450975 | 53 | 7 | 1/16 | 6 par | a0 = 1.001953 |
| | | | | | | BIC | | a1 = 0.009766 |
| | | | | | | | | a2 = −1.0 |
| | | | | | | | | a3 = 0.0 |
| | | | | | | | | a4 = 1.0 |
| | | | | | | | | a5 = −0.25 |
| | | 90875 | 130944 | 0 | 29 | 1/16 | 6 par | a0 = 1.009277 |
| | | | | | | BIC | | a1 = 0.004395 |
| | | | | | | | | a2 = 2.5 |
| | | | | | | | | a3 = −0.001953 |
| | | | | | | | | a4 = 1.005371 |
| | | | | | | | | a5 = −1.0 |
| 17 | 16 | 558112 | 745882 | 64 | 112 | | | |
| | | 36202 | 90438 | 17 | 60 | 1/16 | 8 par | a0 = −0.000211 |
| | | | | | | BIL | | a1 = 0.000073 |
| | | | | | | | | a2 = 0.047743 |
| | | | | | | | | a3 = −0.078125 |
| | | | | | | | | a4 = 11.0 |
| | | | | | | | | a5 = 0.009766 |
| | | | | | | | | a6 = −0.003946 |
| | | | | | | | | a7 = −2.0 |
| | | 432775 | 518144 | 41 | 26 | 1/8 | 6 par | a0 = 1.001953 |
| | | | | | | AVC | | a1 = 0.010254 |
| | | | | | | | | a2 = −1.25 |
| | | | | | | | | a3 = 0.0 |
| | | | | | | | | a4 = 1.0 |
| | | | | | | | | a5 = −0.25 |
| | | 89135 | 137300 | 6 | 24 | 1/16 | 6 par | a0 = 1.009766 |
| | | | | | | BIC | | a1 = 0.004395 |
| | | | | | | | | a2 = 2.25 |
| | | | | | | | | a3 = −0.000488 |
| | | | | | | | | a4 = 1.003418 |
| | | | | | | | | a5 = −1.25 |
| 18 | 17 | 610278 | 797265 | 45 | 117 | | | |
| | | 36076 | 77759 | 5 | 59 | 1/16 | 8 par | a0 = −0.000219 |
| | | | | | | BIC | | a1 = −0.000059 |
| | | | | | | | | a2 = 0.050347 |
| | | | | | | | | a3 = −0.058105 |
| | | | | | | | | a4 = 9.0 |
| | | | | | | | | a5 = 0.016113 |
| | | | | | | | | a6 = 0.04143 |
| | | | | | | | | a7 = −4.0 |
| | | 477483 | 563868 | 39 | 25 | 1/8 | 6 par | a0 = 1.001465 |
| | | | | | | AVC | | a1 = 0.008789 |
| | | | | | | | | a2 = −0.75 |
| | | | | | | | | a3 = 0.0 |
| | | | | | | | | a4 = 1.000977 |
| | | | | | | | | a5 = −0.5 |
| | | 96719 | 155638 | 1 | 31 | 1/16 | 6 par | a0 = 1.001953 |
| | | | | | | BIC | | a1 = 0.004395 |
| | | | | | | | | a2 = 3.5 |
| | | | | | | | | a3 = −0.001465 |
| | | | | | | | | a4 = 1.004395 |
| | | | | | | | | a5 = −1.25 |
| 19 | 18 | 583351 | 796897 | 85 | 111 | | | |
| | | 36858 | 102943 | 11 | 57 | 1/16 | 8 par | a0 = −0.000265 |
| | | | | | | BIL | | a1 = −0.000012 |
| | | | | | | | | a2 = 0.069287 |
| | | | | | | | | a3 = −0.069336 |
| | | | | | | | | a4 = 9.0 |
| | | | | | | | | a5 = 0.008301 |
| | | | | | | | | a6 = 0.008286 |
| | | | | | | | | a7 = −1.0 |
| | | 461071 | 537714 | 73 | 24 | 1/8 | 6 par | a0 = 1.001953 |
| | | | | | | HEVC | | a1 = 0.010254 |
| | | | | | | | | a2 = −1.25 |
| | | | | | | | | a3 = −0.000488 |
| | | | | | | | | a4 = 1.0 |
| | | | | | | | | a5 = −0.25 |
| | | 85422 | 156240 | 1 | 28 | 1/16 | 6 par | a0 = 1.004395 |
| | | | | | | BIC | | a1 = 0.007813 |
| | | | | | | | | a2 = 2.5 |
| | | | | | | | | a3 = 0.0 |
| | | | | | | | | a4 = 1.003418 |
| | | | | | | | | a5 = −1.25 |
| 20 | 19 | 520348 | 723655 | 54 | 162 | | | |
| | | 49286 | 113793 | 14 | 62 | 1/16 | 8 par | a0 = −0.000269 |
| | | | | | | BIL | | a1 = 0.000099 |
| | | | | | | | | a2 = 0.061001 |
| | | | | | | | | a3 = −0.067871 |
| | | | | | | | | a4 = 9.0 |
| | | | | | | | | a5 = 0.02002 |
| | | | | | | | | a6 = 0.005287 |
| | | | | | | | | a7 = −4.0 |
| | | 391491 | 500959 | 36 | 26 | 1/16 | 6 par | a0 = 1.001953 |
| | | | | | | BIC | | a1 = 0.007813 |
| | | | | | | | | a2 = −0.75 |
| | | | | | | | | a3 = 0.0 |
| | | | | | | | | a4 = 1.0 |
| | | | | | | | | a5 = −0.25 |
| | | 79571 | 108903 | 4 | 72 | 1/16 | 8 par | a0 = −0.000083 |
| | | | | | | BIC | | a1 = 0.000048 |
| | | | | | | | | a2 = 0.064631 |
| | | | | | | | | a3 = 0.013184 |
| | | | | | | | | a4 = 7.0 |
| | | | | | | | | a5 = 0.003418 |
| | | | | | | | | a6 = 0.013021 |
| | | | | | | | | a7 = −5.0 |
| 21 | 20 | 515361 | 729143 | 62 | 123 | | | |
| | | 46284 | 107987 | 12 | 67 | 1/16 | 8 par | a0 = −0.000148 |
| | | | | | | BIC | | a1 = 0.000126 |
| | | | | | | | | a2 = 0.022964 |
| | | | | | | | | a3 = −0.057129 |
| | | | | | | | | a4 = 9.0 |
| | | | | | | | | a5 = 0.019043 |
| | | | | | | | | a6 = −0.007576 |
| | | | | | | | | a7 = −3.0 |
| | | 390388 | 508074 | 45 | 27 | 1/8 | 6 par | a0 = 1.001953 |
| | | | | | | HEVC | | a1 = 0.007813 |
| | | | | | | | | a2 = −0.75 |
| | | | | | | | | a3 = 0.000488 |
| | | | | | | | | a4 = 1.000977 |
| | | | | | | | | a5 = −0.5 |
| | | 78689 | 113082 | 5 | 27 | 1/8 | 6 par | a0 = 1.009277 |
| | | | | | | HEVC | | a1 = 0.003418 |
| | | | | | | | | a2 = 2.5 |
| | | | | | | | | a3 = 0.001953 |
| | | | | | | | | a4 = 1.005371 |
| | | | | | | | | a5 = −1.75 |
| 22 | 21 | 489436 | 669473 | 73 | 165 | | | |
| | | 39490 | 97641 | 11 | 67 | 1/16 | 8 par | a0 = −0.000117 |
| | | | | | | BIC | | a1 = −0.000061 |
| | | | | | | | | a2 = 0.022885 |
| | | | | | | | | a3 = −0.040039 |
| | | | | | | | | a4 = 8.0 |
| | | | | | | | | a5 = 0.003418 |
| | | | | | | | | a6 = 0.024305 |
| | | | | | | | | a7 = −2.0 |
| | | 371427 | 468717 | 54 | 66 | 1/16 | 8 par | a0 = −0.00004 |
| | | | | | | BIC | | a1 = −0.000038 |
| | | | | | | | | a2 = 0.029987 |
| | | | | | | | | a3 = 0.054688 |
| | | | | | | | | a4 = −8.0 |
| | | | | | | | | a5 = 0.007813 |
| | | | | | | | | a6 = 0.028567 |
| | | | | | | | | a7 = −5.0 |
| | | 78519 | 103115 | 8 | 30 | 1/16 | 6 par | a0 = 1.010742 |
| | | | | | | BIC | | a1 = 0.003418 |
| | | | | | | | | a2 = 2.5 |
| | | | | | | | | a3 = −0.001953 |
| | | | | | | | | a4 = 1.004395 |
| | | | | | | | | a5 = −1.0 |
| 23 | 22 | 339256 | 577831 | 39 | 117 | | | |
| | | 42344 | 124494 | 5 | 65 | 1/16 | 8 par | a0 = −0.000156 |
| | | | | | | BIL | | a1 = 0.000082 |
| | | | | | | | | a2 = 0.024305 |
| | | | | | | | | a3 = −0.060059 |
| | | | | | | | | a4 = 10.0 |
| | | | | | | | | a5 = 0.001465 |
| | | | | | | | | a6 = −0.015309 |
| | | | | | | | | a7 = 2.0 |
| | | 231224 | 362784 | 27 | 26 | 1/16 | 6 par | a0 = 1.001953 |
| | | | | | | BIC | | a1 = 0.010254 |
| | | | | | | | | a2 = −1.0 |
| | | | | | | | | a3 = 0.0 |
| | | | | | | | | a4 = 1.0 |
| | | | | | | | | a5 = 0.0 |
| | | 65688 | 90553 | 7 | 24 | 1/16 | 6 par | a0 = 1.010742 |
| | | | | | | BIC | | a1 = 0.004395 |
| | | | | | | | | a2 = 2.5 |
| | | | | | | | | a3 = −0.001465 |
| | | | | | | | | a4 = 1.004395 |
| | | | | | | | | a5 = −1.0 |
| 24 | 23 | 345407 | 575191 | 51 | 123 | | | |
| | | 40733 | 106777 | 11 | 71 | 1/16 | 8 par | a0 = −0.000155 |
| | | | | | | BIL | | a1 = −0.000216 |
| | | | | | | | | a2 = 0.046717 |
| | | | | | | | | a3 = −0.037109 |
| | | | | | | | | a4 = 9.0 |
| | | | | | | | | a5 = −0.000488 |
| | | | | | | | | a6 = 0.050505 |
| | | | | | | | | a7 = 0.0 |
| | | 230405 | 368017 | 34 | 22 | 1/16 | 6 par | a0 = 1.001953 |
| | | | | | | BIC | | a1 = 0.008789 |
| | | | | | | | | a2 = −0.75 |
| | | | | | | | | a3 = 0.0 |
| | | | | | | | | a4 = 1.0 |
| | | | | | | | | a5 = 0.0 |
| | | 74269 | 100397 | 6 | 28 | 1/16 | 6 par | a0 = 1.010742 |
| | | | | | | BIC | | a1 = 0.004395 |
| | | | | | | | | a2 = 2.75 |
| | | | | | | | | a3 = 0.000488 |
| | | | | | | | | a4 = 1.003418 |
| | | | | | | | | a5 = −1.0 |
| 25 | 24 | 406658 | 629120 | 67 | 112 | | | |
| | | 41968 | 124680 | 11 | 60 | 1/16 | 8 par | a0 = −0.000191 |
| | | | | | | BIL | | a1 = 0.00004 |
| | | | | | | | | a2 = 0.047348 |
| | | | | | | | | a3 = −0.055664 |
| | | | | | | | | a4 = 9.0 |
| | | | | | | | | a5 = 0.005859 |
| | | | | | | | | a6 = 0.009233 |
| | | | | | | | | a7 = −2.0 |
| | | 300550 | 425958 | 39 | 21 | 1/16 | 6 par | a0 = 1.001953 |
| | | | | | | BIC | | a1 = 0.009766 |
| | | | | | | | | a2 = −0.75 |
| | | | | | | | | a3 = −0.000488 |
| | | | | | | | | a4 = 1.0 |
| | | | | | | | | a5 = 0.0 |
| | | 64140 | 78482 | 17 | 29 | 1/16 | 6 par | a0 = 1.013672 |
| | | | | | | BIC | | a1 = 0.004395 |
| | | | | | | | | a2 = 2.5 |
| | | | | | | | | a3 = −0.00293 |
| | | | | | | | | a4 = 1.004395 |
| | | | | | | | | a5 = −0.75 |
| 26 | 25 | 347566 | 564716 | 49 | 150 | | | |
| | | 36781 | 85995 | 5 | 72 | 1/16 | 8 par | a0 = −0.000206 |
| | | | | | | BIL | | a1 = −0.000124 |
| | | | | | | | | a2 = 0.047191 |
| | | | | | | | | a3 = −0.054688 |
| | | | | | | | | a4 = 10.0 |
| | | | | | | | | a5 = 0.018555 |
| | | | | | | | | a6 = 0.036853 |
| | | | | | | | | a7 = −3.0 |
| | | 233120 | 383709 | 32 | 46 | 1/16 | 8 par | a0 = −0.000041 |
| | | | | | | BIC | | a1 = −0.000036 |
| | | | | | | | | a2 = 0.031013 |
| | | | | | | | | a3 = 0.052246 |
| | | | | | | | | a4 = −7.0 |
| | | | | | | | | a5 = 0.008301 |
| | | | | | | | | a6 = 0.026436 |
| | | | | | | | | a7 = −4.0 |
| | | 77665 | 95012 | 12 | 30 | 1/16 | 6 par | a0 = 1.012695 |
| | | | | | | BIC | | a1 = 0.004395 |
| | | | | | | | | a2 = 2.5 |
| | | | | | | | | a3 = −0.004395 |
| | | | | | | | | a4 = 1.004395 |
| | | | | | | | | a5 = −0.5 |
| 27 | 26 | 337929 | 600814 | 38 | 105 | | | |
| | | 36354 | 117610 | 8 | 55 | 1/16 | 8 par | a0 = −0.000218 |
| | | | | | | BIL | | a1 = 0.000092 |
| | | | | | | | | a2 = 0.048059 |
| | | | | | | | | a3 = −0.060059 |
| | | | | | | | | a4 = 10.0 |
| | | | | | | | | a5 = 0.005859 |
| | | | | | | | | a6 = −0.012942 |
| | | | | | | | | a7 = 1.0 |
| | | 236603 | 400930 | 26 | 24 | 1/16 | 6 par | a0 = 1.001953 |
| | | | | | | BIC | | a1 = 0.009766 |
| | | | | | | | | a2 = −0.75 |
| | | | | | | | | a3 = 0.0 |
| | | | | | | | | a4 = 1.0 |
| | | | | | | | | a5 = 0.0 |
| | | 64972 | 82274 | 4 | 24 | 1/16 | 6 par | a0 = 1.012695 |
| | | | | | | BIC | | a1 = 0.003418 |
| | | | | | | | | a2 = 2.75 |
| | | | | | | | | a3 = −0.007324 |
| | | | | | | | | a4 = 1.003418 |
| | | | | | | | | a5 = −0.25 |
| 28 | 27 | 378206 | 639945 | 38 | 106 | | | |
| | | 37768 | 117457 | 12 | 55 | 1/16 | 8 par | a0 = −0.000178 |
| | | | | | | BIL | | a1 = −0.000197 |
| | | | | | | | | a2 = 0.052715 |
| | | | | | | | | a3 = −0.047852 |
| | | | | | | | | a4 = 10.0 |
| | | | | | | | | a5 = 0.001465 |
| | | | | | | | | a6 = 0.045849 |
| | | | | | | | | a7 = −1.0 |
| | | 272544 | 434454 | 24 | 23 | 1/16 | 6 par | a0 = 1.001465 |
| | | | | | | BIC | | a1 = 0.008789 |
| | | | | | | | | a2 = −0.5 |
| | | | | | | | | a3 = 0.0 |
| | | | | | | | | a4 = 1.0 |
| | | | | | | | | a5 = 0.0 |
| | | 67894 | 88034 | 2 | 26 | 1/16 | 6 par | a0 = 1.008301 |
| | | | | | | BIC | | a1 = 0.004395 |
| | | | | | | | | a2 = 3.25 |
| | | | | | | | | a3 = −0.007324 |
| | | | | | | | | a4 = 1.003418 |
| | | | | | | | | a5 = −0.25 |
| 29 | 28 | 382465 | 614123 | 52 | 98 | | | |
| | | 31416 | 98873 | 10 | 67 | 1/16 | 8 par | a0 = −0.000151 |
| | | | | | | BIL | | a1 = 0.00019 |
| | | | | | | | | a2 = 0.025174 |
| | | | | | | | | a3 = −0.069336 |
| | | | | | | | | a4 = 11.0 |
| | | | | | | | | a5 = −0.001953 |
| | | | | | | | | a6 = −0.030382 |
| | | | | | | | | a7 = 2.0 |
| | | 273376 | 417171 | 26 | 7 | 1/16 | 6 par | a0 = 1.001953 |
| | | | | | | BIC | | a1 = 0.009766 |
| | | | | | | | | a2 = −0.75 |
| | | | | | | | | a3 = 0.0 |
| | | | | | | | | a4 = 1.0 |
| | | | | | | | | a5 = 0.0 |
| | | 77673 | 98079 | 16 | 22 | 1/8 | 6 par | a0 = 1.010742 |
| | | | | | | HEVC | | a1 = 0.003418 |
| | | | | | | | | a2 = 3.0 |
| | | | | | | | | a3 = −0.00293 |
| | | | | | | | | a4 = 1.004395 |
| | | | | | | | | a5 = −0.75 |
| 30 | 29 | 478232 | 664950 | 66 | 128 | | | |
| | | 32736 | 101624 | 5 | 71 | 1/16 | 8 par | a0 = −0.000345 |
| | | | | | | BIL | | a1 = −0.000156 |
| | | | | | | | | a2 = 0.087674 |
| | | | | | | | | a3 = −0.041016 |
| | | | | | | | | a4 = 7.0 |
| | | | | | | | | a5 = 0.021973 |
| | | | | | | | | a6 = 0.045849 |
| | | | | | | | | a7 = −3.0 |
| | | 377091 | 475099 | 57 | 28 | 1/16 | 6 par | a0 = 1.001953 |
| | | | | | | BIC | | a1 = 0.010254 |
| | | | | | | | | a2 = −1.0 |
| | | | | | | | | a3 = 0.000488 |
| | | | | | | | | a4 = 1.0 |
| | | | | | | | | a5 = −0.25 |
| | | 68405 | 88227 | 4 | 27 | 1/16 | 6 par | a0 = 1.01123 |
| | | | | | | BIC | | a1 = 0.004395 |
| | | | | | | | | a2 = 2.75 |
| | | | | | | | | a3 = −0.007324 |
| | | | | | | | | a4 = 1.003418 |
| | | | | | | | | a5 = −0.5 |
| 31 | 30 | 374235 | 625795 | 37 | 140 | | | |
| | | 38796 | 117784 | 7 | 67 | 1/16 | 8 par | a0 = −0.000278 |
| | | | | | | BIL | | a1 = 0.000044 |
| | | | | | | | | a2 = 0.062658 |
| | | | | | | | | a3 = −0.053711 |
| | | | | | | | | a4 = 9.0 |
| | | | | | | | | a5 = 0.030762 |
| | | | | | | | | a6 = 0.029593 |
| | | | | | | | | a7 = −6.0 |
| | | 269649 | 424364 | 25 | 45 | 1/16 | 8 par | a0 = −0.000035 |
| | | | | | | BIC | | a1 = −0.000043 |
| | | | | | | | | a2 = 0.029593 |
| | | | | | | | | a3 = 0.052246 |
| | | | | | | | | a4 = −7.0 |
| | | | | | | | | a5 = 0.009277 |
| | | | | | | | | a6 = 0.027146 |
| | | | | | | | | a7 = −4.0 |
| | | 65790 | 83647 | 5 | 26 | 1/16 | 6 par | a0 = 1.010742 |
| | | | | | | BIC | | a1 = 0.003418 |
| | | | | | | | | a2 = 3.0 |
| | | | | | | | | a3 = −0.005859 |
| | | | | | | | | a4 = 1.003418 |
| | | | | | | | | a5 = −0.5 |
| 32 | 31 | 413527 | 644229 | 72 | 190 | | | |
| | | 36757 | 123049 | 8 | 63 | 1/16 | 8 par | a0 = −0.000191 |
| | | | | | | BIL | | a1 = 0.000017 |
| | | | | | | | | a2 = 0.045218 |
| | | | | | | | | a3 = −0.058105 |
| | | | | | | | | a4 = 9.0 |
| | | | | | | | | a5 = 0.000488 |
| | | | | | | | | a6 = −0.006155 |
| | | | | | | | | a7 = 1.0 |
| | | 316813 | 444306 | 57 | 56 | 1/8 | 8 par | a0 = −0.000031 |
| | | | | | | HEVC | | a1 = −0.000017 |
| | | | | | | | | a2 = 0.022254 |
| | | | | | | | | a3 = 0.048828 |
| | | | | | | | | a4 = −6.0 |
| | | | | | | | | a5 = 0.004883 |
| | | | | | | | | a6 = 0.019176 |
| | | | | | | | | a7 = −3.0 |
| | | 59957 | 76874 | 7 | 69 | 1/8 | 8 par | a0 = −0.000051 |
| | | | | | | HEVC | | a1 = 0.000023 |
| | | | | | | | | a2 = 0.042061 |
| | | | | | | | | a3 = 0.013672 |
| | | | | | | | | a4 = 12.0 |
| | | | | | | | | a5 = −0.03418 |
| | | | | | | | | a6 = 0.012942 |
| | | | | | | | | a7 = 0.0 |

TABLE 12
SAD Results of RMM for CIF “Coastguard” sequence (33 frames) with Low Delay
IPP pictures:

| F | R | Ref SAD | RMMs SAD | NBB | Bits | SP Filter | Mod | RMMs Parameters |
|---|---|---|---|---|---|---|---|---|
| 1 | 0 | 521144 | 625104 | 124 | 69 | | | |
| | | 429452 | 461703 | 121 | 29 | 1/16 | 6 par | a0 = 1.000488 |
| | | | | | | BIL | | a1 = 0.002441 |
| | | | | | | | | a2 = −0.5 |
| | | | | | | | | a3 = 0.0 |
| | | | | | | | | a4 = 1.0 |
| | | | | | | | | a5 = −0.75 |
| | | 91692 | 163401 | 3 | 34 | 1/16 | 6 par | a0 = 1.006348 |
| | | | | | | BIL | | a1 = 0.023438 |
| | | | | | | | | a2 = −4.5 |
| | | | | | | | | a3 = 0.0 |
| | | | | | | | | a4 = 0.999023 |
| | | | | | | | | a5 = −0.75 |
| 2 | 1 | 443773 | 564164 | 48 | 64 | | | |
| | | 336976 | 389829 | 42 | 26 | 1/8 | 4 par | a0 = 1.000488 |
| | | | | | | AVC | | a1 = 0.0 |
| | | | | | | | | a2 = 1.0 |
| | | | | | | | | a3 = −1.25 |
| | | 106797 | 174335 | 6 | 36 | 1/8 | 6 par | a0 = 0.992676 |
| | | | | | | AVC | | a1 = 0.049316 |
| | | | | | | | | a2 = −6.0 |
| | | | | | | | | a3 = 0.0 |
| | | | | | | | | a4 = 1.0 |
| | | | | | | | | a5 = −1.25 |
| 3 | 2 | 435763 | 514844 | 196 | 160 | | | |
| | | 352810 | 381565 | 190 | 32 | 1/16 | 6 par | a0 = 1.0 |
| | | | | | | BIL | | a1 = 0.000977 |
| | | | | | | | | a2 = 0.0 |
| | | | | | | | | a3 = 0.0 |
| | | | | | | | | a4 = 1.0 |
| | | | | | | | | a5 = −2.25 |
| | | 82953 | 133279 | 6 | 126 | 1/16 | 8 par | a0 = −0.000603 |
| | | | | | | BIL | | a1 = −0.000012 |
| | | | | | | | | a2 = 0.16785 |
| | | | | | | | | a3 = 0.119629 |
| | | | | | | | | a4 = −29.0 |
| | | | | | | | | a5 = 0.077637 |
| | | | | | | | | a6 = 0.087279 |
| | | | | | | | | a7 = −20.0 |
| 4 | 3 | 470087 | 520103 | 302 | 57 | | | |
| | | 330628 | 280564 | 284 | 29 | 1/16 | 6 par | a0 = 1.0 |
| | | | | | | BIL | | a1 = 0.000977 |
| | | | | | | | | a2 = 0.25 |
| | | | | | | | | a3 = 0.0 |
| | | | | | | | | a4 = 1.000977 |
| | | | | | | | | a5 = −3.75 |
| | | 139459 | 239539 | 18 | 26 | 1/16 | 4 par | a0 = 0.989258 |
| | | | | | | BIL | | a1 = 1.25 |
| | | | | | | | | a2 = 0.994141 |
| | | | | | | | | a3 = −2.75 |
| 5 | 4 | 458785 | 510493 | 300 | 66 | | | |
| | | 327553 | 344927 | 265 | 28 | 1/16 | 6 par | a0 = 1.000488 |
| | | | | | | BIL | | a1 = 0.0 |
| | | | | | | | | a2 = 0.5 |
| | | | | | | | | a3 = −0.000488 |
| | | | | | | | | a4 = 1.0 |
| | | | | | | | | a5 = −5.5 |
| | | 131232 | 165566 | 35 | 36 | 1/16 | 6 par | a0 = 1.004883 |
| | | | | | | BIL | | a1 = 0.026855 |
| | | | | | | | | a2 = −4.25 |
| | | | | | | | | a3 = 0.0 |
| | | | | | | | | a4 = 1.0 |
| | | | | | | | | a5 = −5.75 |
| 6 | 5 | 387519 | 497426 | 264 | 84 | | | |
| | | 288845 | 367461 | 240 | 38 | 1/16 | 6 par | a0 = 1.0 |
| | | | | | | BIL | | a1 = 0.001953 |
| | | | | | | | | a2 = −0.5 |
| | | | | | | | | a3 = 0.0 |
| | | | | | | | | a4 = 1.000977 |
| | | | | | | | | a5 = −7.75 |
| | | 98674 | 129965 | 24 | 44 | 1/16 | 6 par | a0 = 0.993652 |
| | | | | | | BIL | | a1 = 0.041016 |
| | | | | | | | | a2 = −5.75 |
| | | | | | | | | a3 = −0.000488 |
| | | | | | | | | a4 = 0.998047 |
| | | | | | | | | a5 = −7.25 |
| 7 | 6 | 315872 | 470856 | 159 | 51 | | | |
| | | 168072 | 179583 | 158 | 30 | 1/16 | 6 par | a0 = 1.000488 |
| | | | | | | BIL | | a1 = 0.001953 |
| | | | | | | | | a2 = −0.5 |
| | | | | | | | | a3 = 0.0 |
| | | | | | | | | a4 = 1.0 |
| | | | | | | | | a5 = −8.75 |
| | | 147800 | 291273 | 1 | 19 | 1/16 | 4 par | a0 = 0.999512 |
| | | | | | | BIL | | a1 = −0.75 |
| | | | | | | | | a2 = 0.994629 |
| | | | | | | | | a3 = −8.0 |
| 8 | 7 | 390642 | 501500 | 71 | 58 | | | |
| | | 226193 | 277126 | 59 | 24 | 1/8 | 6 par | a0 = 0.999512 |
| | | | | | | AVC | | a1 = 0.0 |
| | | | | | | | | a2 = 0.25 |
| | | | | | | | | a3 = −0.000488 |
| | | | | | | | | a4 = 1.002441 |
| | | | | | | | | a5 = −8.5 |
| | | 164449 | 224374 | 12 | 32 | 1/16 | 6 par | a0 = 0.996582 |
| | | | | | | BIL | | a1 = 0.013184 |
| | | | | | | | | a2 = −2.25 |
| | | | | | | | | a3 = 0.000488 |
| | | | | | | | | a4 = 1.0 |
| | | | | | | | | a5 = −8.25 |
| 9 | 8 | 565120 | 678868 | 82 | 66 | | | |
| | | 415106 | 478896 | 80 | 29 | 1/8 | 4 par | a0 = 1.0 |
| | | | | | | HEVC | | a1 = 0.75 |
| | | | | | | | | a2 = 0.999023 |
| | | | | | | | | a3 = −5.75 |
| | | 150014 | 199972 | 2 | 35 | 1/16 | 6 par | a0 = 0.98877 |
| | | | | | | BIC | | a1 = 0.033691 |
| | | | | | | | | a2 = −3.75 |
| | | | | | | | | a3 = −0.000488 |
| | | | | | | | | a4 = 1.0 |
| | | | | | | | | a5 = −5.75 |
| 10 | 9 | 563648 | 661985 | 152 | 86 | | | |
| | | 437153 | 483768 | 145 | 38 | 1/8 | 6 par | a0 = 0.999512 |
| | | | | | | AVC | | a1 = 0.001953 |
| | | | | | | | | a2 = 1.0 |
| | | | | | | | | a3 = −0.000488 |
| | | | | | | | | a4 = 1.0 |
| | | | | | | | | a5 = −2.5 |
| | | 126495 | 178217 | 7 | 46 | 1/8 | 6 par | a0 = 1.003418 |
| | | | | | | HEVC | | a1 = 0.047852 |
| | | | | | | | | a2 = −8.25 |
| | | | | | | | | a3 = 0.0 |
| | | | | | | | | a4 = 0.995605 |
| | | | | | | | | a5 = −2.0 |
| 11 | 10 | 374909 | 486706 | 87 | 75 | | | |
| | | 312353 | 357712 | 85 | 38 | 1/8 | 6 par | a0 = 1.0 |
| | | | | | | AVC | | a1 = 0.001953 |
| | | | | | | | | a2 = 1.0 |
| | | | | | | | | a3 = 0.0 |
| | | | | | | | | a4 = 1.0 |
| | | | | | | | | a5 = 0.0 |
| | | 62556 | 128994 | 2 | 35 | 1/8 | 6 par | a0 = 0.999512 |
| | | | | | | AVC | | a1 = 0.052734 |
| | | | | | | | | a2 = −8.5 |
| | | | | | | | | a3 = 0.0 |
| | | | | | | | | a4 = 1.000977 |
| | | | | | | | | a5 = 0.0 |
| 12 | 11 | 395324 | 502596 | 126 | 71 | | | |
| | | 318956 | 363912 | 124 | 36 | 1/16 | 6 par | a0 = 1.0 |
| | | | | | | BIC | | a1 = 0.000977 |
| | | | | | | | | a2 = 0.75 |
| | | | | | | | | a3 = 0.0 |
| | | | | | | | | a4 = 1.000977 |
| | | | | | | | | a5 = 1.0 |
| | | 76368 | 138684 | 2 | 33 | 1/8 | 6 par | a0 = 0.996582 |
| | | | | | | AVC | | a1 = 0.048828 |
| | | | | | | | | a2 = −7.5 |
| | | | | | | | | a3 = 0.0 |
| | | | | | | | | a4 = 1.000977 |
| | | | | | | | | a5 = 1.0 |
| 13 | 12 | 411353 | 489760 | 192 | 64 | | | |
| | | 331728 | 347234 | 190 | 31 | 1/16 | 6 par | a0 = 1.0 |
| | | | | | | BIC | | a1 = 0.001953 |
| | | | | | | | | a2 = 0.75 |
| | | | | | | | | a3 = 0.0 |
| | | | | | | | | a4 = 1.0 |
| | | | | | | | | a5 = 0.25 |
| | | 79625 | 142526 | 2 | 31 | 1/16 | 6 par | a0 = 0.999512 |
| | | | | | | BIL | | a1 = 0.045898 |
| | | | | | | | | a2 = −7.0 |
| | | | | | | | | a3 = 0.0 |
| | | | | | | | | a4 = 1.0 |
| | | | | | | | | a5 = 0.25 |
| 14 | 13 | 525226 | 595339 | 181 | 66 | | | |
| | | 402351 | 413208 | 177 | 29 | 1/16 | 6 par | a0 = 0.999512 |
| | | | | | | BIC | | a1 = 0.000977 |
| | | | | | | | | a2 = 0.75 |
| | | | | | | | | a3 = −0.000488 |
| | | | | | | | | a4 = 1.0 |
| | | | | | | | | a5 = −0.5 |
| | | 122875 | 182131 | 4 | 35 | 1/16 | 6 par | a0 = 0.99707 |
| | | | | | | BIL | | a1 = 0.053711 |
| | | | | | | | | a2 = −8.25 |
| | | | | | | | | a3 = 0.000488 |
| | | | | | | | | a4 = 0.996582 |
| | | | | | | | | a5 = −0.25 |
| 15 | 14 | 451869 | 550632 | 71 | 66 | | | |
| | | 348436 | 382273 | 71 | 24 | 1/16 | 4 par | a0 = 1.0 |
| | | | | | | BIC | | a1 = 0.75 |
| | | | | | | | | a2 = 0.999023 |
| | | | | | | | | a3 = −0.75 |
| | | 103433 | 168359 | 0 | 40 | 1/16 | 6 par | a0 = 0.995117 |
| | | | | | | BIL | | a1 = 0.028809 |
| | | | | | | | | a2 = −4.0 |
| | | | | | | | | a3 = 0.000488 |
| | | | | | | | | a4 = 1.0 |
| | | | | | | | | a5 = −1.0 |
| 16 | 15 | 338647 | 420020 | 162 | 62 | | | |
| | | 278026 | 296439 | 160 | 29 | 1/16 | 6 par | a0 = 1.0 |
| | | | | | | BIC | | a1 = 0.001953 |
| | | | | | | | | a2 = 0.0 |
| | | | | | | | | a3 = 0.0 |
| | | | | | | | | a4 = 1.0 |
| | | | | | | | | a5 = 0.0 |
| | | 60621 | 123581 | 2 | 31 | 1/16 | 6 par | a0 = 0.995117 |
| | | | | | | BIL | | a1 = 0.048828 |
| | | | | | | | | a2 = −8.25 |
| | | | | | | | | a3 = 0.0 |
| | | | | | | | | a4 = 1.0 |
| | | | | | | | | a5 = 0.0 |
| 17 | 16 | 508187 | 580729 | 179 | 60 | | | |
| | | 408337 | 424206 | 176 | 26 | 1/16 | 6 par | a0 = 1.0 |
| | | | | | | BIC | | a1 = 0.001953 |
| | | | | | | | | a2 = 0.25 |
| | | | | | | | | a3 = 0.0 |
| | | | | | | | | a4 = 0.999023 |
| | | | | | | | | a5 = 0.5 |
| | | 99850 | 156523 | 3 | 32 | 1/16 | 6 par | a0 = 1.001465 |
| | | | | | | BIC | | a1 = 0.050293 |
| | | | | | | | | a2 = −8.5 |
| | | | | | | | | a3 = 0.0 |
| | | | | | | | | a4 = 0.999023 |
| | | | | | | | | a5 = 0.5 |
| 18 | 17 | 328272 | 415612 | 118 | 54 | | | |
| | | 265413 | 292644 | 116 | 26 | 1/16 | 6 par | a0 = 0.999512 |
| | | | | | | BIC | | a1 = 0.000977 |
| | | | | | | | | a2 = 1.25 |
| | | | | | | | | a3 = 0.0 |
| | | | | | | | | a4 = 1.0 |
| | | | | | | | | a5 = 0.0 |
| | | 62859 | 122968 | 2 | 26 | 1/16 | 6 par | a0 = 0.993652 |
| | | | | | | BIL | | a1 = 0.04248 |
| | | | | | | | | a2 = −5.75 |
| | | | | | | | | a3 = 0.0 |
| | | | | | | | | a4 = 1.0 |
| | | | | | | | | a5 = 0.0 |
| 19 | 18 | 391229 | 496152 | 127 | 54 | | | |
| | | 308874 | 352404 | 121 | 26 | 1/8 | 6 par | a0 = 0.999512 |
| | | | | | | HEVC | | a1 = 0.000977 |
| | | | | | | | | a2 = 1.5 |
| | | | | | | | | a3 = 0.0 |
| | | | | | | | | a4 = 1.000977 |
| | | | | | | | | a5 = −0.25 |
| | | 82355 | 143748 | 6 | 26 | 1/8 | 6 par | a0 = 0.987305 |
| | | | | | | AVC | | a1 = 0.048828 |
| | | | | | | | | a2 = −5.75 |
| | | | | | | | | a3 = 0.0 |
| | | | | | | | | a4 = 1.000977 |
| | | | | | | | | a5 = −0.25 |
| 20 | 19 | 399488 | 479986 | 163 | 50 | | | |
| | | 307560 | 328694 | 155 | 27 | 1/16 | 4 par | a0 = 0.999512 |
| | | | | | | BIC | | a1 = 2.0 |
| | | | | | | | | a2 = 1.0 |
| | | | | | | | | a3 = −0.25 |
| | | 91928 | 151292 | 8 | 21 | 1/16 | 6 par | a0 = 0.990234 |
| | | | | | | BIC | | a1 = 0.053711 |
| | | | | | | | | a2 = −6.5 |
| | | | | | | | | a3 = 0.0 |
| | | | | | | | | a4 = 1.0 |
| | | | | | | | | a5 = −0.25 |
| 21 | 20 | 391776 | 475490 | 145 | 69 | | | |
| | | 309654 | 325685 | 142 | 32 | 1/16 | 6 par | a0 = 1.0 |
| | | | | | | BIC | | a1 = 0.000977 |
| | | | | | | | | a2 = 3.0 |
| | | | | | | | | a3 = 0.0 |
| | | | | | | | | a4 = 1.0 |
| | | | | | | | | a5 = 0.25 |
| | | 82122 | 149805 | 3 | 35 | 1/16 | 6 par | a0 = 0.99707 |
| | | | | | | BIL | | a1 = 0.024414 |
| | | | | | | | | a2 = −1.25 |
| | | | | | | | | a3 = 0.0 |
| | | | | | | | | a4 = 0.999023 |
| | | | | | | | | a5 = 0.25 |
| 22 | 21 | 432787 | 637552 | 106 | 54 | | | |
| | | 324225 | 444899 | 102 | 23 | 1/8 | 6 par | a0 = 0.999512 |
| | | | | | | AVC | | a1 = 0.000977 |
| | | | | | | | | a2 = 4.75 |
| | | | | | | | | a3 = 0.0 |
| | | | | | | | | a4 = 1.0 |
| | | | | | | | | a5 = 0.25 |
| | | 108562 | 192653 | 4 | 29 | 1/8 | 6 par | a0 = 1.001953 |
| | | | | | | AVC | | a1 = 0.041016 |
| | | | | | | | | a2 = −2.5 |
| | | | | | | | | a3 = 0.0 |
| | | | | | | | | a4 = 0.998047 |
| | | | | | | | | a5 = 0.5 |
| 23 | 22 | 436002 | 602615 | 85 | 54 | | | |
| | | 348095 | 458620 | 83 | 23 | 1/16 | 4 par | a0 = 0.998535 |
| | | | | | | BIC | | a1 = 3.5 |
| | | | | | | | | a2 = 1.000977 |
| | | | | | | | | a3 = 0.0 |
| | | 87907 | 143995 | 2 | 29 | 1/16 | 6 par | a0 = 1.0 |
| | | | | | | BIC | | a1 = 0.048828 |
| | | | | | | | | a2 = −5.5 |
| | | | | | | | | a3 = 0.0 |
| | | | | | | | | a4 = 0.999023 |
| | | | | | | | | a5 = 0.25 |
| 24 | 23 | 390469 | 488890 | 162 | 83 | | | |
| | | 310073 | 358186 | 159 | 47 | 1/16 | 8 par | a0 = −0.000011 |
| | | | | | | BIC | | a1 = −0.000004 |
| | | | | | | | | a2 = 0.003551 |
| | | | | | | | | a3 = 0.007813 |
| | | | | | | | | a4 = 4.0 |
| | | | | | | | | a5 = 0.001465 |
| | | | | | | | | a6 = 0.005129 |
| | | | | | | | | a7 = −1.0 |
| | | 80396 | 130704 | 3 | 34 | 1/16 | 6 par | a0 = 0.984375 |
| | | | | | | BIL | | a1 = 0.018066 |
| | | | | | | | | a2 = −0.5 |
| | | | | | | | | a3 = 0.000488 |
| | | | | | | | | a4 = 1.001953 |
| | | | | | | | | a5 = −0.5 |
| 25 | 24 | 405622 | 504217 | 108 | 62 | | | |
| | | 297032 | 328581 | 102 | 30 | 1/16 | 6 par | a0 = 1.0 |
| | | | | | | BIC | | a1 = 0.0 |
| | | | | | | | | a2 = 0.5 |
| | | | | | | | | a3 = 0.0 |
| | | | | | | | | a4 = 1.0 |
| | | | | | | | | a5 = −0.25 |
| | | | | | | | | a0 = 0.987305 |
| | | 108590 | 175636 | 6 | 30 | 1/16 | 6 par | a1 = 0.028809 |
| | | | | | | BIC | | a2 = −3.25 |
| | | | | | | | | a3 = 0.0 |
| | | | | | | | | a4 = 1.0 |
| | | | | | | | | a5 = −0.25 |
| 26 | 25 | 393419 | 500367 | 122 | 61 | | | |
| | | 320193 | 372174 | 121 | 29 | 1/16 | 6 par | a0 = 0.999512 |
| | | | | | | BIC | | a1 = 0.000977 |
| | | | | | | | | a2 = 0.75 |
| | | | | | | | | a3 = 0.0 |
| | | | | | | | | a4 = 0.999023 |
| | | | | | | | | a5 = 0.25 |
| | | 73226 | 128193 | 1 | 30 | 1/8 | 6 par | a0 = 0.998535 |
| | | | | | | AVC | | a1 = 0.039063 |
| | | | | | | | | a2 = −6.25 |
| | | | | | | | | a3 = 0.0 |
| | | | | | | | | a4 = 0.999023 |
| | | | | | | | | a5 = 0.25 |
| 27 | 26 | 517973 | 600132 | 196 | 57 | | | |
| | | 382947 | 403827 | 184 | 25 | 1/16 | 6 par | a0 = 0.999512 |
| | | | | | | BIC | | a1 = 0.001953 |
| | | | | | | | | a2 = 0.75 |
| | | | | | | | | a3 = 0.0 |
| | | | | | | | | a4 = 1.0 |
| | | | | | | | | a5 = 0.5 |
| | | 135026 | 196305 | 12 | 30 | 1/8 | 6 par | a0 = 0.99707 |
| | | | | | | AVC | | a1 = 0.029297 |
| | | | | | | | | a2 = −4.0 |
| | | | | | | | | a3 = −0.000488 |
| | | | | | | | | a4 = 0.998047 |
| | | | | | | | | a5 = 0.75 |
| 28 | 27 | 415427 | 532501 | 117 | 46 | | | |
| | | 326309 | 380716 | 114 | 21 | 1/16 | 6 par | a0 = 0.999512 |
| | | | | | | BIC | | a1 = 0.001953 |
| | | | | | | | | a2 = 0.75 |
| | | | | | | | | a3 = 0.0 |
| | | | | | | | | a4 = 1.0 |
| | | | | | | | | a5 = 0.25 |
| | | 89118 | 151785 | 3 | 23 | 1/16 | 6 par | a0 = 0.999512 |
| | | | | | | BIC | | a1 = 0.036621 |
| | | | | | | | | a2 = −5.5 |
| | | | | | | | | a3 = 0.0 |
| | | | | | | | | a4 = 1.0 |
| | | | | | | | | a5 = 0.25 |
| 29 | 28 | 473812 | 575488 | 156 | 57 | | | |
| | | 331996 | 371516 | 144 | 22 | 1/16 | 4 par | a0 = 0.999512 |
| | | | | | | BIC | | a1 = 1.0 |
| | | | | | | | | a2 = 0.999023 |
| | | | | | | | | a3 = −0.25 |
| | | 141816 | 203972 | 12 | 33 | 1/8 | 6 par | a0 = 0.992676 |
| | | | | | | AVC | | a1 = 0.045898 |
| | | | | | | | | a2 = −7.0 |
| | | | | | | | | a3 = 0.000488 |
| | | | | | | | | a4 = 0.999023 |
| | | | | | | | | a5 = −0.25 |
| 30 | 29 | 389401 | 484197 | 143 | 75 | | | |
| | | 310388 | 362614 | 136 | 45 | 1/8 | 8 par | a0 = 0.000003 |
| | | | | | | AVC | | a1 = 0.00001 |
| | | | | | | | | a2 = −0.00363 |
| | | | | | | | | a3 = 0.005859 |
| | | | | | | | | a4 = 3.0 |
| | | | | | | | | a5 = −0.001465 |
| | | | | | | | | a6 = −0.004261 |
| | | | | | | | | a7 = 0.0 |
| | | 79013 | 121583 | 7 | 28 | 1/8 | 6 par | a0 = 0.990723 |
| | | | | | | AVC | | a1 = 0.037109 |
| | | | | | | | | a2 = −5.0 |
| | | | | | | | | a3 = 0.0 |
| | | | | | | | | a4 = 1.000977 |
| | | | | | | | | a5 = −0.25 |
| 31 | 30 | 434297 | 563302 | 100 | 47 | | | |
| | | 347993 | 420015 | 98 | 17 | 1/16 | 4 par | a0 = 0.998535 |
| | | | | | | BIC | | a1 = 1.5 |
| | | | | | | | | a2 = 1.0 |
| | | | | | | | | a3 = 0.25 |
| | | 86304 | 143287 | 2 | 28 | 1/8 | 6 par | a0 = 1.000488 |
| | | | | | | AVC | | a1 = 0.040039 |
| | | | | | | | | a2 = −6.0 |
| | | | | | | | | a3 = 0.0 |
| | | | | | | | | a4 = 0.998047 |
| | | | | | | | | a5 = 0.5 |
| 32 | 31 | 446516 | 582116 | 127 | 52 | | | |
| | | 349096 | 409958 | 122 | 16 | 1/8 | 6 par | a0 = 0.999512 |
| | | | | | | AVC | | a1 = 0.000977 |
| | | | | | | | | a2 = 1.25 |
| | | | | | | | | a3 = 0.0 |
| | | | | | | | | a4 = 1.0 |
| | | | | | | | | a5 = 0.25 |
| | | 97420 | 172158 | 5 | 34 | 1/16 | 6 par | a0 = 1.006348 |
| | | | | | | BIC | | a1 = 0.067871 |
| | | | | | | | | a2 = −11.25 |
| | | | | | | | | a3 = 0.0 |
| | | | | | | | | a4 = 0.997559 |
| | | | | | | | | a5 = 0.75 |

Frame based SAD reduction for 8 Pyramid pictures

TABLE 13
Average SAD Results of RMM for CIF sequences
(33 frames) with GOP 8 Pyramid.

| | Ref SAD | RMM SAD | NBB | Bits |
|---|---|---|---|---|
| | (33 frame | (33 frame | (33 frame | (33 frame |
| Sequence | Avg) | Avg) | Avg) | Avg) |
| Bus | 389601 | 561486 | 146 | 78 |
| City | 210014 | 212870 | 227 | 70 |
| Flower | 444764 | 636215 | 61 | 127 |
| Stefan | 614102 | 947909 | 60 | 99 |
| Mobile | 503788 | 652820 | 114 | 43 |
| Football | 349557 | 751048 | 53 | 90 |
| Foreman | 213772 | 391640 | 108 | 69 |
| Harbour | 481541 | 514964 | 163 | 16 |
| Soccer | 287422 | 672652 | 112 | 68 |
| Tennis | 286460 | 483821 | 172 | 78 |
| Tennis2 | 352610 | 526263 | 194 | 54 |
| Coastguard | 431386 | 534679 | 146 | 66 |

TABLE 14
SAD Results of RMM for CIF “Bus” sequence (33 frames) with GOP 8 Pyramid:

| F | R | Ref SAD | RMMs SAD | NBB | Bits | SP Filter | Mod | RMMs Parameters |
|---|---|---|---|---|---|---|---|---|
| 1 | 0 | 450196 | 682912 | 166 | 120 | | | |
| | | 305098 | 311388 | 163 | 50 | 1/16 | 6 par | a0 = 1.005859 |
| | | | | | | BIC | | a1 = 0.0 |
| | | | | | | | | a2 = −4.5 |
| | | | | | | | | a3 = 0.0 |
| | | | | | | | | a4 = 1.005371 |
| | | | | | | | | a5 = −0.75 |
| | | 134422 | 357408 | 3 | 46 | 1/16 | 6 par | a0 = 1.003418 |
| | | | | | | BIL | | a1 = 0.107422 |
| | | | | | | | | a2 = −16.0 |
| | | | | | | | | a3 = 0.0 |
| | | | | | | | | a4 = 1.0 |
| | | | | | | | | a5 = −0.25 |
| | | 10676 | 14116 | 0 | 18 | 1/16 | 4 par | a0 = 0.992188 |
| | | | | | | BIC | | a1 = 2.25 |
| | | | | | | | | a2 = 1.000977 |
| | | | | | | | | a3 = −0.25 |
| 2 | 1 | 456828 | 725190 | 88 | 75 | | | |
| | | 304524 | 323713 | 84 | 26 | 1/8 | 4 par | a0 = 1.004883 |
| | | | | | | HEVC | | a1 = −4.5 |
| | | | | | | | | a2 = 1.005859 |
| | | | | | | | | a3 = −1.0 |
| | | 141763 | 386342 | 4 | 29 | 1/16 | 6 par | a0 = 1.003418 |
| | | | | | | BIL | | a1 = 0.110352 |
| | | | | | | | | a2 = −16.25 |
| | | | | | | | | a3 = 0.000488 |
| | | | | | | | | a4 = 1.010254 |
| | | | | | | | | a5 = −2.0 |
| | | 10541 | 15135 | 0 | 18 | 1/16 | 4 par | a0 = 0.992676 |
| | | | | | | BIC | | a1 = 2.0 |
| | | | | | | | | a2 = 1.001953 |
| | | | | | | | | a3 = −0.5 |
| 3 | 2 | 449217 | 747536 | 142 | 92 | | | |
| | | 310926 | 316729 | 141 | 27 | 1/8 | 6 par | a0 = 1.004883 |
| | | | | | | HEVC | | a1 = 0.0 |
| | | | | | | | | a2 = −4.5 |
| | | | | | | | | a3 = 0.0 |
| | | | | | | | | a4 = 1.005371 |
| | | | | | | | | a5 = −0.75 |
| | | 126635 | 415500 | 1 | 19 | 1/16 | 4 par | a0 = 0.998535 |
| | | | | | | BIL | | a1 = 0.0 |
| | | | | | | | | a2 = 1.005859 |
| | | | | | | | | a3 = −1.0 |
| | | 11656 | 15307 | 0 | 44 | 1/16 | 6 par | a0 = 0.992676 |
| | | | | | | BIC | | a1 = −0.009766 |
| | | | | | | | | a2 = 4.5 |
| | | | | | | | | a3 = 0.001465 |
| | | | | | | | | a4 = 1.002441 |
| | | | | | | | | a5 = −1.0 |
| 4 | 3 | 439079 | 575033 | 121 | 69 | | | |
| | | 310122 | 326171 | 113 | 26 | 1/8 | 6 par | a0 = 1.004883 |
| | | | | | | HEVC | | a1 = −0.000977 |
| | | | | | | | | a2 = −4.5 |
| | | | | | | | | a3 = 0.0 |
| | | | | | | | | a4 = 1.004395 |
| | | | | | | | | a5 = −0.5 |
| | | 116698 | 232015 | 8 | 24 | 1/16 | 4 par | a0 = 1.004395 |
| | | | | | | BIL | | a1 = 0.25 |
| | | | | | | | | a2 = 1.002441 |
| | | | | | | | | a3 = −0.5 |
| | | 12259 | 16847 | 0 | 17 | 1/16 | 4 par | a0 = 0.991699 |
| | | | | | | BIC | | a1 = 2.5 |
| | | | | | | | | a2 = 1.003418 |
| | | | | | | | | a3 = −0.75 |
| 5 | 4 | 407518 | 480787 | 134 | 71 | | | |
| | | 304139 | 327736 | 127 | 14 | 1/8 | 6 par | a0 = 1.004395 |
| | | | | | | AVC | | a1 = 0.0 |
| | | | | | | | | a2 = −4.5 |
| | | | | | | | | a3 = 0.0 |
| | | | | | | | | a4 = 1.003418 |
| | | | | | | | | a5 = −0.5 |
| | | 90701 | 137328 | 7 | 39 | 1/16 | 6 par | a0 = 1.004395 |
| | | | | | | BIC | | a1 = 0.015625 |
| | | | | | | | | a2 = −1.75 |
| | | | | | | | | a3 = 0.0 |
| | | | | | | | | a4 = 0.997559 |
| | | | | | | | | a5 = 0.25 |
| | | 12678 | 15723 | 0 | 16 | 1/16 | 4 par | a0 = 0.992188 |
| | | | | | | BIC | | a1 = 2.25 |
| | | | | | | | | a2 = 1.001953 |
| | | | | | | | | a3 = −0.5 |
| 6 | 5 | 385958 | 504500 | 150 | 75 | | | |
| | | 259418 | 266689 | 146 | 25 | 1/8 | 4 par | a0 = 1.00293 |
| | | | | | | HEVC | | a1 = −4.25 |
| | | | | | | | | a2 = 1.001953 |
| | | | | | | | | a3 = −0.25 |
| | | 113090 | 220025 | 4 | 41 | 1/16 | 6 par | a0 = 0.998047 |
| | | | | | | BIL | | a1 = −0.026855 |
| | | | | | | | | a2 = 5.5 |
| | | | | | | | | a3 = 0.0 |
| | | | | | | | | a4 = 1.000977 |
| | | | | | | | | a5 = −0.25 |
| | | 13450 | 17786 | 0 | 7 | 1/16 | 4 par | a0 = 0.992676 |
| | | | | | | BIC | | a1 = 2.0 |
| | | | | | | | | a2 = 1.001953 |
| | | | | | | | | a3 = −0.5 |
| 7 | 6 | 368091 | 468537 | 125 | 83 | | | |
| | | 245682 | 260004 | 122 | 24 | 1/8 | 6 par | a0 = 1.001465 |
| | | | | | | HEVC | | a1 = −0.000977 |
| | | | | | | | | a2 = −4.0 |
| | | | | | | | | a3 = −0.000488 |
| | | | | | | | | a4 = 1.000977 |
| | | | | | | | | a5 = 0.0 |
| | | 109219 | 188226 | 3 | 29 | 1/16 | 6 par | a0 = 1.001465 |
| | | | | | | BIC | | a1 = −0.002441 |
| | | | | | | | | a2 = 1.25 |
| | | | | | | | | a3 = 0.0 |
| | | | | | | | | a4 = 0.999023 |
| | | | | | | | | a5 = 0.0 |
| | | 13190 | 20307 | 0 | 28 | 1/16 | 6 par | a0 = 1.004395 |
| | | | | | | BIC | | a1 = −0.006836 |
| | | | | | | | | a2 = 0.25 |
| | | | | | | | | a3 = −0.000488 |
| | | | | | | | | a4 = 1.0 |
| | | | | | | | | a5 = 0.25 |
| 8 | 7 | 338548 | 412994 | 159 | 71 | | | |
| | | 210334 | 236030 | 155 | 24 | 1/16 | 6 par | a0 = 1.0 |
| | | | | | | BIC | | a1 = 0.0 |
| | | | | | | | | a2 = −4.0 |
| | | | | | | | | a3 = 0.0 |
| | | | | | | | | a4 = 1.0 |
| | | | | | | | | a5 = 0.0 |
| | | 114898 | 150958 | 4 | 21 | 1/8 | 4 par | a0 = 0.999512 |
| | | | | | | AVC | | a1 = 1.25 |
| | | | | | | | | a2 = 1.0 |
| | | | | | | | | a3 = 0.0 |
| | | 13316 | 26006 | 0 | 24 | 1/16 | 6 par | a0 = 1.000488 |
| | | | | | | BIL | | a1 = −0.013184 |
| | | | | | | | | a2 = 2.75 |
| | | | | | | | | a3 = −0.000488 |
| | | | | | | | | a4 = 1.0 |
| | | | | | | | | a5 = 0.25 |
| 9 | 8 | 336075 | 381676 | 209 | 51 | | | |
| | | 215560 | 230083 | 196 | 6 | 1/16 | 6 par | a0 = 1.0 |
| | | | | | | BIC | | a1 = 0.0 |
| | | | | | | | | a2 = −4.0 |
| | | | | | | | | a3 = 0.0 |
| | | | | | | | | a4 = 1.0 |
| | | | | | | | | a5 = 0.0 |
| | | 105785 | 129085 | 13 | 21 | 1/8 | 4 par | a0 = 0.998535 |
| | | | | | | HEVC | | a1 = 1.5 |
| | | | | | | | | a2 = 0.995605 |
| | | | | | | | | a3 = 0.5 |
| | | 14730 | 22508 | 0 | 22 | 1/16 | 4 par | a0 = 1.0 |
| | | | | | | BIC | | a1 = −0.25 |
| | | | | | | | | a2 = 0.999023 |
| | | | | | | | | a3 = 0.25 |
| 10 | 9 | 329192 | 424591 | 154 | 63 | | | |
| | | 215718 | 237877 | 147 | 22 | 1/16 | 6 par | a0 = 1.000488 |
| | | | | | | BIC | | a1 = 0.0 |
| | | | | | | | | a2 = −4.0 |
| | | | | | | | | a3 = 0.0 |
| | | | | | | | | a4 = 0.999023 |
| | | | | | | | | a5 = 0.25 |
| | | 98474 | 163988 | 7 | 19 | 1/8 | 4 par | a0 = 1.001953 |
| | | | | | | AVC | | a1 = 0.75 |
| | | | | | | | | a2 = 1.0 |
| | | | | | | | | a3 = 0.0 |
| | | 15000 | 22726 | 0 | 20 | 1/16 | 4 par | a0 = 1.007813 |
| | | | | | | BIC | | a1 = −2.5 |
| | | | | | | | | a2 = 1.0 |
| | | | | | | | | a3 = 0.0 |
| 11 | 10 | 319843 | 397847 | 233 | 59 | | | |
| | | 204049 | 220991 | 231 | 16 | 1/8 | 4 par | a0 = 1.0 |
| | | | | | | HEVC | | a1 = −4.0 |
| | | | | | | | | a2 = 1.0 |
| | | | | | | | | a3 = 0.0 |
| | | 100106 | 153241 | 2 | 34 | 1/8 | 6 par | a0 = 1.0 |
| | | | | | | HEVC | | a1 = 0.004395 |
| | | | | | | | | a2 = 0.5 |
| | | | | | | | | a3 = 0.0 |
| | | | | | | | | a4 = 0.994629 |
| | | | | | | | | a5 = 0.5 |
| | | 15688 | 23615 | 0 | 7 | 1/16 | 4 par | a0 = 1.0 |
| | | | | | | BIC | | a1 = −0.25 |
| | | | | | | | | a2 = 0.999023 |
| | | | | | | | | a3 = 0.25 |
| 12 | 11 | 339549 | 434032 | 200 | 58 | | | |
| | | 201835 | 220878 | 195 | 7 | 1/8 | 6 par | a0 = 1.0 |
| | | | | | | HEVC | | a1 = 0.0 |
| | | | | | | | | a2 = −4.0 |
| | | | | | | | | a3 = 0.0 |
| | | | | | | | | a4 = 1.0 |
| | | | | | | | | a5 = 0.0 |
| | | 120399 | 192705 | 5 | 27 | 1/16 | 6 par | a0 = 1.0 |
| | | | | | | BIC | | a1 = −0.002441 |
| | | | | | | | | a2 = 1.25 |
| | | | | | | | | a3 = 0.000488 |
| | | | | | | | | a4 = 0.996582 |
| | | | | | | | | a5 = 0.25 |
| | | 17315 | 20449 | 0 | 22 | 1/16 | 4 par | a0 = 0.995605 |
| | | | | | | BIC | | a1 = 1.25 |
| | | | | | | | | a2 = 1.007813 |
| | | | | | | | | a3 = −1.75 |
| 13 | 12 | 363667 | 469814 | 168 | 67 | | | |
| | | 225470 | 228733 | 165 | 20 | 1/16 | 6 par | a0 = 1.0 |
| | | | | | | BIC | | a1 = −0.000977 |
| | | | | | | | | a2 = −4.0 |
| | | | | | | | | a3 = 0.0 |
| | | | | | | | | a4 = 1.0 |
| | | | | | | | | a5 = 0.0 |
| | | 121721 | 220674 | 3 | 22 | 1/16 | 4 par | a0 = 0.999512 |
| | | | | | | BIL | | a1 = 0.75 |
| | | | | | | | | a2 = 0.997559 |
| | | | | | | | | a3 = 0.25 |
| | | 16476 | 20407 | 0 | 23 | 1/16 | 4 par | a0 = 0.98877 |
| | | | | | | BIC | | a1 = 3.25 |
| | | | | | | | | a2 = 1.0 |
| | | | | | | | | a3 = 0.0 |
| 14 | 13 | 367329 | 531075 | 166 | 43 | | | |
| | | 221842 | 235372 | 166 | 14 | 1/8 | 6 par | a0 = 1.0 |
| | | | | | | HEVC | | a1 = 0.0 |
| | | | | | | | | a2 = −4.25 |
| | | | | | | | | a3 = 0.0 |
| | | | | | | | | a4 = 1.0 |
| | | | | | | | | a5 = 0.0 |
| | | 127359 | 270365 | 0 | 20 | 1/16 | 4 par | a0 = 0.99707 |
| | | | | | | BIL | | a1 = 1.0 |
| | | | | | | | | a2 = 0.999023 |
| | | | | | | | | a3 = 0.0 |
| | | 18128 | 25338 | 0 | 7 | 1/16 | 4 par | a0 = 1.0 |
| | | | | | | BIC | | a1 = −0.25 |
| | | | | | | | | a2 = 0.999023 |
| | | | | | | | | a3 = 0.25 |
| 15 | 14 | 366339 | 535804 | 196 | 54 | | | |
| | | 228006 | 227902 | 185 | 17 | 1/8 | 6 par | a0 = 1.0 |
| | | | | | | HEVC | | a1 = 0.0 |
| | | | | | | | | a2 = −4.5 |
| | | | | | | | | a3 = 0.0 |
| | | | | | | | | a4 = 1.0 |
| | | | | | | | | a5 = 0.0 |
| | | 119444 | 289024 | 2 | 19 | 1/16 | 4 par | a0 = 0.995605 |
| | | | | | | BIL | | a1 = 1.0 |
| | | | | | | | | a2 = 0.997559 |
| | | | | | | | | a3 = 0.25 |
| | | 18889 | 18878 | 9 | 16 | 1/8 | 4 par | a0 = 1.0 |
| | | | | | | HEVC | | a1 = 0.0 |
| | | | | | | | | a2 = 1.0 |
| | | | | | | | | a3 = 0.0 |
| 16 | 15 | 376432 | 518436 | 164 | 62 | | | |
| | | 232008 | 248966 | 163 | 6 | 1/8 | 6 par | a0 = 1.0 |
| | | | | | | HEVC | | a1 = 0.0 |
| | | | | | | | | a2 = −4.5 |
| | | | | | | | | a3 = 0.0 |
| | | | | | | | | a4 = 1.0 |
| | | | | | | | | a5 = 0.0 |
| | | 126729 | 244411 | 1 | 34 | 1/8 | 6 par | a0 = 0.998047 |
| | | | | | | AVC | | a1 = 0.001953 |
| | | | | | | | | a2 = 0.5 |
| | | | | | | | | a3 = 0.000488 |
| | | | | | | | | a4 = 1.001953 |
| | | | | | | | | a5 = −0.5 |
| | | 17695 | 25059 | 0 | 20 | 1/16 | 4 par | a0 = 0.986328 |
| | | | | | | BIC | | a1 = 3.75 |
| | | | | | | | | a2 = 1.002441 |
| | | | | | | | | a3 = −0.75 |
| 17 | 16 | 375927 | 568442 | 166 | 43 | | | |
| | | 242929 | 252844 | 165 | 6 | 1/8 | 6 par | a0 = 1.0 |
| | | | | | | HEVC | | a1 = 0.0 |
| | | | | | | | | a2 = −4.5 |
| | | | | | | | | a3 = 0.0 |
| | | | | | | | | a4 = 1.0 |
| | | | | | | | | a5 = 0.0 |
| | | 114395 | 292476 | 0 | 16 | 1/8 | 4 par | a0 = 0.998047 |
| | | | | | | AVC | | a1 = 0.5 |
| | | | | | | | | a2 = 0.998047 |
| | | | | | | | | a3 = 0.0 |
| | | 18603 | 23122 | 1 | 19 | 1/16 | 4 par | a0 = 0.990723 |
| | | | | | | BIC | | a1 = 2.5 |
| | | | | | | | | a2 = 1.000977 |
| | | | | | | | | a3 = −0.25 |
| 18 | 17 | 369877 | 583006 | 156 | 65 | | | |
| | | 235293 | 230571 | 154 | 18 | 1/8 | 6 par | a0 = 1.0 |
| | | | | | | HEVC | | a1 = −0.000977 |
| | | | | | | | | a2 = −4.5 |
| | | | | | | | | a3 = 0.0 |
| | | | | | | | | a4 = 1.0 |
| | | | | | | | | a5 = 0.0 |
| | | 114169 | 313699 | 2 | 17 | 1/16 | 4 par | a0 = 0.998047 |
| | | | | | | BIL | | a1 = 0.25 |
| | | | | | | | | a2 = 0.999023 |
| | | | | | | | | a3 = 0.0 |
| | | 20415 | 38736 | 0 | 28 | 1/8 | 6 par | a0 = 1.015137 |
| | | | | | | AVC | | a1 = 0.014648 |
| | | | | | | | | a2 = −8.5 |
| | | | | | | | | a3 = 0.000488 |
| | | | | | | | | a4 = 0.999023 |
| | | | | | | | | a5 = 0.0 |
| 19 | 18 | 349564 | 449149 | 165 | 135 | | | |
| | | 220761 | 237038 | 162 | 17 | 1/16 | 6 par | a0 = 1.0 |
| | | | | | | BIC | | a1 = 0.0 |
| | | | | | | | | a2 = −4.75 |
| | | | | | | | | a3 = 0.0 |
| | | | | | | | | a4 = 1.0 |
| | | | | | | | | a5 = 0.0 |
| | | 108350 | 176480 | 3 | 94 | 1/8 | 8 par | a0 = 0.000026 |
| | | | | | | AVC | | a1 = −0.000171 |
| | | | | | | | | a2 = 0.002604 |
| | | | | | | | | a3 = 0.035645 |
| | | | | | | | | a4 = −1.0 |
| | | | | | | | | a5 = −0.003418 |
| | | | | | | | | a6 = 0.026594 |
| | | | | | | | | a7 = −1.0 |
| | | 20453 | 35631 | 0 | 22 | 1/16 | 4 par | a0 = 1.007324 |
| | | | | | | BIL | | a1 = −2.5 |
| | | | | | | | | a2 = 1.000977 |
| | | | | | | | | a3 = 0.0 |
| 20 | 19 | 363053 | 514003 | 181 | 60 | | | |
| | | 227443 | 233953 | 180 | 20 | 1/16 | 6 par | a0 = 1.0 |
| | | | | | | BIC | | a1 = −0.000977 |
| | | | | | | | | a2 = −5.0 |
| | | | | | | | | a3 = 0.000488 |
| | | | | | | | | a4 = 1.0 |
| | | | | | | | | a5 = 0.0 |
| | | 113876 | 234885 | 1 | 13 | 1/16 | 4 par | a0 = 0.998535 |
| | | | | | | BIL | | a1 = 0.0 |
| | | | | | | | | a2 = 0.999023 |
| | | | | | | | | a3 = 0.0 |
| | | 21734 | 45165 | 0 | 25 | 1/16 | 4 par | a0 = 1.035645 |
| | | | | | | BIL | | a1 = −11.0 |
| | | | | | | | | a2 = 1.006836 |
| | | | | | | | | a3 = −1.75 |
| 21 | 20 | 406103 | 571966 | 112 | 96 | | | |
| | | 236805 | 247536 | 106 | 22 | 1/8 | 6 par | a0 = 1.0 |
| | | | | | | HEVC | | a1 = −0.000977 |
| | | | | | | | | a2 = −5.5 |
| | | | | | | | | a3 = 0.0 |
| | | | | | | | | a4 = 1.0 |
| | | | | | | | | a5 = 0.0 |
| | | 143808 | 270136 | 6 | 28 | 1/16 | 6 par | a0 = 0.995117 |
| | | | | | | BIC | | a1 = 0.003418 |
| | | | | | | | | a2 = 0.0 |
| | | | | | | | | a3 = −0.001465 |
| | | | | | | | | a4 = 1.004395 |
| | | | | | | | | a5 = −0.5 |
| | | 25490 | 54294 | 0 | 44 | 1/16 | 6 par | a0 = 1.05127 |
| | | | | | | BIL | | a1 = 0.041504 |
| | | | | | | | | a2 = −26.0 |
| | | | | | | | | a3 = −0.004883 |
| | | | | | | | | a4 = 1.000977 |
| | | | | | | | | a5 = 1.25 |
| 22 | 21 | 388160 | 538760 | 113 | 74 | | | |
| | | 239462 | 263599 | 108 | 25 | 1/16 | 6 par | a0 = 0.999512 |
| | | | | | | BIC | | a1 = −0.000977 |
| | | | | | | | | a2 = −5.5 |
| | | | | | | | | a3 = 0.0 |
| | | | | | | | | a4 = 0.999023 |
| | | | | | | | | a5 = 0.25 |
| | | 123459 | 237084 | 4 | 24 | 1/8 | 4 par | a0 = 1.001465 |
| | | | | | | AVC | | a1 = −0.75 |
| | | | | | | | | a2 = 1.005859 |
| | | | | | | | | a3 = −1.0 |
| | | 25239 | 38077 | 1 | 23 | 1/16 | 4 par | a0 = 1.018555 |
| | | | | | | BIL | | a1 = −5.75 |
| | | | | | | | | a2 = 1.0 |
| | | | | | | | | a3 = 0.0 |
| 23 | 22 | 370195 | 564436 | 80 | 83 | | | |
| | | 217635 | 253285 | 78 | 18 | 1/16 | 6 par | a0 = 1.000488 |
| | | | | | | BIC | | a1 = 0.000977 |
| | | | | | | | | a2 = −6.25 |
| | | | | | | | | a3 = 0.0 |
| | | | | | | | | a4 = 0.999023 |
| | | | | | | | | a5 = 0.25 |
| | | 128855 | 265114 | 2 | 23 | 1/16 | 4 par | a0 = 0.998047 |
| | | | | | | BIL | | a1 = −0.5 |
| | | | | | | | | a2 = 1.009766 |
| | | | | | | | | a3 = −1.5 |
| | | 23705 | 46037 | 0 | 40 | 1/16 | 6 par | a0 = 1.039063 |
| | | | | | | BIL | | a1 = 0.048828 |
| | | | | | | | | a2 = −23.75 |
| | | | | | | | | a3 = −0.000488 |
| | | | | | | | | a4 = 0.999023 |
| | | | | | | | | a5 = 0.5 |
| 24 | 23 | 381250 | 602303 | 155 | 75 | | | |
| | | 184341 | 194029 | 153 | 25 | 1/8 | 6 par | a0 = 1.0 |
| | | | | | | HEVC | | a1 = 0.0 |
| | | | | | | | | a2 = −6.25 |
| | | | | | | | | a3 = 0.0 |
| | | | | | | | | a4 = 1.0 |
| | | | | | | | | a5 = 0.0 |
| | | 171709 | 365567 | 2 | 22 | 1/16 | 4 par | a0 = 1.001465 |
| | | | | | | BIL | | a1 = −1.25 |
| | | | | | | | | a2 = 1.006836 |
| | | | | | | | | a3 = −1.25 |
| | | 25200 | 42707 | 0 | 26 | 1/16 | 4 par | a0 = 1.041016 |
| | | | | | | BIL | | a1 = −12.0 |
| | | | | | | | | a2 = 1.010254 |
| | | | | | | | | a3 = −2.5 |
| 25 | 24 | 427065 | 704422 | 137 | 151 | | | |
| | | 236415 | 247716 | 136 | 19 | 1/8 | 6 par | a0 = 0.999512 |
| | | | | | | HEVC | | a1 = −0.000977 |
| | | | | | | | | a2 = −6.25 |
| | | | | | | | | a3 = 0.000488 |
| | | | | | | | | a4 = 1.000977 |
| | | | | | | | | a5 = 0.0 |
| | | 165703 | 410306 | 1 | 103 | 1/16 | 8 par | a0 = −0.000194 |
| | | | | | | BIL | | a1 = −0.000783 |
| | | | | | | | | a2 = 0.174006 |
| | | | | | | | | a3 = 0.100586 |
| | | | | | | | | a4 = −19.0 |
| | | | | | | | | a5 = 0.029297 |
| | | | | | | | | a6 = 0.268308 |
| | | | | | | | | a7 = −22.0 |
| | | 24947 | 46400 | 0 | 27 | 1/16 | 4 par | a0 = 1.049805 |
| | | | | | | BIL | | a1 = −15.0 |
| | | | | | | | | a2 = 0.998047 |
| | | | | | | | | a3 = 0.5 |
| 26 | 25 | 396717 | 535947 | 130 | 69 | | | |
| | | 212510 | 219955 | 123 | 20 | 1/16 | 6 par | a0 = 1.0 |
| | | | | | | BIC | | a1 = 0.0 |
| | | | | | | | | a2 = −6.75 |
| | | | | | | | | a3 = 0.000488 |
| | | | | | | | | a4 = 1.0 |
| | | | | | | | | a5 = 0.0 |
| | | 160328 | 270020 | 7 | 23 | 1/16 | 4 par | a0 = 0.998047 |
| | | | | | | BIL | | a1 = −0.5 |
| | | | | | | | | a2 = 1.001953 |
| | | | | | | | | a3 = −0.25 |
| | | 23879 | 45972 | 0 | 24 | 1/16 | 4 par | a0 = 1.03125 |
| | | | | | | BIL | | a1 = −9.75 |
| | | | | | | | | a2 = 1.0 |
| | | | | | | | | a3 = 0.0 |
| 27 | 26 | 410356 | 569587 | 115 | 121 | | | |
| | | 202047 | 207334 | 104 | 57 | 1/8 | 8 par | a0 = −0.000019 |
| | | | | | | HEVC | | a1 = 0.000006 |
| | | | | | | | | a2 = 0.006313 |
| | | | | | | | | a3 = −0.005371 |
| | | | | | | | | a4 = −28.0 |
| | | | | | | | | a5 = 0.00293 |
| | | | | | | | | a6 = 0.001578 |
| | | | | | | | | a7 = 0.0 |
| | | 184338 | 309363 | 11 | 35 | 1/8 | 6 par | a0 = 0.995605 |
| | | | | | | AVC | | a1 = −0.004395 |
| | | | | | | | | a2 = 0.0 |
| | | | | | | | | a3 = 0.000488 |
| | | | | | | | | a4 = 1.002441 |
| | | | | | | | | a5 = −0.5 |
| | | 23971 | 52890 | 0 | 27 | 1/16 | 4 par | a0 = 0.98291 |
| | | | | | | BIL | | a1 = 4.0 |
| | | | | | | | | a2 = 0.998047 |
| | | | | | | | | a3 = 0.5 |
| 28 | 27 | 419391 | 701873 | 104 | 105 | | | |
| | | 212664 | 221263 | 101 | 21 | 1/8 | 6 par | a0 = 1.0 |
| | | | | | | HEVC | | a1 = −0.000977 |
| | | | | | | | | a2 = −7.25 |
| | | | | | | | | a3 = 0.000488 |
| | | | | | | | | a4 = 1.0 |
| | | | | | | | | a5 = 0.0 |
| | | 183066 | 432744 | 3 | 38 | 1/16 | 6 par | a0 = 0.99707 |
| | | | | | | BIL | | a1 = −0.019043 |
| | | | | | | | | a2 = 2.25 |
| | | | | | | | | a3 = 0.000488 |
| | | | | | | | | a4 = 1.008789 |
| | | | | | | | | a5 = −1.5 |
| | | 23661 | 47866 | 0 | 44 | 1/16 | 6 par | a0 = 1.006348 |
| | | | | | | BIL | | a1 = 0.058105 |
| | | | | | | | | a2 = −16.75 |
| | | | | | | | | a3 = −0.004395 |
| | | | | | | | | a4 = 0.996582 |
| | | | | | | | | a5 = 2.0 |
| 29 | 28 | 446769 | 774599 | 131 | 109 | | | |
| | | 233241 | 235823 | 122 | 27 | 1/8 | 6 par | a0 = 1.0 |
| | | | | | | HEVC | | a1 = −0.000977 |
| | | | | | | | | a2 = −7.25 |
| | | | | | | | | a3 = 0.0 |
| | | | | | | | | a4 = 1.0 |
| | | | | | | | | a5 = 0.25 |
| | | 187942 | 512219 | 5 | 34 | 1/16 | 6 par | a0 = 1.00293 |
| | | | | | | BIL | | a1 = 0.001953 |
| | | | | | | | | a2 = −2.0 |
| | | | | | | | | a3 = 0.001465 |
| | | | | | | | | a4 = 1.010254 |
| | | | | | | | | a5 = −1.75 |
| | | 25586 | 26557 | 4 | 46 | 1/8 | 8 par | a0 = 0.0 |
| | | | | | | AVC | | a1 = 0.0 |
| | | | | | | | | a2 = 0.0 |
| | | | | | | | | a3 = 0.0 |
| | | | | | | | | a4 = 0.0 |
| | | | | | | | | a5 = 0.0 |
| | | | | | | | | a6 = 0.0 |
| | | | | | | | | a7 = 0.0 |
| 30 | 29 | 430705 | 673063 | 125 | 84 | | | |
| | | 231657 | 227703 | 125 | 24 | 1/8 | 6 par | a0 = 1.0 |
| | | | | | | HEVC | | a1 = −0.000977 |
| | | | | | | | | a2 = −7.25 |
| | | | | | | | | a3 = −0.000488 |
| | | | | | | | | a4 = 1.0 |
| | | | | | | | | a5 = 0.25 |
| | | 174786 | 393591 | 0 | 24 | 1/16 | 4 par | a0 = 1.000488 |
| | | | | | | BIL | | a1 = −1.5 |
| | | | | | | | | a2 = 0.995605 |
| | | | | | | | | a3 = 0.5 |
| | | 24262 | 51769 | 0 | 34 | 1/16 | 4 par | a0 = 1.077637 |
| | | | | | | BIL | | a1 = −22.5 |
| | | | | | | | | a2 = 1.014648 |
| | | | | | | | | a3 = −3.5 |
| 31 | 30 | 414954 | 681224 | 114 | 52 | | | |
| | | 220333 | 237129 | 112 | 6 | 1/8 | 6 par | a0 = 1.0 |
| | | | | | | HEVC | | a1 = −0.000977 |
| | | | | | | | | a2 = −7.25 |
| | | | | | | | | a3 = 0.0 |
| | | | | | | | | a4 = 1.0 |
| | | | | | | | | a5 = 0.25 |
| | | 171238 | 391712 | 2 | 19 | 1/16 | 4 par | a0 = 1.003418 |
| | | | | | | BIL | | a1 = −2.25 |
| | | | | | | | | a2 = 1.001953 |
| | | | | | | | | a3 = −0.25 |
| | | 23383 | 52383 | 0 | 25 | 1/16 | 4 par | a0 = 1.053223 |
| | | | | | | BIL | | a1 = −16.25 |
| | | | | | | | | a2 = 0.994141 |
| | | | | | | | | a3 = 1.5 |
| 32 | 31 | 423283 | 644011 | 103 | 56 | | | |
| | | 239873 | 253978 | 99 | 6 | 1/8 | 6 par | a0 = 1.0 |
| | | | | | | HEVC | | a1 = −0.000977 |
| | | | | | | | | a2 = −7.25 |
| | | | | | | | | a3 = 0.0 |
| | | | | | | | | a4 = 1.0 |
| | | | | | | | | a5 = 0.25 |
| | | 156816 | 332641 | 4 | 23 | 1/8 | 4 par | a0 = 0.998535 |
| | | | | | | AVC | | a1 = −1.0 |
| | | | | | | | | a2 = 1.0 |
| | | | | | | | | a3 = 0.0 |
| | | 26594 | 57392 | 0 | 25 | 1/16 | 4 par | a0 = 1.029785 |
| | | | | | | BIL | | a1 = −9.5 |
| | | | | | | | | a2 = 0.989746 |
| | | | | | | | | a3 = 2.75 |

TABLE 15
SAD Results of RMM for CIF “City” sequence (33 frames) with GOP 8 Pyramid:

| F | R | Ref SAD | RMMs SAD | NBB | Bits | SP Filter | Mod | RMMs Parameters |
|---|---|---|---|---|---|---|---|---|
| 1 | 0 | 212423 | 192437 | 319 | 145 | | | |
| | | 158412 | 140102 | 259 | 69 | 1/8 | 8 par | a0 = 0.000021 |
| | | | | | | HEVC | | a1 = −0.000007 |
| | | | | | | | | a2 = −0.006787 |
| | | | | | | | | a3 = −0.005371 |
| | | | | | | | | a4 = 9.0 |
| | | | | | | | | a5 = −0.00293 |
| | | | | | | | | a6 = −0.001736 |
| | | | | | | | | a7 = 0.0 |
| | | 54011 | 52335 | 60 | 70 | 1/8 | 8 par | a0 = 0.000119 |
| | | | | | | HEVC | | a1 = 0.000015 |
| | | | | | | | | a2 = −0.042535 |
| | | | | | | | | a3 = −0.002441 |
| | | | | | | | | a4 = 5.0 |
| | | | | | | | | a5 = −0.022949 |
| | | | | | | | | a6 = −0.02036 |
| | | | | | | | | a7 = 3.0 |
| 2 | 1 | 229550 | 234466 | 223 | 79 | | | |
| | | 169572 | 154724 | 214 | 42 | 1/8 | 6 par | a0 = 1.0 |
| | | | | | | HEVC | | a1 = −0.001953 |
| | | | | | | | | a2 = 1.75 |
| | | | | | | | | a3 = 0.000488 |
| | | | | | | | | a4 = 1.0 |
| | | | | | | | | a5 = −0.75 |
| | | 59978 | 79742 | 9 | 35 | 1/8 | 6 par | a0 = 1.0 |
| | | | | | | AVC | | a1 = 0.0 |
| | | | | | | | | a2 = 0.0 |
| | | | | | | | | a3 = 0.005859 |
| | | | | | | | | a4 = 1.000977 |
| | | | | | | | | a5 = −1.75 |
| 3 | 2 | 205169 | 211963 | 224 | 50 | | | |
| | | 151965 | 147291 | 207 | 26 | 1/8 | 6 par | a0 = 1.0 |
| | | | | | | HEVC | | a1 = −0.000977 |
| | | | | | | | | a2 = 1.25 |
| | | | | | | | | a3 = 0.0 |
| | | | | | | | | a4 = 1.0 |
| | | | | | | | | a5 = −0.75 |
| | | 53204 | 64672 | 17 | 22 | 1/8 | 4 par | a0 = 1.0 |
| | | | | | | HEVC | | a1 = −0.5 |
| | | | | | | | | a2 = 0.999023 |
| | | | | | | | | a3 = −0.75 |
| 4 | 3 | 209697 | 206665 | 238 | 89 | | | |
| | | 153360 | 152438 | 178 | 16 | 1/8 | 6 par | a0 = 0.999512 |
| | | | | | | HEVC | | a1 = −0.001953 |
| | | | | | | | | a2 = 1.25 |
| | | | | | | | | a3 = −0.000488 |
| | | | | | | | | a4 = 1.0 |
| | | | | | | | | a5 = −0.75 |
| | | 56337 | 54227 | 60 | 71 | 1/8 | 8 par | a0 = −0.00004 |
| | | | | | | HEVC | | a1 = −0.000052 |
| | | | | | | | | a2 = 0.018782 |
| | | | | | | | | a3 = 0.012207 |
| | | | | | | | | a4 = −5.0 |
| | | | | | | | | a5 = 0.01123 |
| | | | | | | | | a6 = 0.022175 |
| | | | | | | | | a7 = −6.0 |
| 5 | 4 | 215696 | 207325 | 282 | 92 | | | |
| | | 158210 | 151872 | 233 | 19 | 1/8 | 6 par | a0 = 1.0 |
| | | | | | | HEVC | | a1 = −0.001953 |
| | | | | | | | | a2 = 1.25 |
| | | | | | | | | a3 = 0.0 |
| | | | | | | | | a4 = 1.0 |
| | | | | | | | | a5 = −0.5 |
| | | 57486 | 55453 | 49 | 71 | 1/8 | 8 par | a0 = 0.000089 |
| | | | | | | HEVC | | a1 = −0.00005 |
| | | | | | | | | a2 = −0.014205 |
| | | | | | | | | a3 = 0.010254 |
| | | | | | | | | a4 = −3.0 |
| | | | | | | | | a5 = −0.023926 |
| | | | | | | | | a6 = −0.000631 |
| | | | | | | | | a7 = 1.0 |
| 6 | 5 | 219246 | 229817 | 205 | 45 | | | |
| | | 165371 | 169497 | 174 | 18 | 1/8 | 6 par | a0 = 1.0 |
| | | | | | | HEVC | | a1 = −0.002441 |
| | | | | | | | | a2 = 1.0 |
| | | | | | | | | a3 = 0.0 |
| | | | | | | | | a4 = 1.0 |
| | | | | | | | | a5 = −0.5 |
| | | 53875 | 60320 | 31 | 25 | 1/8 | 6 par | a0 = 1.001465 |
| | | | | | | HEVC | | a1 = 0.0 |
| | | | | | | | | a2 = −1.25 |
| | | | | | | | | a3 = −0.000488 |
| | | | | | | | | a4 = 1.000977 |
| | | | | | | | | a5 = −0.5 |
| 7 | 6 | 208662 | 238344 | 159 | 102 | | | |
| | | 159533 | 186796 | 114 | 29 | 1/8 | 6 par | a0 = 1.000488 |
| | | | | | | HEVC | | a1 = −0.002441 |
| | | | | | | | | a2 = 0.75 |
| | | | | | | | | a3 = 0.0 |
| | | | | | | | | a4 = 1.0 |
| | | | | | | | | a5 = 0.0 |
| | | 49129 | 51548 | 45 | 71 | 1/16 | 8 par | a0 = 0.000212 |
| | | | | | | BIC | | a1 = −0.00003 |
| | | | | | | | | a2 = −0.057134 |
| | | | | | | | | a3 = 0.0 |
| | | | | | | | | a4 = 0.0 |
| | | | | | | | | a5 = −0.051758 |
| | | | | | | | | a6 = −0.020597 |
| | | | | | | | | a7 = 7.0 |
| 8 | 7 | 200582 | 188583 | 269 | 75 | | | |
| | | 146402 | 135954 | 213 | 19 | 1/8 | 6 par | a0 = 1.0 |
| | | | | | | HEVC | | a1 = −0.000977 |
| | | | | | | | | a2 = 0.25 |
| | | | | | | | | a3 = 0.000488 |
| | | | | | | | | a4 = 1.0 |
| | | | | | | | | a5 = 0.0 |
| | | 54180 | 52629 | 56 | 54 | 1/8 | 8 par | a0 = −0.000008 |
| | | | | | | HEVC | | a1 = −0.000013 |
| | | | | | | | | a2 = 0.004182 |
| | | | | | | | | a3 = 0.000977 |
| | | | | | | | | a4 = −6.0 |
| | | | | | | | | a5 = 0.004395 |
| | | | | | | | | a6 = 0.002762 |
| | | | | | | | | a7 = 0.0 |
| 9 | 8 | 213050 | 192488 | 300 | 46 | | | |
| | | 157005 | 139785 | 234 | 16 | 1/8 | 6 par | a0 = 1.0 |
| | | | | | | HEVC | | a1 = −0.002441 |
| | | | | | | | | a2 = 0.25 |
| | | | | | | | | a3 = 0.001465 |
| | | | | | | | | a4 = 1.0 |
| | | | | | | | | a5 = 0.0 |
| | | 56045 | 52703 | 66 | 28 | 1/8 | 6 par | a0 = 1.000488 |
| | | | | | | HEVC | | a1 = −0.000977 |
| | | | | | | | | a2 = −1.75 |
| | | | | | | | | a3 = 0.000488 |
| | | | | | | | | a4 = 1.0 |
| | | | | | | | | a5 = 0.25 |
| 10 | 9 | 209863 | 212980 | 232 | 64 | | | |
| | | 155920 | 153900 | 193 | 43 | 1/8 | 8 par | a0 = −0.0 |
| | | | | | | HEVC | | a1 = −0.0 |
| | | | | | | | | a2 = 0.000868 |
| | | | | | | | | a3 = −0.006836 |
| | | | | | | | | a4 = 1.0 |
| | | | | | | | | a5 = 0.004395 |
| | | | | | | | | a6 = 0.00071 |
| | | | | | | | | a7 = 0.0 |
| | | 53943 | 59080 | 39 | 19 | 1/8 | 4 par | a0 = 1.0 |
| | | | | | | HEVC | | a1 = −1.75 |
| | | | | | | | | a2 = 1.000977 |
| | | | | | | | | a3 = 0.0 |
| 11 | 10 | 187940 | 199108 | 200 | 37 | | | |
| | | 143245 | 141634 | 184 | 17 | 1/8 | 6 par | a0 = 0.999512 |
| | | | | | | HEVC | | a1 = −0.001953 |
| | | | | | | | | a2 = 0.5 |
| | | | | | | | | a3 = 0.0 |
| | | | | | | | | a4 = 1.0 |
| | | | | | | | | a5 = 0.0 |
| | | 44695 | 57474 | 16 | 18 | 1/8 | 4 par | a0 = 1.0 |
| | | | | | | HEVC | | a1 = −1.5 |
| | | | | | | | | a2 = 0.999023 |
| | | | | | | | | a3 = 0.0 |
| 12 | 11 | 210591 | 202473 | 235 | 49 | | | |
| | | 159901 | 148231 | 195 | 20 | 1/8 | 6 par | a0 = 1.0 |
| | | | | | | HEVC | | a1 = −0.003418 |
| | | | | | | | | a2 = 1.0 |
| | | | | | | | | a3 = 0.001465 |
| | | | | | | | | a4 = 1.0 |
| | | | | | | | | a5 = 0.0 |
| | | 50690 | 54242 | 40 | 27 | 1/8 | 6 par | a0 = 1.000488 |
| | | | | | | HEVC | | a1 = −0.000977 |
| | | | | | | | | a2 = −1.0 |
| | | | | | | | | a3 = 0.001465 |
| | | | | | | | | a4 = 1.000977 |
| | | | | | | | | a5 = −0.25 |
| 13 | 12 | 206503 | 211452 | 212 | 41 | | | |
| | | 150555 | 146944 | 189 | 20 | 1/8 | 6 par | a0 = 1.0 |
| | | | | | | HEVC | | a1 = −0.003418 |
| | | | | | | | | a2 = 1.5 |
| | | | | | | | | a3 = 0.001465 |
| | | | | | | | | a4 = 1.0 |
| | | | | | | | | a5 = 0.0 |
| | | 55948 | 64508 | 23 | 19 | 1/16 | 4 par | a0 = 1.001465 |
| | | | | | | BIC | | a1 = −1.0 |
| | | | | | | | | a2 = 1.000977 |
| | | | | | | | | a3 = 0.0 |
| 14 | 13 | 220126 | 230887 | 178 | 49 | | | |
| | | 158717 | 162731 | 143 | 21 | 1/8 | 6 par | a0 = 1.0 |
| | | | | | | HEVC | | a1 = −0.003418 |
| | | | | | | | | a2 = 1.75 |
| | | | | | | | | a3 = 0.001953 |
| | | | | | | | | a4 = 0.999023 |
| | | | | | | | | a5 = 0.25 |
| | | 61409 | 68156 | 35 | 26 | 1/8 | 6 par | a0 = 1.000488 |
| | | | | | | HEVC | | a1 = −0.000977 |
| | | | | | | | | a2 = −0.25 |
| | | | | | | | | a3 = 0.0 |
| | | | | | | | | a4 = 0.999023 |
| | | | | | | | | a5 = 0.5 |
| 15 | 14 | 216806 | 214247 | 236 | 94 | | | |
| | | 156268 | 157991 | 174 | 30 | 1/8 | 6 par | a0 = 1.0 |
| | | | | | | HEVC | | a1 = −0.002441 |
| | | | | | | | | a2 = 2.25 |
| | | | | | | | | a3 = 0.000488 |
| | | | | | | | | a4 = 1.0 |
| | | | | | | | | a5 = −0.5 |
| | | 60538 | 56256 | 62 | 62 | 1/8 | 8 par | a0 = −0.000028 |
| | | | | | | HEVC | | a1 = 0.000009 |
| | | | | | | | | a2 = 0.002131 |
| | | | | | | | | a3 = −0.005371 |
| | | | | | | | | a4 = 2.0 |
| | | | | | | | | a5 = 0.017578 |
| | | | | | | | | a6 = −0.000237 |
| | | | | | | | | a7 = −4.0 |
| 16 | 15 | 204315 | 184048 | 308 | 99 | | | |
| | | 149776 | 136328 | 230 | 47 | 1/8 | 8 par | a0 = 0.000019 |
| | | | | | | HEVC | | a1 = −0.000007 |
| | | | | | | | | a2 = −0.005445 |
| | | | | | | | | a3 = −0.008789 |
| | | | | | | | | a4 = 9.0 |
| | | | | | | | | a5 = 0.000488 |
| | | | | | | | | a6 = 0.0 |
| | | | | | | | | a7 = −4.0 |
| | | 54539 | 47720 | 78 | 50 | 1/16 | 8 par | a0 = 0.000042 |
| | | | | | | BIC | | a1 = 0.000002 |
| | | | | | | | | a2 = −0.016572 |
| | | | | | | | | a3 = −0.002441 |
| | | | | | | | | a4 = 3.0 |
| | | | | | | | | a5 = −0.001465 |
| | | | | | | | | a6 = −0.008207 |
| | | | | | | | | a7 = −3.0 |
| 17 | 16 | 220697 | 235234 | 184 | 58 | | | |
| | | 163720 | 180242 | 138 | 29 | 1/8 | 6 par | a0 = 1.0 |
| | | | | | | HEVC | | a1 = −0.004395 |
| | | | | | | | | a2 = 2.0 |
| | | | | | | | | a3 = 0.001465 |
| | | | | | | | | a4 = 1.000977 |
| | | | | | | | | a5 = −0.75 |
| | | 56977 | 54992 | 46 | 27 | 1/8 | 6 par | a0 = 0.999512 |
| | | | | | | HEVC | | a1 = −0.000977 |
| | | | | | | | | a2 = 0.0 |
| | | | | | | | | a3 = 0.000488 |
| | | | | | | | | a4 = 1.0 |
| | | | | | | | | a5 = −0.5 |
| 18 | 17 | 212522 | 208490 | 241 | 49 | | | |
| | | 157953 | 155194 | 186 | 22 | 1/8 | 6 par | a0 = 1.0 |
| | | | | | | HEVC | | a1 = −0.003418 |
| | | | | | | | | a2 = 1.5 |
| | | | | | | | | a3 = 0.001953 |
| | | | | | | | | a4 = 1.0 |
| | | | | | | | | a5 = −0.75 |
| | | 54569 | 53296 | 55 | 25 | 1/8 | 6 par | a0 = 1.0 |
| | | | | | | HEVC | | a1 = −0.000977 |
| | | | | | | | | a2 = −0.5 |
| | | | | | | | | a3 = 0.001953 |
| | | | | | | | | a4 = 1.0 |
| | | | | | | | | a5 = −0.75 |
| 19 | 18 | 202083 | 210725 | 179 | 83 | | | |
| | | 150404 | 157936 | 127 | 23 | 1/8 | 6 par | a0 = 1.0 |
| | | | | | | HEVC | | a1 = −0.002441 |
| | | | | | | | | a2 = 1.25 |
| | | | | | | | | a3 = 0.001465 |
| | | | | | | | | a4 = 1.0 |
| | | | | | | | | a5 = −0.5 |
| | | 51679 | 52789 | 52 | 58 | 1/8 | 8 par | a0 = 0.000063 |
| | | | | | | HEVC | | a1 = 0.000018 |
| | | | | | | | | a2 = −0.026752 |
| | | | | | | | | a3 = −0.005371 |
| | | | | | | | | a4 = 0.0 |
| | | | | | | | | a5 = −0.004395 |
| | | | | | | | | a6 = −0.015388 |
| | | | | | | | | a7 = 0.0 |
| 20 | 19 | 228566 | 222360 | 263 | 78 | | | |
| | | 164540 | 155123 | 209 | 23 | 1/8 | 6 par | a0 = 1.0 |
| | | | | | | HEVC | | a1 = −0.001953 |
| | | | | | | | | a2 = 1.5 |
| | | | | | | | | a3 = 0.0 |
| | | | | | | | | a4 = 1.000977 |
| | | | | | | | | a5 = −0.75 |
| | | 64026 | 67237 | 54 | 53 | 1/8 | 8 par | a0 = 0.000062 |
| | | | | | | HEVC | | a1 = 0.000025 |
| | | | | | | | | a2 = −0.016651 |
| | | | | | | | | a3 = −0.000977 |
| | | | | | | | | a4 = −1.0 |
| | | | | | | | | a5 = −0.01709 |
| | | | | | | | | a6 = −0.022333 |
| | | | | | | | | a7 = 2.0 |
| 21 | 20 | 214900 | 231231 | 183 | 94 | | | |
| | | 160630 | 167022 | 147 | 22 | 1/8 | 6 par | a0 = 1.0 |
| | | | | | | HEVC | | a1 = −0.003418 |
| | | | | | | | | a2 = 2.0 |
| | | | | | | | | a3 = 0.001465 |
| | | | | | | | | a4 = 1.0 |
| | | | | | | | | a5 = −0.5 |
| | | 54270 | 64209 | 36 | 70 | 1/8 | 8 par | a0 = 0.000284 |
| | | | | | | HEVC | | a1 = −0.000052 |
| | | | | | | | | a2 = −0.078993 |
| | | | | | | | | a3 = 0.001953 |
| | | | | | | | | a4 = 6.0 |
| | | | | | | | | a5 = −0.063965 |
| | | | | | | | | a6 = −0.027304 |
| | | | | | | | | a7 = 8.0 |
| 22 | 21 | 210792 | 212656 | 249 | 48 | | | |
| | | 157735 | 154479 | 204 | 25 | 1/8 | 6 par | a0 = 1.0 |
| | | | | | | HEVC | | a1 = −0.001953 |
| | | | | | | | | a2 = 1.5 |
| | | | | | | | | a3 = 0.000488 |
| | | | | | | | | a4 = 1.0 |
| | | | | | | | | a5 = 0.0 |
| | | 53057 | 58177 | 45 | 21 | 1/8 | 4 par | a0 = 1.001953 |
| | | | | | | HEVC | | a1 = −0.75 |
| | | | | | | | | a2 = 0.998047 |
| | | | | | | | | a3 = 0.5 |
| 23 | 22 | 209067 | 203311 | 273 | 40 | | | |
| | | 157811 | 152582 | 206 | 23 | 1/8 | 6 par | a0 = 1.0 |
| | | | | | | HEVC | | a1 = −0.001953 |
| | | | | | | | | a2 = 1.0 |
| | | | | | | | | a3 = 0.000488 |
| | | | | | | | | a4 = 0.999023 |
| | | | | | | | | a5 = 0.25 |
| | | 51256 | 50729 | 67 | 15 | 1/8 | 4 par | a0 = 1.000488 |
| | | | | | | HEVC | | a1 = −1.0 |
| | | | | | | | | a2 = 1.0 |
| | | | | | | | | a3 = 0.25 |
| 24 | 23 | 192579 | 188654 | 239 | 87 | | | |
| | | 144162 | 140398 | 191 | 16 | 1/8 | 6 par | a0 = 1.0 |
| | | | | | | HEVC | | a1 = −0.002441 |
| | | | | | | | | a2 = 1.0 |
| | | | | | | | | a3 = 0.0 |
| | | | | | | | | a4 = 1.0 |
| | | | | | | | | a5 = 0.0 |
| | | 48417 | 48256 | 48 | 69 | 1/16 | 8 par | a0 = 0.00017 |
| | | | | | | BIC | | a1 = 0.000012 |
| | | | | | | | | a2 = −0.063289 |
| | | | | | | | | a3 = −0.003418 |
| | | | | | | | | a4 = 2.0 |
| | | | | | | | | a5 = −0.039551 |
| | | | | | | | | a6 = −0.031566 |
| | | | | | | | | a7 = 7.0 |
| 25 | 24 | 210923 | 202512 | 272 | 43 | | | |
| | | 153889 | 146668 | 208 | 20 | 1/8 | 6 par | a0 = 1.0 |
| | | | | | | HEVC | | a1 = −0.000977 |
| | | | | | | | | a2 = 1.0 |
| | | | | | | | | a3 = 0.0 |
| | | | | | | | | a4 = 1.0 |
| | | | | | | | | a5 = −0.25 |
| | | 57034 | 55844 | 64 | 21 | 1/8 | 4 par | a0 = 1.0 |
| | | | | | | HEVC | | a1 = −0.75 |
| | | | | | | | | a2 = 1.0 |
| | | | | | | | | a3 = −0.25 |
| 26 | 25 | 220190 | 237977 | 184 | 96 | | | |
| | | 159167 | 158211 | 158 | 22 | 1/8 | 6 par | a0 = 0.999512 |
| | | | | | | HEVC | | a1 = −0.002441 |
| | | | | | | | | a2 = 1.75 |
| | | | | | | | | a3 = 0.001465 |
| | | | | | | | | a4 = 1.0 |
| | | | | | | | | a5 = 0.25 |
| | | 61023 | 79766 | 26 | 72 | 1/8 | 8 par | a0 = 0.000044 |
| | | | | | | HEVC | | a1 = −0.00007 |
| | | | | | | | | a2 = 0.000158 |
| | | | | | | | | a3 = 0.010254 |
| | | | | | | | | a4 = −3.0 |
| | | | | | | | | a5 = −0.022949 |
| | | | | | | | | a6 = 0.009075 |
| | | | | | | | | a7 = 5.0 |
| 27 | 26 | 217409 | 242732 | 182 | 41 | | | |
| | | 167075 | 196924 | 122 | 16 | 1/8 | 6 par | a0 = 1.0 |
| | | | | | | HEVC | | a1 = −0.003418 |
| | | | | | | | | a2 = 2.0 |
| | | | | | | | | a3 = 0.001465 |
| | | | | | | | | a4 = 1.0 |
| | | | | | | | | a5 = 0.25 |
| | | 50334 | 45808 | 60 | 23 | 1/8 | 6 par | a0 = 1.0 |
| | | | | | | HEVC | | a1 = −0.000977 |
| | | | | | | | | a2 = 0.0 |
| | | | | | | | | a3 = 0.001465 |
| | | | | | | | | a4 = 1.0 |
| | | | | | | | | a5 = 0.25 |
| 28 | 27 | 201569 | 201045 | 217 | 110 | | | |
| | | 147695 | 148409 | 160 | 48 | 1/8 | 8 par | a0 = 0.000018 |
| | | | | | | HEVC | | a1 = −0.000012 |
| | | | | | | | | a2 = −0.003867 |
| | | | | | | | | a3 = −0.013672 |
| | | | | | | | | a4 = 9.0 |
| | | | | | | | | a5 = 0.004883 |
| | | | | | | | | a6 = 0.001341 |
| | | | | | | | | a7 = 0.0 |
| | | 53874 | 52636 | 57 | 60 | 1/8 | 8 par | a0 = 0.000091 |
| | | | | | | HEVC | | a1 = 0.000009 |
| | | | | | | | | a2 = −0.032591 |
| | | | | | | | | a3 = −0.008789 |
| | | | | | | | | a4 = 4.0 |
| | | | | | | | | a5 = −0.010742 |
| | | | | | | | | a6 = −0.02036 |
| | | | | | | | | a7 = 3.0 |
| 29 | 28 | 200677 | 195462 | 239 | 79 | | | |
| | | 149224 | 146386 | 178 | 49 | 1/8 | 8 par | a0 = 0.000027 |
| | | | | | | HEVC | | a1 = −0.000001 |
| | | | | | | | | a2 = −0.009075 |
| | | | | | | | | a3 = −0.017578 |
| | | | | | | | | a4 = 10.0 |
| | | | | | | | | a5 = 0.006348 |
| | | | | | | | | a6 = −0.004656 |
| | | | | | | | | a7 = −2.0 |
| | | 51453 | 49076 | 61 | 28 | 1/8 | 6 par | a0 = 0.999512 |
| | | | | | | HEVC | | a1 = −0.002441 |
| | | | | | | | | a2 = 0.5 |
| | | | | | | | | a3 = 0.001953 |
| | | | | | | | | a4 = 1.0 |
| | | | | | | | | a5 = −0.5 |
| 30 | 29 | 200552 | 202578 | 206 | 51 | | | |
| | | 149921 | 150478 | 158 | 26 | 1/8 | 6 par | a0 = 1.0 |
| | | | | | | HEVC | | a1 = −0.004395 |
| | | | | | | | | a2 = 2.25 |
| | | | | | | | | a3 = 0.001953 |
| | | | | | | | | a4 = 1.0 |
| | | | | | | | | a5 = −0.5 |
| | | 50631 | 52100 | 48 | 23 | 1/8 | 6 par | a0 = 1.0 |
| | | | | | | HEVC | | a1 = −0.001953 |
| | | | | | | | | a2 = 0.25 |
| | | | | | | | | a3 = 0.001465 |
| | | | | | | | | a4 = 1.000977 |
| | | | | | | | | a5 = −0.5 |
| 31 | 30 | 203812 | 236197 | 155 | 70 | | | |
| | | 147832 | 147935 | 153 | 49 | 1/8 | 8 par | a0 = 0.000015 |
| | | | | | | HEVC | | a1 = 0.0 |
| | | | | | | | | a2 = −0.004498 |
| | | | | | | | | a3 = −0.016602 |
| | | | | | | | | a4 = 8.0 |
| | | | | | | | | a5 = 0.007813 |
| | | | | | | | | a6 = −0.001736 |
| | | | | | | | | a7 = −1.0 |
| | | 55980 | 88262 | 2 | 19 | 1/8 | 4 par | a0 = 1.0 |
| | | | | | | AVC | | a1 = −0.25 |
| | | | | | | | | a2 = 0.998047 |
| | | | | | | | | a3 = 0.25 |
| 32 | 31 | 203885 | 223401 | 180 | 55 | | | |
| | | 148303 | 151917 | 149 | 27 | 1/8 | 6 par | a0 = 1.0 |
| | | | | | | HEVC | | a1 = −0.004395 |
| | | | | | | | | a2 = 2.0 |
| | | | | | | | | a3 = 0.001953 |
| | | | | | | | | a4 = 1.0 |
| | | | | | | | | a5 = −0.25 |
| | | 55582 | 71484 | 31 | 26 | 1/8 | 6 par | a0 = 1.000488 |
| | | | | | | HEVC | | a1 = −0.001953 |
| | | | | | | | | a2 = 0.0 |
| | | | | | | | | a3 = −0.001465 |
| | | | | | | | | a4 = 0.998047 |
| | | | | | | | | a5 = 0.5 |

TABLE 16
SAD Results of RMM for CIF “Flower” sequence (33 frames) with GOP 8 Pyramid

| F | R | Ref SAD | RMMs SAD | NBB | Bits | SP Filter | Mod | RMMs Parameters |
|---|---|---|---|---|---|---|---|---|
| 1 | 0 | 527540 | 708926 | 63 | 182 | | | |
| | | 45730 | 117600 | 15 | 112 | 1/16 | 8 par | a0 = −0.000199 |
| | | | | | | BIL | | a1 = −0.000272 |
| | | | | | | | | a2 = 0.094302 |
| | | | | | | | | a3 = −0.048828 |
| | | | | | | | | a4 = 5.0 |
| | | | | | | | | a5 = 0.003418 |
| | | | | | | | | a6 = 0.056108 |
| | | | | | | | | a7 = −3.0 |
| | | 406573 | 462448 | 46 | 31 | 1/8 | 6 par | a0 = 1.001953 |
| | | | | | | HEVC | | a1 = 0.010254 |
| | | | | | | | | a2 = −1.25 |
| | | | | | | | | a3 = 0.0 |
| | | | | | | | | a4 = 1.0 |
| | | | | | | | | a5 = −0.25 |
| | | 75237 | 128878 | 2 | 33 | 1/16 | 4 par | a0 = 0.993652 |
| | | | | | | BIC | | a1 = 7.25 |
| | | | | | | | | a2 = 1.005371 |
| | | | | | | | | a3 = −1.75 |
| 2 | 1 | 463009 | 633694 | 63 | 152 | | | |
| | | 44411 | 111541 | 8 | 79 | 1/16 | 8 par | a0 = −0.000038 |
| | | | | | | BIL | | a1 = −0.000005 |
| | | | | | | | | a2 = 0.016888 |
| | | | | | | | | a3 = −0.054688 |
| | | | | | | | | a4 = 9.0 |
| | | | | | | | | a5 = −0.003418 |
| | | | | | | | | a6 = −0.001263 |
| | | | | | | | | a7 = 0.0 |
| | | 346868 | 413480 | 48 | 28 | 1/8 | 6 par | a0 = 1.001465 |
| | | | | | | HEVC | | a1 = 0.009766 |
| | | | | | | | | a2 = −1.0 |
| | | | | | | | | a3 = −0.000488 |
| | | | | | | | | a4 = 1.0 |
| | | | | | | | | a5 = 0.0 |
| | | 71730 | 108673 | 7 | 43 | 1/16 | 6 par | a0 = 1.007813 |
| | | | | | | BIC | | a1 = 0.003418 |
| | | | | | | | | a2 = 3.25 |
| | | | | | | | | a3 = 0.001465 |
| | | | | | | | | a4 = 1.005371 |
| | | | | | | | | a5 = −2.0 |
| 3 | 2 | 355197 | 513141 | 75 | 122 | | | |
| | | 44273 | 111547 | 10 | 68 | 1/16 | 8 par | a0 = −0.000126 |
| | | | | | | BIL | | a1 = −0.000215 |
| | | | | | | | | a2 = 0.048532 |
| | | | | | | | | a3 = −0.050293 |
| | | | | | | | | a4 = 8.0 |
| | | | | | | | | a5 = −0.00293 |
| | | | | | | | | a6 = 0.038826 |
| | | | | | | | | a7 = 0.0 |
| | | 240094 | 309241 | 44 | 20 | 1/8 | 6 par | a0 = 1.001953 |
| | | | | | | HEVC | | a1 = 0.01123 |
| | | | | | | | | a2 = −1.25 |
| | | | | | | | | a3 = 0.0 |
| | | | | | | | | a4 = 1.0 |
| | | | | | | | | a5 = 0.0 |
| | | 70830 | 92353 | 21 | 32 | 1/16 | 6 par | a0 = 1.012207 |
| | | | | | | BIC | | a1 = 0.003418 |
| | | | | | | | | a2 = 2.5 |
| | | | | | | | | a3 = −0.00293 |
| | | | | | | | | a4 = 1.005371 |
| | | | | | | | | a5 = −0.75 |
| 4 | 3 | 327923 | 486773 | 65 | 110 | | | |
| | | 42272 | 106832 | 12 | 62 | 1/16 | 8 par | a0 = −0.00021 |
| | | | | | | BIL | | a1 = −0.000311 |
| | | | | | | | | a2 = 0.082071 |
| | | | | | | | | a3 = −0.048828 |
| | | | | | | | | a4 = 7.0 |
| | | | | | | | | a5 = −0.003418 |
| | | | | | | | | a6 = 0.066288 |
| | | | | | | | | a7 = −1.0 |
| | | 210086 | 277605 | 51 | 19 | 1/8 | 6 par | a0 = 1.001953 |
| | | | | | | HEVC | | a1 = 0.010254 |
| | | | | | | | | a2 = −1.25 |
| | | | | | | | | a3 = 0.0 |
| | | | | | | | | a4 = 1.0 |
| | | | | | | | | a5 = 0.0 |
| | | 75565 | 102336 | 2 | 27 | 1/16 | 6 par | a0 = 1.012207 |
| | | | | | | BIC | | a1 = 0.002441 |
| | | | | | | | | a2 = 2.25 |
| | | | | | | | | a3 = −0.00293 |
| | | | | | | | | a4 = 1.005371 |
| | | | | | | | | a5 = −0.75 |
| 5 | 4 | 424389 | 559797 | 74 | 103 | | | |
| | | 43770 | 100412 | 12 | 54 | 1/16 | 8 par | a0 = −0.000111 |
| | | | | | | BIC | | a1 = −0.00017 |
| | | | | | | | | a2 = 0.043324 |
| | | | | | | | | a3 = −0.035645 |
| | | | | | | | | a4 = 6.0 |
| | | | | | | | | a5 = −0.001465 |
| | | | | | | | | a6 = 0.038905 |
| | | | | | | | | a7 = −1.0 |
| | | 298487 | 352855 | 55 | 17 | 1/8 | 6 par | a0 = 1.001953 |
| | | | | | | HEVC | | a1 = 0.010254 |
| | | | | | | | | a2 = −1.25 |
| | | | | | | | | a3 = −0.000488 |
| | | | | | | | | a4 = 1.0 |
| | | | | | | | | a5 = 0.0 |
| | | 82132 | 106530 | 7 | 30 | 1/16 | 6 par | a0 = 1.008301 |
| | | | | | | BIC | | a1 = 0.002441 |
| | | | | | | | | a2 = 3.0 |
| | | | | | | | | a3 = −0.004883 |
| | | | | | | | | a4 = 1.004395 |
| | | | | | | | | a5 = −0.25 |
| 6 | 5 | 426906 | 571831 | 73 | 120 | | | |
| | | 48326 | 119744 | 15 | 62 | 1/16 | 8 par | a0 = −0.000073 |
| | | | | | | BIL | | a1 = −0.000061 |
| | | | | | | | | a2 = 0.041509 |
| | | | | | | | | a3 = −0.055664 |
| | | | | | | | | a4 = 7.0 |
| | | | | | | | | a5 = −0.003418 |
| | | | | | | | | a6 = 0.02257 |
| | | | | | | | | a7 = −2.0 |
| | | 297729 | 339208 | 52 | 23 | 1/8 | 6 par | a0 = 1.00293 |
| | | | | | | HEVC | | a1 = 0.01123 |
| | | | | | | | | a2 = −1.5 |
| | | | | | | | | a3 = −0.000488 |
| | | | | | | | | a4 = 1.0 |
| | | | | | | | | a5 = 0.0 |
| | | 80851 | 112879 | 6 | 33 | 1/16 | 6 par | a0 = 1.01123 |
| | | | | | | BIL | | a1 = 0.004395 |
| | | | | | | | | a2 = 2.0 |
| | | | | | | | | a3 = 0.0 |
| | | | | | | | | a4 = 1.004395 |
| | | | | | | | | a5 = −1.25 |
| 7 | 6 | 381103 | 561953 | 73 | 170 | | | |
| | | 42289 | 119515 | 9 | 63 | 1/16 | 8 par | a0 = −0.000166 |
| | | | | | | BIL | | a1 = −0.000096 |
| | | | | | | | | a2 = 0.058949 |
| | | | | | | | | a3 = −0.064453 |
| | | | | | | | | a4 = 8.0 |
| | | | | | | | | a5 = −0.007813 |
| | | | | | | | | a6 = 0.015309 |
| | | | | | | | | a7 = 1.0 |
| | | 267467 | 331981 | 56 | 24 | 1/8 | 6 par | a0 = 1.00293 |
| | | | | | | HEVC | | a1 = 0.010254 |
| | | | | | | | | a2 = −1.25 |
| | | | | | | | | a3 = −0.000488 |
| | | | | | | | | a4 = 1.0 |
| | | | | | | | | a5 = 0.0 |
| | | 71347 | 110457 | 8 | 81 | 1/16 | 8 par | a0 = −0.000012 |
| | | | | | | BIC | | a1 = 0.000058 |
| | | | | | | | | a2 = 0.075442 |
| | | | | | | | | a3 = 0.000977 |
| | | | | | | | | a4 = 4.0 |
| | | | | | | | | a5 = 0.009277 |
| | | | | | | | | a6 = 0.001815 |
| | | | | | | | | a7 = −6.0 |
| 8 | 7 | 361055 | 546999 | 54 | 108 | | | |
| | | 39855 | 117321 | 10 | 51 | 1/16 | 8 par | a0 = −0.000185 |
| | | | | | | BIL | | a1 = −0.000304 |
| | | | | | | | | a2 = 0.0756 |
| | | | | | | | | a3 = −0.049316 |
| | | | | | | | | a4 = 6.0 |
| | | | | | | | | a5 = 0.001465 |
| | | | | | | | | a6 = 0.074968 |
| | | | | | | | | a7 = −3.0 |
| | | 238230 | 321802 | 39 | 26 | 1/16 | 6 par | a0 = 1.001953 |
| | | | | | | BIC | | a1 = 0.01123 |
| | | | | | | | | a2 = −1.25 |
| | | | | | | | | a3 = 0.0 |
| | | | | | | | | a4 = 1.0 |
| | | | | | | | | a5 = 0.0 |
| | | 82970 | 107876 | 5 | 29 | 1/16 | 6 par | a0 = 1.012207 |
| | | | | | | BIC | | a1 = 0.004395 |
| | | | | | | | | a2 = 2.25 |
| | | | | | | | | a3 = −0.005859 |
| | | | | | | | | a4 = 1.005371 |
| | | | | | | | | a5 = −0.25 |
| 9 | 8 | 332791 | 521954 | 51 | 103 | | | |
| | | 47542 | 120929 | 12 | 64 | 1/16 | 8 par | a0 = −0.000136 |
| | | | | | | BIL | | a1 = −0.000089 |
| | | | | | | | | a2 = 0.043403 |
| | | | | | | | | a3 = −0.063477 |
| | | | | | | | | a4 = 9.0 |
| | | | | | | | | a5 = 0.009277 |
| | | | | | | | | a6 = 0.023122 |
| | | | | | | | | a7 = −2.0 |
| | | 206465 | 291211 | 39 | 7 | 1/8 | 6 par | a0 = 1.001953 |
| | | | | | | HEVC | | a1 = 0.01123 |
| | | | | | | | | a2 = −1.25 |
| | | | | | | | | a3 = 0.0 |
| | | | | | | | | a4 = 1.0 |
| | | | | | | | | a5 = 0.0 |
| | | 78784 | 109814 | 0 | 30 | 1/16 | 6 par | a0 = 1.009277 |
| | | | | | | BIC | | a1 = 0.003418 |
| | | | | | | | | a2 = 3.0 |
| | | | | | | | | a3 = −0.003418 |
| | | | | | | | | a4 = 1.004395 |
| | | | | | | | | a5 = −0.5 |
| 10 | 9 | 327951 | 513992 | 38 | 104 | | | |
| | | 38317 | 98346 | 9 | 62 | 1/16 | 8 par | a0 = −0.000248 |
| | | | | | | BIL | | a1 = −0.000314 |
| | | | | | | | | a2 = 0.079782 |
| | | | | | | | | a3 = −0.052734 |
| | | | | | | | | a4 = 9.0 |
| | | | | | | | | a5 = 0.026367 |
| | | | | | | | | a6 = 0.099195 |
| | | | | | | | | a7 = −7.0 |
| | | 211145 | 311970 | 26 | 19 | 1/16 | 6 par | a0 = 1.001953 |
| | | | | | | BIC | | a1 = 0.010254 |
| | | | | | | | | a2 = −1.0 |
| | | | | | | | | a3 = 0.0 |
| | | | | | | | | a4 = 1.0 |
| | | | | | | | | a5 = 0.0 |
| | | 78489 | 103676 | 3 | 21 | 1/16 | 6 par | a0 = 1.01123 |
| | | | | | | BIC | | a1 = 0.004395 |
| | | | | | | | | a2 = 2.5 |
| | | | | | | | | a3 = −0.004883 |
| | | | | | | | | a4 = 1.004395 |
| | | | | | | | | a5 = −0.25 |
| 11 | 10 | 427390 | 570389 | 88 | 109 | | | |
| | | 37991 | 96276 | 11 | 61 | 1/16 | 8 par | a0 = −0.00021 |
| | | | | | | BIL | | a1 = −0.000012 |
| | | | | | | | | a2 = 0.059501 |
| | | | | | | | | a3 = −0.078125 |
| | | | | | | | | a4 = 9.0 |
| | | | | | | | | a5 = 0.016113 |
| | | | | | | | | a6 = 0.016098 |
| | | | | | | | | a7 = −3.0 |
| | | 309698 | 374240 | 67 | 18 | 1/8 | 6 par | a0 = 1.001953 |
| | | | | | | HEVC | | a1 = 0.01123 |
| | | | | | | | | a2 = −1.25 |
| | | | | | | | | a3 = −0.000488 |
| | | | | | | | | a4 = 1.0 |
| | | | | | | | | a5 = 0.0 |
| | | 79701 | 99873 | 10 | 28 | 1/16 | 6 par | a0 = 1.018555 |
| | | | | | | BIC | | a1 = 0.003418 |
| | | | | | | | | a2 = 1.25 |
| | | | | | | | | a3 = −0.005859 |
| | | | | | | | | a4 = 1.004395 |
| | | | | | | | | a5 = −0.25 |
| 12 | 11 | 501845 | 607990 | 96 | 177 | | | |
| | | 40898 | 82668 | 7 | 64 | 1/16 | 8 par | a0 = −0.000185 |
| | | | | | | BIC | | a1 = −0.000143 |
| | | | | | | | | a2 = 0.047191 |
| | | | | | | | | a3 = −0.055664 |
| | | | | | | | | a4 = 9.0 |
| | | | | | | | | a5 = 0.015625 |
| | | | | | | | | a6 = 0.048611 |
| | | | | | | | | a7 = −4.0 |
| | | 358061 | 388183 | 87 | 79 | 1/8 | 8 par | a0 = −0.000003 |
| | | | | | | HEVC | | a1 = −0.000003 |
| | | | | | | | | a2 = 0.013573 |
| | | | | | | | | a3 = 0.050293 |
| | | | | | | | | a4 = −7.0 |
| | | | | | | | | a5 = 0.0 |
| | | | | | | | | a6 = 0.003551 |
| | | | | | | | | a7 = −1.0 |
| | | 102886 | 137139 | 2 | 32 | 1/16 | 6 par | a0 = 1.012207 |
| | | | | | | BIL | | a1 = 0.002441 |
| | | | | | | | | a2 = 2.5 |
| | | | | | | | | a3 = −0.001465 |
| | | | | | | | | a4 = 1.004395 |
| | | | | | | | | a5 = −1.0 |
| 13 | 12 | 570213 | 721544 | 57 | 114 | | | |
| | | 37039 | 75890 | 11 | 58 | 1/16 | 8 par | a0 = −0.000198 |
| | | | | | | BIC | | a1 = −0.000189 |
| | | | | | | | | a2 = 0.057923 |
| | | | | | | | | a3 = −0.061523 |
| | | | | | | | | a4 = 11.0 |
| | | | | | | | | a5 = 0.01123 |
| | | | | | | | | a6 = 0.063684 |
| | | | | | | | | a7 = −5.0 |
| | | 428744 | 509305 | 38 | 28 | 1/8 | 6 par | a0 = 1.001953 |
| | | | | | | AVC | | a1 = 0.009766 |
| | | | | | | | | a2 = −1.0 |
| | | | | | | | | a3 = 0.0 |
| | | | | | | | | a4 = 1.0 |
| | | | | | | | | a5 = −0.25 |
| | | 104430 | 136349 | 8 | 26 | 1/16 | 6 par | a0 = 1.012207 |
| | | | | | | BIC | | a1 = 0.003418 |
| | | | | | | | | a2 = 2.5 |
| | | | | | | | | a3 = −0.004395 |
| | | | | | | | | a4 = 1.004395 |
| | | | | | | | | a5 = −0.75 |
| 14 | 13 | 635293 | 815540 | 67 | 124 | | | |
| | | 40024 | 85155 | 16 | 64 | 1/16 | 8 par | a0 = −0.000256 |
| | | | | | | BIL | | a1 = −0.000206 |
| | | | | | | | | a2 = 0.06976 |
| | | | | | | | | a3 = −0.058105 |
| | | | | | | | | a4 = 9.0 |
| | | | | | | | | a5 = 0.02002 |
| | | | | | | | | a6 = 0.05303 |
| | | | | | | | | a7 = −4.0 |
| | | 486823 | 575803 | 44 | 27 | 1/8 | 6 par | a0 = 1.001953 |
| | | | | | | AVC | | a1 = 0.008789 |
| | | | | | | | | a2 = −0.75 |
| | | | | | | | | a3 = 0.0 |
| | | | | | | | | a4 = 1.000977 |
| | | | | | | | | a5 = −0.5 |
| | | 108446 | 154582 | 7 | 31 | 1/16 | 6 par | a0 = 1.017578 |
| | | | | | | BIC | | a1 = 0.005859 |
| | | | | | | | | a2 = 1.0 |
| | | | | | | | | a3 = −0.001953 |
| | | | | | | | | a4 = 1.004395 |
| | | | | | | | | a5 = −1.25 |
| 15 | 14 | 587789 | 759067 | 45 | 83 | | | |
| | | 36551 | 90176 | 7 | 29 | 1/16 | 4 par | a0 = 0.998535 |
| | | | | | | BIL | | a1 = 1.25 |
| | | | | | | | | a2 = 1.001953 |
| | | | | | | | | a3 = −0.25 |
| | | 447329 | 532092 | 37 | 24 | 1/8 | 6 par | a0 = 1.001953 |
| | | | | | | AVC | | a1 = 0.010254 |
| | | | | | | | | a2 = −1.0 |
| | | | | | | | | a3 = 0.0 |
| | | | | | | | | a4 = 1.0 |
| | | | | | | | | a5 = −0.25 |
| | | 103909 | 136799 | 1 | 28 | 1/16 | 6 par | a0 = 1.012207 |
| | | | | | | BIC | | a1 = 0.004395 |
| | | | | | | | | a2 = 2.25 |
| | | | | | | | | a3 = −0.001953 |
| | | | | | | | | a4 = 1.005371 |
| | | | | | | | | a5 = −1.25 |
| 16 | 15 | 501674 | 666272 | 67 | 109 | | | |
| | | 36330 | 84353 | 14 | 71 | 1/16 | 8 par | a0 = −0.000135 |
| | | | | | | BIL | | a1 = 0.000061 |
| | | | | | | | | a2 = 0.019807 |
| | | | | | | | | a3 = −0.076172 |
| | | | | | | | | a4 = 12.0 |
| | | | | | | | | a5 = 0.007324 |
| | | | | | | | | a6 = −0.007102 |
| | | | | | | | | a7 = −1.0 |
| | | 374469 | 450975 | 53 | 7 | 1/16 | 6 par | a0 = 1.001953 |
| | | | | | | BIC | | a1 = 0.009766 |
| | | | | | | | | a2 = −1.0 |
| | | | | | | | | a3 = 0.0 |
| | | | | | | | | a4 = 1.0 |
| | | | | | | | | a5 = −0.25 |
| | | 90875 | 130944 | 0 | 29 | 1/16 | 6 par | a0 = 1.009277 |
| | | | | | | BIC | | a1 = 0.004395 |
| | | | | | | | | a2 = 2.5 |
| | | | | | | | | a3 = −0.001953 |
| | | | | | | | | a4 = 1.005371 |
| | | | | | | | | a5 = −1.0 |
| 17 | 16 | 558112 | 745882 | 64 | 112 | | | |
| | | 36202 | 90438 | 17 | 60 | 1/16 | 8 par | a0 = −0.000211 |
| | | | | | | BIL | | a1 = 0.000073 |
| | | | | | | | | a2 = 0.047743 |
| | | | | | | | | a3 = −0.078125 |
| | | | | | | | | a4 = 11.0 |
| | | | | | | | | a5 = 0.009766 |
| | | | | | | | | a6 = −0.003946 |
| | | | | | | | | a7 = −2.0 |
| | | 432775 | 518144 | 41 | 26 | 1/8 | 6 par | a0 = 1.001953 |
| | | | | | | AVC | | a1 = 0.010254 |
| | | | | | | | | a2 = −1.25 |
| | | | | | | | | a3 = 0.0 |
| | | | | | | | | a4 = 1.0 |
| | | | | | | | | a5 = −0.25 |
| | | 89135 | 137300 | 6 | 24 | 1/16 | 6 par | a0 = 1.009766 |
| | | | | | | BIC | | a1 = 0.004395 |
| | | | | | | | | a2 = 2.25 |
| | | | | | | | | a3 = −0.000488 |
| | | | | | | | | a4 = 1.003418 |
| | | | | | | | | a5 = −1.25 |
| 18 | 17 | 610278 | 797265 | 45 | 117 | | | |
| | | 36076 | 77759 | 5 | 59 | 1/16 | 8 par | a0 = −0.000219 |
| | | | | | | BIC | | a1 = −0.000059 |
| | | | | | | | | a2 = 0.050347 |
| | | | | | | | | a3 = −0.058105 |
| | | | | | | | | a4 = 9.0 |
| | | | | | | | | a5 = 0.016113 |
| | | | | | | | | a6 = 0.04143 |
| | | | | | | | | a7 = −4.0 |
| | | 477483 | 563868 | 39 | 25 | 1/8 | 6 par | a0 = 1.001465 |
| | | | | | | AVC | | a1 = 0.008789 |
| | | | | | | | | a2 = −0.75 |
| | | | | | | | | a3 = 0.0 |
| | | | | | | | | a4 = 1.000977 |
| | | | | | | | | a5 = −0.5 |
| | | 96719 | 155638 | 1 | 31 | 1/16 | 6 par | a0 = 1.001953 |
| | | | | | | BIC | | a1 = 0.004395 |
| | | | | | | | | a2 = 3.5 |
| | | | | | | | | a3 = −0.001465 |
| | | | | | | | | a4 = 1.004395 |
| | | | | | | | | a5 = −1.25 |
| 19 | 18 | 583351 | 796897 | 85 | 111 | | | |
| | | 36858 | 102943 | 11 | 57 | 1/16 | 8 par | a0 = −0.000265 |
| | | | | | | BIL | | a1 = −0.000012 |
| | | | | | | | | a2 = 0.069287 |
| | | | | | | | | a3 = −0.069336 |
| | | | | | | | | a4 = 9.0 |
| | | | | | | | | a5 = 0.008301 |
| | | | | | | | | a6 = 0.008286 |
| | | | | | | | | a7 = −1.0 |
| | | 461071 | 537714 | 73 | 24 | 1/8 | 6 par | a0 = 1.001953 |
| | | | | | | HEVC | | a1 = 0.010254 |
| | | | | | | | | a2 = −1.25 |
| | | | | | | | | a3 = −0.000488 |
| | | | | | | | | a4 = 1.0 |
| | | | | | | | | a5 = −0.25 |
| | | 85422 | 156240 | 1 | 28 | 1/16 | 6 par | a0 = 1.004395 |
| | | | | | | BIC | | a1 = 0.007813 |
| | | | | | | | | a2 = 2.5 |
| | | | | | | | | a3 = 0.0 |
| | | | | | | | | a4 = 1.003418 |
| | | | | | | | | a5 = −1.25 |
| 20 | 19 | 520348 | 723655 | 54 | 162 | | | |
| | | 49286 | 113793 | 14 | 62 | 1/16 | 8 par | a0 = −0.000269 |
| | | | | | | BIL | | a1 = 0.000099 |
| | | | | | | | | a2 = 0.061001 |
| | | | | | | | | a3 = −0.067871 |
| | | | | | | | | a4 = 9.0 |
| | | | | | | | | a5 = 0.02002 |
| | | | | | | | | a6 = 0.005287 |
| | | | | | | | | a7 = −4.0 |
| | | 391491 | 500959 | 36 | 26 | 1/16 | 6 par | a0 = 1.001953 |
| | | | | | | BIC | | a1 = 0.007813 |
| | | | | | | | | a2 = −0.75 |
| | | | | | | | | a3 = 0.0 |
| | | | | | | | | a4 = 1.0 |
| | | | | | | | | a5 = −0.25 |
| | | 79571 | 108903 | 4 | 72 | 1/16 | 8 par | a0 = −0.000083 |
| | | | | | | BIC | | a1 = 0.000048 |
| | | | | | | | | a2 = 0.064631 |
| | | | | | | | | a3 = 0.013184 |
| | | | | | | | | a4 = 7.0 |
| | | | | | | | | a5 = 0.003418 |
| | | | | | | | | a6 = 0.013021 |
| | | | | | | | | a7 = −5.0 |
| 21 | 20 | 515361 | 729143 | 62 | 123 | | | |
| | | 46284 | 107987 | 12 | 67 | 1/16 | 8 par | a0 = −0.000148 |
| | | | | | | BIC | | a1 = 0.000126 |
| | | | | | | | | a2 = 0.022964 |
| | | | | | | | | a3 = −0.057129 |
| | | | | | | | | a4 = 9.0 |
| | | | | | | | | a5 = 0.019043 |
| | | | | | | | | a6 = −0.007576 |
| | | | | | | | | a7 = −3.0 |
| | | 390388 | 508074 | 45 | 27 | 1/8 | 6 par | a0 = 1.001953 |
| | | | | | | HEVC | | a1 = 0.007813 |
| | | | | | | | | a2 = −0.75 |
| | | | | | | | | a3 = 0.000488 |
| | | | | | | | | a4 = 1.000977 |
| | | | | | | | | a5 = −0.5 |
| | | 78689 | 113082 | 5 | 27 | 1/8 | 6 par | a0 = 1.009277 |
| | | | | | | HEVC | | a1 = 0.003418 |
| | | | | | | | | a2 = 2.5 |
| | | | | | | | | a3 = 0.001953 |
| | | | | | | | | a4 = 1.005371 |
| | | | | | | | | a5 = −1.75 |
| 22 | 21 | 489436 | 669473 | 73 | 165 | | | |
| | | 39490 | 97641 | 11 | 67 | 1/16 | 8 par | a0 = −0.000117 |
| | | | | | | BIC | | a1 = −0.000061 |
| | | | | | | | | a2 = 0.022885 |
| | | | | | | | | a3 = −0.040039 |
| | | | | | | | | a4 = 8.0 |
| | | | | | | | | a5 = 0.003418 |
| | | | | | | | | a6 = 0.024305 |
| | | | | | | | | a7 = −2.0 |
| | | 371427 | 468717 | 54 | 66 | 1/16 | 8 par | a0 = −0.00004 |
| | | | | | | BIC | | a1 = −0.000038 |
| | | | | | | | | a2 = 0.029987 |
| | | | | | | | | a3 = 0.054688 |
| | | | | | | | | a4 = −8.0 |
| | | | | | | | | a5 = 0.007813 |
| | | | | | | | | a6 = 0.028567 |
| | | | | | | | | a7 = −5.0 |
| | | 78519 | 103115 | 8 | 30 | 1/16 | 6 par | a0 = 1.010742 |
| | | | | | | BIC | | a1 = 0.003418 |
| | | | | | | | | a2 = 2.5 |
| | | | | | | | | a3 = −0.001953 |
| | | | | | | | | a4 = 1.004395 |
| | | | | | | | | a5 = −1.0 |
| 23 | 22 | 339256 | 577831 | 39 | 117 | | | |
| | | 42344 | 124494 | 5 | 65 | 1/16 | 8 par | a0 = −0.000156 |
| | | | | | | BIL | | a1 = 0.000082 |
| | | | | | | | | a2 = 0.024305 |
| | | | | | | | | a3 = −0.060059 |
| | | | | | | | | a4 = 10.0 |
| | | | | | | | | a5 = 0.001465 |
| | | | | | | | | a6 = −0.015309 |
| | | | | | | | | a7 = 2.0 |
| | | 231224 | 362784 | 27 | 26 | 1/16 | 6 par | a0 = 1.001953 |
| | | | | | | BIC | | a1 = 0.010254 |
| | | | | | | | | a2 = −1.0 |
| | | | | | | | | a3 = 0.0 |
| | | | | | | | | a4 = 1.0 |
| | | | | | | | | a5 = 0.0 |
| | | 65688 | 90553 | 7 | 24 | 1/16 | 6 par | a0 = 1.010742 |
| | | | | | | BIC | | a1 = 0.004395 |
| | | | | | | | | a2 = 2.5 |
| | | | | | | | | a3 = −0.001465 |
| | | | | | | | | a4 = 1.004395 |
| | | | | | | | | a5 = −1.0 |
| 24 | 23 | 345407 | 575191 | 51 | 123 | | | |
| | | 40733 | 106777 | 11 | 71 | 1/16 | 8 par | a0 = −0.000155 |
| | | | | | | BIL | | a1 = −0.000216 |
| | | | | | | | | a2 = 0.046717 |
| | | | | | | | | a3 = −0.037109 |
| | | | | | | | | a4 = 9.0 |
| | | | | | | | | a5 = −0.000488 |
| | | | | | | | | a6 = 0.050505 |
| | | | | | | | | a7 = 0.0 |
| | | 230405 | 368017 | 34 | 22 | 1/16 | 6 par | a0 = 1.001953 |
| | | | | | | BIC | | a1 = 0.008789 |
| | | | | | | | | a2 = −0.75 |
| | | | | | | | | a3 = 0.0 |
| | | | | | | | | a4 = 1.0 |
| | | | | | | | | a5 = 0.0 |
| | | 74269 | 100397 | 6 | 28 | 1/16 | 6 par | a0 = 1.010742 |
| | | | | | | BIC | | a1 = 0.004395 |
| | | | | | | | | a2 = 2.75 |
| | | | | | | | | a3 = 0.000488 |
| | | | | | | | | a4 = 1.003418 |
| | | | | | | | | a5 = −1.0 |
| 25 | 24 | 406658 | 629120 | 67 | 112 | | | |
| | | 41968 | 124680 | 11 | 60 | 1/16 | 8 par | a0 = −0.000191 |
| | | | | | | BIL | | a1 = 0.00004 |
| | | | | | | | | a2 = 0.047348 |
| | | | | | | | | a3 = −0.055664 |
| | | | | | | | | a4 = 9.0 |
| | | | | | | | | a5 = 0.005859 |
| | | | | | | | | a6 = 0.009233 |
| | | | | | | | | a7 = −2.0 |
| | | 300550 | 425958 | 39 | 21 | 1/16 | 6 par | a0 = 1.001953 |
| | | | | | | BIC | | a1 = 0.009766 |
| | | | | | | | | a2 = −0.75 |
| | | | | | | | | a3 = −0.000488 |
| | | | | | | | | a4 = 1.0 |
| | | | | | | | | a5 = 0.0 |
| | | 64140 | 78482 | 17 | 29 | 1/16 | 6 par | a0 = 1.013672 |
| | | | | | | BIC | | a1 = 0.004395 |
| | | | | | | | | a2 = 2.5 |
| | | | | | | | | a3 = −0.00293 |
| | | | | | | | | a4 = 1.004395 |
| | | | | | | | | a5 = −0.75 |
| 26 | 25 | 347566 | 564716 | 49 | 150 | | | |
| | | 36781 | 85995 | 5 | 72 | 1/16 | 8 par | a0 = −0.000206 |
| | | | | | | BIL | | a1 = −0.000124 |
| | | | | | | | | a2 = 0.047191 |
| | | | | | | | | a3 = −0.054688 |
| | | | | | | | | a4 = 10.0 |
| | | | | | | | | a5 = 0.018555 |
| | | | | | | | | a6 = 0.036853 |
| | | | | | | | | a7 = −3.0 |
| | | 233120 | 383709 | 32 | 46 | 1/16 | 8 par | a0 = −0.000041 |
| | | | | | | BIC | | a1 = −0.000036 |
| | | | | | | | | a2 = 0.031013 |
| | | | | | | | | a3 = 0.052246 |
| | | | | | | | | a4 = −7.0 |
| | | | | | | | | a5 = 0.008301 |
| | | | | | | | | a6 = 0.026436 |
| | | | | | | | | a7 = −4.0 |
| | | 77665 | 95012 | 12 | 30 | 1/16 | 6 par | a0 = 1.012695 |
| | | | | | | BIC | | a1 = 0.004395 |
| | | | | | | | | a2 = 2.5 |
| | | | | | | | | a3 = −0.004395 |
| | | | | | | | | a4 = 1.004395 |
| | | | | | | | | a5 = −0.5 |
| 27 | 26 | 337929 | 600814 | 38 | 105 | | | |
| | | 36354 | 117610 | 8 | 55 | 1/16 | 8 par | a0 = −0.000218 |
| | | | | | | BIL | | a1 = 0.000092 |
| | | | | | | | | a2 = 0.048059 |
| | | | | | | | | a3 = −0.060059 |
| | | | | | | | | a4 = 10.0 |
| | | | | | | | | a5 = 0.005859 |
| | | | | | | | | a6 = −0.012942 |
| | | | | | | | | a7 = 1.0 |
| | | 236603 | 400930 | 26 | 24 | 1/16 | 6 par | a0 = 1.001953 |
| | | | | | | BIC | | a1 = 0.009766 |
| | | | | | | | | a2 = −0.75 |
| | | | | | | | | a3 = 0.0 |
| | | | | | | | | a4 = 1.0 |
| | | | | | | | | a5 = 0.0 |
| | | 64972 | 82274 | 4 | 24 | 1/16 | 6 par | a0 = 1.012695 |
| | | | | | | BIC | | a1 = 0.003418 |
| | | | | | | | | a2 = 2.75 |
| | | | | | | | | a3 = −0.007324 |
| | | | | | | | | a4 = 1.003418 |
| | | | | | | | | a5 = −0.25 |
| 28 | 27 | 378206 | 639945 | 38 | 106 | | | |
| | | 37768 | 117457 | 12 | 55 | 1/16 | 8 par | a0 = −0.000178 |
| | | | | | | BIL | | a1 = −0.000197 |
| | | | | | | | | a2 = 0.052715 |
| | | | | | | | | a3 = −0.047852 |
| | | | | | | | | a4 = 10.0 |
| | | | | | | | | a5 = 0.001465 |
| | | | | | | | | a6 = 0.045849 |
| | | | | | | | | a7 = −1.0 |
| | | 272544 | 434454 | 24 | 23 | 1/16 | 6 par | a0 = 1.001465 |
| | | | | | | BIC | | a1 = 0.008789 |
| | | | | | | | | a2 = −0.5 |
| | | | | | | | | a3 = 0.0 |
| | | | | | | | | a4 = 1.0 |
| | | | | | | | | a5 = 0.0 |
| | | 67894 | 88034 | 2 | 26 | 1/16 | 6 par | a0 = 1.008301 |
| | | | | | | BIC | | a1 = 0.004395 |
| | | | | | | | | a2 = 3.25 |
| | | | | | | | | a3 = −0.007324 |
| | | | | | | | | a4 = 1.003418 |
| | | | | | | | | a5 = −0.25 |
| 29 | 28 | 382465 | 614123 | 52 | 98 | | | |
| | | 31416 | 98873 | 10 | 67 | 1/16 | 8 par | a0 = −0.000151 |
| | | | | | | BIL | | a1 = 0.00019 |
| | | | | | | | | a2 = 0.025174 |
| | | | | | | | | a3 = −0.069336 |
| | | | | | | | | a4 = 11.0 |
| | | | | | | | | a5 = −0.001953 |
| | | | | | | | | a6 = −0.030382 |
| | | | | | | | | a7 = 2.0 |
| | | 273376 | 417171 | 26 | 7 | 1/16 | 6 par | a0 = 1.001953 |
| | | | | | | BIC | | a1 = 0.009766 |
| | | | | | | | | a2 = −0.75 |
| | | | | | | | | a3 = 0.0 |
| | | | | | | | | a4 = 1.0 |
| | | | | | | | | a5 = 0.0 |
| | | 77673 | 98079 | 16 | 22 | 1/8 | 6 par | a0 = 1.010742 |
| | | | | | | HEVC | | a1 = 0.003418 |
| | | | | | | | | a2 = 3.0 |
| | | | | | | | | a3 = −0.00293 |
| | | | | | | | | a4 = 1.004395 |
| | | | | | | | | a5 = −0.75 |
| 30 | 29 | 478232 | 664950 | 66 | 128 | | | |
| | | 32736 | 101624 | 5 | 71 | 1/16 | 8 par | a0 = −0.000345 |
| | | | | | | BIL | | a1 = −0.000156 |
| | | | | | | | | a2 = 0.087674 |
| | | | | | | | | a3 = −0.041016 |
| | | | | | | | | a4 = 7.0 |
| | | | | | | | | a5 = 0.021973 |
| | | | | | | | | a6 = 0.045849 |
| | | | | | | | | a7 = −3.0 |
| | | 377091 | 475099 | 57 | 28 | 1/16 | 6 par | a0 = 1.001953 |
| | | | | | | BIC | | a1 = 0.010254 |
| | | | | | | | | a2 = −1.0 |
| | | | | | | | | a3 = 0.000488 |
| | | | | | | | | a4 = 1.0 |
| | | | | | | | | a5 = −0.25 |
| | | 68405 | 88227 | 4 | 27 | 1/16 | 6 par | a0 = 1.01123 |
| | | | | | | BIC | | a1 = 0.004395 |
| | | | | | | | | a2 = 2.75 |
| | | | | | | | | a3 = −0.007324 |
| | | | | | | | | a4 = 1.003418 |
| | | | | | | | | a5 = −0.5 |
| 31 | 30 | 374235 | 625795 | 37 | 140 | | | |
| | | 38796 | 117784 | 7 | 67 | 1/16 | 8 par | a0 = −0.000278 |
| | | | | | | BIL | | a1 = 0.000044 |
| | | | | | | | | a2 = 0.062658 |
| | | | | | | | | a3 = −0.053711 |
| | | | | | | | | a4 = 9.0 |
| | | | | | | | | a5 = 0.030762 |
| | | | | | | | | a6 = 0.029593 |
| | | | | | | | | a7 = −6.0 |
| | | 269649 | 424364 | 25 | 45 | 1/16 | 8 par | a0 = −0.000035 |
| | | | | | | BIC | | a1 = −0.000043 |
| | | | | | | | | a2 = 0.029593 |
| | | | | | | | | a3 = 0.052246 |
| | | | | | | | | a4 = −7.0 |
| | | | | | | | | a5 = 0.009277 |
| | | | | | | | | a6 = 0.027146 |
| | | | | | | | | a7 = −4.0 |
| | | 65790 | 83647 | 5 | 26 | 1/16 | 6 par | a0 = 1.010742 |
| | | | | | | BIC | | a1 = 0.003418 |
| | | | | | | | | a2 = 3.0 |
| | | | | | | | | a3 = −0.005859 |
| | | | | | | | | a4 = 1.003418 |
| | | | | | | | | a5 = −0.5 |
| 32 | 31 | 413527 | 644229 | 72 | 190 | | | |
| | | 36757 | 123049 | 8 | 63 | 1/16 | 8 par | a0 = −0.000191 |
| | | | | | | BIL | | a1 = 0.000017 |
| | | | | | | | | a2 = 0.045218 |
| | | | | | | | | a3 = −0.058105 |
| | | | | | | | | a4 = 9.0 |
| | | | | | | | | a5 = 0.000488 |
| | | | | | | | | a6 = −0.006155 |
| | | | | | | | | a7 = 1.0 |
| | | 316813 | 444306 | 57 | 56 | 1/8 | 8 par | a0 = −0.000031 |
| | | | | | | HEVC | | a1 = −0.000017 |
| | | | | | | | | a2 = 0.022254 |
| | | | | | | | | a3 = 0.048828 |
| | | | | | | | | a4 = −6.0 |
| | | | | | | | | a5 = 0.004883 |
| | | | | | | | | a6 = 0.019176 |
| | | | | | | | | a7 = −3.0 |
| | | 59957 | 76874 | 7 | 69 | 1/8 | 8 par | a0 = −0.000051 |
| | | | | | | HEVC | | a1 = 0.000023 |
| | | | | | | | | a2 = 0.042061 |
| | | | | | | | | a3 = 0.013672 |
| | | | | | | | | a4 = 12.0 |
| | | | | | | | | a5 = −0.03418 |
| | | | | | | | | a6 = 0.012942 |
| | | | | | | | | a7 = 0.0 |

TABLE 17
Detailed results of RMM for CIF “Coastguard” sequence (33 frames) with GOP 8 Pyramid:

| F | R | Ref SAD | RMMs SAD | NBB | Bits | SP Filter | Mod | RMMs Parameters |
|---|---|---|---|---|---|---|---|---|
| 1 | 0 | 521144 | 625104 | 124 | 69 | | | |
| | | 429452 | 461703 | 121 | 29 | 1/16 | 6 par | a0 = 1.000488 |
| | | | | | | BIL | | a1 = 0.002441 |
| | | | | | | | | a2 = −0.5 |
| | | | | | | | | a3 = 0.0 |
| | | | | | | | | a4 = 1.0 |
| | | | | | | | | a5 = −0.75 |
| | | 91692 | 163401 | 3 | 34 | 1/16 | 6 par | a0 = 1.006348 |
| | | | | | | BIL | | a1 = 0.023438 |
| | | | | | | | | a2 = −4.5 |
| | | | | | | | | a3 = 0.0 |
| | | | | | | | | a4 = 0.999023 |
| | | | | | | | | a5 = −0.75 |
| 2 | 1 | 443773 | 564164 | 48 | 64 | | | |
| | | 336976 | 389829 | 42 | 26 | 1/8 | 4 par | a0 = 1.000488 |
| | | | | | | AVC | | a1 = 0.0 |
| | | | | | | | | a2 = 1.0 |
| | | | | | | | | a3 = −1.25 |
| | | 106797 | 174335 | 6 | 36 | 1/8 | 6 par | a0 = 0.992676 |
| | | | | | | AVC | | a1 = 0.049316 |
| | | | | | | | | a2 = −6.0 |
| | | | | | | | | a3 = 0.0 |
| | | | | | | | | a4 = 1.0 |
| | | | | | | | | a5 = −1.25 |
| 3 | 2 | 435763 | 514844 | 196 | 160 | | | |
| | | 352810 | 381565 | 190 | 32 | 1/16 | 6 par | a0 = 1.0 |
| | | | | | | BIL | | a1 = 0.000977 |
| | | | | | | | | a2 = 0.0 |
| | | | | | | | | a3 = 0.0 |
| | | | | | | | | a4 = 1.0 |
| | | | | | | | | a5 = −2.25 |
| | | 82953 | 133279 | 6 | 126 | 1/16 | 8 par | a0 = −0.000603 |
| | | | | | | BIL | | a1 = −0.000012 |
| | | | | | | | | a2 = 0.16785 |
| | | | | | | | | a3 = 0.119629 |
| | | | | | | | | a4 = −29.0 |
| | | | | | | | | a5 = 0.077637 |
| | | | | | | | | a6 = 0.087279 |
| | | | | | | | | a7 = −20.0 |
| 4 | 3 | 470087 | 520103 | 302 | 57 | | | |
| | | 330628 | 280564 | 284 | 29 | 1/16 | 6 par | a0 = 1.0 |
| | | | | | | BIL | | a1 = 0.000977 |
| | | | | | | | | a2 = 0.25 |
| | | | | | | | | a3 = 0.0 |
| | | | | | | | | a4 = 1.000977 |
| | | | | | | | | a5 = −3.75 |
| | | 139459 | 239539 | 18 | 26 | 1/16 | 4 par | a0 = 0.989258 |
| | | | | | | BIL | | a1 = 1.25 |
| | | | | | | | | a2 = 0.994141 |
| | | | | | | | | a3 = −2.75 |
| 5 | 4 | 458785 | 510493 | 300 | 66 | | | |
| | | 327553 | 344927 | 265 | 28 | 1/16 | 6 par | a0 = 1.000488 |
| | | | | | | BIL | | a1 = 0.0 |
| | | | | | | | | a2 = 0.5 |
| | | | | | | | | a3 = −0.000488 |
| | | | | | | | | a4 = 1.0 |
| | | | | | | | | a5 = −5.5 |
| | | 131232 | 165566 | 35 | 36 | 1/16 | 6 par | a0 = 1.004883 |
| | | | | | | BIL | | a1 = 0.026855 |
| | | | | | | | | a2 = −4.25 |
| | | | | | | | | a3 = 0.0 |
| | | | | | | | | a4 = 1.0 |
| | | | | | | | | a5 = −5.75 |
| 6 | 5 | 387519 | 497426 | 264 | 84 | | | |
| | | 288845 | 367461 | 240 | 38 | 1/16 | 6 par | a0 = 1.0 |
| | | | | | | BIL | | a1 = 0.001953 |
| | | | | | | | | a2 = −0.5 |
| | | | | | | | | a3 = 0.0 |
| | | | | | | | | a4 = 1.000977 |
| | | | | | | | | a5 = −7.75 |
| | | 98674 | 129965 | 24 | 44 | 1/16 | 6 par | a0 = 0.993652 |
| | | | | | | BIL | | a1 = 0.041016 |
| | | | | | | | | a2 = −5.75 |
| | | | | | | | | a3 = −0.000488 |
| | | | | | | | | a4 = 0.998047 |
| | | | | | | | | a5 = −7.25 |
| 7 | 6 | 315872 | 470856 | 159 | 51 | | | |
| | | 168072 | 179583 | 158 | 30 | 1/16 | 6 par | a0 = 1.000488 |
| | | | | | | BIL | | a1 = 0.001953 |
| | | | | | | | | a2 = −0.5 |
| | | | | | | | | a3 = 0.0 |
| | | | | | | | | a4 = 1.0 |
| | | | | | | | | a5 = −8.75 |
| | | 147800 | 291273 | 1 | 19 | 1/16 | 4 par | a0 = 0.999512 |
| | | | | | | BIL | | a1 = −0.75 |
| | | | | | | | | a2 = 0.994629 |
| | | | | | | | | a3 = −8.0 |
| 8 | 7 | 390642 | 501500 | 71 | 58 | | | |
| | | 226193 | 277126 | 59 | 24 | 1/8 | 6 par | a0 = 0.999512 |
| | | | | | | AVC | | a1 = 0.0 |
| | | | | | | | | a2 = 0.25 |
| | | | | | | | | a3 = −0.000488 |
| | | | | | | | | a4 = 1.002441 |
| | | | | | | | | a5 = −8.5 |
| | | 164449 | 224374 | 12 | 32 | 1/16 | 6 par | a0 = 0.996582 |
| | | | | | | BIL | | a1 = 0.013184 |
| | | | | | | | | a2 = −2.25 |
| | | | | | | | | a3 = 0.000488 |
| | | | | | | | | a4 = 1.0 |
| | | | | | | | | a5 = −8.25 |
| 9 | 8 | 565120 | 678868 | 82 | 66 | | | |
| | | 415106 | 478896 | 80 | 29 | 1/8 | 4 par | a0 = 1.0 |
| | | | | | | HEVC | | a1 = 0.75 |
| | | | | | | | | a2 = 0.999023 |
| | | | | | | | | a3 = −5.75 |
| | | 150014 | 199972 | 2 | 35 | 1/16 | 6 par | a0 = 0.98877 |
| | | | | | | BIC | | a1 = 0.033691 |
| | | | | | | | | a2 = −3.75 |
| | | | | | | | | a3 = −0.000488 |
| | | | | | | | | a4 = 1.0 |
| | | | | | | | | a5 = −5.75 |
| 10 | 9 | 563648 | 661985 | 152 | 86 | | | |
| | | 437153 | 483768 | 145 | 38 | 1/8 | 6 par | a0 = 0.999512 |
| | | | | | | AVC | | a1 = 0.001953 |
| | | | | | | | | a2 = 1.0 |
| | | | | | | | | a3 = −0.000488 |
| | | | | | | | | a4 = 1.0 |
| | | | | | | | | a5 = −2.5 |
| | | 126495 | 178217 | 7 | 46 | 1/8 | 6 par | a0 = 1.003418 |
| | | | | | | HEVC | | a1 = 0.047852 |
| | | | | | | | | a2 = −8.25 |
| | | | | | | | | a3 = 0.0 |
| | | | | | | | | a4 = 0.995605 |
| | | | | | | | | a5 = −2.0 |
| 11 | 10 | 374909 | 486706 | 87 | 75 | | | |
| | | 312353 | 357712 | 85 | 38 | 1/8 | 6 par | a0 = 1.0 |
| | | | | | | AVC | | a1 = 0.001953 |
| | | | | | | | | a2 = 1.0 |
| | | | | | | | | a3 = 0.0 |
| | | | | | | | | a4 = 1.0 |
| | | | | | | | | a5 = 0.0 |
| | | 62556 | 128994 | 2 | 35 | 1/8 | 6 par | a0 = 0.999512 |
| | | | | | | AVC | | a1 = 0.052734 |
| | | | | | | | | a2 = −8.5 |
| | | | | | | | | a3 = 0.0 |
| | | | | | | | | a4 = 1.000977 |
| | | | | | | | | a5 = 0.0 |
| 12 | 11 | 395324 | 502596 | 126 | 71 | | | |
| | | 318956 | 363912 | 124 | 36 | 1/16 | 6 par | a0 = 1.0 |
| | | | | | | BIC | | a1 = 0.000977 |
| | | | | | | | | a2 = 0.75 |
| | | | | | | | | a3 = 0.0 |
| | | | | | | | | a4 = 1.000977 |
| | | | | | | | | a5 = 1.0 |
| | | 76368 | 138684 | 2 | 33 | 1/8 | 6 par | a0 = 0.996582 |
| | | | | | | AVC | | a1 = 0.048828 |
| | | | | | | | | a2 = −7.5 |
| | | | | | | | | a3 = 0.0 |
| | | | | | | | | a4 = 1.000977 |
| | | | | | | | | a5 = 1.0 |
| 13 | 12 | 411353 | 489760 | 192 | 64 | | | |
| | | 331728 | 347234 | 190 | 31 | 1/16 | 6 par | a0 = 1.0 |
| | | | | | | BIC | | a1 = 0.001953 |
| | | | | | | | | a2 = 0.75 |
| | | | | | | | | a3 = 0.0 |
| | | | | | | | | a4 = 1.0 |
| | | | | | | | | a5 = 0.25 |
| | | 79625 | 142526 | 2 | 31 | 1/16 | 6 par | a0 = 0.999512 |
| | | | | | | BIL | | a1 = 0.045898 |
| | | | | | | | | a2 = −7.0 |
| | | | | | | | | a3 = 0.0 |
| | | | | | | | | a4 = 1.0 |
| | | | | | | | | a5 = 0.25 |
| 14 | 13 | 525226 | 595339 | 181 | 66 | | | |
| | | 402351 | 413208 | 177 | 29 | 1/16 | 6 par | a0 = 0.999512 |
| | | | | | | BIC | | a1 = 0.000977 |
| | | | | | | | | a2 = 0.75 |
| | | | | | | | | a3 = −0.000488 |
| | | | | | | | | a4 = 1.0 |
| | | | | | | | | a5 = −0.5 |
| | | 122875 | 182131 | 4 | 35 | 1/16 | 6 par | a0 = 0.99707 |
| | | | | | | BIL | | a1 = 0.053711 |
| | | | | | | | | a2 = −8.25 |
| | | | | | | | | a3 = 0.000488 |
| | | | | | | | | a4 = 0.996582 |
| | | | | | | | | a5 = −0.25 |
| 15 | 14 | 451869 | 550632 | 71 | 66 | | | |
| | | 348436 | 382273 | 71 | 24 | 1/16 | 4 par | a0 = 1.0 |
| | | | | | | BIC | | a1 = 0.75 |
| | | | | | | | | a2 = 0.999023 |
| | | | | | | | | a3 = −0.75 |
| | | 103433 | 168359 | 0 | 40 | 1/16 | 6 par | a0 = 0.995117 |
| | | | | | | BIL | | a1 = 0.028809 |
| | | | | | | | | a2 = −4.0 |
| | | | | | | | | a3 = 0.000488 |
| | | | | | | | | a4 = 1.0 |
| | | | | | | | | a5 = −1.0 |
| 16 | 15 | 338647 | 420020 | 162 | 62 | | | |
| | | 278026 | 296439 | 160 | 29 | 1/16 | 6 par | a0 = 1.0 |
| | | | | | | BIC | | a1 = 0.001953 |
| | | | | | | | | a2 = 0.0 |
| | | | | | | | | a3 = 0.0 |
| | | | | | | | | a4 = 1.0 |
| | | | | | | | | a5 = 0.0 |
| | | 60621 | 123581 | 2 | 31 | 1/16 | 6 par | a0 = 0.995117 |
| | | | | | | BIL | | a1 = 0.048828 |
| | | | | | | | | a2 = −8.25 |
| | | | | | | | | a3 = 0.0 |
| | | | | | | | | a4 = 1.0 |
| | | | | | | | | a5 = 0.0 |
| 17 | 16 | 508187 | 580729 | 179 | 60 | | | |
| | | 408337 | 424206 | 176 | 26 | 1/16 | 6 par | a0 = 1.0 |
| | | | | | | BIC | | a1 = 0.001953 |
| | | | | | | | | a2 = 0.25 |
| | | | | | | | | a3 = 0.0 |
| | | | | | | | | a4 = 0.999023 |
| | | | | | | | | a5 = 0.5 |
| | | 99850 | 156523 | 3 | 32 | 1/16 | 6 par | a0 = 1.001465 |
| | | | | | | BIC | | a1 = 0.050293 |
| | | | | | | | | a2 = −8.5 |
| | | | | | | | | a3 = 0.0 |
| | | | | | | | | a4 = 0.999023 |
| | | | | | | | | a5 = 0.5 |
| 18 | 17 | 328272 | 415612 | 118 | 54 | | | |
| | | 265413 | 292644 | 116 | 26 | 1/16 | 6 par | a0 = 0.999512 |
| | | | | | | BIC | | a1 = 0.000977 |
| | | | | | | | | a2 = 1.25 |
| | | | | | | | | a3 = 0.0 |
| | | | | | | | | a4 = 1.0 |
| | | | | | | | | a5 = 0.0 |
| | | 62859 | 122968 | 2 | 26 | 1/16 | 6 par | a0 = 0.993652 |
| | | | | | | BIL | | a1 = 0.04248 |
| | | | | | | | | a2 = −5.75 |
| | | | | | | | | a3 = 0.0 |
| | | | | | | | | a4 = 1.0 |
| | | | | | | | | a5 = 0.0 |
| 19 | 18 | 391229 | 496152 | 127 | 54 | | | |
| | | 308874 | 352404 | 121 | 26 | 1/8 | 6 par | a0 = 0.999512 |
| | | | | | | HEVC | | a1 = 0.000977 |
| | | | | | | | | a2 = 1.5 |
| | | | | | | | | a3 = 0.0 |
| | | | | | | | | a4 = 1.000977 |
| | | | | | | | | a5 = −0.25 |
| | | 82355 | 143748 | 6 | 26 | 1/8 | 6 par | a0 = 0.987305 |
| | | | | | | AVC | | a1 = 0.048828 |
| | | | | | | | | a2 = −5.75 |
| | | | | | | | | a3 = 0.0 |
| | | | | | | | | a4 = 1.000977 |
| | | | | | | | | a5 = −0.25 |
| 20 | 19 | 399488 | 479986 | 163 | 50 | | | |
| | | 307560 | 328694 | 155 | 27 | 1/16 | 4 par | a0 = 0.999512 |
| | | | | | | BIC | | a1 = 2.0 |
| | | | | | | | | a2 = 1.0 |
| | | | | | | | | a3 = −0.25 |
| | | 91928 | 151292 | 8 | 21 | 1/16 | 6 par | a0 = 0.990234 |
| | | | | | | BIC | | a1 = 0.053711 |
| | | | | | | | | a2 = −6.5 |
| | | | | | | | | a3 = 0.0 |
| | | | | | | | | a4 = 1.0 |
| | | | | | | | | a5 = −0.25 |
| 21 | 20 | 391776 | 475490 | 145 | 69 | | | |
| | | 309654 | 325685 | 142 | 32 | 1/16 | 6 par | a0 = 1.0 |
| | | | | | | BIC | | a1 = 0.000977 |
| | | | | | | | | a2 = 3.0 |
| | | | | | | | | a3 = 0.0 |
| | | | | | | | | a4 = 1.0 |
| | | | | | | | | a5 = 0.25 |
| | | 82122 | 149805 | 3 | 35 | 1/16 | 6 par | a0 = 0.99707 |
| | | | | | | BIL | | a1 = 0.024414 |
| | | | | | | | | a2 = −1.25 |
| | | | | | | | | a3 = 0.0 |
| | | | | | | | | a4 = 0.999023 |
| | | | | | | | | a5 = 0.25 |
| 22 | 21 | 432787 | 637552 | 106 | 54 | | | |
| | | 324225 | 444899 | 102 | 23 | 1/8 | 6 par | a0 = 0.999512 |
| | | | | | | AVC | | a1 = 0.000977 |
| | | | | | | | | a2 = 4.75 |
| | | | | | | | | a3 = 0.0 |
| | | | | | | | | a4 = 1.0 |
| | | | | | | | | a5 = 0.25 |
| | | 108562 | 192653 | 4 | 29 | 1/8 | 6 par | a0 = 1.001953 |
| | | | | | | AVC | | a1 = 0.041016 |
| | | | | | | | | a2 = −2.5 |
| | | | | | | | | a3 = 0.0 |
| | | | | | | | | a4 = 0.998047 |
| | | | | | | | | a5 = 0.5 |
| 23 | 22 | 436002 | 602615 | 85 | 54 | | | |
| | | 348095 | 458620 | 83 | 23 | 1/16 | 4 par | a0 = 0.998535 |
| | | | | | | BIC | | a1 = 3.5 |
| | | | | | | | | a2 = 1.000977 |
| | | | | | | | | a3 = 0.0 |
| | | 87907 | 143995 | 2 | 29 | 1/16 | 6 par | a0 = 1.0 |
| | | | | | | BIC | | a1 = 0.048828 |
| | | | | | | | | a2 = −5.5 |
| | | | | | | | | a3 = 0.0 |
| | | | | | | | | a4 = 0.999023 |
| | | | | | | | | a5 = 0.25 |
| 24 | 23 | 390469 | 488890 | 162 | 83 | | | |
| | | 310073 | 358186 | 159 | 47 | 1/16 | 8 par | a0 = −0.000011 |
| | | | | | | BIC | | a1 = −0.000004 |
| | | | | | | | | a2 = 0.003551 |
| | | | | | | | | a3 = 0.007813 |
| | | | | | | | | a4 = 4.0 |
| | | | | | | | | a5 = 0.001465 |
| | | | | | | | | a6 = 0.005129 |
| | | | | | | | | a7 = −1.0 |
| | | 80396 | 130704 | 3 | 34 | 1/16 | 6 par | a0 = 0.984375 |
| | | | | | | BIL | | a1 = 0.018066 |
| | | | | | | | | a2 = −0.5 |
| | | | | | | | | a3 = 0.000488 |
| | | | | | | | | a4 = 1.001953 |
| | | | | | | | | a5 = −0.5 |
| 25 | 24 | 405622 | 504217 | 108 | 62 | | | |
| | | 297032 | 328581 | 102 | 30 | 1/16 | 6 par | a0 = 1.0 |
| | | | | | | BIC | | a1 = 0.0 |
| | | | | | | | | a2 = 0.5 |
| | | | | | | | | a3 = 0.0 |
| | | | | | | | | a4 = 1.0 |
| | | | | | | | | a5 = −0.25 |
| | | 108590 | 175636 | 6 | 30 | 1/16 | 6 par | a0 = 0.987305 |
| | | | | | | BIC | | a1 = 0.028809 |
| | | | | | | | | a2 = −3.25 |
| | | | | | | | | a3 = 0.0 |
| | | | | | | | | a4 = 1.0 |
| | | | | | | | | a5 = −0.25 |
| 26 | 25 | 393419 | 500367 | 122 | 61 | | | |
| | | 320193 | 372174 | 121 | 29 | 1/16 | 6 par | a0 = 0.999512 |
| | | | | | | BIC | | a1 = 0.000977 |
| | | | | | | | | a2 = 0.75 |
| | | | | | | | | a3 = 0.0 |
| | | | | | | | | a4 = 0.999023 |
| | | | | | | | | a5 = 0.25 |
| | | 73226 | 128193 | 1 | 30 | 1/8 | 6 par | a0 = 0.998535 |
| | | | | | | AVC | | a1 = 0.039063 |
| | | | | | | | | a2 = −6.25 |
| | | | | | | | | a3 = 0.0 |
| | | | | | | | | a4 = 0.999023 |
| | | | | | | | | a5 = 0.25 |
| 27 | 26 | 517973 | 600132 | 196 | 57 | | | |
| | | 382947 | 403827 | 184 | 25 | 1/16 | 6 par | a0 = 0.999512 |
| | | | | | | BIC | | a1 = 0.001953 |
| | | | | | | | | a2 = 0.75 |
| | | | | | | | | a3 = 0.0 |
| | | | | | | | | a4 = 1.0 |
| | | | | | | | | a5 = 0.5 |
| | | 135026 | 196305 | 12 | 30 | 1/8 | 6 par | a0 = 0.99707 |
| | | | | | | AVC | | a1 = 0.029297 |
| | | | | | | | | a2 = −4.0 |
| | | | | | | | | a3 = −0.000488 |
| | | | | | | | | a4 = 0.998047 |
| | | | | | | | | a5 = 0.75 |
| 28 | 27 | 415427 | 532501 | 117 | 46 | | | |
| | | 326309 | 380716 | 114 | 21 | 1/16 | 6 par | a0 = 0.999512 |
| | | | | | | BIC | | a1 = 0.001953 |
| | | | | | | | | a2 = 0.75 |
| | | | | | | | | a3 = 0.0 |
| | | | | | | | | a4 = 1.0 |
| | | | | | | | | a5 = 0.25 |
| | | 89118 | 151785 | 3 | 23 | 1/16 | 6 par | a0 = 0.999512 |
| | | | | | | BIC | | a1 = 0.036621 |
| | | | | | | | | a2 = −5.5 |
| | | | | | | | | a3 = 0.0 |
| | | | | | | | | a4 = 1.0 |
| | | | | | | | | a5 = 0.25 |
| 29 | 28 | 473812 | 575488 | 156 | 57 | | | |
| | | 331996 | 371516 | 144 | 22 | 1/16 | 4 par | a0 = 0.999512 |
| | | | | | | BIC | | a1 = 1.0 |
| | | | | | | | | a2 = 0.999023 |
| | | | | | | | | a3 = −0.25 |
| | | 141816 | 203972 | 12 | 33 | 1/8 | 6 par | a0 = 0.992676 |
| | | | | | | AVC | | a1 = 0.045898 |
| | | | | | | | | a2 = −7.0 |
| | | | | | | | | a3 = 0.000488 |
| | | | | | | | | a4 = 0.999023 |
| | | | | | | | | a5 = −0.25 |
| 30 | 29 | 389401 | 484197 | 143 | 75 | | | |
| | | 310388 | 362614 | 136 | 45 | 1/8 | 8 par | a0 = 0.000003 |
| | | | | | | AVC | | a1 = 0.00001 |
| | | | | | | | | a2 = −0.00363 |
| | | | | | | | | a3 = 0.005859 |
| | | | | | | | | a4 = 3.0 |
| | | | | | | | | a5 = −0.001465 |
| | | | | | | | | a6 = −0.004261 |
| | | | | | | | | a7 = 0.0 |
| | | 79013 | 121583 | 7 | 28 | 1/8 | 6 par | a0 = 0.990723 |
| | | | | | | AVC | | a1 = 0.037109 |
| | | | | | | | | a2 = −5.0 |
| | | | | | | | | a3 = 0.0 |
| | | | | | | | | a4 = 1.000977 |
| | | | | | | | | a5 = −0.25 |
| 31 | 30 | 434297 | 563302 | 100 | 47 | | | |
| | | 347993 | 420015 | 98 | 17 | 1/16 | 4 par | a0 = 0.998535 |
| | | | | | | BIC | | a1 = 1.5 |
| | | | | | | | | a2 = 1.0 |
| | | | | | | | | a3 = 0.25 |
| | | 86304 | 143287 | 2 | 28 | 1/8 | 6 par | a0 = 1.000488 |
| | | | | | | AVC | | a1 = 0.040039 |
| | | | | | | | | a2 = −6.0 |
| | | | | | | | | a3 = 0.0 |
| | | | | | | | | a4 = 0.998047 |
| | | | | | | | | a5 = 0.5 |
| 32 | 31 | 446516 | 582116 | 127 | 52 | | | |
| | | 349096 | 409958 | 122 | 16 | 1/8 | 6 par | a0 = 0.999512 |
| | | | | | | AVC | | a1 = 0.000977 |
| | | | | | | | | a2 = 1.25 |
| | | | | | | | | a3 = 0.0 |
| | | | | | | | | a4 = 1.0 |
| | | | | | | | | a5 = 0.25 |
| | | 97420 | 172158 | 5 | 34 | 1/16 | 6 par | a0 = 1.006348 |
| | | | | | | BIC | | a1 = 0.067871 |
| | | | | | | | | a2 = −11.25 |
| | | | | | | | | a3 = 0.0 |
| | | | | | | | | a4 = 0.997559 |
| | | | | | | | | a5 = 0.75 |

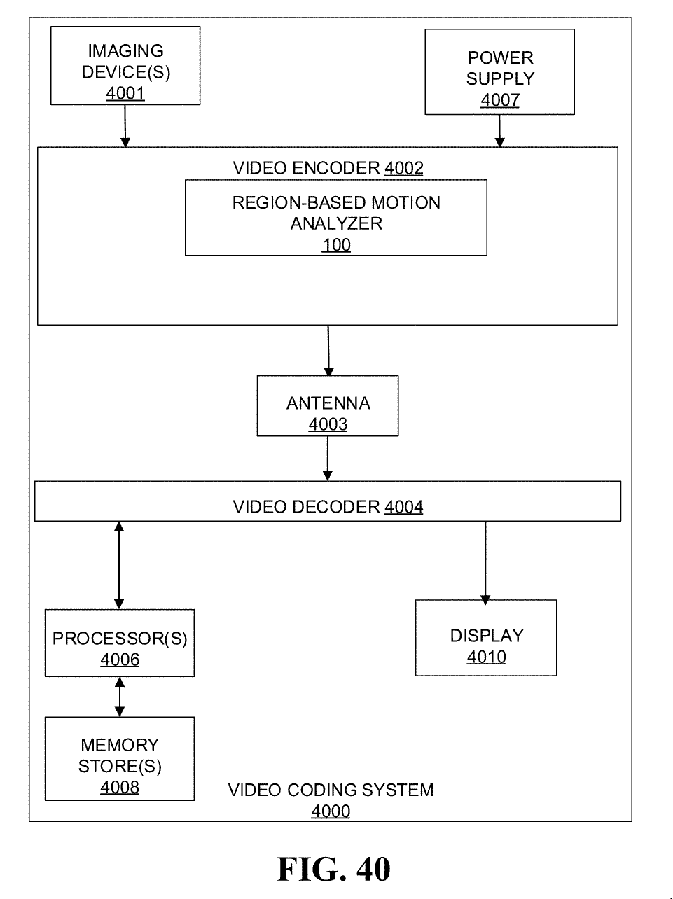

FIG. 40 is an illustrative diagram of example video coding system 4000, arranged in accordance with at least some implementations of the present disclosure. In the illustrated implementation, video coding system 4000, although illustrated with both video encoder 4002 and video decoder 4004, video coding system 4000 may include only video encoder 4002 or only video decoder 4004 in various examples. Video coding system 4000 may include imaging device(s) 4001, an antenna 4003, one or more processor(s) 4006, one or more memory store(s) 4008, a power supply 4007, and/or a display device 4010. As illustrated, imaging device(s) 4001, antenna 4003, video encoder 4002, video decoder 4004, processor(s) 4006, memory store(s) 4008, and/or display device 4010 may be capable of communication with one another.

In some examples, video coding system 4000 may include a region-based motion analyzer system 100 (e.g., region-based motion analyzer system 100 of FIG. 1 and/or FIG. 3) associated with video encoder 4002 and/or video decoder 4004. Further, antenna 4003 may be configured to transmit or receive an encoded bitstream of video data, for example. Processor(s) 4006 may be any type of processor and/or processing unit. For example, processor(s) 4006 may include distinct central processing units, distinct graphic processing units, integrated system-on-a-chip (SoC) architectures, the like, and/or combinations thereof. In addition, memory store(s) 4008 may be any type of memory. For example, memory store(s) 4008 may be volatile memory (e.g., Static Random Access Memory (SRAM), Dynamic Random Access Memory (DRAM), etc.) or non-volatile memory (e.g., flash memory, etc.), and so forth. In a non-limiting example, memory store(s) 4008 may be implemented by cache memory. Further, in some implementations, video coding system 4000 may include display device 4010. Display device 4010 may be configured to present video data.

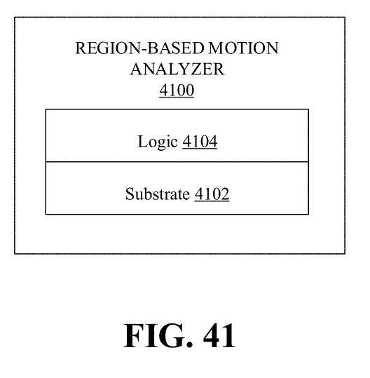

FIG. 41 shows a region-based motion analyzer 4100 (e.g., semiconductor package, chip, die). The apparatus 4100 may implement one or more aspects of process 3900 (FIG. 39). The apparatus 4100 may be readily substituted for some or all of the region-based motion analyzer system 100 (e.g., region-based motion analyzer system 100 of FIG. 1 and/or FIG. 3), already discussed.

The illustrated apparatus 4100 includes one or more substrates 4102 (e.g., silicon, sapphire, gallium arsenide) and logic 4104 (e.g., transistor array and other integrated circuit/IC components) coupled to the substrate(s) 4102. The logic 4104 may be implemented at least partly in configurable logic or fixed-functionality logic hardware. In one example, the logic 4104 includes transistor channel regions that are positioned (e.g., embedded) within the substrate(s) 4102. Thus, the interface between the logic 4104 and the substrate(s) 4102 may not be an abrupt junction. The logic 4104 may also be considered to include an epitaxial layer that is grown on an initial wafer of the substrate(s) 4102.

Moreover, the logic 4104 may configure one or more first logical cores associated with a first virtual machine of a cloud server platform, where the configuration of the one or more first logical cores is based at least in part on one or more first feature settings. The logic 4104 may also configure one or more active logical cores associated with an active virtual machine of the cloud server platform, where the configuration of the one or more active logical cores is based at least in part on one or more active feature settings, and where the active feature settings are different than the first feature settings.

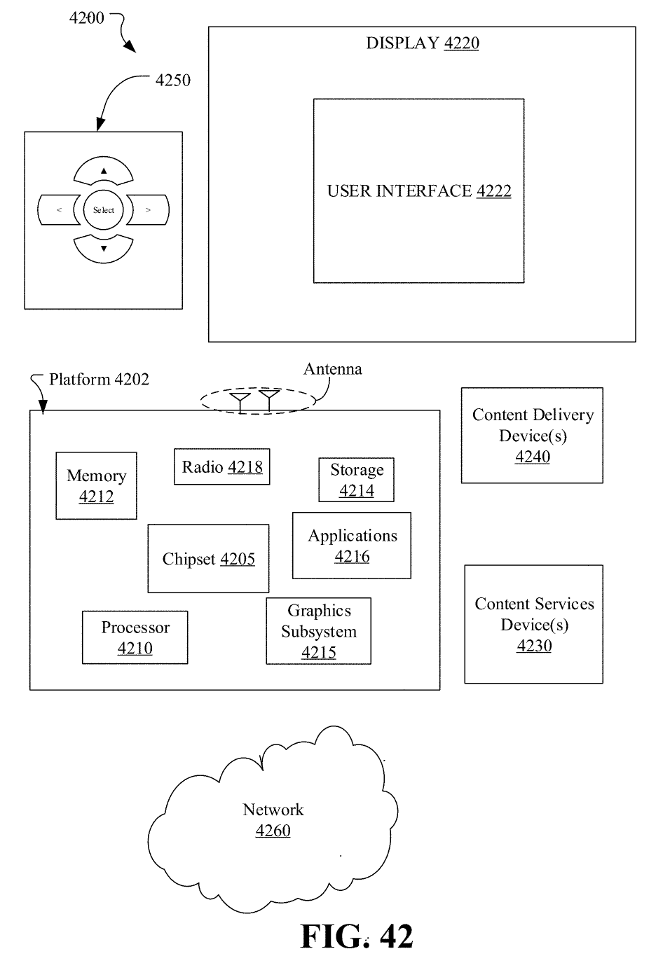

FIG. 42 illustrates an embodiment of a system 4200. In embodiments, system 4200 may include a media system although system 4200 is not limited to this context. For example, system 4200 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, the system 4200 comprises a platform 4202 coupled to a display 4220 that presents visual content. The platform 4202 may receive video bitstream content from a content device such as content services device(s) 4230 or content delivery device(s) 4240 or other similar content sources. A navigation controller 4250 comprising one or more navigation features may be used to interact with, for example, platform 4202 and/or display 4220. Each of these components is described in more detail below.

In embodiments, the platform 4202 may comprise any combination of a chipset 4205, processor 4210, memory 4212, storage 4214, graphics subsystem 4215, applications 4216 and/or radio 4218 (e.g., network controller). The chipset 4205 may provide intercommunication among the processor 4210, memory 4212, storage 4214, graphics subsystem 4215, applications 4216 and/or radio 4218. For example, the chipset 4205 may include a storage adapter (not depicted) capable of providing intercommunication with the storage 4214.

The processor 4210 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 4210 may comprise dual-core processor(s), dual-core mobile processor(s), and so forth.

The memory 4212 may be implemented as a volatile memory device such as, but not limited to, a Random Access Memory (RAM), Dynamic Random Access Memory (DRAM), or Static RAM (SRAM).

The storage 4214 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 4214 may comprise technology to increase the storage performance enhanced protection for valuable digital media when multiple hard drives are included, for example.

The graphics subsystem 4215 may perform processing of images such as still or video for display. The graphics subsystem 4215 may be a graphics processing unit (GPU) or a visual processing unit (VPU), for example. An analog or digital interface may be used to communicatively couple the graphics subsystem 4215 and display 4220. For example, the interface may be any of a High-Definition Multimedia Interface (HDMI), DisplayPort, wireless HDMI, and/or wireless HD compliant techniques. The graphics subsystem 4215 could be integrated into processor 4210 or chipset 4205. The graphics subsystem 4215 could be a stand-alone card communicatively coupled to the chipset 4205. In one example, the graphics subsystem 4215 includes a noise reduction subsystem as described herein.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 4218 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 4218 may operate in accordance with one or more applicable standards in any version.

In embodiments, the display 4220 may comprise any television type monitor or display. The display 4220 may comprise, for example, a computer display screen, touch screen display, video monitor, television-like device, and/or a television. The display 4220 may be digital and/or analog. In embodiments, the display 4220 may be a holographic display. Also, the display 4220 may be a transparent surface that may receive a visual projection. Such projections may convey various forms of information, images, and/or objects. For example, such projections may be a visual overlay for a mobile augmented reality (MAR) application. Under the control of one or more software applications 4216, the platform 4202 may display user interface 4222 on the display 4220.

In embodiments, content services device(s) 4230 may be hosted by any national, international and/or independent service and thus accessible to the platform 4202 via the Internet, for example. The content services device(s) 4230 may be coupled to the platform 4202 and/or to the display 4220. The platform 4202 and/or content services device(s) 4230 may be coupled to a network 4260 to communicate (e.g., send and/or receive) media information to and from network 4260. The content delivery device(s) 4240 also may be coupled to the platform 4202 and/or to the display 4220.

In embodiments, the content services device(s) 4230 may comprise a cable television box, personal computer, network, telephone, Internet enabled devices or appliance capable of delivering digital information and/or content, and any other similar device capable of unidirectionally or bidirectionally communicating content between content providers and platform 4202 and/display 4220, via network 4260 or directly. It will be appreciated that the content may be communicated unidirectionally and/or bidirectionally to and from any one of the components in system 4200 and a content provider via network 4260. Examples of content may include any media information including, for example, video, music, medical and gaming information, and so forth.

The content services device(s) 4230 receives content such as cable television programming including media information, digital information, and/or other content. Examples of content providers may include any cable or satellite television or radio or Internet content providers. The provided examples are not meant to limit embodiments.

In embodiments, the platform 4202 may receive control signals from a navigation controller 4250 having one or more navigation features. The navigation features of the controller 4250 may be used to interact with the user interface 4222, for example. In embodiments, the navigation controller 4250 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 4250 may be echoed on a display (e.g., display 4220) by movements of a pointer, cursor, focus ring, or other visual indicators displayed on the display. For example, under the control of software applications 4216, the navigation features located on the navigation controller 4250 may be mapped to virtual navigation features displayed on the user interface 4222, for example. In embodiments, the controller 4250 may not be a separate component but integrated into the platform 4202 and/or the display 4220. Embodiments, however, are not limited to the elements or in the context shown or described herein.

In embodiments, drivers (not shown) may comprise technology to enable users to instantly turn on and off the platform 4202 like a television with the touch of a button after initial boot-up, when enabled, for example. Program logic may allow the platform 4202 to stream content to media adaptors or other content services device(s) 4230 or content delivery device(s) 4240 when the platform is turned “off” In addition, chipset 4205 may comprise hardware and/or software support for (5.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 4200 may be integrated. For example, the platform 4202 and the content services device(s) 4230 may be integrated, or the platform 4202 and the content delivery device(s) 4240 may be integrated, or the platform 4202, the content services device(s) 4230, and the content delivery device(s) 4240 may be integrated, for example. In various embodiments, the platform 4202 and the display 4220 may be an integrated unit. The display 4220 and content service device(s) 4230 may be integrated, or the display 4220 and the content delivery device(s) 4240 may be integrated, for example. These examples are not meant to limit the embodiments.

In various embodiments, system 4200 may be implemented as a wireless system, a wired system, or a combination of both. When implemented as a wireless system, system 4200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 4200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

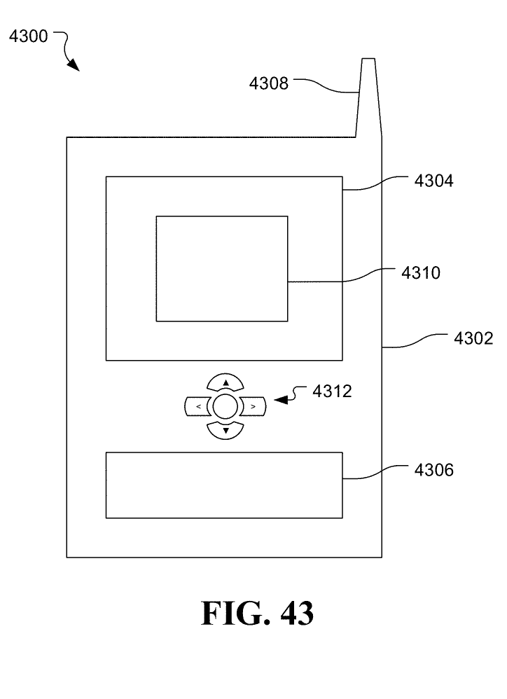

The platform 4202 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 43.

As described above, the system 4200 may be embodied in varying physical styles or form factors. FIG. 43 illustrates embodiments of a small form factor device 4300 in which the system 4200 may be embodied. In embodiments, for example, the device 4300 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 43, the device 4300 may comprise a housing 4302, a display 4304, an input/output (I/O) device 4306, and an antenna 4308. The device 4300 also may comprise navigation features 4312. The display 4304 may comprise any suitable display unit for displaying information appropriate for a mobile computing device. The I/O device 4306 may comprise any suitable I/O device for entering information into a mobile computing device. Examples for the I/O device 4306 may include an alphanumeric keyboard, a numeric keypad, a touch pad, input keys, buttons, switches, rocker switches, microphones, speakers, voice recognition device and software, and so forth. Information also may be entered into the device 4300 by way of microphone. Such information may be digitized by a voice recognition device. The embodiments are not limited in this context.

### ADDITIONAL NOTES AND EXAMPLES

Example 1 may include a system to perform efficient motion based video processing using region-based motion, including: a region-based motion analyzer, the region-based motion analyzer including one or more substrates and logic coupled to the one or more substrates, where the logic is to: obtain a plurality of block motion vectors for a plurality of blocks of a current frame with respect to a reference frame; modify the plurality of block motion vectors, where the modification of the plurality of block motion vectors includes one or more of the following operations: smoothing of at least a portion of the plurality of block motion vectors, merging of at least a portion of the plurality of block motion vectors, and discarding of at least a portion of the plurality of block motion vectors; segment the current frame into a plurality of regions, where the regions include a background region-type including a background moving region, and include a foreground region-type including a single foreground moving region in some instances and a plurality of foreground moving regions in other instances; and a power supply to provide power to the region-based motion analyzer.

Example 2 may include the system of Example 1, where the logic is further to: prior to the segmentation or the current frame into a plurality of regions: restrict the modified plurality of block motion vectors by excluding a portion of the frame in some instances; after the segmentation or the current frame into a plurality of regions: compute a plurality of candidate region-based motion models individually for the background region-type and the foreground region-type based on the restricted-modified plurality of block motion vectors for the current frame with respect to the reference frame, where each candidate region-based motion model includes a set of candidate region-based motion model parameters representing region-based motion of each region-type of the current frame; determine a best region-based motion model from the plurality of candidate region-based motion models on a frame-by-frame basis and on a region-type-by-region-type basis, where each best region-based motion model includes a set of best region-based motion model parameters representing region-based motion of each region-type of the current frame; modify a precision of the best region-based motion model parameters in response to one or more application parameters; map the modified-precision best region-based motion model parameters to a pixel-based coordinate system to determine a plurality of mapped region-based motion warping vectors for a plurality of reference frame control-grid points; predict and encode the plurality of mapped region-based motion warping vectors for the current frame with respect to a plurality of previous mapped region-based motion warping vectors; determine a best sub-pel filter to use for interpolation at an ⅛^{th} pel location or a 1/16^{th} pel location from among two or more sub-pel filter choices per region and per frame; and apply the plurality of mapped region-based motion warping vectors at sub-pel locations to the reference frame per region and perform interpolation of pixels based on the determined best sub-pel filter to generate a region-based motion compensated warped reference frame.

Example 3 may include the system of Example 1, where the segmentation of the current frame into the plurality of regions further includes operations to: background segment the current frame into the background moving region and a non-background moving region, where the initial segmentation of the frame into the background moving region and the non-background moving region is based on purely motion based segmentation when no dominant color is present and is based on color assisted motion based segmentation when dominant color is present; foreground segment the non-background moving region from the single foreground moving region into the plurality of foreground moving regions when dominant motion and peak analysis indicates that more than one foreground moving region is present in the current frame; and where the plurality of regions further include a static region when one or more inactive static area types are present in the current frame, where the static region is subtracted from the non-background moving region prior to the foreground segmentation, where the one or more inactive static areas include one or more of the following inactive static area types: black bar-type inactive static areas, black boarder-type inactive static areas, letterbox-type inactive static areas, logo overlay-type inactive static areas, and text overlay-type inactive static areas.

Example 4 may include the system of Example 1, where the segmentation of the current frame into the plurality of regions further includes operations to: calculate a set of initial global motion model parameters for an initial global motion model for the current frame; use random sampling through a plurality of iterations to selects a set of three linearly independent motion vectors at a time per iteration, where each set of three linearly independent motion vectors are linearly independent motion vectors used to calculate a sampled six parameter global motion model; and generate a histogram for each of the sampled six parameter global motion model to find a best model parameter from a peak value of each parameter, where a set of best model parameters describes an initial global motion equation.

Example 5 may include the system of Example 3, where the background segmentation is performed in at least some instances using several thresholds to create multiple alternate binary masks.

Example 6 may include the system of Example 3, where the segmentation of the current frame into the plurality of regions is performed in at least some instances by morphologically operation of erosion and dilation to form one or more revised segmentations of the plurality of regions.

Example 7 may include the system of Example 2, where the computation of the plurality of candidate region-based motion models further includes operations to: choose a set of global motion models per region in a first mode selected from among four parameter models, six parameter models, and eight parameter models as well as in a second mode selected from among six parameter models, eight parameter models, and twelve parameter models, where the first mode is selected for low definition scene sequences and the second mode is selected for high definition scene sequences; choose a method for computing each individual global motion model of the set of global motion models selected from among least square and Levenberg Marquardt (LMA); and choose one or more convergence parameters for the chosen least square and Levenberg Marquardt method.

Example 8 may include the system of Example 7, further including operations to: select a method for computing each individual global motion model depending on the order of the model including for four and six parameter model using the least square method, and for eight and twelve parameter model using the Levenberg Marquardt method; perform computation of the each global motion model using the related chosen method; and select a best model based on lowest modified distortion.

Example 9 may include the system of Example 7, further including operations to: select a method for computing each individual global motion model depending on the order of the model including for four and six parameter model using the least square method, and for eight and twelve parameter model using the Levenberg Marquardt method; perform computation of the each global motion model using the related chosen method; and select a best model based on a best Rate Distortion Optimization tradeoff that takes into account both distortion as well as rate.

Example 10 may include the system of Example 2, where the modification of the precision of the best region-based motion model parameters further including operations to: determine the significance of each model parameter of the best region-based motion model parameters to define an active range; determine the application parameters including one or more of the following application parameter types: coding bit-rate, resolution, and required quality; and assign a different accuracy to each model parameter of the best region-based motion model parameters based on the determined significance in some instances, based on the determined application parameter in other instances, and based on the determined significance and the determined application parameter in further instances.

Example 11 may include the system of Example 2, where the map of the modified-precision best region-based motion model parameters to the pixel-based coordinate system to determine the plurality of mapped region-based motion warping vectors for the plurality of reference frame control-grid points further includes operations to: map modified precision region-based motion model parameters to pixel-domain based mapped region-based motion warping vectors as applied to control-grid points, where the control-grid points include two vertices of a frame for four parameters, three vertices of a frame for six parameters, all four vertices of a frame for eight parameters, and four vertices of a frame plus two negative-mirror vertices of a frame for twelve parameters.

Example 12 may include the system of Example 2, where the prediction and encode of the plurality of mapped region-based motion warping vectors further includes operations to: predict the warping vectors of the current frame based on one or more previously stored warping vectors to generate first predicted warping vectors, where the previously stored warping vectors are scaled to adjust for frame distance; predict the warping vectors of the current frame based on multiple codebook warping vectors to generate second predicted warping vectors, where the codebook warping vectors are scaled to adjust for frame distance; compute a difference of the warping vectors of the current frame with the first and second predicted warping vectors to generate residual warping vectors; choose a best one of the residual warping vectors based on minimal residual warping vectors, of the first prediction and the second prediction resulting in the selected warping vectors prediction; entropy encode a codebook index associated with the predicted codebook warping vectors when the best residual warping vectors is chosen based on the multiple codebook warping vectors and entropy encode identifying information associated with the one or more previously stored warping vectors when the best residual warping vectors is chosen based on the one or more previously stored warping vectors; and entropy encode the best residual warping vectors.

Example 13 may include the system of Example 2, where predicting and encoding warping vectors further includes operations to: predict the warping vectors of the current frame based on a most recently stored warping vectors to generate first predicted warping vectors, where the most recently stored warping vectors are scaled to adjust for frame distance, and where the most recently stored warping vectors are mapped at initialization to one-half of a number of region-based motion parameters of the current frame; predict the warping vectors of the current frame based on multiple codebook warping vectors to generate second predicted warping vectors, where the codebook warping vectors are scaled to adjust for frame distance; compute a difference of the warping vectors of the current frame with the first and second predicted warping vectors to generate residual warping vectors; choose a best one of the residual warping vectors based on minimal residual warping vectors, of the first prediction and the second prediction resulting in the selected warping vectors prediction; entropy encode a codebook index associated with the predicted codebook warping vectors when the best residual warping vectors is chosen based on the multiple codebook warping vectors and entropy encode identifying information associated with the most recently stored warping vectors when the best residual warping vectors is chosen based on the most recently stored warping vectors; and entropy encode the best residual warping vectors.

Example 14 may include the system of Example 2, where the determination of the best sub-pel filter to use for interpolation at the ⅛^{th} pel location from among the two or more sub-pel filter choices per frame further includes operations to: determine the application parameters including one or more of the following application parameter types: coding bit-rate, resolution, and required quality; determine a filter overhead bit-cost that can be afforded based on the application parameters to determine whether the best sub-pel filter can be sent on one of the following basis: a per frame basis, a per slice basis, and a per large block basis; determine for each of the two or more sub-pel filter choices: an extended-AVC ¼^{th} pel filter to ⅛^{th} pel accuracy, and an extended HEVC ¼^{th} pel filter to ⅛^{th} pel accuracy, and where the determination of the best sub-pel filter is determined by computing a residual of at least a portion of the current frame with respect to a corresponding portion of the region-based motion compensated warped reference frame, and by selection of the best of the two or more sub-pel filter choices per frame that produces the smallest residual, where the portion of the current frame chosen to correspond to based on the basis of the best sub-pel filter from among the per frame basis, the per slice basis, and the per large block basis.

Example 15 may include the system of Example 2, where the determination of the best sub-pel filter further includes operations to: determine the application parameters including one or more of the following application parameter types: coding bit-rate, resolution, and required quality; determine a filter overhead bit-cost that can be afforded based on the application parameters to determine whether the best sub-pel filter can be sent on one of the following basis: a per frame basis, a per slice basis, and a per large block basis; determine for each of four filter choices of the two or more sub-pel filter choices: an extended-AVC ¼^{th} pel filter to ⅛^{th} pel accuracy, an extended HEVC ¼^{th} pel filter to ⅛^{th} pel accuracy, a bi-linear 1/16^{th} pel filter, and a bi-cubic 1/16^{th} pel filter, and where the determination of the best filter is determined by computing a residual of at least a portion of the current frame with respect to a corresponding portion of the region-based motion compensated warped reference frame, and by selection of the best of the four filters per frame that produces the smallest residual, where the portion of the current frame chosen to correspond to based on the basis of the best sub-pel filter from among the per frame basis, the per slice basis, and the per large block basis.

Example 16 may include the system of Example 1, where the logic coupled to the one or more substrates includes transistor channel regions that are positioned within the one or more substrates.

Example 17 may include a method to perform efficient motion based video processing using region-based motion, including: obtaining and modifying a plurality of block motion vectors of a current frame with respect to a reference frame of a video sequence, where the modification of the plurality of block motion vectors includes one or more of the following operations: smoothing of at least a portion of the plurality of block motion vectors, merging of at least a portion of the plurality of block motion vectors, and discarding of at least a portion of the plurality of block motion vectors; performing pre-segmentation based on motion global features in some instances and based on a combination of color and motion global features in other instances, where the pre-segmentation includes segmenting a background region-type including a background moving region; performing segmentation of each frame of the video sequence into a plurality of regions based on the pre-segmentation and based on local features, where the local features include one or more of the following: color local features, motion local features, texture local features, and any combination thereof; where each of the plurality of regions are spatially and temporally consistent, and where the segmentation includes segmenting a foreground region-type including a single foreground moving region in certain instances and a plurality of foreground moving regions in different instances; computing a best region-based parametric motion model based on a plurality of modified region-based parametric motion models, including computing the plurality of modified region-based parametric motion models using modified block motion vectors for at least one of the plurality of regions of the video sequence using a least square fitting in particular instances and an Levenberg Marquardt (LMA) iterative optimization in further instances, where the best region-based parametric motion model one of the following: a 4 parameter motion model, a 6 parameter motion model, an 8 parameter motion model, and a 12 parameter motion model, and where the modified region-based parametric motion models are modified by adaptively reducing accuracy of model parameters for efficient coding; and generating a prediction region for one of the plurality of regions of the current frame region by using the best region-based parametric motion model parameters on the reference frame and on one of the plurality of regions of the video sequence for which the best region-based parametric motion model parameters were computed.

Example 18 may include the method of Example 17, where performing segmentation further includes segmentation of each frame of the video sequence into at least two regions that are not only spatially and temporally consistent but are also semantically coherent.

Example 19 may include the method of Example 18, where computing the best region-based parametric motion model further includes: calculating two modified region-based parametric motion models simultaneously for a select region of the plurality of regions, where the two models include two of the following models: such as a 4 parameter model, a different 4 parameter model, a 6 parameter model, a different 6 parameter model, an 8 parameter model, a different 8 parameter model, a 12 parameter 4 parameter model, and a different 12 parameter model; and selecting the best parametric motion model for that region.

Example 20 may include the method of Example 18, where computing the best region-based parametric motion model further includes: calculating two modified region-based parametric motion models simultaneously for the foreground region-type and the background region-type, where the two modified region-based parametric motion models include two of the following models: such as a 4 parameter model, a different 4 parameter model, a 6 parameter model, a different 6 parameter model, an 8 parameter model, a different 8 parameter model, a 12 parameter 4 parameter model, and a different 12 parameter model; and selecting the best parametric motion model for both the foreground region-type and the background region-type.

Example 21 may include the method of Example 17, where performing segmentation further includes segmenting each frame of the video sequence into three or more regions that are not only spatially and temporally consistent but are also semantically coherent.

Example 22 may include the method of Example 17, where the generation of the prediction region further includes: determining a first best subpel filter adaptively to use for interpolation at a ⅛^{th} pel location accuracy based on residual error from among two choices: a first being an AVC standard based ¼ pel interpolation extended to ⅛^{th} pel, and a second being an HEVC standard based ¼ pel interpolation extended to ⅛ pel; determining a second best subpel filter adaptively to use for interpolation at a 1/16^{th} pel location accuracy based on residual error from among two choices: a first being a bilinear filtering based 1/16 pel interpolation, and a second being a bicubic filtering based 1/16 pel interpolation; and selecting a final best subpel filter to use for interpolation from among the first best subpel filter and the second best subpel filter choices based on residual error.

Example 23 may include the method of Example 17, further including coding region-based motion model parameters via prediction and entropy coding and coding region boundary information via explicit encoding with a small block accuracy using one or more of the following accuracies: 4 pel small block accuracy, 8 pel small block accuracy, and 16 pel small block accuracy.

Example 24 may include the method of Example 17, further including coding region-based motion model parameters via prediction and entropy coding and coding region boundary information via implicitly encoding using an extension of standard coding mode tables to associate a block being coded with the corresponding region the block being coded belongs to.

Example 25 may include at least one computer readable storage medium including a set of instructions, which when executed by a computing system, cause the computing system to: obtain a plurality of block motion vectors for a plurality of blocks of a current frame with respect to a reference frame; modify the plurality of block motion vectors, where the modification of the plurality of block motion vectors includes one or more of the following operations: smoothing of at least a portion of the plurality of block motion vectors, merging of at least a portion of the plurality of block motion vectors, and discarding of at least a portion of the plurality of block motion vectors; and segment the current frame into a plurality of regions, where the regions include a background region-type including a background moving region, and include a foreground region-type including a single foreground moving region in some instances and a plurality of foreground moving regions in other instances.

Example 26 may include the at least one computer readable storage medium of Example 25, where the instructions, when executed, cause the computing system to: prior to the segmentation or the current frame into a plurality of regions: restrict the modified plurality of block motion vectors by excluding a portion of the frame in some instances; after the segmentation or the current frame into a plurality of regions: compute a plurality of candidate region-based motion models individually for the background region-type and the foreground region-type based on the restricted-modified plurality of block motion vectors for the current frame with respect to the reference frame, where each candidate region-based motion model includes a set of candidate region-based motion model parameters representing region-based motion of each region-type of the current frame; determine a best region-based motion model from the plurality of candidate region-based motion models on a frame-by-frame basis and on a region-type-by-region-type basis, where each best region-based motion model includes a set of best region-based motion model parameters representing region-based motion of each region-type of the current frame; modify a precision of the best region-based motion model parameters in response to one or more application parameters; map the modified-precision best region-based motion model parameters to a pixel-based coordinate system to determine a plurality of mapped region-based motion warping vectors for a plurality of reference frame control-grid points; predict and encode the plurality of mapped region-based motion warping vectors for the current frame with respect to a plurality of previous mapped region-based motion warping vectors; determine a best sub-pel filter to use for interpolation at an ⅛th pel location or a 1/16th pel location from among two or more sub-pel filter choices per region and per frame; and apply the plurality of mapped region-based motion warping vectors at sub-pel locations to the reference frame per region and perform interpolation of pixels based on the determined best sub-pel filter to generate a region-based motion compensated warped reference frame.

Example 27 may include means for performing a method as described in any preceding Example.

Example 28 may include machine-readable storage including machine-readable instructions which, when executed, implement a method or realize an apparatus as described in any preceding Example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually include one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A system to perform efficient motion based video processing using region-based motion, comprising:
a region-based motion analyzer, the region-based motion analyzer including one or more substrates and logic coupled to the one or more substrates, wherein the logic is to:
obtain a plurality of block motion vectors for a plurality of blocks of a current frame with respect to a reference frame;
modify the plurality of block motion vectors, wherein the modification of the plurality of block motion vectors includes one or more of the following operations: smoothing of at least a portion of the plurality of block motion vectors, merging of at least a portion of the plurality of block motion vectors, and discarding of at least a portion of the plurality of block motion vectors;
segment the current frame into a plurality of regions, wherein the regions comprise a background region-type including a background moving region, and comprise a foreground region-type including a single foreground moving region in some instances and a plurality of foreground moving regions in other instances; and
a power supply to provide power to the region-based motion analyzer.

2. The system of claim 1, wherein the logic is further to:
prior to the segmentation or the current frame into a plurality of regions:
restrict the modified plurality of block motion vectors by excluding a portion of the frame in some instances;
after the segmentation or the current frame into a plurality of regions:
compute a plurality of candidate region-based motion models individually for the background region-type and the foreground region-type based on the restricted-modified plurality of block motion vectors for the current frame with respect to the reference frame, wherein each candidate region-based motion model comprises a set of candidate region-based motion model parameters representing region-based motion of each region-type of the current frame;
determine a best region-based motion model from the plurality of candidate region-based motion models on a frame-by-frame basis and on a region-type-by-region-type basis, wherein each best region-based motion model comprises a set of best region-based motion model parameters representing region-based motion of each region-type of the current frame;
modify a precision of the best region-based motion model parameters in response to one or more application parameters;
map the modified-precision best region-based motion model parameters to a pixel-based coordinate system to determine a plurality of mapped region-based motion warping vectors for a plurality of reference frame control-grid points;
predict and encode the plurality of mapped region-based motion warping vectors for the current frame with respect to a plurality of previous mapped region-based motion warping vectors;
determine a best sub-pel filter to use for interpolation at an ⅛^{th} pel location or a 1/16^{th} pel location from among two or more sub-pel filter choices per region and per frame; and
apply the plurality of mapped region-based motion warping vectors at sub-pel locations to the reference frame per region and perform interpolation of pixels based on the determined best sub-pel filter to generate a region-based motion compensated warped reference frame.

3. The system of claim 1, wherein the segmentation of the current frame into the plurality of regions further comprises operations to:
background segment the current frame into the background moving region and a non-background moving region, wherein the initial segmentation of the frame into the background moving region and the non-background moving region is based on purely motion based segmentation when no dominant color is present and is based on color assisted motion based segmentation when dominant color is present;
foreground segment the non-background moving region from the single foreground moving region into the plurality of foreground moving regions when dominant motion and peak analysis indicates that more than one foreground moving region is present in the current frame; and
wherein the plurality of regions further include a static region when one or more inactive static area types are present in the current frame, wherein the static region is subtracted from the non-background moving region prior to the foreground segmentation, wherein the one or more inactive static areas include one or more of the following inactive static area types: black bar-type inactive static areas, black boarder-type inactive static areas, letterbox-type inactive static areas, logo overlay-type inactive static areas, and text overlay-type inactive static areas.

4. The system of claim 1, wherein the segmentation of the current frame into the plurality of regions further comprises operations to:
calculate a set of initial global motion model parameters for an initial global motion model for the current frame;
use random sampling through a plurality of iterations to selects a set of three linearly independent motion vectors at a time per iteration, wherein each set of three linearly independent motion vectors are linearly independent motion vectors used to calculate a sampled six parameter global motion model; and
generate a histogram for each of the sampled six parameter global motion model to find a best model parameter from a peak value of each parameter, wherein a set of best model parameters describes an initial global motion equation.

5. The system of claim 3, wherein the background segmentation is performed in at least some instances using several thresholds to create multiple alternate binary masks.

6. The system of claim 3, wherein the segmentation of the current frame into the plurality of regions is performed in at least some instances by morphologically operation of erosion and dilation to form one or more revised segmentations of the plurality of regions.

7. The system of claim 2, wherein the computation of the plurality of candidate region-based motion models further comprises operations to:
choose a set of global motion models per region in a first mode selected from among four parameter models, six parameter models, and eight parameter models as well as in a second mode selected from among six parameter models, eight parameter models, and twelve parameter models, wherein the first mode is selected for low definition scene sequences and the second mode is selected for high definition scene sequences;
choose a method for computing each individual global motion model of the set of global motion models selected from among least square and Levenberg Marquardt (LMA); and
choose one or more convergence parameters for the chosen least square and Levenberg Marquardt method.

8. The system of claim 7, further comprising operations to:
select a method for computing each individual global motion model depending on the order of the model including for four and six parameter model using the least square method, and for eight and twelve parameter model using the Levenberg Marquardt method;
perform computation of the each global motion model using the related chosen method; and
select a best model based on lowest modified distortion.

9. The system of claim 7, further comprising operations to:
select a method for computing each individual global motion model depending on the order of the model including for four and six parameter model using the least square method, and for eight and twelve parameter model using the Levenberg Marquardt method;
perform computation of the each global motion model using the related chosen method; and
select a best model based on a best Rate Distortion Optimization tradeoff that takes into account both distortion as well as rate.

10. The system of claim 2, wherein the modification of the precision of the best region-based motion model parameters further comprises operations to:
determine the significance of each model parameter of the best region-based motion model parameters to define an active range;
determine the application parameters including one or more of the following application parameter types: coding bit-rate, resolution, and required quality; and
assign a different accuracy to each model parameter of the best region-based motion model parameters based on the determined significance in some instances, based on the determined application parameter in other instances, and based on the determined significance and the determined application parameter in further instances.

11. The system of claim 2, wherein the map of the modified-precision best region-based motion model parameters to the pixel-based coordinate system to determine the plurality of mapped region-based motion warping vectors for the plurality of reference frame control-grid points further comprises operations to:
map modified precision region-based motion model parameters to pixel-domain based mapped region-based motion warping vectors as applied to control-grid points, wherein the control-grid points comprise two vertices of a frame for four parameters, three vertices of a frame for six parameters, all four vertices of a frame for eight parameters, and four vertices of a frame plus two negative-mirror vertices of a frame for twelve parameters.

12. The system of claim 2, wherein the prediction and encode of the plurality of mapped region-based motion warping vectors further comprises operations to:
predict the warping vectors of the current frame based on one or more previously stored warping vectors to generate first predicted warping vectors, wherein the previously stored warping vectors are scaled to adjust for frame distance;
predict the warping vectors of the current frame based on multiple codebook warping vectors to generate second predicted warping vectors, wherein the codebook warping vectors are scaled to adjust for frame distance;
compute a difference of the warping vectors of the current frame with the first and second predicted warping vectors to generate residual warping vectors;
choose a best one of the residual warping vectors based on minimal residual warping vectors, of the first prediction and the second prediction resulting in the selected warping vectors prediction;
entropy encode a codebook index associated with the predicted codebook warping vectors when the best residual warping vectors is chosen based on the multiple codebook warping vectors and entropy encode identifying information associated with the one or more previously stored warping vectors when the best residual warping vectors is chosen based on the one or more previously stored warping vectors; and
entropy encode the best residual warping vectors.

13. The system of claim 2, wherein predicting and encoding warping vectors further comprises operations to:
predict the warping vectors of the current frame based on a most recently stored warping vectors to generate first predicted warping vectors, wherein the most recently stored warping vectors are scaled to adjust for frame distance, and wherein the most recently stored warping vectors are mapped at initialization to one-half of a number of region-based motion parameters of the current frame;
predict the warping vectors of the current frame based on multiple codebook warping vectors to generate second predicted warping vectors, wherein the codebook warping vectors are scaled to adjust for frame distance;
compute a difference of the warping vectors of the current frame with the first and second predicted warping vectors to generate residual warping vectors;
choose a best one of the residual warping vectors based on minimal residual warping vectors, of the first prediction and the second prediction resulting in the selected warping vectors prediction;
entropy encode a codebook index associated with the predicted codebook warping vectors when the best residual warping vectors is chosen based on the multiple codebook warping vectors and entropy encode identifying information associated with the most recently stored warping vectors when the best residual warping vectors is chosen based on the most recently stored warping vectors; and
entropy encode the best residual warping vectors.

14. The system of claim 2, wherein the determination of the best sub-pel filter to use for interpolation at the ⅛^{th} pel location from among the two or more sub-pel filter choices per frame further comprises operations to:
determine the application parameters including one or more of the following application parameter types: coding bit-rate, resolution, and required quality;
determine a filter overhead bit-cost that can be afforded based on the application parameters to determine whether the best sub-pel filter can be sent on one of the following basis: a per frame basis, a per slice basis, and a per large block basis;
determine for each of the two or more sub-pel filter choices: an extended-AVC ¼^{th} pel filter to ⅛^{th} pel accuracy, and an extended HEVC ¼^{th} pel filter to ⅛^{th} pel accuracy, and
wherein the determination of the best sub-pel filter is determined by computing a residual of at least a portion of the current frame with respect to a corresponding portion of the region-based motion compensated warped reference frame, and by selection of the best of the two or more sub-pel filter choices per frame that produces the smallest residual, wherein the portion of the current frame chosen to correspond to based on the basis of the best sub-pel filter from among the per frame basis, the per slice basis, and the per large block basis.

15. The system of claim 2, wherein the determination of the best sub-pel filter further comprises operations to:
determine the application parameters including one or more of the following application parameter types: coding bit-rate, resolution, and required quality;
determine a filter overhead bit-cost that can be afforded based on the application parameters to determine whether the best sub-pel filter can be sent on one of the following basis: a per frame basis, a per slice basis, and a per large block basis;
determine for each of four filter choices of the two or more sub-pel filter choices: an extended-AVC ¼^{th} pel filter to ⅛^{th} pel accuracy, an extended HEVC ¼th pel filter to ⅛^{th} pel accuracy, a bi-linear 1/16^{th} pel filter, and a bi-cubic 1/16^{th} pel filter, and
wherein the determination of the best filter is determined by computing a residual of at least a portion of the current frame with respect to a corresponding portion of the region-based motion compensated warped reference frame, and by selection of the best of the four filters per frame that produces the smallest residual, wherein the portion of the current frame chosen to correspond to based on the basis of the best sub-pel filter from among the per frame basis, the per slice basis, and the per large block basis.

16. The system of claim 1, wherein the logic coupled to the one or more substrates includes transistor channel regions that are positioned within the one or more substrates.

17. A method to perform efficient motion based video processing using region-based motion, comprising:
obtaining and modifying a plurality of block motion vectors of a current frame with respect to a reference frame of a video sequence, wherein the modification of the plurality of block motion vectors includes one or more of the following operations: smoothing of at least a portion of the plurality of block motion vectors, merging of at least a portion of the plurality of block motion vectors, and discarding of at least a portion of the plurality of block motion vectors;
performing pre-segmentation based on motion global features in some instances and based on a combination of color and motion global features in other instances, wherein the pre-segmentation comprises segmenting a background region-type including a background moving region;
performing segmentation of each frame of the video sequence into a plurality of regions based on the pre-segmentation and based on local features, wherein the local features include one or more of the following: color local features, motion local features, texture local features, and any combination thereof; wherein each of the plurality of regions are spatially and temporally consistent, and wherein the segmentation comprises segmenting a foreground region-type including a single foreground moving region in certain instances and a plurality of foreground moving regions in different instances;
computing a best region-based parametric motion model based on a plurality of modified region-based parametric motion models, including computing the plurality of modified region-based parametric motion models using modified block motion vectors for at least one of the plurality of regions of the video sequence using a least square fitting in particular instances and an Levenberg Marquardt (LMA) iterative optimization in further instances, wherein the best region-based parametric motion model one of the following: a 4 parameter motion model, a 6 parameter motion model, an 8 parameter motion model, and a 12 parameter motion model, and wherein the modified region-based parametric motion models are modified by adaptively reducing accuracy of model parameters for efficient coding; and
generating a prediction region for one of the plurality of regions of the current frame region by using the best region-based parametric motion model parameters on the reference frame and on one of the plurality of regions of the video sequence for which the best region-based parametric motion model parameters were computed.

18. The method of claim 17, wherein performing segmentation further comprises segmentation of each frame of the video sequence into at least two regions that are not only spatially and temporally consistent but are also semantically coherent.

19. The method of claim 18, wherein computing the best region-based parametric motion model further comprises:
calculating two modified region-based parametric motion models simultaneously for a select region of the plurality of regions, wherein the two models include two of the following models: such as a 4 parameter model, a different 4 parameter model, a 6 parameter model, a different 6 parameter model, an 8 parameter model, a different 8 parameter model, a 12 parameter 4 parameter model, and a different 12 parameter model; and
selecting the best parametric motion model for that region.

20. The method of claim 18, wherein computing the best region-based parametric motion model further comprises:
calculating two modified region-based parametric motion models simultaneously for the foreground region-type and the background region-type, wherein the two modified region-based parametric motion models include two of the following models: such as a 4 parameter model, a different 4 parameter model, a 6 parameter model, a different 6 parameter model, an 8 parameter model, a different 8 parameter model, a 12 parameter 4 parameter model, and a different 12 parameter model; and
selecting the best parametric motion model for both the foreground region-type and the background region-type.

21. The method of claim 17, wherein performing segmentation further comprises:
segmenting each frame of the video sequence into three or more regions that are not only spatially and temporally consistent but are also semantically coherent.

22. The method of claim 17, wherein the generation of the prediction region further comprises:
determining a first best subpel filter adaptively to use for interpolation at a ⅛^{th} pel location accuracy based on residual error from among two choices: a first being an AVC standard based ¼ pel interpolation extended to ⅛^{th} pel, and a second being an HEVC standard based ¼ pel interpolation extended to ⅛ pel;
determining a second best subpel filter adaptively to use for interpolation at a 1/16^{th} pel location accuracy based on residual error from among two choices: a first being a bilinear filtering based 1/16 pel interpolation, and a second being a bicubic filtering based 1/16 pel interpolation; and
selecting a final best subpel filter to use for interpolation from among the first best subpel filter and the second best subpel filter choices based on residual error.

23. The method of claim 17, further comprising:
coding region-based motion model parameters via prediction and entropy coding and coding region boundary information via explicit encoding with a small block accuracy using one or more of the following accuracies: 4 pel small block accuracy, 8 pel small block accuracy, and 16 pel small block accuracy.

24. The method of claim 17, further comprising:
coding region-based motion model parameters via prediction and entropy coding and coding region boundary information via implicitly encoding using an extension of standard coding mode tables to associate a block being coded with the corresponding region the block being coded belongs to.

25. At least one computer readable storage medium comprising a set of instructions, which when executed by a computing system, cause the computing system to:
obtain a plurality of block motion vectors for a plurality of blocks of a current frame with respect to a reference frame;
modify the plurality of block motion vectors, wherein the modification of the plurality of block motion vectors includes one or more of the following operations: smoothing of at least a portion of the plurality of block motion vectors, merging of at least a portion of the plurality of block motion vectors, and discarding of at least a portion of the plurality of block motion vectors; and
segment the current frame into a plurality of regions, wherein the regions comprise a background region-type including a background moving region, and comprise a foreground region-type including a single foreground moving region in some instances and a plurality of foreground moving regions in other instances.

26. The at least one computer readable storage medium of claim 25, wherein the instructions, when executed, cause the computing system to:
prior to the segmentation or the current frame into a plurality of regions:
restrict the modified plurality of block motion vectors by excluding a portion of the frame in some instances;
after the segmentation or the current frame into a plurality of regions:
compute a plurality of candidate region-based motion models individually for the background region-type and the foreground region-type based on the restricted-modified plurality of block motion vectors for the current frame with respect to the reference frame, wherein each candidate region-based motion model comprises a set of candidate region-based motion model parameters representing region-based motion of each region-type of the current frame;
determine a best region-based motion model from the plurality of candidate region-based motion models on a frame-by-frame basis and on a region-type-by-region-type basis, wherein each best region-based motion model comprises a set of best region-based motion model parameters representing region-based motion of each region-type of the current frame;
modify a precision of the best region-based motion model parameters in response to one or more application parameters;
map the modified-precision best region-based motion model parameters to a pixel-based coordinate system to determine a plurality of mapped region-based motion warping vectors for a plurality of reference frame control-grid points;
predict and encode the plurality of mapped region-based motion warping vectors for the current frame with respect to a plurality of previous mapped region-based motion warping vectors;
determine a best sub-pel filter to use for interpolation at an ⅛^{th} pel location or a 1/16^{th} pel location from among two or more sub-pel filter choices per region and per frame; and
apply the plurality of mapped region-based motion warping vectors at sub-pel locations to the reference frame per region and perform interpolation of pixels based on the determined best sub-pel filter to generate a region-based motion compensated warped reference frame.
